(19) United States
(12) Patent Application Publication
(10) Pub. No.: US 2006/0282356 A1
(43) Pub. Date: Dec. 14, 2006

(54) System and method for structured put auction rate combination structure

(76) Inventors: Brad Andres, Hoboken, NJ (US); Thomas J. O'Hara, Belle Meade, NJ (US)

Correspondence Address: MORGAN LEWIS & BOCKIUS LLP, 1111 PENNSYLVANIA AVENUE NW, WASHINGTON, DC, 20004, US

(21) Appl. No.: 11/107,720

(22) Filed: Apr. 15, 2005

Related U.S. Application Data
(60) Provisional application No. 60/562,591, filed on Apr. 15, 2004.

(51) Int. Cl. G06Q 40/00

(52) U.S. Cl. 705/35; 705/37

(57) ABSTRACT

A trust can issue notes based on pooled home equity lines of credit (HELOCs). During a predetermined period, interest and principal payments can be made in connection with the HELOCs can be used to make payments to noteholders, to further capitalize or enhance the underlying loans or certificates based on those loans, or can be placed in a reserve fund. In an embodiment, on a defined date, the notes can be offered for auction. Where market clearing bids are within preferred parameters, the noteholders can sell their notes at par value. Where market clearing bids are within acceptable, but not preferred parameters, the noteholders can sell their notes at a discount value, with a backstop amount paid to the noteholders by a guarantor. Where the auction fails, the noteholders can retain their notes, and can be paid a backstop amount by the guarantor, up to a maximum backstop amount.

### CROSS-REFERENCE TO RELATED APPLICATIONS

This application claims the benefit of U.S. Provisional Application No. 60/562,591, filed Apr. 15, 2004. The entire contents of the above application are incorporated herein by reference.

### FIELD

This invention relates to the field of securitization of home equity lines of credit.

### BACKGROUND

A Home Equity Line of Credit loan agreement can be referred to as a HELOC or home equity line of credit. HELOCs are typically variable rate, open-ended, revolving lines of credit secured by first or second lien positions against the available equity of the borrower's residential properties. HELOCs can be secured by liens on the related mortgaged properties subject to various limitations. Some banks offer their customers credit lines that can allow them to borrow against the value of the real estate up to 100% of the property's value. The maximum amount that can be borrowed differs among HELOCs and can be limited based on the loan amount, property type, borrower's credit score, and underwriting documentation used for approval of the HELOCs. These credit lines generally have an associated combined loan-to-value (“CLTV”) ratio.

### SUMMARY

In an embodiment, HELOCs can be pooled and serviced. These pooled loans can then be consolidated and purchased by a trust. The trust can then issue notes with the underlying loans pledged as collateral for the notes. In this embodiment, the payments received on the HELOCs can be used to make payments on the issued notes. In an embodiment, the trust can issue certificates (“underlying certificates”), backed by the HELOCs, to capitalize the issuance of the notes. In this embodiment, distributions on the underlying certificates can be used to make payments on the issued notes.

During a predetermined (revolving) period, interest payments made in connection with the original HELOCs can be used to make payments to noteholders, and also to further capitalize or enhance the underlying loans or certificates. Principal payments received can be used to fund the acquisition of new HELOCs to maintain the loan balance of the pool. A portion of the payments can be placed in a reserve fund. In an embodiment, on a defined date, the notes can be offered for auction. Where market clearing bids are within preferred parameters, the noteholders can sell their notes at par value, and the new purchaser(s) can receive future note payments. As described in detail below, preferred parameters can be assigned using a coupon cap rate, which can be determined through statistical or other methods. The coupon cap rate can be a maximum bid price accepted that can result in a par value payment to noteholders without a backstop payment being made. By way of non-limiting example, a coupon cap rate of LIBOR +0.45% can be a preferred parameter such that all bids received below the coupon cap rate can be considered to be within preferred parameters.

Where market clearing bids are within acceptable, but not preferred parameters, the noteholders can sell their notes at a discount value, and the noteholders can be paid a par value that can include a backstop payment to the noteholders to offset the discounted price. As described in detail below, acceptable parameters can be assigned using the coupon cap rate and a fail rate (both discussed in detail below), which can be determined through statistical or other methods. The fail rate can be a maximum bid price accepted that can result in a successful auction, and can result in a backstop payment being made. By way of non-limiting example, bids between a coupon cap rate of LIBOR +0.45% and a fail rate of LIBOR +0.90% can be considered to be within acceptable parameters.

Where market clearing bids are above the fail rate, the auction fails, the noteholders can retain their notes, and can be paid a maximum backstop amount. In this scenario, the noteholders can continue to receive note payments, and the notes can amortize normally.

With a backstop amount in place, noteholders can have an increased likelihood of receiving par value for their notes. As will be recognized, a backstop amount can be guaranteed through a guarantor or through posted collateral. A maximum backstop amount can be defined, such that the guarantor can be assured that it will not have unlimited liability to the noteholders. The preferred parameters, acceptable parameters, coupon cap rate(s), and fail rate(s), as well as the backstop amount, and the maximum backstop amount can be calculated using computer implemented components and steps as will be apparent to those skilled in the art. As noted below, in addition to the auction, other outcome determinative events can transpire, resulting in noteholders retaining their notes and/or no backstop amount being paid to the noteholder.

In an embodiment, a successful auction can be one where market clearing bids are within the preferred or acceptable parameters, and a failed auction cab be one where there are no market clearing bids within preferred or acceptable parameters, or where all bids are above the fail rate. The disclosed system and method can calculate a new coupon margin for interest payments following a successful auction. This new coupon margin can include using the most favorable market clearing bid from the preferred or the acceptable bids. As will be recognized, these calculations can be determined using computer implemented components and steps.

In an aspect, the present invention is directed to a method for determining a coupon margin comprising:

establishing one or more collateralized notes each having a first coupon margin, said first coupon margin comprising one or more periodic distributions and one or more periodic payments for a predetermined time;

at the expiration of the predetermined time, holding an auction for the one or more collateralized notes, said auction comprising one or more auction bids from each of one or more parties;

calculating a second coupon margin based on at least one of the one or more auction bids;

transferring the one or more collateralized notes to at least one of the one or more parties; and

making a par payment.

In an aspect of the present invention, a portion of the par payment comprises an amount provided by a guarantor.

In an aspect of the present invention, the one or more collateralized notes are secured by a lot loan pool certificate.

In an aspect of the present invention, the one or more collateralized notes are secured by a lot loan pool.

In an aspect of the present invention, a portion of the par payment is calculated using a backstop amount.

In an aspect of the present invention, said one or more collateralized notes are secured by a HELOC loan pool certificate.

In an aspect of the present invention, said one or more collateralized notes are secured by a HELOC loan pool.

In an aspect, the present invention is directed to a method for determining a coupon margin comprising:

establishing one or more collateralized notes each having a first coupon margin, said first coupon margin comprising one or more periodic distributions and one or more periodic payments for a predetermined time;

at the expiration of the predetermined time, holding an auction for the one or more collateralized notes, said auction comprising one or more bids from each of one or more parties;

if no bid is within one or more parameters, setting a second coupon margin based on at least one of said one or more parameters; and

making a backstop payment.

In an aspect, the present invention is directed to a method for limiting guarantor exposure in a note auction comprising:
setting a preferred coupon margin, an acceptable coupon margin, and a maximum coupon margin in a note auction;
holding said note auction;
where the note auction results in the preferred coupon margin, paying a par value comprising proceeds from the note auction;
where the note auction results in the acceptable coupon margin, paying the par value comprising proceeds from the note auction and a backstop payment; and
where the note auction exceeds the maximum coupon margin, paying only a backstop payment.

In an aspect, the present invention is directed to a method for ensuring par payments to one or more note owners comprising:

setting a preferred coupon margin and an acceptable coupon margin in a note auction; holding said note auction;

where the note auction results in the preferred coupon margin, paying a par value comprising proceeds from the note auction; and

where the note auction results in the acceptable coupon margin, paying the par value comprising proceeds from the note auction and a backstop payment.

### FIGURES

FIG. 1 is a flow chart illustrating the present system and method; and

FIG. 2 is composite block/flow diagram illustrating the present system and method.

### DETAILED DESCRIPTION

The detailed description below illustrates a novel structure for the securitization of home equity lines of credit (HELOCs). Features of the present system and method are illustrated below in the various embodiments, and can include bullet-like maturity of notes provided by a mandatory auction mechanism at the end of a predetermined (revolving) period. The revolving period may vary in length, as described below, and by way of non-limiting example, can be 24 months. Further, a mandatory auction mechanism is disclosed that can determine a new coupon margin for interest payments following a predetermined period. The initial noteholders can receive a par payment of principal from the auction proceeds. The stated margin can be subject to a maximum margin. Additionally, a backstop mechanism is disclosed that can guarantee the par takeout of the initial noteholders in the event that the required coupon margin for a par price set at auction exceeds the maximum margin. In an embodiment, the backstop provider (by way of non-limiting example, a guarantor) can pay a market value adjustment (the “Backstop Amount”) to noteholders to cover the discount associated with a coupon margin equal to the maximum margin and a discount margin equal to the rate determined at auction. Further, the auction can be deemed to have failed to the extent the auction rate margin exceeds a “fail rate”; in this case, the original noteholders can retain the notes but receive a payment equal to the backstop amount associated with a margin equal to the maximum margin and a discount margin equal to the fail rate.

In an embodiment, HELOCs can be pooled and serviced. These pooled loans can then be consolidated and purchased by a trust. The trust can then issue notes with the underlying loans pledged as collateral for the notes. In this embodiment, the payments received on the HELOCs can be used to make payments on the issued notes. In an embodiment, the trust can issue certificates (“underlying certificates”), backed by the HELOCs, to capitalize the issuance of the notes. In this embodiment, distributions on the underlying certificates can be used to make payments on the issued notes.

During a predetermined (revolving) period, interest payments made in connection with the original HELOCs can be used to make payments to noteholders, and also to further capitalize or enhance the underlying loans or certificates. Principal payments received can be used to fund the acquisition of new HELOCs to maintain the loan balance. A portion of the payments can be placed in a reserve fund. In an embodiment, on a defined date, the notes can be offered for auction. Where market clearing bids are within preferred parameters, the noteholders can sell their notes at par value, and the new purchaser(s) can receive future note payments. As described in detail below, preferred parameters can be assigned using a coupon cap rate, which can be determined through statistical or other methods. The coupon cap rate can be a maximum bid price accepted that can result in a par value payment to noteholders without a backstop payment being made. By way of non-limiting example, a coupon cap rate of LIBOR +0.45% can be a preferred parameter such that all bids received below the coupon cap rate can be considered to be within preferred parameters.

Where market clearing bids are within acceptable, but not preferred parameters, the noteholders can sell their notes at a discount value, and the noteholders can be paid a par value that can include a backstop payment to the noteholders to offset the discounted price. As described in detail below, acceptable parameters can be assigned using the coupon cap rate and a fail rate (both discussed in detail below), which can be determined through statistical or other methods. The fail rate can be a maximum bid price accepted that can result in a successful auction, and can result in a backstop payment being made. By way of non-limiting example, bids between a coupon cap rate of LIBOR +0.45% and a fail rate of LIBOR +0.90% can be considered to be within acceptable parameters.

Where market clearing bids are above the fail rate, the auction fails, the noteholders can retain their notes, and can be paid a maximum backstop amount. In this scenario, the noteholders can continue to receive note payments, and the notes can amortize normally.

With a backstop amount in place, noteholders can have an increased likelihood of receiving par value for their notes. As will be recognized, a backstop amount can be guaranteed through a guarantor or through posted collateral. A maximum backstop amount can be defined, such that the guarantor can be assured that it will not have unlimited liability to the noteholders. The preferred parameters, acceptable parameters, coupon cap rate(s), and fail rate(s), as well as the backstop amount, and the maximum backstop amount can be calculated using computer implemented components and steps as will be apparent to those skilled in the art. As noted below, in addition to the auction, other outcome determinative events can transpire, resulting in noteholders retaining their notes and/or no backstop amount being paid to the noteholder.

In an embodiment, a successful auction can be one where market clearing bids are within the preferred or acceptable parameters, and a failed auction can be one where there are no market clearing bids within preferred or acceptable parameters, or where all bids are above the fail rate. The disclosed system and method can calculate a new coupon margin for interest payments following a successful auction. This new coupon margin can include using the most favorable market clearing bid from the preferred or the acceptable bids. As will be recognized, these calculations can be determined using computer implemented components and steps.

As will further be recognized, the methods disclosed below can be implemented in a computer system, such that the note auction, note transfer, purchase of additional HELOCs, payments, distributions, and other calculations can be automated. Moreover, those skilled in the art will recognize that implementing the steps and descriptions detailed below in a computerized system can provide improved automation of the system.

Appendix A attached hereto illustrates an embodiment whereby lot loans can be included in the pooled loans. The present system and method discloses a new structure for the securitization of home equity lines of credit (HELOCs). Features of this system and method include:
Bullet-like maturity of the notes provided by a mandatory auction mechanism at the end of a revolving period (by way of non-limiting example, 24 months, 48 months, etc.);
The mandatory auction mechanism can determine a new coupon margin (by way of non-limiting example, over LIBOR) for interest payments following the revolving period (during a rapid amortization period of the transaction (described in detail below)). The initial noteholders can receive a par payment of principal from the auction proceeds. The stated margin can be subject to a maximum margin (described in detail below);
A backstop mechanism that can guarantee the par takeout of the initial noteholders in the event that the required coupon margin for a par price set at auction exceeds the maximum margin:
   A backstop provider that can pay a market value adjustment (a “backstop amount”) to noteholders that can cover the discount associated with a coupon margin equal to the maximum margin and a discount margin equal to the rate determined at auction.
   The auction can be deemed to have failed to the extent the auction rate margin exceeds a “fail rate”. In an embodiment, where the auction is deemed to have failed, the original noteholders retain the notes but can receive a payment equal to the backstop amount associated with a margin equal to the maximum margin and a discount margin equal to the fail rate.

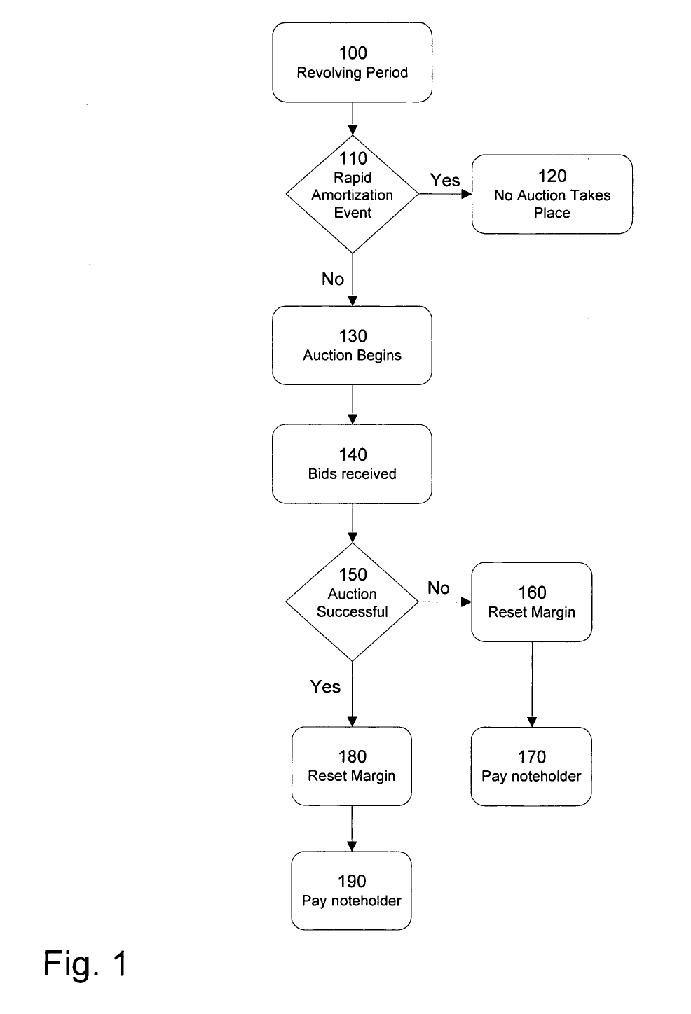

FIG. 1 illustrates the operation of the auction disclosed in the present system and method. As shown in FIG. 1, a revolving period transpires (step 100) where the original noteholders can receive interest and principal payments based on the underlying loan pool. The details of the revolving period are discussed above and are described in greater detail below. As will be recognized, loan pools can include HELOCs and lot loans.

Where a rapid amortization event has occurred (step 110), flow continues to step 120, and no auction takes place. In this scenario, as described in detail below, the noteholder can retain possession of the notes and would not receive a backstop payment. Such rapid amortization events are described in detail below and can include:
(i) interest collections or principal collections allocable to the Notes for any Payment Date are not enough to make any payment of principal or interest in each case that is due on the Notes, and such failure continues for a period of five Business Days;
(ii) Before the OC Target has been reached and during the first year, if the amount on deposit in the Reserve Fund is greater than [ ]% of the Class A Note balance;
(iii) Before the OC Target has been reached and during the second year, if the amount on deposit in the Reserve Fund is greater than [ ]%;
(iv) After the OC Target has been reached, if the amount on deposit in the Reserve Fund is greater than [ ]% of the Class A Note balance;
(v) a declaration of bankruptcy or insolvency by any of the mortgage loan transferor or the Servicer;
(vi) aggregate cumulative draws under the Policies exceed [ ]% of the Cut-Off Date pool principal balance;
(vii) the Notes are rated less than “Aaa”/“AAA” by S&P or Moody's for a period of 60 days or more (the Seller has the option to either replace the Surety Provider or to provide external credit enhancement in order to maintain a rating of “Aaa”/“AAA” by Moody's and S&P, respectively);
(viii) the Trust becomes subject to the Investment Company Act of 1940; or
(ix) failure on the part of the Trust, the Depositor, the Seller or the Servicer to perform any of its other material obligations under the pooling and servicing agreement, the note trust agreement or the indenture.

Where a rapid amortization event has not occurred (step 130) an auction can take place. The auction can be implemented on a computer system enabled to accept bids and determine a winning bid based on defined parameters, included preferred and acceptable parameters. The system can be further enabled to determine whether an auction has failed.

In step 140, bids can be received as part of the auction. The results of the auction are determined in step 150. As previously described, and detailed below, where market clearing bids are within preferred parameters or acceptable parameters, the auction can be deemed to be successful and flow continues to step 180. Where market clearing bids are above the fail rate, [or where the bids are not market clearing], the auction can be deemed unsuccessful, and flow continues to step 160.

Where an unsuccessful auction takes place (step 160), the note margin can be reset to a predefined rate. In an embodiment, this predefined rate can be the coupon cap rate. The noteholder can retain the notes, and can be paid a backstop amount. In an embodiment, this amount can be a maximum backstop amount.

Where a successful auction takes place (step 180), the note margin can be reset based on the bids received. Where the bids are within preferred parameters, the note margin can be reset to the winning bid price. The notes can be resold at par value, the noteholder can receive a par payment, and cannot receive a backstop payment.

Where the bids are within acceptable parameters, the note margin can be reset to the coupon cap rate. As described above, and detailed below, the coupon cap rate can be a rate that results in a par payment to the noteholder without a backstop payment being made. This amount can be calculated using statistical or other methods. The notes are sold at a discount rate, and the noteholders received a backstop payment to offset the discounted price. This backstop payment can be less than a maximum backstop amount.

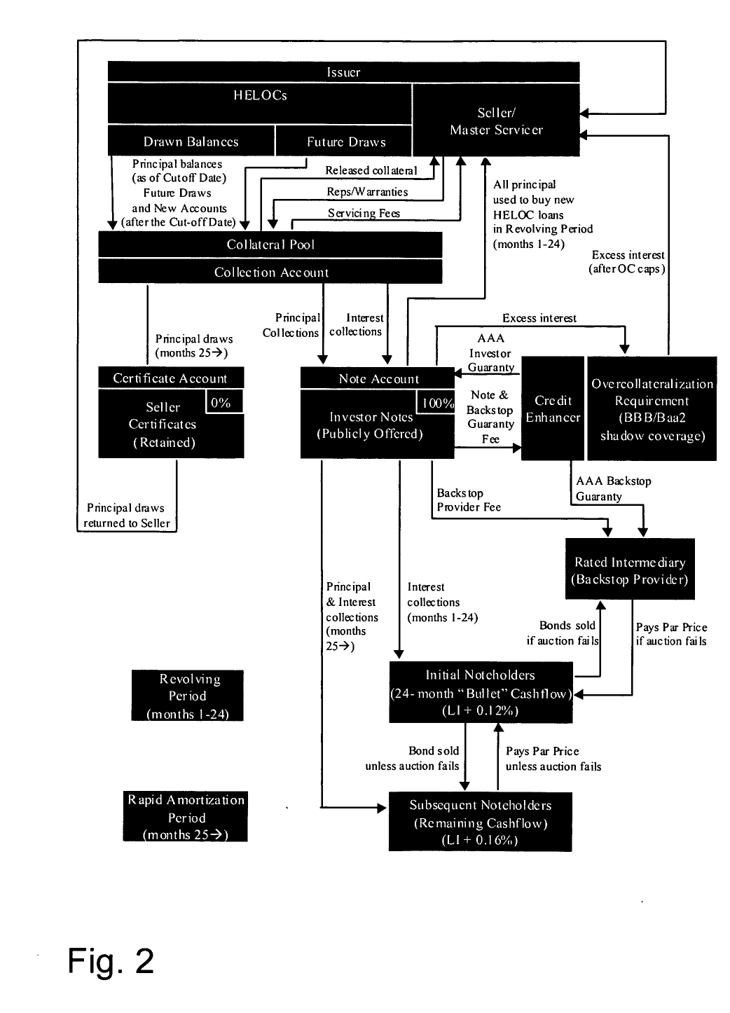

FIG. 2 is a block/flow diagram illustrating the operation of an embodiment of the present system and method. The parties and flow are described in detail below. As shown in FIG. 2, a seller sells all drawn balances under the HELOCs to a trust. The trust issues investor notes (100%) and a seller certificate (0%) which is retained by the seller. The transaction is divided into two sequential periods:
Revolving Period. (assumed here to be 24 months) Principal collections are used to purchase additional balances and additional accounts. The notes do not receive principal absent a rapid amortization event (described below).
Rapid Amortization Period. The notes receive 100% of all principal collections. The rapid amortization period ends upon the earlier of (1) the servicer's exercise of the optional clean-up call, or (2) full repayment of the security.

For a predefined period (here 24 months), the notes receive interest at a stated coupon of 1 mo LIBOR plus a fixed spread determined at pricing. At a time prior to the end of the revolving period, the notes are subject to an auction process: The auction proceeds are used to repay the initial noteholders at the end of the revolving period. Following the auction process, the coupon on the notes resets to the rate determined at the auction. To the extent that the market discount margin is greater than the “backstop rate,” but less than or equal to the “fail rate” assumed here to be 45 bps and 90 bps respectively, a payment can be made that will provide a market-value payment to the seller equal to the discount associated with a 1 mo LIBOR +0.45% coupon tail bond. The guarantee is backstopped by a AAA-rated monoline insurer.

Features and variations disclosed above are described in greater detail below.

Summary of Terms

Credit Enhancement

Credit Enhancement to the Notes:

The Class A Notes have the following primary forms of credit support:

(i) Excess Spread;
(ii) [ ]% Overcollateralization target; and
(iii) The Surety Provider will unconditionally guarantee timely payments of interest on the Class A Notes. The Surety Provider will guarantee payment of principal as described below (“Guaranteed Principal Distribution Amount”).

Reserve Fund:

Initially [0.00]%. To the extent that HELOC accounts are not purchased from the Seller during the Revolving Period, Net Principal Collections and excess interest required to build Overcollateralization will be deposited in the Reserve Fund.

Excess Spread:

The interest payments on the HELOCs are expected to exceed the amount of interest due and payable on the Notes.

Overcollateralization:

During the Revolving Period: A portion of the Excess Spread will be used to purchase additional HELOC accounts from the Seller (or will be deposited in the Reserve Fund) to the extent required to reach the OC Target. This will result in an increase of the balance of the Invested Amount, thereby creating Overcollateralization for the Notes.

During the Rapid Amortization Period: A portion of the Excess Spread will be applied as payments of principal on the Notes to the extent required to reach the OC Target. This will result in an acceleration of principal payments on the Notes relative to the amortization of the HELOCs, thereby creating Overcollateralization for the Notes.

Initially, the required level of Overcollateralization (“OC Target”) will equal [ ]% of the initial Collateral Balance.

Until the OC Target is reached, the Reserve Fund will be allowed to grow to a maximum of [ ]% of the Collateral Balance. After the OC Target is reached, the Reserve Fund will be allowed to grow to a maximum of [ ]% of the Collateral Balance. If the Reserve Fund is greater than 1% but less than or equal to [ ]% of the Collateral Balance, then the required level of Overcollateralization will increase by [ ]%. If the Reserve Fund is greater than [ ]% but less than or equal to [ ]% of the Collateral Balance, then the required level of Overcollateralization will increase by [ ]%. If the Reserve Fund is greater than 10% but less than or equal to [ ]% of the Collateral Balance, then the required level of Overcollateralization will increase by [ ]%.

Overcollateralization Release:

Beginning with the Payment Date in [ ] (the [31]st Distribution Date or the “Step-Down Date”), the Overcollateralization amount is allowed to step down to [ ]% of the current Collateral Balance, subject to certain stepdown tests; provided that in no event will the Overcollateralization be less than the OC Floor.

OC Floor:

[ ]% of the Cut-Off Date pool principal balance.

Summary of Terms

Distribution of Payments—Interest

Interest Distributions on the Notes:

The Floating Allocation Percentage of interest collections (net of the servicing fee, the certificate/indenture trustee fee, the owner trustee fee, and the insurance premium) allocable to the Notes will be distributed in the following priority (or similar):
(1) to pay accrued interest for the current accrual period and overdue accrued interest on the Notes;
(2) to cover any charge-off amounts allocated to the Notes by, (i) during the Revolving Period, being applied to purchase additional HELOC accounts (or to fund the Reserve Fund) or, (ii) during the Rapid Amortization Period, being applied as principal on the Notes;
(3) to reimburse the Surety Provider for prior draws made from the policies issued by the Surety Provider (the “Policies”);
(4) to build Overcollateralization up to the required level by, (i) during the Revolving Period, being applied to purchase additional HELOC accounts (or to fund the Reserve Fund) or, (ii) during the Rapid Amortization Period, being applied as principal on the Notes;
(5) as payment for any other amounts owed to the Surety Provider;
(6) to pay the Class A LIBOR Interest Carryover; and
(7) to the owner of the Seller's Interest.

Class A Note Rate:

The lesser of (x) the Class A Note Formula Rate and (y) the Maximum Rate.

Class A Note Formula Rate:
(1) Months 1-24*: 1 Month LIBOR +[ ]%, subject to the Maximum Rate.
(2) Months 25+*: the lesser of (i) the Auction Rate and (ii) the Coupon Cap Rate, subject to the Maximum Rate.
   * The period described in (1) above may range from 18 to 48 months. The period described in (2) will commence in the month following the end of the first period.

Maximum Rate:

The Maximum Rate for any Payment Date is based on the average of the HELOC rates, minus the servicing fee rate, the rate at which the certificate trustee's fees are calculated, the rate at which the indenture trustee's fees are calculated and the rate at which the premium on the Policies is calculated, for each HELOC, weighted on the basis of the related principal balance of each HELOC on the first day of the related Due Period. The Maximum Rate is expressed on an Actual/360 basis.

Class A LIBOR Interest Carryover (“Catch-Up Feature”):

If the Class A Note Rate is equal to the Maximum Rate, any interest which would have accrued at the Class A Note Formula Rate above the related Maximum Rate will be payable on the next Payment Date or Distribution Date, together with accrued interest at the then current Class A Note Formula Rate to the extent of Available Funds thereof.

Summary of Terms

Distribution of Payments—Principal

Revolving Period:

Begins on the first Payment Date and ends on the earlier of the Payment Date in [ ] (the 24th Distribution Date*) or the occurrence of a Rapid Amortization Event.
* This date may range from the 18th through the 48th Distribution Dates

Rapid Amortization Period:

Begins on the earlier of Payment Date in [ ] (the 25th Distribution Date*) or the occurrence of a Rapid Amortization Event.
* Or immediately following the Revolving Period if such period is not 24 months.

Principal Distribution Amount:

During the Revolving Period, aggregate principal collections on the HELOCs allocable to such period less aggregate draws on such HELOCs allocable to such period (“Net Principal Collections”) will be used to purchase additional HELOC accounts (or to the extent that HELOC accounts are not purchased from the Seller, Net Principal Collections will be deposited in the Reserve Fund). During this period, the noteholders will not receive any payment of principal. To the extent that there are any amounts in the Reserve Fund at the end of the Revolving Period, these amounts will be paid as a principal on the Notes on the next Distribution Date.

During the Rapid Amortization Period, holders of the Notes will receive 100% of the principal collections on the HELOCs until the principal balance has been reduced to zero.

Guaranteed Principal Distribution Amount:

With respect to any Payment Date other than the Payment Date in [Legal Final Maturity Date], the Surety Provider will guarantee a payment equal to the amount, if any, by which the Note principal balance exceeds the Invested Amount as of the end of the related Due Period. With respect to the Payment Date in [Legal Final Maturity Date], the Surety Provider will guarantee a payment equal to the outstanding Note principal balance.

Invested Amount:

With respect to any Payment Date is the Initial Invested Amount plus the aggregate of any new HELOC accounts or additional balances purchased for the purpose of creating Overcollateralization plus the Reserve Fund amount reduced by (i) the aggregate amount of principal collected on the HELOCs and allocable to the Notes as of the end of the previous Due Period and on the related Payment Date and (ii) the aggregate of Investor Charge-Off Amounts since the Cut-Off Date, including the Investor Charge-Off Amount for such Payment Date.

The Initial Invested Amount will be [Initial Collateral Amount].

Seller 's Interest:

The Seller's Interest is equal to the outstanding pool balance at the end of the previous Due Period minus the Invested Amount. This amount represents a pari passu interest in the assets of the Underlying Trust equal to the cumulative amount of draws on the HELOCs since the beginning of the Rapid Amortization Period. In addition, during the Revolving Period, in the event that draw amounts are greater than the principal received in a Due Period, the Seller's Interest will accrete by the excess amount.

Floating Allocation Percentage:

With respect to any Payment Date is the percentage equivalent of a fraction with a numerator which is the Invested Amount at the end of the previous Due Period and a denominator of the outstanding pool balance at the end of the previous Due Period (in the case of the first Payment Date, the outstanding pool balance as of the Cut-Off Date), provided such percentage shall not be greater than 100%.

Summary of Terms

Mandatory Auction

Investor Charge-Off Amounts:

For a given Payment Date, the amount of charge-offs incurred during related Due Period multiplied by the Floating Allocation Percentage.

Mandatory Auction:

[Eight] business days prior the Mandatory Auction Distribution Date, provided that the Notes are rated “Aaa”/“AAA” by Moody's and S&P up to and including the Mandatory Auction Distribution Date, the Auction Administrator will auction the Notes to third-party investors (the underwriters, Surety Provider, and Seller(s) (or any affiliate) will be permitted to bid in the Mandatory Auction).

Bids solicited will be either (i) a Par Price spread bid equal to or less than the Coupon Cap Rate (1 month LIBOR +[0.45]%) or (ii) a discount price bid such that the equivalent Par Price spread would be greater than the Coupon Cap Rate. The Auction Administrator will assemble the bids in ascending order until there are bids for all available Notes.

On the Mandatory Auction Distribution Date, the Class A Notes will be assigned a rate for their remaining life equal to the lesser of the Coupon Cap Rate and the Auction Rate.

“Successful Auction”: To the extent that the Auction Rate is less than or equal to the Coupon Cap Rate, the Notes will be resold at par. To the extent that the Auction Rate is above the Coupon Cap Rate but less than or equal to the Fail Rate (1 month LIBOR +[0.90]%), the Notes will be resold at the Discount Price and the Surety Provider guarantees payment of the Backstop Amount to the Indenture Trustee, who will then remit an amount equal to the Par Price to the noteholders on the Auction Distribution Date. *
* The Backstop Amount may also be guaranteed by a rated intermediary or through the posting of collateral in an amount equal to the Backstop Amount if the Auction Rate were equal to the Fail Rate.

“Failed Auction”: To the extent that the Auction Rate is above the Fail Rate, the noteholders will keep their notes with a rate reset to the Coupon Cap Rate. The Backstop Amount will be paid by the Surety Provider to the Indenture Trustee who will then remit it to the noteholders.

Mandatory Auction Distribution Date:

The Distribution Date in [ ] (Last Distribution Date during Revolving Period)

Auction Administrator:

[Lehman Brothers]

Auction Rate:

A floating rate with a spread to LIBOR, determined at the Mandatory Auction, such that the Class A Notes would settle at the Par Price.

Coupon Cap Rate:

1 Month LIBOR +[0.45]%

Fail Rate:

1 Month LIBOR +[0.90]%

Summary of Terms

Rapid Amortization Events

Par Price:

With respect to each of the Notes, the principal balance after giving effect to principal distributions made and losses applied on the Mandatory Auction Distribution Date.

Discount Price:

If the Auction Rate is greater than the Coupon Cap Rate, the price determined by setting the yield equal to the Auction Rate and rate equal to the Coupon Cap Rate (assuming the pricing speed to the [10]% optional termination).

Backstop Price:

The greater of the Discount Price and the price determined by setting the yield equal to the Fail Rate and the rate equal to the Coupon Cap Rate (assuming the pricing speed to the [10]% optional termination).

Backstop Amount:

The difference between the Par Price and the Backstop Price, if any.

Rapid Amortization Event:

The following would be typical of the types of Rapid Amortization Events for a transaction:
(i) interest collections or principal collections allocable to the Notes for any Payment Date are not enough to make any payment of principal or interest in each case that is due on the Notes, and such failure continues for a period of five Business Days;
(ii) Before the OC Target has been reached and during the first year, if the amount on deposit in the Reserve Fund is greater than [ ]% of the Class A Note balance;
(iii) Before the OC Target has been reached and during the second year, if the amount on deposit in the Reserve Fund is greater than [ ]%;
(iv) After the OC Target has been reached, if the amount on deposit in the Reserve Fund is greater than [ ]% of the Class A Note balance;
(v) a declaration of bankruptcy or insolvency by any of the mortgage loan transferor or the Servicer;
(vi) aggregate cumulative draws under the Policies exceed [ ]% of the Cut-Off Date pool principal balance;
(vii) the Notes are rated less than “Aaa”/“AAA” by S&P or Moody's for a period of 60 days or more (the Seller has the option to either replace the Surety Provider or to provide external credit enhancement in order to maintain a rating of “Aaa”/“AAA” by Moody's and S&P, respectively);
(viii) the Trust becomes subject to the Investment Company Act of 1940; or
(ix) failure on the part of the Trust, the Depositor, the Seller or the Servicer to perform any of its other material obligations under the pooling and servicing agreement, the note trust agreement or the indenture.
   Summary of Terms
   Optional Termination:

The Servicer (or owner of the Seller's Interest) of the residual may exercise its right to purchase the HELOCs on any Payment Date on or after which the principal balance of the Class A Notes declines to [10]% or less of the principal balance of the HELOCs as of the Closing Date.

Termination of Trust:

The Trust shall terminate upon notice to the Indenture Trustee of the later of (A) payment in full of all amounts owing on the notes and to the Insurer unless the Insurer shall otherwise consent and (B) the earliest of (i) the final payment or other liquidation of the last mortgage loan remaining in the Trust; (ii) the optional purchase by the Servicer of the mortgage loans as described above and (iii) the Payment Date in [Legal Final Maturity Date].

Servicing Advances:

All reasonable and customary “out of pocket” costs and expenses incurred in the performance by the Servicer of its servicing obligations, generally including, but not limited to, the cost of
(i) the preservation, restoration and protection of the mortgaged property,
(ii) any enforcement or judicial proceedings, including foreclosures,
(iii) the management and liquidation of the REO Property, including reasonable fees paid to any independent contractor in connection therewith, and
(iv) compliance with various other obligations as specified in the pooling and servicing agreement.

Generally, the Servicer will not advance delinquent payments of principal and interest.

Summary of Terms

Subsequent Mortgage Loan Criteria

Each additional HELOC purchased by the Trust must meet certain requirements based on these or similar parameters:
may not be [ ] or more days delinquent as of the transfer date;
remaining term to stated maturity of each subsequent HELOC will not exceed [ ] months;
will be secured by a mortgage in a first or second lien position;
will have a fully-indexed margin between−[ ]% and [ ]%;
will not have a principal balance in excess of $[ ];
will have a credit limit between $[ ] and $[ ];
the subsequent mortgage loan will be underwritten substantially in accordance with the criteria set forth under “Description of the Mortgage Loans—Underwriting Standards” in the prospectus supplement;
will have a CLTV not in excess of [ ]%;
will have a utilization not in excess of [ ]%
no credit score less than [ ]
shall not provide for negative amortization

Additionally, each subsequently transferred HELOC pool must have the following characteristics (or similar requirements):
a weighted average fully-indexed margin of at least [ ]%;
a weighted average combined loan-to-value ratio of no more than [ ]%;
a weighted average credit score of at least [ ];
for loans with a CLTV greater than [ ]%, a weighted average credit score of at least [ ].
no more than [ ]% of the pool will have a FICO score less than [ ];
no less than [ ]% of the pool will be a single family residence;
no less than [ ]% of the pool will be owner occupied;
no more than [ ]% of the pool will have a loan purpose of cash-out refinance;
no less than [ ]% of the pool will have “full documentation”;
no more than [ ]% of the pool will be in the state of California; and
no more than [ ]% of the pool will be in any state other than California.

A depositor may offer securities that are asset-backed notes, asset-backed certificates and asset-backed custody receipts which may be sold in one or more series. Each series of securities will be issued in one or more classes.

The detailed description below, and the attached appendix, will set forth the specific assets of a trust fund and the seller or sellers from whom the assets are acquired. These assets may include:

(a) one or more pools of

(1) closed-end and/or revolving home equity loans or specified balances thereof and/or loans of which the proceeds have been applied to the purchase of the related mortgaged property, secured by mortgages primarily on one- to four-family residential properties,
(2) home improvement installment sales contracts and installment loan agreements which may be unsecured, secured by mortgages primarily on one- to four-family residential properties, or secured by purchase money security interests in the related home improvements;
(3) private securities evidencing ownership interests in or secured by loans similar to the types of loans described in clauses (1) and (2) above,
   (b) all monies due under the above assets (which may be net of amounts payable to the servicer), and
   (c) funds or accounts established for the related trust fund, or one or more forms of enhancement.
   The Notes

The notes are issued by a trust, whose assets consist primarily of certificates backed by a pool of adjustable rate home equity line of credit loans and property relating to those loans. The notes are secured by assets of the trust. The notes currently have no trading market. The notes are obligations of the trust only and are not obligations of any other person

Credit Enhancements

The class A underlying certificates securing the notes will have the benefit of credit enhancement provided by excess interest, overcollateralization and a certificate policy issued by a financial guaranty company. The notes will have the benefit of a note policy issued by a financial guaranty company

Neither the Securities and Exchange Commission nor any state securities commission has approved or disapproved of these securities or passed upon the adequacy or accuracy of this prospectus. Any representation to the contrary is a criminal offense.

Dealers will deliver a prospectus supplement and prospectus when acting as underwriters of the securities and with respect to their unsold allotments or subscriptions. In addition, all dealers selling the securities will be required to deliver a prospectus supplement and prospectus for ninety days following the date of this prospectus supplement.

Securities Offered

Home Equity Loan Asset-Backed Notes, as described below, the notes will be secured by the class A underlying certificates, which will be entitled to certain payments and other amounts received in respect of a pool of home equity line of credit loans, referred to as the HELOCs in this prospectus supplement. Amounts distributed on the class A underlying certificates are the only funds available to make payments on the notes.

The Note Trust

A statutory trust will be created pursuant to and governed by a trust agreement, as amended and restated, among the certificate seller, the depositor, the owner trustee and the indenture trustee, as registrar and paying agent. The note trust will own the class A underlying certificates, which will be sold to the depositor from the certificate seller and transferred from the depositor to the note trust.

The purpose of the note trust is to (i) hold the class A underlying certificates, the note policy and the payments under the class A underlying certificates and to have the right to hold a derivative contributed by the holder of the owner trust certificates, (ii) issue the notes and the owner trust certificates and (iii) to pledge the class.

A underlying certificates to the indenture trustee. The certificate seller will initially hold the owner trust certificates and will be entitled to all distributions of amounts received in connection with the class A underlying certificates after payments have been made on the notes, but will have no discretion to direct any actions with respect to the assets of the owner trust.

Note Trust Property

The property of the note trust will consist solely of the class A underlying certificates issued by the underlying trust, a note policy as described below under “—Mandatory Auction of the Notes,” and any derivative contributed to it by the holder of the owner trust certificates, initially the certificate seller.

Payments to Noteholders

Noteholders will be entitled to receive payments of interest each month starting in March 2004. The notes will not be entitled to payments of principal until the earlier of the payment date in March 2006, after the mandatory auction described below has occurred, and the occurrence of a rapid amortization event with respect to the underlying trust. All payments on each payment date will be made to the extent of the amount of distributions on the class A underlying certificates on their related distribution date, referred to as available funds. Each month the indenture trustee will calculate the amounts to be paid to the noteholders. A noteholder that holds a note on the day preceding a payment date, or if the notes are no longer book-entry securities, on the last day of the month preceding a payment date, will be entitled to receive payments on the next payment date. The payment date will be the 25th day of each month or, if that day is not a business day, the next succeeding business day.

Interest Accrual Period of the Notes

Interest for the first payment date will accrue on the unpaid principal balance of the notes at the related rate from the closing date to the day before the first payment. After the first payment date, interest will accrue from and including the preceding payment date to but excluding the current payment date. Interest will be calculated on the basis of the actual number of days in each interest accrual period divided by 360.

Note Rate

Prior to the mandatory auction of the notes described below, interest will accrue on the notes at a rate equal to the lesser of (i) the sum of one-month LIBOR and 0.12% and (ii) the maximum rate. After the mandatory auction payment date, interest will accrue on the notes at a rate equal to the lesser of (i) the rate determined at the mandatory auction as described below under “Description of the Notes—Mandatory Auction of the Notes” and (ii) the maximum rate on the notes.

For each distribution date, the maximum rate on the notes will be equal to the weighted average of the loan rates on the first day of the related collection period, minus the sum of 0.03%, the servicing fee rate, the certificate trustee fee rate, the indenture trustee fee rate and the rate at which the premium on the policies is calculated, for each loan, weighted on the basis of the related principal balance of each loan on the first day of the related collection period, adjusted to a rate calculated on an actual/360 basis.

Distribution of Available Funds to the Notes

On each payment date, the indenture trustee will pay the following amounts from available finds in the following order of priority:
(1) to the indenture trustee, the indenture trustee fee;
(2) to the noteholders, from interest distributions on the class A underlying certificates, the accrued interest for the current accrual period, overdue accrued interest and any LIBOR interest carryover amounts for such payment date;
(3) to the noteholders, from principal distributions on the class A underlying certificates, as a payment of principal, (x) for each payment date prior to the payment date in February 2006 (unless a rapid amortization event has occurred), zero, (y) for the payment date in February 2006 or the payment date following the occurrence of a rapid amortization event, an amount equal to the amount on deposit in the reserve fund, as described below under “—Credit Enhancement for the Class A Underlying Certificates—Over-collateralization, Excess Interest and the Reserve Fund,” and (z) for each payment date after the payment date in February 2006 or each payment date following the occurrence of a rapid amortization event, the principal payment amount for such payment date until the outstanding principal balance of the notes has been reduced to zero;
(4) to the surety provider, as reimbursement for prior draws made under the note policy;
(5) to the certificate trustee, to defray certain fees and expenses of the underlying trust; and
(6) on behalf of the note trust, in the priority and in the manner set forth in the indenture, to the extent of any remaining amounts, after the payments required above have been made, to the indenture trustee and the holders of the owner trust certificates.
   The Note Policy

Credit enhancement for the notes will be provided by the note policy, under which the surety provider will make timely payments of interest on the notes to the extent that distributions on the class A underlying certificates are insufficient and payments of principal equal to, prior to the final payment date, the amount if any by which the principal balance of the notes exceeds the principal balance of the class A underlying certificates after the application of distributions on the class A underlying certificates, and, on the final payment date, an amount necessary to reduce the outstanding principal balance of the notes to zero after application of distributions on the class A underlying certificates. Additionally, the note policy will guarantee the payment on the mandatory auction payment date of certain amounts due to the noteholders, as described below under “—Mandatory Auction of the Notes.”

Refer to the section “Description of the Notes” in this prospectus supplement for more detail.

Mandatory Auction of the Notes

During the eight business days prior to and including the payment date in February 2006, referred to as the mandatory auction payment date, so long as the notes are rated in the highest rating category by each rating agency listed below under “Rating” during the period from the eighth business day prior to the payment date in February 2006 through the payment date in February 2006 and a rapid amortization event has not occurred, Lehman Brothers Inc., in its capacity as auction administrator, will auction the notes to third-party investors (which may include the auction administrator, the surety provider, the indenture trustee, the seller or any of their affiliates).

If the notes are not rated in the highest category by each rating agency listed below under “Rating” during the period described above or if a rapid amortization event occurs with respect to the notes prior to the mandatory auction payment date, the notes will not be auctioned, noteholders will not be required to re-sell their notes and no backstop payments will be made by any party as described below.

Investors willing to accept a yield on the notes equal to the sum of one-month LIBOR and 0.45% or less will make a spread bid on the notes. Investors requiring a yield in excess of the sum of LIBOR and 0.45% will make a price bid on the notes.

The auction administrator will assemble the bids obtained to determine the market-clearing bid no later than four business days prior to the mandatory auction payment date in ascending order (by spread) or descending order (by price) until there are bids for all available notes, as described in this prospectus supplement under “Description of the Notes—Mandatory Auction.”

If the market-clearing bid is a spread bid, a successful auction will have occurred, and consequently, the note rate will be reset to the market-clearing bid and the noteholders will resell the notes to third-party investors at a price, referred to as the par price, equal to the principal balance of the notes after giving effect to any payment of principal made on the notes on the mandatory auction payment date.

If, however, the market-clearing bid is a price bid and the auction rate is less than or equal to the sum of one-month LIBOR and 0.90%, a successful auction will also have occurred, but the noteholders will re-sell the notes to third party investors at a discount price described below under “Description of the Notes—Mandatory Auction of the Notes.” In addition to the discount price, the noteholders will receive an amount resulting in a payment equal to the par price, referred to as the backstop amount, as described below under “Description of the Notes—Mandatory Auction of the Notes.” The discount price and the backstop amount will be paid to the noteholders by the indenture trustee as the auction paying agent. Payment of the backstop amount to the noteholders will be guaranteed by the surety provider pursuant to the note policy.

A failed auction will occur if the market-clearing bid is a price bid and the resulting auction rate is greater than the sum of one-month LIBOR and 0.90% or if there are no bids for all the notes. In the event of a failed auction, the auction will terminate, noteholders will retain their notes and the note rate will be set to the sum of one-month LIBOR and 0.45% for the remainder of the life of the notes. Additionally, noteholders will receive an amount as described below under “Description of the Notes—Mandatory Auction of the Notes.” Payment of the amount referred to above to the noteholders will be guaranteed by the surety provider pursuant to the note policy.

As a result, on the mandatory auction payment date, if the auction is successful, the notes will be transferred from noteholders immediately prior to the auction to third party investors, in return for a payment distributed by the indenture trustee equal to the outstanding principal balance of the notes plus accrued interest. If the auction is unsuccessful, noteholders will retain their notes, the note rate will be set to the sum of one-month LIBOR and 0.45% for the remainder of the life of the notes and noteholders will receive a payment equal to the backstop amount.

Refer to the section “Description of the Notes—Mandatory Auction of the Notes” in this prospectus supplement for more detail.

Final Maturity Date of the Notes

The final maturity date of the notes will be the payment date in April 2026.

In one embodiment, the actual final payment date for the notes may be earlier than the maturity date.

Termination of Note Trust

The note trust will terminate on the earliest of (i) the payment date that the notes and all other amounts due under the indenture have been paid in full and (ii) the termination of the underlying trust.

Optional Purchase of Notes

On any payment date after the outstanding principal balance of the notes is reduced to an amount less than or equal to 35% of the outstanding principal balance of the notes on the closing date, the note trust will have the option of purchasing the notes at a price equal to 100% of the outstanding principal balance of the notes plus accrued interest thereon. The sale agreement provides that the right to purchase the notes will be exercised by the owner trustee on behalf of the note trust and at the direction of the certificate seller (or any successor owner of the owner trust certificates). Such purchase will have the same effect as a prepayment on the notes.

Refer to sections “Description of the Notes—Optional Terminations” and “Description of the Securities—Optional Redemption, Purchase or Termination” and “The Agreements—Termination” for more detail.

Registration of Notes

Notes may be issued in book-entry form. Holders retain their interests either through a depository in the United States or through one of two depositories in Europe. While the notes are book-entry they will be registered in the name of the applicable depository, or in the name of the depository's nominee. Transfers within any depository system will be made in accordance with the usual rules and operating procedures of that system. Cross-market transfers between two different systems may be made through a third-party bank and/or the related depositories. The limited circumstances under which definitive notes will replace the book-entry notes are described in this prospectus supplement.

Refer to sections “Risk Factors—Consequences of Owning Book-Entry Notes,” “Description of the Notes—Book-Entry Notes” and “ANNEX I” for more detail.

The Underlying Trust

A New York common law trust will be created pursuant to and governed by a pooling and servicing agreement, among the servicer, the mortgage loan transferor, the seller and the certificate trustee. The underlying trust will issue two classes of certificates, a class designated as class A underlying certificates, and a class, designated as the seller's interest. The class A underlying certificates and the seller's interest are referred to as the underlying certificates. The seller's interest will be retained by the seller and the class A underlying certificates will be sold by the seller to the certificate seller.

The property of the underlying trust will primarily include:
a pool of adjustable rate home equity line of credit loans made or to be made in the future under home equity line of credit loan agreements, and secured primarily by first and second lien deeds of trust or mortgages on residential properties that are primarily one- to four-family properties. A Home Equity Line of Credit loan agreements may be referred to as a HELOC(s) or home equity lines of credit.
additional home equity lines of credit purchased during the period from the closing date to Feb. 24, 2006.
payments on the HELOCs received after the cut-off date.
any additions to the loan balances of the HELOCs during the life of the underlying trust.
property that secured a loan which has been acquired by foreclosure or deed in lieu of foreclosure.
the benefit of a certificate policy in the case of the class A underlying certificates.
certain rights of the mortgage loan transferor under the purchase agreement by which the seller sells the HELOCs to the mortgage loan transferor.
benefits under any hazard insurance policies covering the mortgaged properties.
amounts on deposit in certain accounts, including the reserve fund.
all proceeds from the items above.

Payments on the Class A Underlying Certificates

The class A underlying certificates will be entitled to receive payments of interest each month starting in March 2004. Except as described below under “—Principal”, the class A underlying certificates will not be entitled to payments of principal until the distribution date in March 2006. All payments of principal received on the HELOCs and allocable to the class A underlying certificates in the period from the closing date to the distribution date in March 2006 will be used to purchase additional balances and, at the option of the seller, additional HELOCs, or be deposited into a reserve fund. Each month the certificate trustee will calculate the amounts to be paid to the class A underlying certificates. All amounts received in respect of the HELOCs and not allocated to the class A underlying certificates will be allocated to the seller's interest. The distribution date will be the 25th day of each month or, if that day is not a business day, the next succeeding business day.

Interest Accrual Period of the Underlying Certificates Interest for the first distribution date will accrue on the unpaid principal balance of the class A underlying certificates at the related rate from the closing date to the day before the first distribution date. After the first distribution date, interest will accrue from and including the preceding distribution date to but excluding the current distribution date. Interest will be calculated on the basis of the actual number of days in each interest accrual period divided by 360.

Class A Underlying Certificate Rate

Interest will accrue on the class A underlying certificates at a rate equal to the lesser of (i) the sum of the note rate as described above under “—Note Rate” and 0.05% and (ii) the maximum rate on the class A underlying certificates. On and after the distribution date in February 2006, if the mandatory auction of the notes occurs, the certificate rate will reset to the lesser of (i) the sum of the then-current note rate and 0.05% and (ii) the maximum rate on the class A underlying certificates.

For each distribution date, the maximum rate on the class A underlying certificates will be equal to the weighted average of the loan rates on the first day of the related collection period, minus the servicing fee rate, the certificate trustee fee rate and the rate at which the premium on the policies is calculated, for each loan, weighted on the basis of the related principal balance of each loan on the first day of the related collection period, adjusted to a rate calculated on an actual/360 basis.

Application of Collections to the Underlying Certificates

Interest

On each payment date, the portion of interest collections on the HELOCs received during the preceding calendar month that are allocated to the class A underlying certificates will be applied in the following order of priority:
(1) (a) in each case, in respect of the portion of the HELOCs applicable to the class A underlying certificates (i) to the servicer, to the extent not previously retained, the servicing fee, (ii) any accrued and unpaid servicing fees and (iii) any unreimbursed nonrecoverable advance previously made, (b) to the certificate trustee, the certificate trustee fee;
(2) to the surety provider, the premium due for the policies;
(3) to the class A underlying certificates, accrued interest for the current accrual period and any overdue accrued interest on the class A underlying certificates, to the extent described under “Description of the Notes—Distributions on the Class A Underlying Certificates;
   to cover the portion of charge-offs incurred during the preceding calendar month allocable to the class A underlying certificates and the portion of charge-offs incurred during previous periods
(4) allocable to the class A underlying certificates that were not subsequently covered by the portion of interest collections, overcollateralization or draws under the certificate policy by (a) for each distribution date prior to the distribution date in March 2006 or prior to the occurrence of a rapid amortization event (as described under “Description of the Notes—Rapid Amortization Events”), application of interest collections remaining in the certificate account to the purchase of additional balances and, at the option of the seller, additional HELOCs, or to fund the reserve fund, as described below under “—Credit Enhancement—Over-collateralization, Excess Interest and the Reserve Fund” and (b) for each distribution date on and after the distribution date in March 2006 or after the occurrence of a rapid amortization event, application of interest collections remaining in the certificate account as a payment of principal to the class A underlying certificates;
(5) to the surety provider, as reimbursement for prior draws made under the certificate policy;
(6) to build overcollateralization to the required level by (a) for each distribution date prior to the distribution date in March 2006 or prior to the occurrence of a rapid amortization event, application of interest collections remaining in certificate account to the purchase of additional balances and, at the option of the seller, additional HELOCs, or to find the reserve fund and (b) for each distribution date on and after the distribution date in March 2006 or after the occurrence of a rapid amortization event, application of interest collections remaining in the certificate account as a payment of principal to the class A underlying certificates;
(7) to the surety provider, any other amounts owed to the surety provider pursuant to the insurance agreement;
(8) to the class A underlying certificates, any carryover interest amounts from prior periods when the amount of interest paid on the class A underlying certificates was limited to the weighted average of the loan rates minus certain fees; and
(9) to the owner of the seller's interest, which shall initially be the seller.

Principal

During the period from the first distribution date through the earlier of the distribution date in February 2006 and the occurrence of a rapid amortization event, no principal collections will be distributed to the underlying certificates. Instead, all principal collections on the HELOCs received during the preceding calendar month will be applied, except as provided below, to purchase additional balances drawn under the HELOCs during the preceding calendar month and additional HELOCs, remaining after the application of interest collections for that purpose, to maintain the collateral balance.

On any distribution date, the seller may elect not to sell additional HELOCs and principal collections that would otherwise have been applied to the purchase of additional HELOCs will be deposited into a reserve fund for the benefit of the certificateholders. On the earlier of the distribution date in February 2006 and the occurrence of a rapid amortization event, all amounts on deposit in the reserve fund will be distributed as principal to the class A underlying certificates.

On every distribution date after the earlier of the distribution date in February 2006 and the occurrence of a rapid amortization event, all principal collections on the HELOCs received during the preceding calendar month and allocable to the class A underlying certificates will be distributed to the class A underlying certificates as a distribution of principal until the principal balance of the class A underlying certificates has been reduced to zero. However, the amount of principal collections on the HELOCs paid on the class A underlying certificates on any distribution date after the distribution date in February 2006 will be reduced if the amount of overcollateralization exceeds the required level of overcollateralization.

Notwithstanding the above, the class A underlying certificates may be entitled to a distribution of the portion of principal collections allocable to the class A underlying certificates on or prior to the payment date in February 2006 if a rapid amortization event occurs.

Refer to sections “Description of the Notes—Distributions on the Class A Underlying Certificates” and “Description of the HELOCs—Additional HELOCs” for more detail.

Credit Enhancement for the Class A Underlying Certificates

Overcollateralization, Excess Interest and the Reserve Fund

The application of the payments on the HELOCs to the holders of the class A underlying certificates has been structured to create overcollateralization. On the closing date the overcollateralization will be approximately zero and is expected to build to the required amount after the class A underlying certificates have been issued.

The portion of interest payments on the HELOCs allocable to the class A underlying certificates is expected to exceed the amount of interest due and payable on the class A underlying certificates. A portion of this excess, for each payment date to and including the distribution date in February 2006, will be used to purchase, at the option of the seller, additional HELOCs. The purchase of additional HELOCs will result in an increase in the amount of loan balances represented by the invested amount relative to the principal balance of the class A underlying certificates, thereby creating overcollateralization for the class A underlying certificates.

However, for each distribution date after the distribution date in February 2006 or if a rapid amortization event occurs, that portion of excess interest will be used as a distribution of principal on the class A underlying certificates to the extent necessary to build overcollateralization to the required amount. This will result in the limited acceleration of principal distributions on the class A underlying certificates relative to the amortization of the HELOCs, thereby creating overcollateralization for the class A underlying certificates.

If additional HELOCs are not purchased from the seller, such excess will be deposited by the certificate trustee into a reserve fund thereby providing the required level of overcollateralization. The total amount permitted to be deposited into the reserve fund will be limited. The limit will vary based on whether the required amount of overcollateralization has been met and the amount of overcollateralization provided by the purchase of additional HELOCs.

The required level of overcollateralization is based on certain minimum and maximum levels of overcollateralization and on the performance of the HELOCs. In addition, the required level of overcollateralization is based on the amount of excess interest and principal collections deposited in the reserve fund and not used to purchase additional HELOCs. As a result, the level of required overcollateralization will increase and decrease over time. For example, an increase in the required level of overcollateralization will result if the delinquency or default experience on the HELOCs exceeds certain set levels. In that event, additional HELOCs would be purchased by the underlying trust or excess interest and principal collections will be deposited in the reserve fund until the level of overcollateralization reaches its required level.

Refer to sections “Description of the Notes—Overcollateralization, Excess Interest and the Reserve Fund” and “Maturity and Prepayment Considerations” for more detail.

The Certificate Policy

Credit enhancement for the class A underlying certificates will also be provided by the certificate policy, under which the surety provider will make timely payments of interest on the class A underlying certificates to the extent that amounts on deposit in the certificate account are insufficient and payments of principal equal to, prior to the final distribution date, the amount if any by which the principal balance of the class A underlying certificates exceeds the invested amount at the end of the related collection period, and, on the final distribution date, to the extent that amounts on deposit in the certificate account, after providing for the payment of interest, are insufficient to reduce the outstanding principal balance of the class A underlying certificates to zero.

Refer to the section “Description of the Notes” for more detail.

Final Distribution Date of the Underlying Certificates

The final distribution date of the underlying certificates will be the distribution date in April 2026.

In one embodiment, the actual final distribution date for the underlying certificates may be earlier than the final distribution date.

Termination of Underlying Trust

The underlying trust will terminate on the distribution date following the later of (A) payment in full of all amounts owing to the surety provider unless the surety provider otherwise consents and (B) earliest of (i) the distribution date occurring in April 2026, (ii) the final payment or other liquidation of the last HELOC in the underlying trust and (iii) the servicer's exercise of its right to repurchase the HELOCs as described under “—Otional Termination of the Underlying Trust”.

Optional Termination of the Underlying Trust

On any distribution date after the outstanding principal balance of the class A underlying certificates is reduced to an amount less than or equal to 10% of the outstanding principal balance of the class A underlying certificates on the closing date, the servicer will have the option of purchasing the HELOCs. Such an optional termination will result in a prepayment on the class A underlying certificates as well as the notes.

Refer to sections “Description of the Notes—optional Terminations” in this prospectus supplement and “Description of the Securities—Optional Redemption, Purchase or Termination” and “The Agreements—Termination” for more detail.

Federal Income Tax Considerations

In the opinion of McKee Nelson LLP, for federal income tax purposes, the notes will be characterized as indebtedness, and neither the underlying trust nor the note trust will be characterized as an association, publicly traded partnership taxable as a corporation, or as a taxable mortgage pool. Each holder of a note, by the acceptance of a note, will agree to treat the security as indebtedness for federal, state and local income and franchise tax purposes.

Refer to sections “Federal Income Tax Considerations” and “State Tax Considerations” and “Federal Income Tax Considerations” and “State Tax Considerations” for more detail.

ERISA Considerations

Subject to the considerations and conditions described under “ERISA Considerations” in this prospectus supplement and the prospectus, the notes may be transferred to an employee benefit or other plan or arrangement subject to the Employee Retirement Income Security Act of 1974, as amended, or to Section 4975 of the Internal Revenue Code of 1986, as amended. Refer to the section “ERISA Considerations” for more detail.

Legal Investment Considerations

The Secondary Mortgage Market Enhancement Act of 1984 defines “mortgage related securities” to include only first-lien mortgages. Because the pool of HELOCs owned by the underlying trust includes second-lien mortgage loans, the notes will not be “mortgage related securities” under that definition. Some institutions may be limited in their legal investment authority to only first-lien mortgages or “mortgage related securities” and will be unable to invest in the notes.

Refer to sections “Legal Investment Considerations” in this prospectus supplement and “Legal Investment” for more detail.

Ratings

Before the notes or the class A underlying certificates can be issued, the applicable trust must obtain ratings on each of the notes and the class A underlying certificates of:
AAA by Standard & Poor's, a division of The McGraw-Hill Companies, Inc.
Aaa by Moody's Investors Service, Inc.

Ratings such as the ratings obtained for the notes address credit risk. When evaluating credit risk, the rating agencies evaluate the likelihood of receiving interest and principal payments. Credit risk does not relate to the likelihood of prepayments on the HELOCs. Prepayments affect the timing of payments, such that the actual return could differ substantially from the anticipated return on investment. The ratings on the notes and the class A underlying certificates do not address any payments of interest that could accrue if the notes are subject to the maximum rate of interest.

Refer to sections “Risk Factors—Ratings on Notes Based Primarily on Claims-Paying Ability of the Surety Provider” and “Rating” for more detail.

Risk Factors

The following discussion is related to risk factors to be considered prior to any purchase of notes. Also see the information set forth under “Risk Factors” in the prospectus.

Geographic Concentration Increases Risk That the Yield on the Notes May Be Impaired

One risk associated with investing in notes backed by HELOCs is created by any concentration of the related mortgaged properties in one or more geographic regions. If the regional economy or housing market of any state (or other region) having a significant concentration of the properties underlying the HELOCs weakens, the HELOCs related to properties in that region may experience high rates of loss and delinquency, resulting in losses to noteholders if the surety provider fails to perform under the certificate policy. A region's economic condition and housing market may be adversely affected by a variety of events, including natural disasters such as earthquakes, hurricanes, wildfires, floods, eruptions and civil disturbances. The economic impact of any such events may also be felt in areas beyond the region immediately affected by the disaster or disturbance. The properties underlying the HELOCs may be concentrated in these regions. Such concentration may result in greater losses to noteholders than those generally present for similar notes without such concentration. As of the close of business on Jan. 31, 2004, approximately 58.33% and 12.05%, of the HELOCs were secured by mortgaged properties in California and New York, respectively. A weakening of the economy of these states may result in increases in the loss and delinquency rate for HELOCs concentrated in such areas and if the surety provider fails to perform under the certificate policy, which may result in delays in payment or a loss.

Cash Flow Limited in Early Years of HELOCs

Each HELOC has a draw period that lasts for the first ten years and a repayment term for the last ten years of the term of the HELOC. No principal or a minimal amount of principal is due during the draw period although a borrower may voluntarily make a principal payment. Monthly principal payments during the repayment period are required in amounts that will amortize the amount outstanding at the commencements of the repayment period over the remaining term of the HELOC. Collections on the HELOCs may also vary due to seasonal purchasing and payment habits of borrowers. As a result there may be limited collections available to make payments and may also delay payments of principal.

The Servicer Has Limited Ability to Change the Terms of the HELOCs

The servicer may agree to changes in the terms of a HELOC if the changes:
do not materially and adversely affect the interest of the noteholders or the surety provider; and
re consistent with prudent business practice.

In addition, the servicer, within certain limitations, may increase the credit limit and reduce the loan rate related to a HELOC. Any increase in the credit limit related to a HELOC could increase the combined loan-to-value ratio of that HELOC and, accordingly, may increase the likelihood and could increase the severity of loss in the event of a default under the HELOC. In addition, any reduction in the loan rate of a HELOC could reduce the excess cash flow available to absorb losses.

Refer to sections “The Pooling and Servicing Agreement—Modifications to HELOCs” and “—Consent to Senior Liens” for more detail.

Increase in Delinquencies and Defaults May Result from an Event of a Servicing Transfer

If the servicing of any HELOC were to be transferred from a subservicer to the servicer, or if any other servicing transfer were to occur, there may be an increase in delinquencies and defaults due to misapplied or lost payments, data input errors, system incompatibilities or otherwise. Although any increase in delinquencies is expected to be temporary, there can be no assurance as to the duration or severity of any disruption in servicing the applicable HELOCs as a result of any servicing transfer.

Interest Payable on the Notes and Interest Payable on the Mortgage Loans Differ

Interest payable on the HELOCs may be insufficient to distribute interest on the class A underlying certificates, which initially accrue on the basis of one-month LIBOR plus 0.17% (but which may increase up to the sum of one-month LIBOR plus 0.50% as described herein), subject to a cap based in part on the interest rates on the HELOCs. This may result in interest payments on the class A underlying certificates being insufficient to pay interest on the notes. Interest payable on the HELOCs will accrue at a variable rate based on the prime rate as published in the “Money Rates” table of the Wall Street Journal, plus a designated margin, subject to maximum limitations on adjustments. As a result, the class A underlying certificates, and consequently the notes, may accrue less interest than they would accrue if the interest rate on the class A underlying certificates were based solely on one-month LIBOR plus 0.17% or such other higher rate.

One-month LIBOR and the prime rate may not respond to the same economic factors and there is no necessary correlation between them. Any reduction in the spread between one-month LIBOR and the prime rate will also reduce the amount of interest receipts on the HELOCs that would be available to absorb losses and charge-offs allocated to the class A underlying certificates, and consequently in reduced interest available to make payments on the notes. In that event, if the overcollateralization were depleted and the surety provider failed to perform under either the certificate policy or the note policy, a loss would be realized. In addition, if the spread between one-month LIBOR and the prime rate is reduced or eliminated, the interest payable on the class A underlying certificates, and therefore the notes, also may be reduced. If the sum of one-month LIBOR plus 0.17% (or such other higher rate) exceeds the maximum rate of interest allowed on the class A underlying certificates, such shortfalls with accrued interest thereon will be paid to the class A underlying certificates, and consequently the noteholders, only to the extent such amounts are paid on the class A underlying certificates. These shortfalls will be paid only if amounts are available for such payment on a subsequent distribution date at a lower priority than interest is normally paid to the class A underlying certificates. Such shortfalls will not be guaranteed by the surety provider.

Ratings on Notes Based Primarily on Claims-Paying Ability of the Surety Provider

The rating on the notes depends primarily on the claims paying ability of the surety provider. Therefore, a reduction in the financial strength rating of the surety provider may result in a corresponding reduction in the credit ratings assigned to the notes. A reduction in the credit rating assigned to the notes would reduce the market value of the notes and may affect the ability to sell them. The surety provider does not guarantee the market value of the certificates or the notes, or the credit ratings assigned to them.

Refer to the section “Rating” for more detail.

Limited Information Regarding Prepayment History

All of the HELOCs may be prepaid in whole or in part at any time. Neither the seller nor the servicer is aware of any publicly available studies or statistics on the rate of prepayment of home equity loans. Home equity loans usually are not viewed by borrowers as permanent financing and may experience a higher rate of prepayment than traditional HELOCs. The trust's prepayment experience may be affected by a wide variety of factors, including:
general economic conditions,
interest rates,
the availability of alternative financing,
homeowner mobility, and
changes affecting the ability to deduct interest payments on home equity lines of credit for Federal income tax purposes.

Prepayments on the HELOCs made on and after Feb. 1, 2006 (or earlier if a rapid amortization event occurs) will result in earlier payments of principal on the notes. In addition, substantially all of the HELOCs contain due-on-sale provisions, which may affect the rate of prepayment.

Refer to the section “Maturity and Prepayment Considerations” for more detail.

Yield to Maturity of Notes May be Affected by Repurchases

The yield to maturity of the notes may be affected by certain repurchase requirements. The seller will be required to purchase HELOCs from the underlying trust in the event certain breaches of representations and warranties made by it have not been cured. These purchases will have the same effect on the holders of the notes as a prepayment of the related HELOCs.

Consequences of Owning Book-Entry Notes

Limit on Liquidity of Notes. Issuance of the notes in book-entry form may reduce the liquidity of the notes in the secondary trading market since investors may be unwilling to purchase securities for which they cannot obtain physical notes.

Limit on Ability to Transfer or Pledge. Since transactions in the notes can be effected only through DTC, Clearstream, Euroclear, participating organizations, indirect participants and banks, the ability to pledge notes to persons or entities that do not participate in the DTC, Clearstream or Euroclear system or otherwise to take actions in respect of the notes, may be limited due to lack of a physical security representing the notes.

Delays in Payments. As a beneficial owner, delays may be experienced in the receipt of payments of interest on and principal of notes since payments will be forwarded by the trustee to DTC and DTC will credit payments to the accounts of its participants which will credit them to the accounts of the beneficial owners either directly or indirectly through indirect participants.

Refer to the section “Description of the Notes—Book-Entry Notes” for more detail.

Impact of Terrorist Attacks

The economic impact of the United States' military operations in Iraq, as well as the possibility of any terrorist attacks in response to these operations, is uncertain but could have a material effect on general economic conditions, consumer confidence and market liquidity. No assurance can be given as to the effect of these events on consumer confidence and the performance of the HELOCs. Any adverse impact resulting from these events would be borne by the holders of the notes. United States military operations also may increase the likelihood of shortfalls under the Servicemembers' Civil Relief Act and similar state laws.

Refer to the section “Legal Aspects of Loans—Servicemembers' Civil Relief Act” for more detail.

Insolvency of the Seller Could Result in Delays in Payments or Losses on Notes

The seller is a federal savings bank over which the Office of Thrift Supervision (the “OTS”) and the Federal Deposit Insurance Corporation (“FDIC”) have special powers under the banking laws to take certain actions upon the insolvency or certain other events of the seller. The transfer of the HELOCs by the seller to the mortgage loan transferor will be characterized in the mortgage loan purchase agreement as a sale transaction. Similarly, the transfer of the class A underlying certificates by the seller to the certificate seller and by the certificate seller to the depositor will be characterized in the applicable transfer agreement as a sale transaction. Nevertheless, in the event of insolvency of the seller, the FDIC as conservator or receiver, could attempt to recharacterize the sale of the HELOCs to the mortgage loan transferor as a borrowing secured by a pledge of the HELOCs. However, the FDIC has issued regulations (the “FDIA Rule”) surrendering certain rights under the Federal Deposit Insurance Act (the “FDIA”) to reclaim, recover or recharacterize a financial institution's transfer of financial assets if (i) the transfer involved a securitization of the financial assets and meets specified conditions for treatment as a sale under relevant accounting principles, (ii) the financial institution received adequate consideration for the transfer at the time of the transfer, (iii) the parties intended that the transfer constitute a sale for accounting purposes and the relevant documentation reflects such intention, and (iv) the financial assets were not transferred fraudulently, in contemplation of the financial institution's insolvency, or with the intent to hinder, delay or defraud the financial institution or its creditors.

The transfer of the HELOCs by the seller to the mortgage loan transferor has been structured to satisfy the requirements of the FDIA Rule. If the FDIC were to take the position that the FDIA Rule did not apply or that its requirements were not satisfied, and if the FDIC were further successful in an attempt to recharacterize the seller's transfer of the HELOCs as a secured borrowing, the FDIC could elect to accelerate payment of the certificates and liquidate the HELOCs. As a holder of the class A underlying certificates, the note trust would be entitled to no more than the outstanding principal balances, if any, of the class A underlying certificates, together with interest thereon at the class A underlying certificate rate. In the event of an acceleration of the class A underlying certificates, the note trust would lose the right to future payments of interest, might suffer reinvestment losses in a lower interest rate environment and may fail to recover the initial investment made by the depositor in such class A underlying certificates. Further, with respect to an acceleration by the FDIC, interest may be payable only through the date of appointment of the FDIC as conservator or receiver. The FDIC has a reasonable period of time (which it has stated will generally not exceed 180 days after the date of its appointment) to elect to accelerate payment. Whether or not an acceleration takes place, delays in payments on the class A underlying certificates and possible reductions in the amount of such payments could occur. As a result, funds available to the note trust to make payments on the notes may be reduced.

The transfer of the class A underlying certificates from the seller to the certificate seller and from the certificate seller to the depositor is intended by the parties and has been documented as sales in the applicable transfer agreement. However, if the certificate seller were to become bankrupt, a trustee in bankruptcy could attempt to recharacterize the sale of the class A underlying certificates as a loan secured by the class A underlying certificates and consequently, the bankruptcy court could consolidate the class A underlying certificates with the assets of the certificate seller. Although steps have been taken to minimize this risk that the sale of the class A underlying certificates by the certificate seller could be recharacterized as a secured loan for bankruptcy purposes, any such attempt to recharacterize the transaction could result in a delay in or reduction of collections on the class A underlying certificates available to make payments on the notes.

Refer to the section “Description of the HELOCs—Certain Regulatory Matters Related to Banks” for more detail.

An Optional Purchases May Adversely Affect the Yield on the Notes

On any distribution date on or after the outstanding principal balance of the class A underlying certificates is reduced to an amount less than or equal to 10% of the outstanding principal balance of the class A underlying certificates on the closing date, the servicer may purchase all of the HELOCs and thereby cause a termination of the underlying trust. In addition, on any payment date on or after the outstanding principal balance of the notes is reduced to an amount less than or equal to 35% of the outstanding principal balance of the notes on the closing date, the owner trustee on behalf of the note trust and at the direction of the certificate seller (or any successor owner of the owner trust certificates) may purchase the notes at a price equal to the outstanding principal balance on the notes plus accrued interest thereon. See “Description of the Notes—Optional Terminations” in this prospectus supplement. If either event happens, it will have the same effect as if all of the remaining borrowers made prepayments in full. Notes purchased at a premium could be adversely affected by such an optional purchase. See “Maturity and Prepayment Considerations” in this prospectus supplement.

The Obligations of the Seller, the Mortgage Loan Transferor, the Certificate Seller, the Depositor and the Servicer are Limited

None of the seller, the mortgage loan transferor, the certificate seller, the depositor or the servicer is obligated to make any distributions of principal or interest on the class A underlying certificates or the notes. The only obligation of the seller to make any payment in respect of the HELOCs is its obligation to repurchase from the trust those HELOCs with respect to which there is a defect in the related documentation, if there is a material breach of representations and warranties. There is no guarantee, however, that the seller will have the financial ability to repurchase any of those HELOCs.

Increased Risk of Loss as a Result of Ten Year Amortization Period of the HELOCs

The HELOCs require no principal payments or minimal principal payments during the first ten years following origination, and all require repayment of the principal amount outstanding at the commencement of the repayment period over the remaining term in equal monthly installments. HELOCs with terms like these pose a special payment risk because the borrower must start making substantially higher monthly payments at the start of the repayment period. If the borrower is unable to make such increased payments, the borrower may default. Losses may occur for such loans, and the other forms of credit enhancement, are insufficient or unavailable to cover the loss and the surety provider fails to perform under the certificate policy.

Risks Associated With the Mandatory Auction of the Notes

On the payment date in February 2006, it is expected that a mandatory auction of the notes will occur.

If the auction is successful, noteholders will be required to resell their notes, but the market-clearing price bid may not be sufficient to pay the par price on the notes. The difference between the par price and the price at which the notes are sold is guaranteed by the surety provider pursuant to the note policy. If the surety provider fails to perform its obligations under the note policy, a loss may occur.

If the auction is unsuccessful as described herein, noteholders will be required to retain their notes and the note rate will reset to the sum of one-month LIBOR and 0.45%. Although the noteholders are entitled to receive an additional amount (as described herein), no assurance can be made that such amount will be full compensation for any differences between the par price and the market value of the notes on such date. Payment of this additional amount is also guaranteed by the note policy.

None of the issuer, the auction administrator or the surety provider guarantees the market value of the notes. See “Description of the Notes—Mandatory Auction of the Notes” in this prospectus supplement.

The Incurrence of Additional Debt by Borrowers Could Increase Risk

With respect to HELOCs that were used for debt consolidation, there can be no assurance that the borrower will not incur further debt. This reloading of debt could impair the ability of borrowers to service their debts, which in turn could result in higher rates of delinquency and loss on the HELOCs. See “The HELOCs” in this prospectus supplement.

The Underlying Trust

General

A trust company, referred to as the underlying trust, will be formed pursuant to a pooling and servicing agreement dated as of Feb. 1, 2004, among the servicer, the mortgage loan transferor, the seller and the certificate trustee.

The trust property will consist of:
each of the home equity lines of credit or “HELOCs” that are transferred by the mortgage loan transferor to the trust;
collections on the HELOCs received after the close of business on Jan. 31, 2004 or the first day of the month during which such HELOCs are transferred to the Underlying Trust, whichever is later (in each case the “Cut-Off Date”);
the outstanding balances as of the Cut-Off Date and any additional balances generated under the HELOCs;
mortgaged properties relating to the HELOCs that are acquired by foreclosure or deed in lieu of foreclosure;
the collection account and the distribution account, excluding, in each case, net earnings thereon;
the class A underlying certificate policy (the “Certificate Policy”);
an assignment of the mortgage loan transferor's rights under the purchase agreement, including all rights of the mortgage loan transferor to purchase any additions to the loan balances of the HELOCs;
benefits under any hazard insurance policies covering the mortgaged properties; and
all proceeds from the items above.

### The Surety Provider

The Surety Provider provides financial guaranty insurance for public finance and structured finance obligations. The Surety Provider is preferably licensed to engage in financial guaranty insurance in all 50 states, the District of Columbia, the Commonwealth of Puerto Rico and, through a branch, in the United Kingdom.

For example, where an investor group acquired approximately 42%, 23%, 23% and 7%, respectively, of a corporation's common stock. The corporation paid approximately $284.3 million in pre-closing dividends from the proceeds of dividends it, in turn, had received from the Surety Provider, and the parent retained approximately $234.6 million in liquidation preference of the corporation's convertible participating preferred stock and approximately 5% of the corporation's common stock. Neither the corporation nor any of its shareholders is obligated to pay any debts of the Surety Provider or any claims under any insurance policy, including the Policies, issued by the Surety Provider.

The Surety Provider is subject to the insurance laws and regulations of the State of New York, where the Surety Provider is domiciled, including Article 69 of the New York Insurance Law (“Article 69”), a comprehensive financial guaranty insurance statute. The Surety Provider is also subject to the insurance laws and regulations of all other jurisdictions in which it is licensed to transact insurance business. The insurance laws and regulations, as well as the level of supervisory authority that may be exercised by the various insurance regulators, vary by jurisdiction, but generally require insurance companies to maintain minimum standards of business conduct and solvency, to meet certain financial tests, to comply with requirements concerning permitted investments and the use of policy forms and premium rates and to file quarterly and annual financial statements on the basis of statutory accounting principles (“SAP”) and other reports. In addition, Article 69, among other things, limits the business of each financial guaranty insurance company to financial guaranty insurance and certain related lines.

The New York State Insurance Department recognizes only statutory accounting practices for determining and reporting the financial condition and results of operations of an insurance company, for determining its solvency under the New York Insurance Law, and for determining where its financial conditions warrants the payment of a dividend to its stockholders. No consideration is given by the New York State Insurance Department to financial statements prepared in accordance with generally accepted principles in making any such determination.

For the nine months ended Sep. 30, 2003, and the years ended Dec. 31, 2002, and Dec. 31, 2001, the Surety Provider had written directly or assumed through reinsurance, guaranties of approximately $35.3 billion, $47.9 billion, and $40.4 billion par value of securities, respectively (of which approximately 77 percent, 81 percent and 81 percent, respectively constituted guaranties of municipal bonds), for which it had collected gross premiums of approximately $205.1 million, $232.6 million and $154.6 million, respectively. For the nine months ended Sept. 30, 2003, the Surety Provider had reinsured, through facultative arrangements, approximately 2.1% of the risks it had written.

Capitalization

The following table sets forth the capitalization of the Surety Provider as of Dec. 31, 2001, Dec. 31, 2002 and Sept. 30, 2003 respectively, on the basis of generally accepted accounting principles (“GAAP”), and the pro forma capitalization as of Sept. 30, 2003 as adjusted to reflect the effects of the acquisition.

A financial guaranty company (millions)

| | (unaudited) | | | | | (pro forma) |
|---|---|---|---|---|---|---|
| | Dec. 31, 2001 | Dec. 31, 2002 | Sep. 30, 2003 | Adjustments | | Sep. 30, 2003 |
| Unearned Premiums | $613 | $684 | $757 | $135 | (a) | $892 |
| Other Liabilities | 238 | 255 | 236 | (66) | (b) | 96 |
| | | | | (81) | (c) | |
| | | | | 7 | (d) | |
| Stockholder's Equity | | | | | | |
| Common Stock | 15 | 15 | 15 | | (a) | 15 |
| Additional Paid-in | 384 | 384 | 384 | (75) | (b) | 1,846 |
| Capital | | | | (49) | (e) | |
| | | | | (248) | (f) | |
| | | | | 1,834 | (g) | |
| Accumulated Other | | | | | | |
| Comprehensive | (15) | 49 | 31 | (30) | (g) | 1 |
| Income | | | | | | |
| Retained Earnings | $1,623 | $1,741 | $1,889 | $(1,804) | (g) | $85 |
| Total Stockholder's | $2,007 | $2,189 | $2,319 | $(372) | | $1,947 |
| Equity | | | | | | |
| Total Liabilities and | $2,858 | $3,128 | $3,312 | $(377) | | $2,935 |
| Stockholder's Equity | | | | | | |

(a) Reflects the estimated purchase accounting adjustment for the GAAP unearned premium reserve (“GAAP UPR”). The adjustment is an estimate of the increase in the balance that is necessary to bring the future returns for the Surety Provider's embedded book of business to a market return. This adjustment is necessary because the purchase price paid in connection with the acquisition represents a discount to the corporation's book value. The fair value adjustment to GAAP UPR is determined based on the difference between the value paid for the cash premium balance (determined by the net present value of the future cash flows of the business over the life of the in-force book, discounted at a market rate of return), and the existing GAAP UPR balance. The fair value adjustment to unearned premiums is $141.1 million, adjusted downward to $135 million to reflect the fact that only 95.5% of the corporation was acquired. The Surety Provider's GAAP UPR balance reflects the gross unearned premium for the Surety Provider's insured risk and the premium balance attributable to the reinsurers is reflected in the prepaid reinsurance premiums balance. These balances will be amortized and earned over the period at risk based on the inforce book of business. (See note (b) for the related deferred tax consequences.)
(b) Reflects the estimated purchase accounting adjustment for deferred taxes associated with all the fair value adjustments described in notes (a) and (e).
(c) In connection with the consummation of the acquisition, the Surety Provider redeemed its tax and loss bonds and settled in cash its resulting current federal income tax obligations of $81 million.
(d) In connection with the consummation of the acquisition, the Surety Provider entered into a capital lease agreement that covers leasehold improvements at the Surety Provider's main office and computer hardware. The adjustment represents the net impact of the undiscounted value of the $8 million of future payments under the lease or $7 million discounted.
(e) In accordance with purchase accounting, the portion of the deferred policy acquisition costs balance acquired (95.5%) was eliminated at closing. (See note (b) for related deferred tax consequences.)
(f) In connection with the consummation of the acquisition, the Surety Provider paid to its parent, and the corporation paid a pre-closing dividend in an amount equal to $100.0 million plus year-to-date adjusted net income of the Surety Provider, through the consummation of the acquisition. The portion of the pre-closing dividends attributable to such adjusted net income would have been $148 million as of Sept. 30, 2003.
(g) In connection with consummation of the Acquisition, the 95.5% of the historical amounts of retained earnings and accumulated other comprehensive income were reclassified to additional paid in capital for the purposes of the pro forma presentation.

The audited financial statements of the Surety Provider as of Dec. 31, 2002 and 2001 and for each of the years in the three-year period ended Dec. 31, 2002, and the unaudited financial statements of the Surety Provider as of Sept. 30, 2003 and for the three and nine month periods ended Sept. 30, 2003 and 2002 which are included as Exhibit 99.1 and 99.2 to the Current Report on Form 8-K filed by the depositor (SEC file number 333-108503) in connection with the registration statement of which this prospectus supplement is a part, are hereby incorporated by reference in this prospectus supplement. Any statement contained herein under the heading “The Surety Provider” or in such Exhibit 99.1 or 99.2, shall be modified or superseded to the extent required by any statement in any document subsequently incorporated by reference in this prospectus supplement with the approval of the Surety Provider, and shall not be deemed, except as so modified or superseded, to constitute a part of this prospectus supplement.

All financial statements of the Surety Provider (if any) included in documents filed by the depositor with the Securities and Exchange Commission pursuant to Section 13(a), 13(c), 14 or 15(d) of the Exchange Act, subsequent to the date of this prospectus supplement and prior to the termination of the offering of the notes shall be deemed to be incorporated by reference into this prospectus supplement and to be a part hereof from the respective dates of filing of such documents.

Copies of the Surety Provider's GAAP and SAP financial statements are available upon request to: Financial Guaranty Insurance Company, 125 Park Avenue, New York, N.Y. 10017, Attention: Corporate Communications Department. The Surety Provider's telephone number is (212) 312-3000.

The Surety Provider's Credit Ratings

The financial strength of the Surety Provider is rated “AAA” by Standard & Poor's, a Division of The McGraw-Hill Companies, Inc., “Aaa” by Moody's Investors Service, and “AAA” by Fitch Ratings. Each rating of the Surety Provider should be evaluated independently. The ratings reflect the respective ratings agencies' current assessments of the insurance financial strength of the Surety Provider. Any further explanation of any rating may be obtained only from the applicable rating agency. These ratings are not recommendations to buy, sell or hold the notes, and are subject to revision or withdrawal at any time by the rating agencies. Any downward revision or withdrawal of any of the above ratings may have an adverse effect on the market price of the notes. The Surety Provider does not guarantee the market price or investment value of the notes nor does it guarantee that the ratings on the notes will not be revised or withdrawn.

Neither the Surety Provider nor any of its affiliates accepts any responsibility for the accuracy or completeness of the prospectus, the prospectus supplement or any information or disclosure that is provided to potential purchasers of the notes, or omitted from such disclosure, other than with respect to the accuracy of information regarding the Surety Provider and the Policies set forth under the headings “The Surety Provider” and “Description of the Notes—The Policies” herein. In addition, the Surety Provider makes no representation regarding the notes or the advisability of investing in the notes.

The Seller

A bank or other financial entity may serve as the seller. Such institutions are preferably experienced in originating and servicing HELOCs of the type contained in the pool. Additionally, such institutions are also preferably approved by Fannie Mae and the Federal Home Loan Mortgage Corporation (“Freddie Mac”), as well as being a mortgagee approved by the U.S. Department of Housing and Urban Development (“HUD”) and an institution the deposit accounts of which are insured by the FDIC.

The Servicer

A bank will preferably act as the servicer. The servicer will be responsible for servicing the HELOCs in accordance with the terms set forth in the pooling and servicing agreement employing the same degree of skill and care which it employs in servicing the HELOCs comparable to the HELOCs serviced by the servicer for itself or others. The servicer may perform its servicing obligations under the pooling and servicing agreement through one or more subservicers selected by the servicer. Notwithstanding any subservicing agreement, the servicer will remain liable for its servicing duties and obligations under the pooling and servicing agreement as if the servicer alone were servicing the HELOCs. Additional sub-servicing agreements may be in effect between the service and other sub-servicing entities.

Sub-servicing agreements may be renewed automatically on a monthly basis upon the expiration of their initial terms in 2006. These agreements can be terminated in the event that the bank decides not to renew or that the bank exercises its right to terminate for convenience. It is unlikely that a bank will choose not to renew its agreements with a third party sub-servicer or to exercise its right of termination since the bank may be obligated to pay a fee for such non-renewal. Those skilled in the art will recognize that other relevant terms may apply between the service and sub-servicer, however, the servicer, will typically remain liable for its servicing duties and obligations under the pooling and servicing agreement.

Mortgage Loan Transferor

The mortgage loan transferor is preferably formed solely for the purpose of acquiring from the seller financial assets, including HELOCs and conveying the same into trusts or other securitization vehicles. As a bankruptcy-remote entity, the mortgage loan transferor's operations are restricted so that it does not engage in business with, or incur liabilities to, any other entity other than entities such as the seller, the underlying trust, the certificate trustee and the servicer as contemplated under the pooling and servicing agreement or similar securitization agreements. The restrictions are intended to prevent the mortgage loan transferor from engaging in business with other entities that may bring bankruptcy proceedings against the mortgage loan transferor. The restrictions are also intended to reduce the risk that the mortgage loan transferor will be consolidated into the bankruptcy proceedings of any other entity. The mortgage loan transferor does not have, nor is it expected in the future to have, any significant assets.

The Certificate Seller

A third party, other bank, or other financial institution may act as a the holding company for the original seller or servicer.

Loan Program

HELOCs are originated through multiple channels, but primarily through business-to-business channels (“B2B”), business-to-consumer channels (“B2C”) and third party originators (“Direct Channel”). All of the HELOCs will have been originated by the bank. Under the Direct Channel, the origination processing of HELOCs may have been outsourced to two third-party originators. The third-party originators are required to adhere to underwriting guidelines and are not given any underwriting discretion. Underwriting standards are uniform among all channels except the Direct Channel. The differences in underwriting standards between the Direct Channel and other channels are described under “Underwriting Standards” hereunder.

The general terms of HELOCs are described below under “Description of the HELOCs—HELOC Terms.”

The borrower's right to make a draw under a HELOC may be suspended or the borrower's line of credit may be reduced if, among other things:
the borrower is in default of a material obligation under the HELOC (other than a payment default, which will result in an acceleration of the entire outstanding principal balance);
the HELOC experiences unsatisfactory payment history;
the value of the mortgaged property securing the HELOC declines to a level significantly below the appraised value at the time of origination;
the servicer determines that the borrower will not be able to meet the repayment requirements due to a change in the borrower's financial circumstances;
the priority of the lien on the mortgaged property is impaired by an adverse governmental action; or
a regulatory agency has notified the originator that continued advances would constitute an unsafe and unsound practice.

In addition, the borrower may be required to pay the entire balance due plus all other accrued but unpaid charges immediately, if:
the borrower fails to make any required payment by the due date;
the borrower engaged in fraud or a material misrepresentation in connection with the origination of the HELOC; or
the borrower's action or inaction adversely affects the mortgaged property or the holder of the mortgage note's rights in the mortgaged property.
   Underwriting and Credit Criteria

All of the HELOCs are originated or acquired by the seller or originated through the Direct Channel by authorized third-party vendors based on the seller's underwriting standards. All of the HELOCs were underwritten generally in accordance with the seller's underwriting standards. The following is a brief description of the underwriting standards and procedures applicable to the HELOCs.

The seller's underwriting standards with respect to the HELOCs generally will conform to those published in the seller's underwriting guidelines, including the provisions of the seller's underwriting guidelines applicable to the seller's Home Equity Line of Credit Program. However, seller may approve a loan that otherwise doesn't meet seller's underwriting standards based on certain mitigating factors. Such determination is made on a loan-by-loan basis. In addition, the underwriting standards as set forth in the seller's underwriting guidelines are continually revised based on prevailing conditions in the residential mortgage market and the market for mortgage securities.

The underwriting standards set forth in the seller's Home Equity Line of Credit Program provide for several different levels of documentation: (1) the “Full/Alternate Documentation Program,” (2) the “Reduced Documentation Program,” (3) the “Pre-Approved Program” and (4) the “Invitation-to-Apply Program” (also referred to as the “ITA Program” herein). All HELOCs originated in the Direct Channel follow guidelines for the Pre-Approved Program and the ITA Programs.

Asset, Income and Employment Documentation

Full/Alternate Documentation Program

For Full/Alternate Documentation HELOCs, a prospective borrower is required to fill out a detailed application providing pertinent credit information, including tax returns if the borrower is self-employed or received income from dividends and interest, rental properties or other income which can be verified via tax returns. In addition, a borrower (other than a self-employed borrower) must demonstrate income and employment directly by providing alternative documentation in the form of a pay stub showing year-to-date earnings and a W-2 to provide verification of employment. Borrowers that claim other sources of income such as pension, social security, VA benefits and public assistance must provide written documentation that identifies the source and amount of such income, such as an award letter, and demonstrate that such income can reasonably be expected to continue for at least 3 years. Income in the form of alimony, child support or separate maintenance income must be substantiated by a copy of the divorce decree or separate maintenance agreement, as applicable.

Reduced Documentation Program

Borrowers who qualify for the Reduced Documentation Program need to provide only verbal verification of employment, but will be required to demonstrate that he or she has an average account balance of at least one month's income from qualified assets and sources. Closing balances and loan proceeds, for example, may not be used to meet this requirement. The types of assets that can be considered in determining whether the reserve requirement has been met include funds from checking, savings, money market or CD accounts, stocks, bonds, and mutual funds. The Reduced Documentation Program is not available to borrowers whose credit reports do not show that the borrower has had a mortgage for at least 12 months within the past 3 years.

Pre-Approved Program and ITA Program

Borrowers who qualify under the ITA Program must provide either two current consecutive pay stubs or two current consecutive tax returns as income verification. A credit report is also required. Because borrowers who qualify under the Pre-Approved Program have high credit scores relative to the combined loan-to-value (“CLTV”) on the related mortgaged properties, Pre-Approved HELOCs require no documentation with respect to the borrowers' income or employment.

Credit Criteria

Full/Alternate Documentation Program and Reduced Documentation Program

Each borrower under the Full/Alternate Documentation Program must meet the following credit criteria:
credit scores reported by at least 2 credit bureaus with at least 2 trade lines open for at least 12 months, or, one credit score with at least 5 trade lines open at least 12 months;
no mortgage payments thirty days or more delinquent within the last twelve months;
no foreclosures within the last three years; and
borrower has not participated in a consumer credit counseling plan within the last two years.

The minimum credit amount for second lien HELOCs that close concurrently with a first mortgage is $10,000 for most states in which the seller originates second lien HELOCs. The minimum credit amount for first lien HELOCs or second lien HELOCs that do not close concurrently with a first mortgage is $50,000.

Pre-Approved Program and ITA Program Each borrower under either the Pre-Approved Program or the ITA Program must meet the following credit criteria:
no bankruptcy, foreclosures, repossessions or debt counseling within the past 3 years;
no charge-offs, unpaid collections, tax liens or judgments in an amount over $1,000;
no payment delinquency of 60 days or more on any trade within the past year;
no payment delinquency of 30 days or more on a mortgage or home equity line of credit within the past 2 years;
no non-standard addresses should be shown on the credit report (i.e., P.O. Boxes)(applicable only to Pre-Approved HELOCs); and
miscellaneous status codes (i.e., I.D. Theft) are not allowed (applicable only to Pre-Approved HELOCs).
   First Mortgage Requirements

Full/Alternate Documentation Program and Reduced Documentation Program

For second lien HELOCs, the following additional requirements apply with respect to the first lien mortgage:
the LTV of the first lien may not exceed 90% (based on the current principal balance);
the current principal balance of the first lien may not exceed $750,000;
if the first mortgage relates to a balloon loan, such balloon loan must have a reset or refinance option;
if the first mortgage relates to a loan with a negative amortization feature, the maximum possible principal balance must not exceed 110% of the original principal balance;
if the first mortgage relates to a loan with interest only payments, the interest only payment period must be 10 years or less; and
the first mortgage may not:
   be held by a private party;
   be a contract for a deed, contract for purchase, or land contract;
   have provisions against additional liens;
   have provisions for future advances or disbursements; or
   be a HELOC.

Pre-Approved Program and ITA Program

For second lien HELOCs, the principal balance of the first lien may not exceed $750,000.

Title Insurance

Full/Alternate Documentation Program and Reduced Documentation Program

Title insurance requirements vary among the different types of HELOCs. A lender's ALTA policy is required for first lien HELOCs. For second lien HELOCs originated concurrently with a first mortgage, a copy of the preliminary title report, commitment, binder, or abstract obtained for the origination of the first mortgage is required. The lender's title insurance coverage amount need not include the amount of the second mortgage. There can be no intervening liens between the first and second mortgages. For second lien HELOCs that are not originated concurrently with a first mortgage, the seller requires at a minimum a preliminary title report for any HELOC with a credit limit of up to $200,000 and, for any HELOC with a credit limit over $200,000, a lender's ALTA title policy.

Pre-Approved Program and ITA Program

Provided that there are no intervening liens between the first and second mortgages, title insurance is not required. In lieu of a title insurance policy, a title or vesting report is typically obtained on a HELOC originated under these programs and a lien search will be conducted.

Appraisal Requirements

Full/Alternate Documentation Program and Reduced Documentation Program Appraisal requirements differ depending on the mortgage type and loan amounts. For second lien HELOCs originated concurrently with a first mortgage, a copy of the appraisal and a set of original photos used for the origination of the new first mortgage are required. For second lien HELOCs that are not originated concurrently with a first mortgage, if the loan amount is less than $75,000, either a property inspection or a Fannie Mae Form 2975 (Condition & Marketability Report with exterior inspection only) may be used, depending on whether the initial appraised value indicated on the loan application matches the seller's valuation model. For second lien HELOCs that are not originated concurrently with a first mortgage, if the loan amount is greater than $75,000, a Freddie Mac form 2055 (Quantitative Analysis Appraisal Report with exterior inspection only) is required and the report must include a photo of the front view of the subject property, a location map and comparable sales.

Pre-Approved Program and ITA Program

The appraisal requirement is dependent upon the loan amount and is as follows:
loan amounts less than $75,000: an appraised value generated by the Appraisal Value Model (“AVM”)
loan amounts between $75,001 to $100,000: desktop appraisal
loan amounts between $100,001 to $150,000: drive-by appraisal
loan amounts between $150,000 to $200,000: full appraisal
   Mortgaged Properties

The properties which secure repayment of the HELOCs are referred to as the “mortgaged properties.” All mortgaged properties must be owner-occupied at the time of origination.

In general, the mortgaged properties will include primarily single family properties. Specifically, the mortgaged properties may consist of:
detached single family dwellings;
individual units in planned unit developments;
attached single family dwellings;
low rise condominium with no more than 4 stories;
two unit properties; or
second homes.

The HELOCs may be subordinated to other mortgages on the same mortgaged property.

Principal amounts on the HELOCs may be drawn down up to a maximum amount as set forth in the line of credit agreement or repaid from time to time. New draws by borrowers under the HELOCs will automatically become part of the underlying trust. As a result, the aggregate balance of the HELOCs will fluctuate from day to day as new draws by borrowers are added to the underlying trust and principal payments are applied to the balances.

Servicing

The servicer will be responsible for servicing the HELOCs in accordance with the terms set forth in the pooling and servicing agreement employing the same degree of skill and care which it employs in servicing the HELOCs comparable to the HELOCs serviced by the servicer for itself or others. The servicer may perform its servicing obligations under the pooling and servicing agreement through one or more subservicers selected by the servicer. Notwithstanding any subservicing agreement, the servicer will remain liable for its servicing duties and obligations under the pooling and servicing agreement as if the servicer alone were servicing the HELOCs.

It is expected that a bank will perform a portion of its servicing obligations under the pooling and servicing agreement through one or more subservicers. The bank subservicers provide comprehensive day-to-day servicing functions, many of which are associated with the borrowers' use of the bank equity card and general customer service matters. Moreover, the day-to-day servicing functions include, but are not limited to, (1) providing electronic systems (currently provided by FDR pursuant to a tri-party agreement among FDR, CMC and the seller) necessary to continuously monitor and update borrower accounts (i.e., tracking payments received from the borrowers and draws made by the borrowers on the HELOCs), to generate monthly billing statements and to process payments received from the borrowers, (2) maintaining customer support call centers and (3) conducting initial collection services on delinquent HELOCs.

If the servicing of any HELOC were to be transferred from a subservicer to the bank, or if any other servicing transfer were to occur, there may be an increase in all delinquencies and defaults due to misapplied or lost payments, data input errors, system incompatibilities or otherwise. Although any increase in delinquencies is expected to be temporary, there can be no assurance as to the duration or severity of any disruption in servicing the applicable HELOCs as a result of any servicing transfer.

Collection and Default Management Services

The servicer, through one or more subservicers, performs the initial collection services on delinquent HELOCs. As part of the collection services, the subservicer makes outbound calls to the borrowers according to a pre-determined schedule and such outbound calls are logged into the customer account database. Collection services are performed by subservicers on HELOCs that are no more than 69 days delinquent. Once a HELOC becomes more than 69 days delinquent, collection activities with respect to such HELOC are transferred from the subservicer to the servicer. The servicer then engages in further collection activities on such delinquent HELOCs which may include, without limitations, workouts or foreclosure proceedings through the servicer's loss mitigation department to the extent the servicer deems necessary.

To the extent that the servicer determines, in its sole discretion, that liquidation proceeds will be maximized through foreclosure, the servicer will foreclose upon or otherwise comparably convert to ownership mortgaged properties securing the HELOCs that come into default when, in accordance with applicable servicing procedures under the pooling and servicing agreement, no satisfactory arrangements can be made for the collection of delinquent payments. In connection with foreclosure or other conversion, the servicer will follow practices as it deems necessary or advisable and as are in keeping with its general servicing activities, provided that the servicer will not be required to expend its own funds in connection with foreclosure or other conversion, curing of default on a related senior mortgage loan or restoration of any property unless, in its sole judgment, foreclosure, correction or restoration will increase net liquidation proceeds. The servicer will be reimbursed out of liquidation proceeds for advances of its own funds as liquidation expenses before any net liquidation proceeds are distributed on the underlying class A certificates.

Delinquency and Loss Experience

The delinquency and loss statistics may be affected by the size and relative lack of seasoning of the portfolio because many of the HELOCs were not outstanding long enough to give rise to some or all of the periods of delinquency and loss indicated in the charts below. The delinquency and loss experience set forth below may not be indicative of any particular bank's delinquency and loss experience for future periods. Accordingly, the information in the tables below (which includes HELOCs with underwriting, payment and other characteristics which differ from those of the HELOCs in the trust fund) should not be considered as a basis for assessing the likelihood, amount, or severity of delinquency or losses on the HELOCs, and no assurances can be given that the delinquency and loss experience presented in these tables will be indicative of the delinquency and loss experience on the HELOCs in the future.

The table below summarizes the historical delinquency and loss experience of HELOCs owned and originated by the seller, but excludes HELOCs that the seller acquired as a result of its merger with the San Gabriel Valley Bancorp in 2000. The HELOCs originated by the San Gabriel Valley Bank are excluded from this table because they were not underwritten using the seller's current underwriting guidelines. No HELOCs originated by the San Gabriel Valley Bank will be transferred to the underlying trust on the Closing Date. Accordingly, the delinquency and loss figures presented below for Dec. 31, 2003 represent information for all HELOCs currently owned and originated by the seller, but may not be representative of the HELOCs included in the underlying trust.

| | As of December 31 | | | | | |
|---|---|---|---|---|---|---|
| | 2001 | | 2002 | | 2003 | |
| | Balance | % | Balance | % | Balance | % |
| Total Unpaid Principal | $83,514,557 | | $302,304,700 | | $688,889,226 | |
| Balance | | | | | | |
| Delinquency at Period End | | | | | | |
| 31-60 days | 575,056 | 0.69% | 1,437,377 | 0.48% | 1,837,953 | 0.27% |
| 61-90 days | 38,008 | 0.05% | 550,053 | 0.18% | 1,542,720 | 0.22% |
| 91-120 days | 90,852 | 0.11% | — | 0.00% | 187,950 | 0.03% |
| 121+ days | 292,811 | 0.35% | 426,327 | 0.14% | 974,816 | 0.14% |
| Total 31+ Day | 996,726 | 1.19% | 2,413,757 | 0.80% | 4,543,440 | 0.66% |
| Delinquencies | | | | | | |
| Charge-0ffs (1) | — | 0.00% | 938,516 | 0.49% | 1,230,549 | 0.25% |
| Recoveries | — | 0.00% | — | 0.00% | 34,889 | 0.01% |
| Net Charge-offs | — | 0.00% | 938,516 | 0.49% | 1,195,660 | 0.24% |

(1) Charge-off and recovery percentages are calculated based on average annual balances, which are calculated using the straight-line method.

Description of the HELOCs
General

The HELOCs in the underlying trust were originated under loan agreements and disclosure statements (the “Credit Line Agreements”) and are secured by mortgages or deeds of trust, which are primarily first and second mortgages or second deeds of trust, on mortgaged properties. The mortgaged properties securing the HELOCs consist primarily of residential properties that are one- to four-family properties. Each mortgaged property was owner-occupied at the time of origination. The HELOCs are usually underwritten in accordance with the standards in effect at the time of origination. Current underwriting standards are described in the section “Underwriting and Credit Criteria.”

Unless otherwise stated, all of the information set forth below with regard to the HELOCs is as of the Cut-Off Date for the HELOCs to be conveyed to the underlying trust on the Closing Date. Prior to the closing date, some of the HELOCs may be removed from the pool and other HELOCs may be substituted for those HELOCs removed. The seller believes that the information in this prospectus supplement relating to the HELOCs to be included in the pool as presently constituted is representative of the characteristics of the HELOCs to be included in the pool as of the closing date, although some characteristics may vary.

In the information that follows, weighted average percentages are based upon the principal balances of the HELOCs on the Cut-Off Date.

The pool of HELOCs consists of 11,580 HELOCs with an aggregate Cut-Off Date pool balance of approximately $500,012,819. As of the Cut-Off Date, the average principal balance was approximately $43,179, the minimum principal balance was approximately $0, the maximum principal balance was approximately $384,511, the minimum loan rate and the maximum loan rate were approximately 4.000% and 10.500% per annum, respectively, and the weighted average loan rate was approximately 5.608% per annum. As of the Cut-Off Date, the average credit limit utilization rate was approximately 76.67%, the minimum credit limit utilization rate was approximately 0.00% and the maximum credit limit utilization rate was approximately 100.98%. The credit limit utilization rate is determined by dividing the Cut-Off Date principal balance of a HELOC by the credit limit of the related Credit Line Agreement. The weighted average combined original loan-to-value ratio of the HELOCs was approximately 80.79% as of the Cut-Off Date.

As of the Cut-Off Date, no HELOC had a combined loan-to-value ratio greater than approximately 101.00%, no more than 0.25% of the HELOCs were delinquent by more than 30 days and none of the HELOCs were delinquent by more than 60 days.

HELOC Pool Statistics

The seller has compiled the following additional information as of the Cut-Off Date with respect to the HELOCs and the related mortgaged properties to be included in the pool on the closing date. The sum of the columns below may not equal the total indicated due to rounding.

Principal Balances

| | | | Percentage |
|---|---|---|---|
| | | Aggregate | of Aggregate |
| | Number of | Outstanding | Outstanding |
| Range of | Mortgage | Principal | Principal |
| Principal Balance | Loans | Balance | Balance |
| $0.01-$2,500.00 | 303 | $293,399.21 | 0.06% |
| $2,500.01-$5,000.00 | 244 | 934,348.51 | 0.19 |
| $5,000.01-$7,500.00 | 233 | 1,461,113.14 | 0.29 |
| $7,500.01-$10,000.00 | 333 | 2,997,802.62 | 0.60 |
| $10,000.01-$20,000.00 | 1,907 | 29,821,590.46 | 5.96 |
| $20,000.01-$30,000.00 | 2,077 | 52,191,902.62 | 10.44 |
| $30,000.01-$40,000.00 | 1,698 | 59,056,175.04 | 11.81 |
| $40,000.01-$50,000.00 | 1,308 | 59,194,185.81 | 11.84 |
| $50,000.01-$60,000.00 | 968 | 52,949,903.86 | 10.59 |
| $60,000.01-$70,000.00 | 655 | 42,597,707.56 | 8.52 |
| $70,000.01-$80,000.00 | 492 | 36,690,576.66 | 7.34 |
| $80,000.01-$90,000.00 | 293 | 24,807,865.75 | 4.96 |
| $90,000.01-$100,000.00 | 347 | 33,317,407.55 | 6.66 |
| $100,000.01-$150,000.00 | 452 | 53,594,190.48 | 10.72 |
| $150,000.01-$200,000.00 | 213 | 37,484,393.07 | 7.50 |
| $200,000.01-$250,000.00 | 48 | 10,141,600.15 | 2.03 |
| $250,000.01-$300,000.00 | 7 | 1,779,014.45 | 0.36 |
| $300,000.01-$350,000.00 | 1 | 315,130.94 | 0.06 |
| $350,000.01-$400,000.00 | 1 | 384,510.84 | 0.08 |
| Total | 11,580 | $500,012,818.72 | 100.00% |

Occupancy Type

| | | | Percentage |
|---|---|---|---|
| | Number of | Aggregate | of Aggregate |
| | Mortgage | Outstanding | Outstanding |
| Occupancy Type | Loans | Principal Balance | Principal Balance |
| Primary Home | 11,580 | $500,012,818.72 | 100.00% |
| Total: | 11,580 | $500,012,818.72 | 100.00% |

Original Combined Loan-to-Value Ratios

The combined loan-to-value ratio in the following table is a fraction whose numerator is the sum of (i) the credit limit of the HELOCs and (ii) any outstanding principal balances of mortgage loans senior to the HELOCs (calculated generally at the date of origination of the related HELOC) and whose denominator is the most recent appraised value of the related mortgaged property, as of the Cut-Off Date.

| Range of Original | | | Percentage |
|---|---|---|---|
| Combined | Number of | Aggregate | of Aggregate |
| Loan-to-Value | Mortgage | Outstanding | Outstanding |
| Ratios | Loans | Principal Balance | Principal Balance |
| 5.01%-10.00% | 8 | $167,089.85 | 0.03% |
| 10.01%-15.00% | 12 | 310,636.53 | 0.06 |
| 15.01%-20.00% | 32 | 1,174,011.11 | 0.23 |
| 20.01%-25.00% | 30 | 1,158,544.26 | 0.23 |
| 25.01%-30.00% | 40 | 2,018,620.64 | 0.40 |
| 30.01%-35.00% | 50 | 2,619,216.04 | 0.52 |
| 35.01%-40.00% | 86 | 4,375,017.32 | 0.87 |
| 40.01%-45.00% | 89 | 4,016,396.40 | 0.80 |
| 45.01%-50.00% | 148 | 6,727,396.37 | 1.35 |
| 50.01%-55.00% | 211 | 9,965,811.58 | 1.99 |
| 55.01%-60.00% | 296 | 14,129,659.61 | 2.83 |
| 60.01%-65.00% | 406 | 20,656,959.11 | 4.13 |
| 65.01%-70.00% | 536 | 26,224,239.56 | 5.24 |
| 70.01%-75.00% | 926 | 37,925,195.38 | 7.58 |
| 75.01%-80.00% | 1,609 | 86,334,083.09 | 17.27 |
| 80.01%-85.00% | 906 | 34,472,107.39 | 6.89 |
| 85.01%-90.00% | 4,233 | 163,881,199.54 | 32.78 |
| 90.01%-95.00% | 1,672 | 71,697,903.97 | 14.34 |
| 95.01%-100.00% | 290 | 12,158,730.97 | 2.43 |
| Total: | 11,580 | $500,012,818.72 | 100.00% |

Loan Purpose

| | | | Percentage |
|---|---|---|---|
| | Number of | Aggregate | of Aggregate |
| | Mortgage | Outstanding | Outstanding |
| Purpose | Loans | Principal Balance | Principal Balance |
| Cash-Out Refinance | 9,288 | $395,725,035.01 | 79.14% |
| Purchase | 1,946 | 90,287,478.86 | 18.06 |
| Rate/Term Refinance | 346 | 14,000,304.85 | 2.80 |
| Total: | 11,580 | $500,012,818.72 | 100.00% |

Property Type

| | | | Percentage |
|---|---|---|---|
| | Number of | Aggregate | of Aggregate |
| | Mortgage | Outstanding | Outstanding |
| Purpose | Loans | Principal Balance | Principal Balance |
| Single Family | 8,621 | $374,337,186.34 | 74.87% |
| Planned Unit | 1,667 | 74,193,118.28 | 14.84 |
| Development | | | |
| Condominium | 898 | 32,387,918.61 | 6.48 |
| 2-4 Family | 394 | 19,094,595.49 | 3.82 |
| Total: | 11,580 | $500,012,818.72 | 100.00% |

### Geographic Distribution

The geographic locations used for the following table were determined by the property address for the mortgaged property securing the related HELOC.

| | | | Percentage of |
|---|---|---|---|
| | Number of | Aggregate | Aggregate |
| | Mortgage | Outstanding | Outstanding |
| State | Loans | Principal Balance | Principal Balance |
| California | 6,281 | $291,650,835.28 | 58.33% |
| New York | 1,258 | 60,255,227.97 | 12.05 |
| Florida | 412 | 15,957,291.90 | 3.19 |
| New Jersey | 340 | 14,286,894.81 | 2.86 |
| Colorado | 259 | 10,254,217.04 | 2.05 |
| Virginia | 249 | 9,543,789.24 | 1.91 |
| Connecticut | 191 | 8,405,954.59 | 1.68 |
| Massachusetts | 219 | 8,134,565.98 | 1.63 |
| Illinois | 205 | 7,364,200.35 | 1.47 |
| Arizona | 223 | 7,221,600.01 | 1.44 |
| Maryland | 187 | 7,043,408.80 | 1.41 |
| Washington | 155 | 5,608,188.84 | 1.12 |
| Georgia | 150 | 5,501,759.64 | 1.10 |
| Hawaii | 117 | 5,251,631.72 | 1.05 |
| Pennsylvania | 151 | 5,073,648.57 | 1.01 |
| Nevada | 129 | 4,730,883.49 | 0.95 |
| Michigan | 151 | 4,675,212.04 | 0.94 |
| Oregon | 101 | 3,388,354.97 | 0.68 |
| Missouri | 91 | 3,200,391.35 | 0.64 |
| Minnesota | 93 | 3,040,510.02 | 0.61 |
| Ohio | 78 | 2,354,250.83 | 0.47 |
| North Carolina | 87 | 2,202,534.94 | 0.44 |
| District of | 29 | 1,622,763.68 | 0.32 |
| Columbia | | | |
| Utah | 39 | 1,226,841.49 | 0.25 |
| Indiana | 42 | 1,161,303.98 | 0.23 |
| New Mexico | 33 | 1,139,820.71 | 0.23 |
| Oklahoma | 43 | 1,063,492.42 | 0.21 |
| Idaho | 28 | 997,562.15 | 0.20 |
| Kansas | 34 | 984,959.66 | 0.20 |
| Iowa | 26 | 794,010.03 | 0.16 |
| New Hampshire | 28 | 788,704.06 | 0.16 |
| Wisconsin | 26 | 710,800.02 | 0.14 |
| Louisiana | 16 | 671,731.88 | 0.13 |
| Mississippi | 11 | 620,596.89 | 0.12 |
| Montana | 15 | 617,940.40 | 0.12 |
| Kentucky | 25 | 600,282.13 | 0.12 |
| Delaware | 18 | 529,425.66 | 0.11 |
| Nebraska | 10 | 351,589.39 | 0.07 |
| Rhode Island | 9 | 287,466.67 | 0.06 |
| West Virginia | 10 | 284,304.24 | 0.06 |
| Wyoming | 6 | 283,182.67 | 0.06 |
| North Dakota | 3 | 70,733.35 | 0.01 |
| Vermont | 2 | 59,954.86 | 0.01 |
| Total: | 11,580 | $500,012,818.72 | 100.00% |

### Current Credit Scores

The weighted average credit score of the HELOCs as of a date within three months prior to the Cut-Off Date is 701. The current credit score rating of any HELOC originated in January 2004 represents the credit score at origination.

| | | | Percentage |
|---|---|---|---|
| | Number of | Aggregate | of Aggregate |
| Credit Score | Mortgage | Outstanding | Outstanding |
| Rating | Loans | Principal Balance | Principal Balance |
| 601-620 | 27 | $1,259,632.12 | 0.25% |
| 621-640 | 890 | 38,758,000.75 | 7.75 |
| 641-660 | 1,451 | 62,245,932.24 | 12.45 |
| 661-680 | 1,767 | 78,529,296.26 | 15.71 |
| 681-700 | 1,847 | 82,298,195.94 | 16.46 |
| 701-720 | 1,527 | 67,230,964.97 | 13.45 |
| 721-740 | 1,338 | 60,115,102.07 | 12.02 |
| 741-760 | 1,248 | 53,238,242.35 | 10.65 |
| 761-780 | 948 | 37,811,061.22 | 7.56 |
| 781-800 | 482 | 17,009,350.63 | 3.40 |
| 801-820 | 55 | 1,517,040.17 | 0.30 |
| Total: | 11,580 | $500,012,818.72 | 100.00% |

Credit Limits

| | | | Percentage |
|---|---|---|---|
| | | Aggregate | of Aggregate |
| | Number of | Outstanding | Outstanding |
| Range of | Mortgage | Principal | Principal |
| Credit Limits | Loans | Balance | Balance |
| $7,500.01-$10,000.00 | 34 | $288,346.88 | 0.06% |
| $10,000.01-$20,000.00 | 1,172 | 16,093,921.70 | 3.22 |
| $20,000.01-$30,000.00 | 1,738 | 36,846,603.09 | 7.37 |
| $30,000.01-$40,000.00 | 1,870 | 52,891,608.78 | 10.58 |
| $40,000.01-$50,000.00 | 1,684 | 60,643,221.46 | 12.13 |
| $50,000.01-$60,000.00 | 1,033 | 47,242,837.53 | 9.45 |
| $60,000.01-$70,000.00 | 732 | 37,924,780.01 | 7.58 |
| $70,000.01-$80,000.00 | 1,014 | 49,178,358.17 | 9.84 |
| $80,000.01-$90,000.00 | 347 | 24,351,957.41 | 4.87 |
| $90,000.01-$100,000.00 | 929 | 61,816,692.75 | 12.36 |
| $100,000.01-$150,000.00 | 492 | 45,379,142.46 | 9.08 |
| $150,000.01-$200,000.00 | 454 | 55,935,240.22 | 11.19 |
| $200,000.01-$250,000.00 | 73 | 9,719,150.09 | 1.94 |
| $250,000.01-$300,000.00 | 3 | 621,268.77 | 0.12 |
| $300,000.01-$350,000.00 | 2 | 576,904.28 | 0.12 |
| $350,000.01-$400,000.00 | 2 | 429,123.38 | 0.09 |
| $400,000.01-$500,000.00 | 1 | 73,661.74 | 0.01 |
| Total: | 11,580 | $500,012,818.72 | 100.00% |

### Credit Limit Utilization Rates

The credit limit utilization rates in the following table were determined by dividing the principal balances as of the Cut-Off Date by the credit limits of the related HELOCs.

| | | | Percentage |
|---|---|---|---|
| | Number of | Aggregate | of Aggregate |
| Range of Credit | Mortgage | Outstanding | Outstanding |
| Limit Utilization | Loans | Principal Balance | Principal Balance |
| 0.000%-0.000% | 8 | $10.07 | 0.00% |
| 0.001%-10.000% | 520 | 1,756,956.09 | 0.35 |
| 10.001%-20.000% | 436 | 4,912,104.26 | 0.98 |
| 20.001%-30.000% | 479 | 8,515,272.77 | 1.70 |
| 30.001%-40.000% | 459 | 10,808,895.44 | 2.16 |
| 40.001%-50.000% | 476 | 13,808,393.18 | 2.76 |
| 50.001%-60.000% | 562 | 20,198,363.03 | 4.04 |
| 60.001%-70.000% | 656 | 27,334,946.30 | 5.47 |
| 70.001%-80.000% | 726 | 33,226,208.34 | 6.65 |
| 80.001%-90.000% | 909 | 44,353,824.12 | 8.87 |
| 90.001%-100.000% | 4,431 | 220,643,430.99 | 44.13 |
| 100.001%-101.000% | 1,918 | 114,454,414.13 | 22.89 |
| Total: | 11,580 | $500,012,818.72 | 100.00% |

Original Term

| | | | Percentage |
|---|---|---|---|
| | Number of | Aggregate | of Aggregate |
| | Mortgage | Outstanding | Outstanding |
| Months | Loans | Principal Balance | Principal Balance |
| 240 | 11,580 | $500,012,818.72 | 100.00% |
| Total: | 11,580 | $500,012,818.72 | 100.00% |

Remaining Term

| | Number of | Aggregate | Percentage of |
|---|---|---|---|
| | Mortgage | Outstanding | Aggregate Outstanding |
| Months | Loans | Principal Balance | Principal Balance |
| 190-195 | 1 | $22,826.85 | 0.00% |
| 196-201 | 6 | 210,920.96 | 0.04 |
| 202-207 | 19 | 843,909.07 | 0.17 |
| 208-213 | 72 | 3,253,546.76 | 0.65 |
| 214-219 | 363 | 15,892,571.72 | 3.18 |
| 220-225 | 1,026 | 47,255,476.17 | 9.45 |
| 226-231 | 2,541 | 110,533,286.68 | 22.11 |
| 232-237 | 5,078 | 216,365,551.07 | 43.27 |
| 238-243 | 2,474 | 105,634,729.44 | 21.13 |
| Total: | 11,580 | $500,012,818.72 | 100.00% |

Original Draw Period

| | Number of | Aggregate | Percentage of |
|---|---|---|---|
| | Mortgage | Outstanding | Aggregate Outstanding |
| Months | Loans | Principal Balance | Principal Balance |
| 120 | 11,580 | $500,012,818.72 | 100.00% |
| Total: | 11,580 | $500,012,818.72 | 100.00% |

Remaining Draw Period

| | Number of | Aggregate | Percentage of |
|---|---|---|---|
| | Mortgage | Outstanding | Aggregate Outstanding |
| Months | Loans | Principal Balance | Principal Balance |
| 71-75 | 1 | $22,826.85 | 0.00% |
| 76-80 | 6 | 210,920.96 | 0.04 |
| 81-85 | 14 | 661,493.31 | 0.13 |
| 86-90 | 39 | 1,700,295.23 | 0.34 |
| 91-95 | 177 | 6,762,731.03 | 1.35 |
| 96-100 | 415 | 20,930,073.69 | 4.19 |
| 101-105 | 1,171 | 51,347,570.50 | 10.27 |
| 106-110 | 2,155 | 93,829,736.17 | 18.77 |
| 111-115 | 4,067 | 173,437,824.53 | 34.69 |
| 116-120 | 3,535 | 151,109,346.45 | 30.22 |
| Total: | 11,580 | $500,012,818.72 | 100.00% |

Fully-Indexed Margins*
The weighted average fully-indexed margin for the HELOCs as of the
Cut-Off Date was 1.891%. All HELOCs are indexed to the “Prime
Rate” as published in the “Money Rates” table of
the Wall Street Journal.

| | Number of | Aggregate | Percentage of |
|---|---|---|---|
| | Mortgage | Outstanding | Aggregate Outstanding |
| Range of Margins | Loans | Principal Balance | Principal Balance |
| 0.000%-0.249% | 1,247 | $47,248,086.91 | 9.45% |
| 0.250%-0.499% | 29 | 940,255.19 | 0.19 |
| 0.500%-0.749% | 1,126 | 55,888,327.81 | 11.18 |
| 0.750%-0.999% | 55 | 2,702,457.94 | 0.54 |
| 1.000%-1.249% | 1,651 | 76,058,985.73 | 15.21 |
| 1.250%-1.499% | 38 | 2,129,870.08 | 0.43 |
| 1.500%-1.749% | 984 | 40,242,310.47 | 8.05 |
| 1.750%-1.999% | 902 | 48,174,636.41 | 9.63 |
| 2.000%-2.249% | 1,232 | 45,208,782.54 | 9.04 |
| 2.250%-2.499% | 804 | 34,990,080.37 | 7.00 |
| 2.500%-2.749% | 412 | 17,357,499.36 | 3.47 |
| 2.750%-2.999% | 211 | 9,644,336.03 | 1.93 |
| 3.000%-3.249% | 577 | 22,201,212.20 | 4.44 |
| 3.250%-3.499% | 990 | 40,842,637.06 | 8.17 |
| 3.500%-3.999% | 473 | 20,708,102.31 | 4.14 |
| 4.000%-4.499% | 149 | 6,335,140.57 | 1.27 |
| 4.500%-4.999% | 93 | 4,101,610.53 | 0.82 |
| 5.000%-5.499% | 361 | 14,866,543.48 | 2.97 |
| 5.500%-5.999% | 207 | 8,779,033.99 | 1.76 |
| 6.000%-6.499% | 38 | 1,561,357.27 | 0.31 |
| 6.500%-6.999% | 1 | 31,552.47 | 0.01 |
| Total: | 11,580 | $500,012,818.72 | 100.00% |

*Approximately 8.9% of the HELOCs are in a teaser period that will end no later than April 2004. The weighted average margin of the HELOCs as of the Cut-Off Date is 1.608%.

Current Loan Rates

| | | Aggregate | Percentage of |
|---|---|---|---|
| | Number of | Outstanding | Aggregate |
| Range of | Mortgage | Principal | Outstanding |
| Loan Rates | Loans | Balance | Principal Balance |
| 3.501%-4.000% | 2,604 | $108,336,980.05 | 21.67% |
| 4.001%-4.500% | 1,037 | 51,270,464.35 | 10.25 |
| 4.501%-5.000% | 1,522 | 69,598,896.38 | 13.92 |
| 5.001%-5.500% | 912 | 37,460,031.07 | 7.49 |
| 5.501%-6.000% | 1,863 | 81,464,662.50 | 16.29 |
| 6.001%-6.500% | 1,037 | 44,207,718.35 | 8.84 |
| 6.501%-7.000% | 681 | 27,348,532.61 | 5.47 |
| 7.001%-7.500% | 981 | 40,449,000.93 | 8.09 |
| 7.501%-8.000% | 329 | 14,225,116.34 | 2.84 |
| 8.001%-8.500% | 105 | 4,559,969.53 | 0.91 |
| 8.501%-9.000% | 304 | 12,680,250.41 | 2.54 |
| 9.001%-9.500% | 167 | 6,790,157.69 | 1.36 |
| 9.501%-10.000% | 37 | 1,589,486.04 | 0.32 |
| 10.001%-10.500% | 1 | 31,552.47 | 0.01 |
| Total: | 11,580 | $500,012,818.72 | 100.00% |

Maximum Loan Rates

| | | Aggregate | Percentage of |
|---|---|---|---|
| | Number of | Outstanding | Aggregate |
| Maximum | Mortgage | Principal | Outstanding |
| Loan Rates | Loans | Balance | Principal Balance |
| 16.000% | 87 | $2,202,534.94 | 0.44% |
| 18.000% | 11,493 | 497,810,283.78 | 99.56 |
| Total: | 11,580 | $500,012,818.72 | 100.00% |

Origination Year

| | | Aggregate | Percentage of |
|---|---|---|---|
| | | Outstanding | Aggregate |
| Origination | Number of | Principal | Outstanding |
| Year | Mortgage Loans | Balance | Principal Balance |
| 2000 | 11 | $407,667.66 | 0.08% |
| 2001 | 226 | 8,950,599.72 | 1.79 |
| 2002 | 2,254 | 101,963,820.38 | 20.39 |
| 2003 | 9,033 | 386,288,734.70 | 77.26 |
| 2004 | 56 | 2,401,996.26 | 0.48 |
| Total: | 11,580 | $500,012,818.72 | 100.00% |

Lien Position

| | Number of | Aggregate | Percentage of |
|---|---|---|---|
| | Mortgage | Outstanding | Aggregate Outstanding |
| Lien Position | Loans | Principal Balance | Principal Balance |
| First | 22 | $1,815,041.93 | 0.36% |
| Second | 11,558 | 498,197,776.79 | 99.64 |
| Total: | 11,580 | $500,012,818.72 | 100.00% |

Additional HELOCs

As described in this prospectus supplement under “Description of the Notes—Distributions on the Class A Underlying Certificates” and “—Overcollateralization, Excess Interest and the Reserve Fund,” at the option of the seller, payments of principal received on the HELOCs and allocable to the class A underlying certificates in the period from the Cut-Off Date to the distribution date in February 2006, unless a Rapid Amortization Event occurs, may be used to purchase additional HELOCs. The additional HELOCs may have characteristics which differ from the HELOCs initially included in the underlying trust. Accordingly, the statistical characteristics of the HELOCs in the underlying trust will vary upon the acquisition of any additional HELOCs.

The option of the seller to sell additional HELOCs to the underlying trust is subject to the following requirements in addition to other requirements set forth in the pooling and servicing agreement:
the additional HELOCs may not be 30 or more days delinquent as of the date they are transferred to the underlying trust;
the remaining term to stated maturity of each additional HELOC will not exceed 240 months;
the additional HELOCs will be secured by a mortgage in a first or second lien position;
each additional HELOC will have a fully-indexed margin between −0.250% and 8.875%;
each additional HELOC will not have a principal balance in excess of $500,000;
each additional HELOC will have a credit limit between $4,000 and $500,000;
each additional HELOC will have been originated under the seller's “full documentation” or “reduced documentation” underwriting programs as described under “Underwriting and Credit Criteria;”
each additional HELOC will have a combined loan-to-value ratio less than or equal to 101%;
each additional HELOC will have a Utilization less than or equal to 101%; and
each additional HELOC will have a credit score greater than or equal to 600.

Such pool of additional HELOCs subsequently transferred will have the following characteristics:
a weighted average fully-indexed margin of at least 1.75%;
a weighted average combined loan-to-value ratio less than or equal to 85%;
a weighted average credit score of 690 or greater;
no more than 22% of the pool will have a credit score less than 660;
at least 72% of the HELOCs in the pool will be secured by a single family residence;
at least 95% of the HELOCs in the pool will be secured by an owner-occupied property;
no more than 80% of the pool will have a loan purpose of cash-out refinance;
at least 50% of the HELOCs in the pool will have been originated under the seller's “full documentation” program as described under “Underwriting and Credit Criteria”;
no more than 60% of the HELOCs in the pool will be secured by a property located in the state of California;
no more than 15% of the HELOCs in the pool will be secured by a property located in a state other than the state of California; and
the weighted average credit score of the additional HELOCs with a CLTV greater than 90%, determined on the basis of the credit limits, is 710.
   HELOC Terms

The general terms of the HELOCs are described above under “—General.”

The HELOCs are variable rate, open-ended, revolving lines of credit secured by first or second lien positions against the available equity of the related borrower's residential properties. HELOCs originated are typically secured by liens on the related mortgaged properties subject to maximum CLTV limitations. Credit lines may be offered that may allow customers to borrow against the value of the real estate up to 100% of the property's value. The maximum CLTVs differ among the HELOCs and is limited based on the loan amount, property type, borrower's credit score, and underwriting documentation used for approval of the HELOCs. These lines generally have maximum CLTVs as specified in the table below.

| | Credit | Underwriting | Maximum |
|---|---|---|---|
| Property | Score | Documentation | CLTV |
| Primary Residence | >680 | Pre-Approved/No Doc | 90% |
| Second/Vacation Home | >680 | Pre-Approved/No Doc | 70% |
| Primary Residence | >640 | ITA/Stated Income | 80% |
| Second/Vacation Home | >640 | ITA/Stated Income | 70% |

| Loan Amount | CLTV | Minimum Credit Score* |
|---|---|---|
| | Full Alternate Documentation | |
| $100,000 | 100%¹ | 680 |
| $150,000 | 95% | 660 |
| $200,000 | 90% | 660 |
| $250,000 | 80% | 660 |
| $100,000 | 90% | 620-659 |
| $200,000 | 80% | 620-659 |
| | Reduced Documentation | |
| $75,000 | 95% | 680 |
| $100,000 | 90% | 640 |
| $200,000 | 80% | 640 |

¹Purchase and No Cash Out refinance transactions only.
*Determined by using the lowest credit score among the borrowers on a HELOC loan by each of the three major credit reporting bureaus that are accessed, and then taking the middle of such lowest scores.

The HELOCs provide for a 10 year draw period, which is a revolving open-ended period during which borrowings may be made periodically, and during which minimum monthly payments are due. A borrower may draw on a HELOC by writing Equity Checks, which are provided to the borrower at the time of origination or receiving a substitute check, or by accessing a bank equity card, which is a Visa card provided by the bank to all of its HELOC borrowers. A $250 minimum draw requirement is applicable to all draws made by writing a check, however, such minimum draw requirement does not apply to a draw made by accessing the HELOC.

The minimum monthly payment during the draw period is the amount of accrued finance charge or $100, whichever is greater. If no outstanding balance exists on the last day of the billing cycle, no payment will be required. Accrued finance charge is calculated based on the average daily outstanding balance of a HELOC account during the billing period and interest begins to accrue from the date a check is posted to such HELOC account.

Once the draw period ends, the outstanding balance must be repaid over 10 years. The minimum monthly payment during this 10 year repayment period is in an amount sufficient to amortize the outstanding balance and is calculated as the product of 0.83333% times the outstanding principal balance of the HELOC account as of the last day of the draw period plus all unpaid finance charges, and other charges imposed during the billing cycle together with any amount past due.

The HELOCs may be repaid at any time. However, if a HELOC is repaid in full and terminated within three years of the date of origination, the borrower is generally required to pay an early termination fee of up to $500 if such fee is allowed by state law. Late charges are imposed on past due accounts. Terms and amounts of late charges vary by state.

The HELOCs bear interest at a variable rate computed based on the “Prime Rate” as published in the “Money Rates” table of the Wall Street Journal, plus a margin, depending on the CLTV and credit score. The HELOC interest rate is subject to a lifetime cap equal to the lesser of a maximum per annum interest rate of 18% (16% in North Carolina) or the maximum rate permitted by governing state laws. The interest rate on a HELOC resets on its monthly cycle date following a rate change. No HELOC is subject to a minimum loan rate or a periodic loan rate cap.

An annual fee of $75 is charged to all HELOCs but may be waived in the first year following origination.

Each HELOC has a set monthly payment due date, which may be any day from the 2nd day to the 27th day of the month (the “cycle date”). Monthly billing statements are sent to borrowers approximately 15 days prior to the payment due date for every month in which there is an outstanding balance on the related HELOCs. The billing statement details all debits, credits and the loan rate and specifies the minimum payment due and the available credit line in compliance with Regulation Z.

Servicing Compensation and Payment of Expenses

With respect to each Due Period, the servicing compensation to be paid to the servicer in respect of its servicing activities relating to the HELOCs is referred to as the “servicing fee” and will be paid from Interest Collections in respect of the HELOCs. The amount of the servicing fee is equal to 0.50% per annum which is referred to as the servicing fee rate, multiplied by the sum of the outstanding principal balance of each HELOC as of the first day of each Due Period. The servicing fee will be calculated on the basis of a 30-day month and a 360-day year. All annual fees, late payment charges and other fees and charges, to the extent collected from borrowers, will be retained by the servicer as additional servicing compensation. From the servicing fee, the servicer will pay any amount due to a subservicer.

With respect to each payment date, the “Due Period” is the prior calendar month.

The servicer will pay ongoing expenses associated with the underlying trust and incurred by it in connection with its responsibilities under the pooling and servicing agreement. In addition, the servicer will be entitled to reimbursement for customary costs it incurs in connection with the performance by the servicer or its servicer of its servicing obligations, including in connection with restoring mortgaged properties related to defaulted HELOCs, entering into any enforcement or judicial proceedings (including foreclosures), managing and liquidating properties related to defaulted HELOCs and compliance with various other obligations specified in the pooling and servicing agreement, to the extent that recoveries are realized, and if the servicer certifies that the costs are nonrecoverable. The servicer's right of reimbursement is senior to the rights of holders of the class A underlying certificates to receive any proceeds from the liquidation of the related mortgaged property.

Assignment of HELOCs

On or before the closing date, the seller will sell to the mortgage loan transferor, the mortgage loan transferor will transfer to the underlying trust all of its right, title and interest in and to each HELOC to be transferred on the closing date and, during the period from the closing date to the Amortization Date, defined below under “Description of the Notes—Certain Definitions” each additional HELOC, including its right to purchase from the seller any additional balances arising in the future, related Credit Line Agreements, mortgages and other HELOC documents, including all collections received on or with respect to each HELOC after the related Cut-Off Date. The underlying trust, concurrently with the transfer, will deliver the class A underlying certificates and the seller's interest to the seller. Each HELOC transferred to the underlying trust will be identified on a mortgage loan schedule, which will be updated to reflect the transfer of each additional HELOC to the underlying trust. The mortgage loan schedule will be delivered to the certificate trustee. The mortgage loan schedule will include information including the principal balance as of the Cut-Off Date or subsequent transfer date, as applicable, for each HELOC, as well as information with respect to the loan rate.

Within 90 days following the closing date in the case of HELOCs transferred on the closing date and within 30 days following the transfer of additional HELOCs, the HELOC documents for each HELOC, including, the note and mortgage for each HELOC, will be delivered to the certificate trustee or its custodian for the benefit of the class A underlying certificates, and the seller will submit the assignments of mortgage or deed of trust for recording in the appropriate recording offices in the relevant jurisdictions. Such recordation will not be required if opinions of counsel satisfactory to the certificate trustee and the surety provider are delivered to the certificate trustee and the surety provider to the effect that recordation of such assignments is not required in the relevant jurisdictions to perfect the security interest of the underlying trust or the class A underlying certificateholders in the HELOCs. The seller will file two UCC-1 financing statements to perfect and provide notice of the underlying trust's ownership of the HELOCs. Within 60 days following the delivery of the HELOC documents to the certificate trustee, the certificate trustee will review the HELOC loan documents required to be reviewed pursuant to the pooling and servicing agreement, as applicable. If the underlying trustee finds that any document required to be reviewed by it to be non-compliant with the criteria under the pooling and servicing agreement or missing and the non-compliance or omission is not cured by the seller within 90 days following notification of the non-compliance or omission by the certificate trustee to the seller, the seller will be obligated to repurchase the HELOC as described in the following paragraph.

The seller will make representations and warranties as to the accuracy in all material respects of information furnished to the certificate trustee and the underlying trust with respect to each HELOC. In addition, the seller will represent and warrant, on the closing date, with respect to each HELOC that, among other things: (1) at the time of transfer to the trust, that seller has transferred or assigned all of its right, title and interest in each HELOC and the related documents, free of any lien, subject to exceptions; (2) each HELOC was generated under a Credit Line Agreement that complied, at the time of origination, in all material respects with applicable state and federal laws and (3) each HELOC file contains the documents specified in the pooling and servicing agreement. Upon discovery of a breach of any representation and warranty that materially and adversely affects the interests of the underlying certificateholders in a HELOC, the seller will have a period of 90 days after discovery or notice of the breach to effect a cure. If the breach cannot be cured within the 90-day period, the seller will be obligated to repurchase the HELOC and to deposit the Purchase Price (as defined below) into the collection account. Upon retransfer, the principal balance of the HELOC will be deducted from the pool balance. In lieu of any repurchase, a seller may substitute one or more Eligible Substitute HELOCs (as defined below). Any repurchase or substitution will be considered a payment in full of the defective HELOC. The obligation of the seller to accept a retransfer of a defective HELOC through repurchase or substitution is the sole remedy regarding any defects in the HELOCs and related documents available to the certificate trustee or the class A underlying certificateholders.

With respect to any HELOC, the “Purchase Price” is equal to the principal balance of the HELOC at the time of any transfer described above plus (a) the greater of (i) accrued and unpaid interest at the applicable loan rate net of the servicing fee to the date of repurchase and (ii) 30 days' interest, computed at the applicable loan rate and (b) any expenses incurred by the underlying trust as a result of the defect, including any costs and damages actually incurred and paid by or on behalf of the underlying trust in connection with any violation of such HELOC of any predatory or abusive lending laws.

An “Eligible Substitute HELOC” is a HELOC substituted by the seller for a defective HELOC which must, on the date of the substitution, satisfy the criteria specified in the pooling and servicing agreement. To the extent the principal balance of an Eligible Substitute HELOC is less than the principal balance of the related defective HELOC, a seller will be required to make a deposit to the collection account equal to the difference (each, a “Substitution Adjustment Amount”).

In certain circumstances, the interest of the underlying trust in the HELOCs could be impaired, and payments on the class A underlying certificates and, accordingly, on the notes, could be delayed and, if the surety provider fails to perform under a Policy, reduced. For instance,
a prior or subsequent transferee of HELOCs could have an interest in the HELOCs superior to the interest of the mortgage loan transferor and the certificate trustee;
a tax, governmental, or other nonconsensual lien that attaches to the property of the seller, or the mortgage loan transferor could have priority over the interest of the mortgage loan transferor, the certificate trustee in the HELOCs;
the administrative expenses of a conservator or receiver for the seller or the mortgage loan transferor could be paid from collections on the HELOCs before the mortgage loan transferor or the certificate trustee receives any payments; and
if insolvency proceedings were commenced by or against the servicer, or if certain time periods were to pass, the mortgage loan transferor or the certificate trustee may lose any perfected interest in collections held by the servicer and commingled with its other funds.
   Certain Regulatory Matters Related to Banks

General

The seller is a federal savings bank and, as such, the OTS and the FDIC have special powers under the banking laws to take certain actions upon the insolvency of the seller. For example, the FDIC has broad discretion and authority to appoint itself conservator or receiver of the seller.

Certain Matters Relating to Conservatorship and Receivership The transfer of the HELOCs by the seller to the mortgage loan transferor will be characterized in the mortgage loan purchase agreement as a sale transaction. In addition, under the FDIA Rule, the FDIC has stated that it will not reclaim, recover, or recharacterize a financial institution's transfer of financial assets such as the HELOCs if (i) the transfer involved a securitization of the financial assets and meets specified conditions for treatment as a sale under relevant accounting principles (other than the condition that, as a result of the transfer, the financial assets are “legally isolated” from the seller), (ii) the financial institution received adequate consideration for the transfer at the time of the transfer, (iii) the parties intended that the transfer constitute a sale for accounting purposes and the relevant documents reflect such intentions, and (iv) the financial assets were not transferred fraudulently, in contemplation of the financial institution's insolvency, or with the intent to hinder, delay, or defraud the financial institution or its creditors. The seller's transfer of the HELOCs and the mortgage loan purchase agreement are intended to satisfy all of these conditions.

Nevertheless, in the event of insolvency of the seller, if the FDIC were to take the position that the FDIA Rule did not apply to the seller's transfer of the HELOCs or that such transfer failed to satisfy the requirements of the FDIA Rule, and if the FDIC were further successful in an attempt to recharacterize the transfer of the HELOCs as a borrowing secured by a pledge of the HELOCs instead of a sale, the FDIC as conservator or receiver, could elect to accelerate payment of the certificates and liquidate the HELOCs. As a holder of the class A underlying certificates, the note trust would be entitled to no more than the outstanding principal balances, if any, of the class A underlying certificates, together with interest thereon at the class A underlying certificate rate. In the event of an acceleration of the certificates, the note trust would lose the right to future payments of interest, might suffer reinvestment losses in a lower interest rate environment and may fail to recover the initial investment made by the depositor in such class A underlying certificates. Further, with respect to an acceleration by the FDIC, interest may be payable only through the date of appointment of the FDIC as conservator or receiver. The FDIC has a reasonable period of time (which it has stated will generally not exceed 180 days after the date of its appointment) to elect to accelerate payment. Whether or not an acceleration takes place, delays in payments on the class A underlying certificates and possible reductions in the amount of such payments could occur. As a result, funds available to the note trust to make payments on the notes may be reduced.

The transfer of the class A underlying certificates from seller to the certificate seller and from the certificate seller to the depositor is intended by the parties and has been documented as a sale in the applicable transfer agreement. However, if the seller were to become bankrupt, a trustee in bankruptcy could attempt to recharacterize the sale of the class A underlying certificates as a loan secured by the class A underlying certificates and consequently, the bankruptcy court could consolidate the class A underlying certificates with the assets of the seller. Although steps have been taken to minimize this risk that the sale of the class A underlying certificates by the seller could be recharacterized as a secured loan for bankruptcy purposes, any such attempt to recharacterize the transaction could result in a delay in or reduction of collections on the class A underlying certificates available to make payments on the notes.

Certain Regulatory Matters

If the bank regulatory authorities supervising the seller or the servicer were to find that any obligation of the seller or the servicer or any of their affiliates under any securitization or other agreement, or any activity of the seller, servicer or affiliate, constituted an unsafe or unsound practice or violated any law, rule, regulation or written condition or agreement applicable to the seller, servicer or affiliate, such regulatory authorities may have the power under the FDIA or other applicable laws to order the seller, servicer or affiliate, among other things, to rescind such agreement or contract, refuse to perform that obligation, terminate the activity, amend the terms of such obligation or take such other action as such regulatory authorities determine to be appropriate. In such an event, the seller, the servicer and such affiliates may not be liable to noteholders for contractual damages for complying with such an order and noteholders may have no recourse against the applicable regulatory authority.

While the seller has no reason to believe that any applicable regulatory authority would consider provisions relating to the seller, the servicer or their affiliates or the payment or amount of a servicing fee to the servicer or any affiliate, or any other obligation of the seller, the servicer or an affiliate under the mortgage loan purchase agreement, the pooling and servicing agreement, the administration agreement, the certificate purchase agreement, the sale agreement, the trust agreement or the indenture, to be unsafe or unsound or violative of any law, rule or regulation applicable to them, there can be no assurance that any such regulatory authority would not conclude otherwise in the future. If such a bank regulatory authority did reach such a conclusion, and ordered the seller, the servicer or affiliate to rescind or amend these agreements, payments could be delayed or, if the Surety Provider fails to perform under the Certificate Policy or Note Policy, reduced.

Description of the Notes

General

The notes will be issued under an indenture, between the note trust, and the indenture trustee. The only sources of payment on the notes will be the class A underlying certificates, the Note Policy and amounts distributed from a derivative contributed by to the note trust by the holder of the owner trust certificates (initially the certificate seller), if any. The class A underlying certificates will be issued pursuant to a pooling and servicing agreement dated as of Feb. 1, 2004 among the servicer, the mortgage loan transferor, the seller and the certificate trustee. The class A underlying certificates will be issued together with the seller's interest in exchange for the transfer of the HELOCs. The seller will retain the seller's interest and will transfer the class A underlying certificates to the certificate seller, who will then transfer them to the depositor, pursuant to the certificate purchase agreement. The depositor will in turn transfer the class A underlying certificates to the note trust, pursuant to the sale agreement, among the depositor, the note trust and the indenture trustee. The note trust will pledge the class A underlying certificates under the lien of the indenture as collateral for the notes. As holder of the class A underlying certificates, the indenture trustee will exercise, in the manner described below under “The Indenture—Voting of Class A Underlying Certificates” all rights provided to the holders of such class of certificates under the pooling and servicing agreement.

The following summaries describe provisions of the class A underlying certificates, the pooling and servicing agreement, the notes and the indenture. The summaries do not purport to be complete and are subject to, and qualified in their entirety by reference to, the provisions of the applicable agreement. As used in this prospectus supplement, agreement shall mean either the pooling and servicing agreement in respect of the class A underlying certificates or the indenture in respect of the notes, as the context requires.

The notes will be issued in fully registered, certificated form only. The notes will be freely transferable and exchangeable at the corporate trust office of the indenture trustee.

The Note Trust

A statutory trust will be created pursuant to and governed by a trust agreement, as amended and restated, among the certificate seller, the depositor, the owner trustee and the indenture trustee, as registrar and paying agent. The note trust will own the class A underlying certificates, which will be sold to the depositor by the certificate seller and transferred from the depositor to the note trust.

The purpose of the note trust is to (i) hold the class A underlying certificates, a note policy issued by the Surety Provider (the “Note Policy”), the payments made under the class A underlying certificates and the right to receive a derivative contributed by the note trust by the holder of the owner trust certificates, (ii) issue the notes and the owner trust certificates and (iii) to pledge the class A underlying certificates to the indenture trustee. The designated party will hold the owner trust certificates and will be entitled to all distributions of amounts received in connection with the class A underlying certificates after payments have been made on the notes.

Book-Entry Notes

The notes will be in book-entry form. Persons acquiring beneficial ownership interests in the notes, or beneficial owners, will hold their notes through The Depository Trust Company, New York, N.Y. (“DTC”) in the United States, or Clearstream Banking, société anonyme (“Clearstream”) or Euroclear Bank S.A./N.V. (“Euroclear”) in Europe if they are participants of those systems, or indirectly through organizations which are participants in those systems.

The book-entry notes will initially be registered in the name of Cede & Co., the nominee of DTC. Unless and until definitive notes are issued, it is anticipated that the only note owner under the indenture will be Cede & Co., as nominee of DTC. Clearstream and Euroclear will hold omnibus positions on behalf of their participants through customers' securities accounts in Clearstream's and Euroclear's names on the books of their respective depositaries, which in turn will hold positions in customers' securities accounts in the depositaries' names on the books of DTC. Beneficial owners will not be noteholders as that term is used in the indenture. Beneficial owners are only permitted to exercise their rights indirectly through the participating organizations that use the services of DTC, including securities brokers and dealers, banks and trust companies, clearing corporations and certain other organizations, and DTC. Beneficial owners may hold their beneficial interests in minimum denominations of $25,000 and multiples of $1,000 in excess thereof.

The beneficial owner's ownership of a book-entry note will be recorded on the records of the brokerage firm, bank, thrift institution or other financial intermediary that maintains the beneficial owner's account for such purpose. In turn, the financial intermediary's ownership of that book-entry note will be recorded on the records of the applicable depository, or of a participating firm that acts as agent for the financial intermediary, whose interest will in turn be recorded on the records of the depository, if the beneficial owner's financial intermediary is not a participant of DTC, and the records of Clearstream or Euroclear, as appropriate.

Payments on the notes and transfers of the securities take place through book-entry notations. The indenture trustee makes payments to the holding depository, which in turn makes payments to its participants. The participants will then, in turn, credit the payments to the accounts of beneficial owners either directly or through indirect participants. Consequently, beneficial owners of the book-entry notes may experience delay in their receipt of payments. The payments will be subject to tax reporting in accordance with relevant United States tax laws and regulations.

Transfers of the notes are made similarly through book-entry notations. Each beneficial owner instructs its financial intermediary of the transaction, and the information is eventually passed on to the holding depository. Each financial intermediary and the depository will note the transaction on its records and either debit or credit the account of the selling and purchasing beneficial owners. Payments and transfers between DTC participants, Clearstream participants and Euroclear participants will occur in accordance with the rules and operating procedures of each depository. For information on transfers between depositories, see “Annex I—Global Clearance, Settlement and Tax Documentation Procedures” at the end of this prospectus supplement.

DTC has advised the depositor as follows: DTC is a limited-purpose trust company organized under the New York Banking Law, a “banking organization” within the meaning of the New York Banking Law, a member of the Federal Reserve System, a “clearing corporation” within the meaning of the New York Uniform Commercial Code and a “clearing agency” registered pursuant to the provisions of Section 17A of the Securities Exchange Act of 1934, as amended. DTC holds securities that its participants deposit with DTC. DTC also facilitates the settlement among DTC participants of securities transactions, such as transfers and pledges, in deposit securities through electronic computerized book-entry changes in DTC participants' accounts, which eliminates the need for physical movements of securities. DTC participants include underwriters, securities brokers and dealers, banks, trust companies, clearing corporations and similar organizations. Certain of such participants (or their representatives), together with other entities, own DTC. Indirect access to the DTC system is available to others such as banks, brokers and dealers and trust companies that clear through or maintain a custodial relationship with a DTC participant, either directly or indirectly.

Clearstream was incorporated as a limited liability company under Luxembourg law. Clearstream is owned by Cedel International, société anonyme, and Deutsche Borse AG. The shareholders of these two entities are banks, securities dealers and financial institutions. Clearstream holds securities for its participants, or participating organizations, and facilitates the clearance and settlement of securities transactions between Clearstream participants through electronic book-entry changes in accounts of Clearstream participants, eliminating the need for physical movement of certificates. Transactions may be settled in Clearstream in many currencies, including United States dollars. Clearstream provides to its participants, among other things, services for safekeeping, administration, clearance and settlement of internationally traded securities, securities lending and borrowing and collateral management. Clearstream interfaces with domestic markets in several countries. As a registered bank, Clearstream is regulated by the Luxembourg Commission for the Supervision of the Financial Sector. Clearstream has established an electronic bridge with the Euroclear Operator to facilitate settlement of trades between Clearstream and Euroclear. Clearstream participants are recognized financial institutions around the world, including underwriters, securities brokers and dealers, banks, trust companies, clearing corporations and other organizations. Indirect access to Clearstream is also available to others, like banks, brokers, dealers and trust companies that clear through or maintain a custodial relationship with a Clearstream participant, either directly or indirectly. In the United States, Clearstream customers are limited to securities brokers and dealers and banks, and may include the underwriters for the book-entry notes. Clearstream is an indirect participant in DTC.

Euroclear was created in 1968 to hold securities for its participants and to clear and settle transactions between its participants through simultaneous electronic book-entry delivery against payment, thereby eliminating the need for physical movement of securities and the risk from lack of simultaneous transfers of securities and cash. Transactions may be settled in many currencies, including U.S. dollars. In addition to safekeeping (custody) and securities clearance and settlement, the Euroclear system includes securities lending and borrowing and interfaces with domestic markets in several countries generally similar to the arrangements for cross-market transfers with DTC. Euroclear is operated by Euroclear Bank S.A./N.V., under contract with Euroclear Clearance System plc, a UK corporation (“Euroclear Clearance System”). All operations are conducted by the Euroclear operator, and all Euroclear securities clearance accounts and Euroclear cash accounts are accounts with the Euroclear operator, not the Euroclear Clearance System. The Euroclear Clearance System establishes policy for Euroclear on behalf of Euroclear participants. Euroclear participants include banks (including central banks), securities brokers and dealers and other professional financial intermediaries and may include the underwriters specified in this prospectus supplement. Indirect access to the Euroclear system is also available to other firms that clear through or maintain a custodial relationship with a Euroclear participant, either directly or indirectly. Euroclear is an indirect participant in DTC.

The Euroclear operator is a Belgian bank. The Belgian Banking and Finance Commission and the National Bank of Belgium regulate and examine the Euroclear Operator.

The terms and conditions governing use of Euroclear and the related operating procedures of Euroclear and applicable Belgian law govern securities clearance accounts and cash accounts with the Euroclear Operator. Specifically, these terms and conditions govern:
transfers of securities and cash within Euroclear;
withdrawal of securities and cash from Euroclear; and
receipts of payments with respect to securities in Euroclear.

All securities in Euroclear are held on a fungible basis without attribution of specific certificates to specific securities clearance accounts. The Euroclear Operator acts under the terms and conditions only on behalf of Euroclear participants and has no record of or relationship with persons holding securities through Euroclear participants.

Distributions with respect to book-entry notes held beneficially through Euroclear will be credited to the cash accounts of Euroclear participants in accordance with the Euroclear Terms and Conditions, to the extent received by the Euroclear Operator and by Euroclear.

Distributions with respect to the book-entry notes held beneficially through Clearstream will be credited to cash accounts of Clearstream customers in accordance with its rules and procedures, to the extent received by Clearstream.

Title to book-entry notes will pass by book-entry registration of the transfer within the records of Euroclear, Clearstream or DTC, as the case may be, in accordance with their respective procedures. Book-entry notes may be transferred within Euroclear and within Clearstream and between Euroclear and Clearstream in accordance with procedures established for these purposes by Euroclear and Clearstream, Luxembourg. Book-entry notes may be transferred within DTC in accordance with procedures established for this purpose by DTC. Transfers of book-entry notes between Euroclear and Clearstream and DTC may be effected in accordance with procedures established for this purpose by Euroclear, Clearstream and DTC.

Initial settlement for the book-entry notes will be made in immediately available funds. Secondary market trading between DTC participants will occur in the ordinary way in accordance with DTC rules and will be settled in immediately available finds. Secondary market trading between Euroclear participants and/or Clearstream participants will occur in the ordinary way in accordance with the applicable rules and operating procedures of Euroclear and Clearstream and will be settled using the procedures applicable to conventional Eurobonds in immediately available funds.

Cross-market transfers between persons holding directly or indirectly through DTC on the one hand, and directly or indirectly through Euroclear or Clearstream participants, on the other, will be effected by DTC in accordance with DTC rules on behalf of the relevant European international clearing system by its respective depositary in the United States. However, those cross-market transactions will require delivery of instructions to the relevant European international clearing system by the counterparty in such system in accordance with its rules and procedures and within its established deadlines (European time). The relevant European international clearing system will, if the transaction meets its settlement requirements, deliver instructions to its U.S. depositary to take action to effect final settlement on its behalf by delivering or receiving book-entry notes to or from DTC, and making or receiving payment in accordance with normal procedures for same-day funds settlement applicable to DTC. Euroclear participants and Clearstream participants may not deliver instructions directly to their respective depositaries in the United States.

Because of time-zone differences, credits of book-entry notes received in Euroclear or Clearstream as a result of a transaction with a DTC participant will be made during subsequent securities settlement processing and dated the business day following DTC settlement date. These credits or any transactions in book-entry notes settled during such processing will be reported to the relevant Euroclear or Clearstream participants on that business day. Cash received in Euroclear or Clearstream as a result of sales of book-entry notes by or through a Euroclear participant or a Clearstream participant to a DTC participant will be received with value on DTC settlement date but will be available in the relevant Euroclear or Clearstream cash account only as of the business day following settlement in DTC.

Although DTC, Euroclear and Clearstream have agreed to the foregoing procedures in order to facilitate transfers of certificates among participants of DTC, Euroclear and Clearstream, they are under no obligation to perform or continue to perform the procedures and the procedures may be discontinued at any time. See “Appendix I” to this prospectus supplement.

For a discussion of the federal income tax consequences for non-United States persons, see Appendix I to this prospectus supplement.

Monthly and annual reports with respect to the trust will be provided to Cede & Co., as nominee of DTC, and may be made available by Cede & Co. to beneficial owners upon request, in accordance with the rules, regulations and procedures creating and affecting the depository, and to the financial intermediaries to whose DTC accounts the book-entry notes of the beneficial owners are credited.

DTC has advised the indenture trustee that, unless and until definitive notes are issued, DTC will take any action permitted to be taken by the holders of the book-entry notes under the indenture only at the direction of one or more financial intermediaries to whose DTC accounts the book-entry notes are credited, to the extent that actions are taken on behalf of financial intermediaries whose holdings include those book-entry notes. Clearstream or the Euroclear operator, as the case may be, will take any other action permitted to be taken by a noteholder under the indenture on behalf of a Clearstream participant or Euroclear participant only in accordance with its relevant rules and procedures and subject to the ability of the relevant depositary to effect actions on its behalf through DTC. DTC may take actions, at the direction of its participants, with respect to some notes which conflict with actions taken with respect to other notes.

Definitive notes will be issued to beneficial owners of the book-entry notes, or their nominees, rather than to DTC, only if: (a) DTC or the issuer advises the indenture trustee in writing that DTC is no longer willing, qualified or able to discharge properly its responsibilities as nominee and depository with respect to the book-entry securities and the issuer or the indenture trustee is unable to locate a qualified successor, (b) the issuer, at its sole option, elects to terminate a book-entry system through DTC or (c) after the occurrence of an event of default under the indenture, beneficial owners having percentage interests aggregating not less than 51% of the principal balance of the book-entry securities advise the indenture trustee and DTC through the financial intermediaries and the DTC participants in writing that the continuation of a book-entry system through DTC, or a successor to DTC, is no longer in the best interests of beneficial owners.

Upon the occurrence of any of the events described in the immediately preceding paragraph, the indenture trustee will be required to notify all beneficial owners of the occurrence of the event and the availability through DTC of definitive securities. Upon surrender by DTC of the global note or notes representing the book-entry notes and instructions for re-registration, the indenture trustee will issue and authenticate definitive notes, and the indenture trustee will recognize the holders of the definitive notes as holders under the indenture.

Although DTC, Clearstream and Euroclear have agreed to the foregoing procedures in order to facilitate transfers of securities among participants of DTC, Clearstream and Euroclear, they are under no obligation to perform or continue to perform the procedures and the procedures may be discontinued at any time.

Distributions on the Class A Underlying Certificates

Payments on the notes will correspond in the aggregate to distributions on the class A underlying certificates.

On each distribution date, collections on the HELOCs received during the preceding Due Period and allocable to the class A underlying certificates will be applied as distributions on the class A underlying certificates as follows:
A. From Investor Interest Collections reduced by the Investor Servicing Fee and any unreimbursed nonrecoverable advance previously made:
   (10) To the certificate trustee, the Certificate Trustee Fee;
   (11) to the Surety Provider, the premium due for the Policies;
   (12) to the class A underlying certificates, accrued interest on the outstanding principal balance of the class A underlying certificates for the current accrual period and any overdue accrued interest in each case accrued at a rate that is not higher than the Maximum Rate (as defined in “—Interest” below);
   (13) to cover Investor Charge Off Amounts incurred during the related Due Period and the Investor Charge Off Amounts incurred during previous Due Periods that were not subsequently covered by Investor Interest Collections, overcollateralization or draws under the Certificate Policy by (a) for each distribution date prior to the Amortization Date, application of Investor Interest Collections remaining in the certificate account to the purchase of additional balances and, at the option of the seller, additional HELOCs, or to find the Reserve Fund, as described below under “—Credit Enhancement—Overcollateralization, Excess Interest and the Reserve Fund” and (b) for each distribution date starting with the distribution date that is the Amortization Date, to the class A underlying certificates, as a payment of principal;
   (14) to the Surety Provider, as reimbursement for prior draws made under the certificate policy;
   (15) to build overcollateralization to the Specified O/C Amount by (a) for each distribution date prior to the Amortization Date, application of Investor Interest Collections remaining in the certificate account to the purchase of additional balances and, at the option of the seller, additional HELOCs, or to fund the Reserve Fund, as described below under “—Credit Enhancement—Overcollateralization, Excess Interest and the Reserve Fund” and (b) for each distribution date starting with the distribution date that is the Amortization Date, to the class A underlying certificates, as a payment of principal;
   (16) to the Surety Provider, any other amounts owed to the surety provider pursuant to the insurance agreement;
   (17) to the class A underlying certificates, any carryover interest amounts from prior periods when the rate at which interest on the class A underlying certificates was calculated at the Maximum Rate (such carryover interest amounts are referred to as “LIBOR Carryover Interest Shortfalls”);
   (18) to the payment of indemnification expenses to the extent provided in the pooling and servicing agreement; and
   (19) to the owner of the seller's interest, which shall initially be the seller, the balance.
B. From Principal Collections:
   (20) (a) During the period from the first distribution date through the payment date preceding the Mandatory Auction Payment Date, unless a Rapid Amortization Event has occurred, zero, (b) on the earlier of the Mandatory Auction Payment Date and the payment date following the occurrence of a Rapid Amortization Event, the amount on deposit in the Reserve Fund and (c) on every distribution date on and after the Amortization Date an amount equal to the lesser of the outstanding principal balance of the class A underlying certificates and the Investor Principal Distribution Amount and
   (21) to the owner of the seller's interest, the balance.
      Payments on the Notes

On each payment date, the indenture trustee will pay the following amounts from interest and principal distributions on the class A underlying certificates in the following order of priority:
(22) From interest distributions, to the indenture trustee, the Indenture Trustee Fee;
(23) from interest distributions, to the noteholders, the accrued interest for the current accrual period, overdue accrued interest and any LIBOR Carryover Interest Shortfalls for such payment date;
(24) from principal distributions, to the noteholders, for each payment date on or after the Amortization Date, the Note Principal Payment Amount for such payment date until the outstanding principal balance of the notes has been reduced to zero;
(25) to the Surety Provider, as reimbursement for prior draws made under the note policy;
(26) to the certificate trustee, to defray certain fees and expenses of the underlying trust; and
(27) on behalf of the note trust to the holder of the owner trust certificates, in the priority and in the manner set forth in the indenture, to the extent of any remaining amounts, after the payments required above have been made.
   Certain Definitions

The “Amortization Date” means the earlier of the distribution or payment date, as applicable, in March 2006 and the distribution or payment date, as applicable, following the occurrence of a Rapid Amortization Event.

The “Certificate Trustee Fee” for any distribution date is an amount equal to an amount agreed to between the seller and the certificate trustee.

A “Charged-Off HELOC” is a HELOC with a balance that has been written down on the servicer's servicing system in accordance with its policies and procedures.

The “Charge-Off Amount” for any Charged-Off HELOC is the amount of the principal balance that has been written down. If a HELOC is 180 days or more delinquent, the Charge-Off Amount will equal the Principal Balance of the HELOC.

The “Closing Date” is Feb. 27, 2004.

The “Excess O/C Amount” for a distribution date is the amount by which the amount of overcollateralization, assuming the full Investor Principal Distribution Amount was paid on the notes for such distribution date, exceeds the Specified O/C Amount; provided, however, that following the occurrence of a Rapid Amortization Event the Excess O/C Amount shall be zero.

The “Floating Allocation Percentage” for any distribution date is the percentage equal to a fraction with a numerator of the Invested Amount at the end of the previous Due Period and a denominator equal to the Pool Balance at the end of the previous Due Period (in the case of the first distribution date the Pool Balance as of the Cut-Off Date); provided that such percentage shall not be greater than 100%.

The “Indenture Trustee Fee” for any payment date is an amount equal to an amount agreed to between the certificate seller and the indenture trustee.

For each distribution date the “Interest Collections” are amounts collected during the related Due Period on the HELOCs and allocated to interest in accordance with the terms of the related Credit Line Agreements, together with the interest portion of any Purchase Price and Substitution Adjustment Amount paid during the related Due Period and any Net Recoveries on HELOCs that were previously Charged-Off HELOCs less any foreclosure profits.

The “Interest Period” with respect to each payment date or distribution date and the notes or the class A underlying certificates, respectively, other than the first payment and distribution date, the period from the payment date or distribution date, as applicable, in the month preceding the month of such payment date or distribution date, as applicable, through the day before such payment date or distribution date, as applicable, and with respect to the first payment and distribution date the period from the Closing Date through Mar. 24, 2004.

The “Invested Amount” for any distribution date is the Invested Amount on the Closing Date (x) reduced by (i) the aggregate amount of Investor Principal Distribution Amounts (before taking into account O/C Reduction Amounts) as of the end of the previous Due Period and on the related distribution date and (ii) the aggregate of Investor Charge-Off Amounts since the Cut-Off Date, including the Investor Charge-Off Amount for such distribution date and (y) prior to the Amortization Date increased by the sum of (i) additional balances and additional HELOCs purchased with Investor Interest Collections and Principal Collections during the period from the Closing Date to the end of the related Due Period and (ii) the amount on deposit in the Reserve Fund. The Invested Amount on the Closing Date will be $500,012,818.72.

The “Investor Charge-Off Amount” for any distribution date is the Floating Allocation Percentage of Charge-Off Amounts incurred during the related Due Period.

“Investor Interest Collections” for any distribution date is the Floating Allocation Percentage of Interest Collections for the related Due Period.

The “Investor Principal Distribution Amount” during the period from the first distribution date through the distribution date preceding the Amortization Date, zero, and on every distribution date on and after the Amortization Date, all Principal Collections received during the preceding Due Period reduced by the O/C Reduction Amount.

The “Investor Servicing Fee” for any distribution date is the Floating Allocation Percentage of the servicing fee for the related Due Period plus any accrued and unpaid Investor Servicing Fee.

“Net Recoveries” with respect to a HELOC are equal to the aggregate of all amounts received upon liquidation of the related mortgaged property, including, without limitation, insurance proceeds, reduced by any amounts due to a senior lien holder and related servicing fees and servicing advances incurred by the servicer in connection with that HELOC.

The “Note Principal Payment Amount” for any payment date is the amount of principal distributed on the class A underlying certificates on the related distribution date, including any amounts distributed as principal from the Reserve Fund.

The “O/C Reduction Amount” for a distribution date during the period from the first distribution date through the distribution date preceding the Amortization Date, is the Excess O/C Amount, and on every distribution date on and after the Amortization Date, is the lesser of the Excess O/C Amount for such distribution date and the Investor Principal Distribution Amount for such distribution date (before taking into account the O/C Reduction Amount).

The “payment date” and “distribution date” in each month will be the 25th day of the month or, if that day is not a business day, the next business day.

The “Pool Balance” for any distribution date is the aggregate of the Principal Balances of the HELOCs at the end of the related Due Period.

For each payment date the “Principal Collections” are amounts collected during the related Due Period on the HELOCs and allocated to principal in accordance with the terms of the related Credit Line Agreement together with the principal portion of any Purchase Price or any Substitution Adjustment Amounts paid during the preceding Due Period.

The “Specified O/C Amount” is the amount set forth in the pooling and servicing agreement.

Interest

Prior to the mandatory auction of the notes, interest will accrue on the unpaid principal balance of the notes during each Interest Period at the lesser of (i) a floating rate equal to LIBOR (determined as of the related LIBOR Determination Date) plus 0.12% and (ii) the Maximum Note Rate. After the mandatory auction, interest will accrue on the notes at a rate equal to the lesser of (i) the rate determined at the mandatory auction described below under “—Mandatory Auction of the Notes” and (ii) the Maximum Note Rate. Interest will be calculated on the basis of the actual number of days in each Interest Period and a 360-day year. The rate at which interest accrues on the notes is referred to as the “note rate”. A failure to pay interest on any notes on a payment date and that continues for five days constitutes an event of default under the indenture.

Interest will accrue on the class A underlying certificates at a rate equal to the lesser of (i) the sum of the note rate as described above under “—Note Rate” and 0.05% and (ii) the Maximum Certificate Rate. On and after the distribution date in February 2006, if the mandatory auction of the notes occurs, the certificate rate will reset to the lesser of (i) the sum of the then-current note rate and 0.05% and (ii) the Maximum Certificate Rate.

The “Maximum Note Rate” for any payment date is equal to the average of the loan rates, minus the sum of 0.03%, the rate at which the Indenture Trustee Fee is calculated and the Expense Fee Rate, weighted on the basis of the related Principal Balance of each HELOC on the first day of the related Due Period, adjusted to a rate calculated on an actual/360 basis.

The “Maximum Certificate Rate” for any distribution date is equal to the average of the loan rates, minus the Expense Fee Rate, weighted on the basis of the related Principal Balance of each HELOC on the first day of the related Due Period, adjusted to a rate calculated on an actual/360 basis.

The “Expense Fee Rate” is equal to the sum of the servicing fee rate, the rate at which the Certificate Trustee Fee is calculated and the rate at which the premium on Policies is calculated for each HELOC. The Expense Fee Rate for any payment date is expected to be approximately 0.71% per annum.

The “Principal Balance” of a HELOC on any day is equal to the Cut-Off Date principal balance of the HELOC, (i) plus any additional balances transferred to the underlying trust in respect of the HELOC, (ii) minus all collections credited against the Principal Balance of the HELOC in accordance with the related Credit Line Agreement prior to that day, and (iii) minus all prior related Charge-Off Amounts.

With respect to each “LIBOR Determination Date”, “LIBOR” is the rate for deposits in United States dollars for a period of the Designated Maturity which appears on Telerate Page 3750 as of 11:00 a.m., London time on that date. If the rate does not appear on Telerate Page 3750, the rate for the LIBOR Determination Date will be determined on the basis of the rates at which deposits in United States dollars are offered by the reference banks at approximately 11:00 a.m., London time, on that date to prime banks in the London interbank market for a period of the Designated Maturity. The indenture trustee will request the principal London office of each of the reference banks to provide a quotation of its rate. If at least two such quotations are provided, the rate for that LIBOR Determination Date will be the arithmetic mean of the quotations. If fewer than two quotations are provided as requested, the rate for that LIBOR Determination Date will be the arithmetic mean of the rates quoted by the reference banks, selected by the servicer, at approximately 11:00 a.m., New York City time, on that day for loans in United States dollars to leading European banks for a period of the Designated Maturity.

The “Designated Maturity” with respect to any LIBOR Determination Date that is a LIBOR Business Day, is one month.

A “determination date” is, with respect to any payment date, the fifth business day preceding such payment date.

A “LIBOR Business Day” is any day other than (i) a Saturday or a Sunday and (ii) a day on which banking institutions in the State of New York or in the city of London, England are required or authorized by law to be closed.

A “LIBOR Determination Date” is, with respect to any Interest Period, the second LIBOR Business Day preceding the first day of such Interest Period.

Overcollateralization, Excess Interest and the Reserve Fund

The application of the payments on the HELOCs to the holders of the class A underlying certificates has been structured to create overcollateralization. On the closing date the overcollateralization will be approximately zero and is expected to build to the Specified O/C Amount after the class A underlying certificates have been issued.

The portion of interest payments on the HELOCs allocable to the class A underlying certificates is expected to exceed the amount of interest due and payable on the class A underlying certificates. A portion of this excess, for each distribution date to and including the distribution date prior to the Amortization Date, will be used to purchase, at the option of the seller, additional HELOCs, to the extent necessary to build overcollateralization to the Specified O/C Amount. The purchase of additional HELOCs will result in an increase in the amount of Principal Balances represented by the Invested Amount relative to the principal balance of the class A underlying certificates, thereby creating overcollateralization for the class A underlying certificates.

For each distribution date on or after the Amortization Date, that portion of excess interest will be used as a distribution of principal on the class A underlying certificates to the extent necessary to build overcollateralization to the Specified O/C Amount. This will result in the limited acceleration of principal distributions on the class A underlying certificates relative to the amortization of the HELOCs, thereby creating overcollateralization for the class A underlying certificates.

In addition, for each distribution date to and including the distribution date prior to the Amortization Date, all principal collections on the HELOCs received during the preceding calendar month will be applied to purchase additional balances drawn under the HELOCs during the preceding calendar month and, at the option of the seller, additional HELOCs, remaining after the application of interest collections for that purpose, to maintain the collateral balance. Principal collections not used to purchase additional HELOCs will be deposited into the Reserve Fund as described below. For each distribution date after the Amortization Date, all principal collections will be distributed to the class A underlying certificates until the principal balance of the class A underlying certificates has been reduced to zero. However, such amount of principal collections on the HELOCs distributed to the class A underlying certificates will be reduced if the amount of overcollateralization exceeds the Specified O/C Amount.

If additional balances and additional HELOCs are not purchased from the seller, such excess will be deposited by the certificate trustee into a reserve fund (the “Reserve Fund”). Amounts deposited in the Reserve Fund may be used to provide the required level of overcollateralization, however until the Specified O/C Amount is reached, the total amount deposited into the Reserve Fund will be limited to a maximum of 1% of the Pool Balance. Once the Specified O/C Amount is reached, the maximum amount of proceeds on deposit in the Reserve Fund will be allowed to increase to 15% of the Pool Balance.

The Specified O/C Amount is based on certain minimum and maximum levels of overcollateralization and on the performance of the HELOCs. As a result, the Specified O/C Amount will increase and decrease over time.

For example, an increase in the Specified O/C Amount will result if the delinquency or default experience on the HELOCs exceeds certain set levels. In that event, additional HELOCs would be purchased by the underlying trust at the option of the seller or excess interest and Principal Collections will be deposited in the Reserve Fund until Specified O/C Amount reaches its required level.

The Specified O/C Amount will also fluctuate based on the amount of excess interest and Principal Collections deposited into the Reserve Fund. For any distribution date on which the amount on deposit in the Reserve Fund is greater than 1% but less than or equal to 5% of the Pool Balance, the Specified O/C Amount will increase by 0.50%. For any distribution date on which the amount on deposit in the Reserve Fund is greater than 5% but less than or equal to 10% of the Pool Balance immediately preceding that distribution date, the Specified O/C Amount will increase by 1.00%. For any distribution date on which the amount on deposit in the Reserve Fund is greater than 10% but less than or equal to 15% of the Pool Balance immediately preceding that distribution date, the Specified O/C Amount will increase by 1.50%. For any distribution date on which the amount on deposit in the Reserve Fund exceeds 15% of the Pool Balance immediately preceding that distribution date, a Rapid Amortization Event will occur as described below under “—Rapid Amortization Events.” The percentages listed above are subject to adjustment in the final prospectus supplement. The Specified O/C Amount may be adjusted based upon pool statistics on or about the payment date in February 2005 and on or about the payment date in February 2006 with the approval of the rating agencies.

The Policies

The Certificate Policy and the Note Policy (each, a “Policy,” and together, the “Policies”) will be issued by the Surety Provider by the Closing Date pursuant to the Insurance and Indemnity Agreement (the “Insurance Agreement”) to be dated as of the Closing Date, among the seller, the mortgage loan transferor, the servicer, the certificate trustee, the indenture trustee, the depositor and the Surety Provider.

The Certificate Policy and Note Policy will irrevocably and unconditionally guarantee payment on each distribution and payment date, respectively, to the related trustee for the benefit of the related securityholder the full and complete payment of Insured Amounts with respect to such securities. Additionally, the Note Policy will guarantee the payment of any Backstop Amount as a result of the mandatory auction of the notes. Neither Policy covers any LIBOR Carryover Interest Shortfalls or any shortfalls due to the Servicemembers' Civil Relief Act.

An “Insured Amount” for the class A underlying certificates as of any distribution date is the sum of (a)(i) the related Guaranteed Principal Payment Amount for such date and (ii) the related Guaranteed Interest Payment for such date and (b) any Preference Amount that occurs before the related determination date; and for the notes as of any payment date is the sum of (a)(i) the related Guaranteed Principal Payment Amount for such date and (ii) the related Guaranteed Interest Payment Amount for such date, (b) any Preference Amount that occurs before the related determination date and (c) the Guaranteed Backstop Amount.

The “Guaranteed Principal Payment Amount” for the Certificate Policy (a) for the distribution date occurring in April 2026, is the amount needed to pay the outstanding principal balance of the class A underlying securities and (b) for any other distribution date, is the amount of the excess, if any, of the outstanding principal balance of such class A underlying certificates (after giving effect to all allocations and payments of principal to be made on such class A underlying certificates on the related distribution date, without giving effect to payments under the Certificate Policy to be made on such distribution date) over the Invested Amount (at the end of the related Due Period); and, for the Note Policy (x) for the payment date occurring in April 2026, is the amount needed to pay the outstanding principal balance of the notes and (y) for any other payment date, is the amount of the excess, if any, of the outstanding principal balance of such notes (after giving effect to all allocations and payments of principal to be made on such notes on the related payment date, without giving effect to payment under the Note Policy to be made on such payment date) over the principal balance of the class A underlying certificates after the application of distributions on the class A underlying certificates. All calculations under the Policies are made after giving effect to all other amounts distributable and allocable to principal on the securities on such date.

“Guaranteed Interest Payment” for any distribution date with respect to the Certificate Policy equals the amount by which (a) accrued and unpaid interest for payment on the class A underlying certificates as set forth above under clause (A)(3) of “—Distributions on the Class A Underlying Certificates” calculated in accordance with the original terms of the class A underlying certificates, the pooling and servicing agreement after giving effect to amendments or modifications to which the Surety Provider has given its written consent exceeds (b) the amount of Investor Interest Collections on deposit in the collection account on the date the servicer is required to remit collections on the HELOCs to the collection account in respect of that distribution date; and, for any payment date with respect to the Note Policy equals the amount by which (x) accrued and unpaid interest for payment on the notes as set forth above under clause (1) of “—Distributions on the Notes” calculated in accordance with the original terms of the notes, the sale agreement and the indenture after giving effect to amendments or modifications to which the Surety Provider has given its written consent exceeds (y) the amount of interest to be distributed on the class A underlying certificates in respect of that distribution date.

A “Preference Amount” means any amount previously paid to a securityholder, which would have been covered by any Policy, that is recoverable and recovered as a voidable preference by a trustee in bankruptcy pursuant to the United States Bankruptcy Code, as amended from time to time, in accordance with a final nonappealable order of a court having proper jurisdiction in an insolvency proceeding.

The “Guaranteed Backstop Amount” means, on the Mandatory Auction Payment Date, if a valid auction has been conducted in accordance with the terms of the auction administration agreement, the amount by which (A) the Backstop Amount, if any, (as defined below under “—Mandatory Auction of the Notes”) exceeds (B) the funds in an auction administration account to pay such amount on the Mandatory Auction Payment Date.

Payment of claims on the Policies will be made by the Surety Provider following receipt by the Surety Provider the appropriate notice for payment (and any other required documentation) on the later to occur of (i) 12:00 Noon, New York City time, on the second Business Day following receipt of the notice for payment and (ii) 12:00 Noon, New York City time, on the relevant payment date.

The terms “receipt” and “received”, with respect to the Policies, means actual delivery to the Surety Provider in the manner required by the related Policy and occurs on the day delivered if delivered before 12:00 p.m., New York City time, on a business day, or on the next business day if delivered either on a day that is not a business day or after 12:00 p.m., New York City time. If any notice given under a Policy by the related trustee is not in proper form or is otherwise insufficient for a making a claim under the Policies, it is not received, and the Surety Provider shall promptly so advise such trustee and such trustee may submit an amended notice.

Under each Policy, “business day” means any day other than a Saturday or Sunday on which banking institutions in the States of New York or California or the city in which the corporate trust office of the related trustee or the Surety Provider is located are authorized or obligated by law or executive order to be closed.

The Surety Provider's obligations under the Policies with respect to Insured Amounts will be discharged to the extent funds are transferred to the related trustee as provided in the related Policy, whether or not the funds are properly applied by such trustee. The Surety Provider will be subrogated to the rights of the related securityholder to receive payments of principal and interest, as applicable, on the notes to the extent of any payment by the Surety Provider under such Policy. The Policies cannot be modified, altered or affected by any other agreement or instrument, or by the merger, consolidation or dissolution of the seller, the mortgage loan transferor or the depositor. Each Policy by its terms may not be cancelled or revoked. Each Policy is governed by the laws of the State of New York.

Insured Amounts will be paid only at the time stated in the related Policy and no accelerated Insured Amounts shall be paid regardless of any acceleration of the related securities, unless the acceleration is at the sole option of the Surety Provider. Neither Policy covers shortfalls attributable to the liability of the related trust or the related trustee for withholding taxes, if any (including interest and penalties in respect of any such liability).

To the extent that Investor Interest Collections are applied to pay the interest on the class A underlying certificates, Investor Interest Collections may be insufficient to cover Investor Charge-Off Amounts. If the insufficiency exists and results in the outstanding principal balance of the class A underlying certificates exceeding the Invested Amount, a draw will be made on the Certificate Policy in accordance with the Certificate Policy.

Capitalized terms used in the Policies and not otherwise defined in such Policy shall have the respective meanings set forth in the pooling and servicing agreement as of the date of execution of the Certificate Policy or in the indenture as of the date of execution of the Note Policy, without giving effect to any subsequent amendment or modification to such agreement unless such amendment has been approved in writing by the Surety Provider.

Pursuant to, with respect to the Certificate Policy, the pooling and servicing agreement, and with respect to the Note Policy, the Indenture, unless a Surety Provider default exists, the Surety Provider will be treated as a securityholder for certain purposes, will be entitled to exercise all rights of the related securityholder under the related agreement without the consent of such securityholder, and the such securityholder may exercise their respective rights under such agreements only with the written consent of the Surety Provider. In addition, the Surety Provider will have certain additional rights as a third party beneficiary to the pooling and servicing agreement and the indenture.

With respect to the Certificate Policy, the pooling and servicing agreement, and with respect to the Note Policy, the sale agreement, provides that the seller or the depositor, respectively, may replace the Surety Provider if the financial strength of the Surety Provider is not rated in the highest rating category by each of the rating agencies listed below under “Rating.” If the Surety Provider is replaced due to such reduction in ratings, another surety provider may be appointed, if such replacement will not result in a downgrade or withdrawal of the ratings on the class A underlying certificates or the notes, or additional credit support may be transferred to the underlying trust or the note trust to maintain the ratings on the class A underlying certificates or the notes.

THE INSURANCE PROVIDED BY THE POLICIES IS NOT COVERED BY THE PROPERTY/CASUALTY INSURANCE SECURITY FUND SPECIFIED IN ARTICLE 76 OF THE NEW YORK INSURANCE LAW.

Rapid Amortization Events

A “Rapid Amortization Event” is any of the following events:
(a) if Interest Collections or Principal Collections for any payment date are not enough to make any payment of principal or interest in each case that is due on the class A underlying certificates, and such failure continues for a period of five business days;
(b) the occurrence of certain events of insolvency with respect to the underlying trust, the mortgage loan transferor or the servicer;
(c) if the aggregate draws under the Certificate Policy exceed 1% of the Cut-Off Date Pool Balance;
(d) if, during the first twelve months following the Closing Date, before an amount equal to the product of 2.20% and the Pool Balance as of the Cut-Off Date (the “Base O/C Amount”) is reached, the amount on deposit in the Reserve Fund exceeds 1% of the Pool Balance immediately preceding that distribution date;
(e) if, during the second twelve months following the Closing Date, before the Base O/C Amount is reached, the amount on deposit in the Reserve Fund exceeds zero;
(f) if after the Specified O/C Amount is reached, the amount on deposit in the Reserve Fund exceeds 15% of the Pool Balance immediately preceding that distribution date;
(g) the underlying trust or the note trust becomes subject to regulation by the Commission as an investment company within the meaning of the Investment Company Act of 1940, as amended;
(h) the rating on the notes falls below the highest rating category by either rating agency listed below under “Rating” for a period of sixty days; and
(i) failure on the part of the seller, the certificate seller, the mortgage loan transferor or the servicer to perform any of its material obligations under the mortgage loan purchase agreement, the pooling and servicing agreement, the trust agreement, the certificate purchase agreement or the indenture, which failure materially and adversely affects the interests of the noteholders or the Surety Provider and continues unremedied for 60 days.

If any event described in clause (a) or (i) occurs, a Rapid Amortization Event will occur only if, after the applicable grace period, either the indenture trustee, the Surety Provider, or the indenture trustee acting at the direction of the noteholders holding notes evidencing more than 51% in principal amount of the notes then outstanding, by written notice to the holder of the seller's interest, the holder of the owner trust certificates, the depositor and the servicer (and to the indenture trustee, if given by the Surety Provider, or the noteholders) declare that a Rapid Amortization Event has occurred. If any event described in clauses (b) through (h) occurs, a Rapid Amortization Event will occur without any notice or other action on the part of the indenture trustee, the Surety Provider or the noteholders immediately on the occurrence of such event.

Notwithstanding the foregoing, if a conservator, receiver or trustee-in-bankruptcy is appointed for the servicer and no Rapid Amortization Event exists other than the conservatorship, receivership or insolvency of the servicer, the conservator, receiver or trustee-in-bankruptcy may have the power to prevent the commencement of a Rapid Amortization Event. See “Certain Regulatory Matters Related to Banks” in this prospectus supplement for additional information.

Mandatory Auction of the Notes

During the eight business days prior to and including the payment date in February 2006, referred to as the mandatory auction payment date (the “Mandatory Auction Payment Date”), so long as the notes are rated in the highest rating category by each rating agency listed below under “Rating” during the period from the eighth business day prior to the Mandatory Auction Payment Date through the Mandatory Auction Payment Date and a Rapid Amortization Event has not occurred, Lehman Brothers Inc., in its capacity as auction administrator, will auction the notes to third-party investors (which may include the auction administrator, the Surety Provider, the indenture trustee, the seller or any of their affiliates).

If the notes are not rated in the highest rating category by each rating agency listed below under “Rating” during the period described above or if a Rapid Amortization Event occurs with respect to the notes prior to the Mandatory Auction Payment Date, the notes will not be auctioned, noteholders will not be required to re-sell their notes and no payment of any Backstop Amount will be made as described below.

Bids solicited by the auction administrator will be either (1) a spread bid to LIBOR or (2) a price bid. Investors willing to accept a yield on the notes equal to the sum of LIBOR and 0.45% or less will make a spread bid on the notes. Investors requiring a yield in excess of the sum of LIBOR and 0.45% will make a price bid on the notes. The auction administrator will assemble the bids no later than the fourth business day prior to the Mandatory Auction Payment Date to determine the market-clearing bid based on the lowest spread or highest discount price until there are bids for all the notes. If a market clearing spread bid is made, such bid will be the successful bid. If no market-clearing spread bid is made, then the highest market-clearing price bid, provided the related Auction Rate is not greater than the sum of LIBOR and 0.90%, will be the successful bid. If the Auction Rate related to the highest market-clearing price bid is greater than the sum of LIBOR and 0.90%, the auction will be deemed to have failed.

If the market clearing bid:
(a) is a spread bid less than or equal to the sum of LIBOR and 0.45%, the note rate will be reset to the market-clearing spread bid and the notes will be re-sold to third-party investors at the Par Price.
(b) is a price bid and the Auction Rate is less than or equal to the sum of LIBOR and 0.90%, (i) the note rate will be reset to the sum of LIBOR and 0.45%, (ii) the notes will be re-sold to third-party investors at a price equal to the Discount Price and (iii) the noteholders will be paid the Backstop Amount, resulting in a payment equal to the Par Price.
(c) is a price bid and the Auction Rate is over the sum of LIBOR and 0.90% or if there are not bids for all the notes, (i) the auction will be deemed to have failed, (ii) the noteholders will keep their notes, (iii) the note rate will be reset to the sum of LIBOR and 0.45% and (iv) the noteholders will be paid the Backstop Amount.

Payment to the noteholders of the portion of the outstanding principal balance of the notes represented by the Backstop Amount will be guaranteed by the Surety Provider pursuant to the Note Policy.

The “Auction Rate” will be LIBOR plus a spread, resulting in a yield that would produce a price equal to the market-clearing price bid, assuming Pricing Cashflows and a note rate equal to the sum of LIBOR and 0.45%.

The “Backstop Amount” is the amount equal to the product of (a) the amount by which the Par Price exceeds the Backstop Price and (b) Par.

The “Backstop Price” is the greater of the Discount Price and the Failed Discount Price.

The “Discount Price” is the price, expressed as a percentage of Par, that would result if the yield on the notes, assuming a note rate equal to the sum of LIBOR and 0.45% and the Pricing Cashflows, were equal to the Auction Rate.

The “Failed Discount Price” is the price, expressed as a percentage of Par, that would result if the yield on the notes, assuming a note rate equal to the sum of LIBOR and 0.45% and the Pricing Cashflows, were to equal the sum of LIBOR and 0.90%.

“Par” is equal to the outstanding principal balance of the notes after giving effect to the payment of principal to be made on the Mandatory Auction Payment Date.

The “Par Price” is the price equal to 100%.

The “Pricing Cashflows” for purposes of determining the Discount Price, the Auction Rate and the Failed Discount Price are the cashflows that would result based on the outstanding principal balance of the notes as of the Closing Date, a constant prepayment rate of 40%, a constant draw rate of 20% and assumes the exercise of the option to purchase the notes when the outstanding principal balance of the notes is equal to or less than 35% of the outstanding principal balance of the notes as of the Closing Date.

Termination of Trusts

The underlying trust will terminate on the distribution date following the later of (A) payment in full of all amounts owing to the Surety Provider unless the Surety Provider otherwise consents and (B) earliest of (i) the distribution date occurring in April 2026, (ii) the final payment or other liquidation of the last HELOC in the trust and (iii) the servicer's exercise of its right to purchase the HELOCs as described below under “Optional Terminations.”

The note trust will terminate on the earliest of (i) the payment date that the notes and all other amounts due under the indenture have been paid in full and (ii) the termination of the underlying trust.

Optional Termination of Underlying Trust

The HELOCs will be subject to optional repurchase by the servicer on any distribution date on or after the outstanding principal balance of the class A underlying certificates is reduced to an amount less than or equal to 10% of the outstanding principal balance of the class A underlying certificates on the Closing Date. The optional repurchase price of the HELOCs will be equal to the lesser of (i) the fair market value of the HELOCs and (ii) the sum of the outstanding principal balance of the HELOCs and accrued and unpaid interest thereon at the weighted average of the loan rates through the day preceding the final distribution date.

Optional Purchase of Notes

On any payment date after the outstanding principal balance of the notes is reduced to an amount less than or equal to 35% of the outstanding principal balance of the notes on the Closing Date, the note trust will have the option of purchasing the notes at a price equal to 100% of the outstanding principal balance of the notes plus accrued interest thereon. The sale agreement provides that the right to purchase the notes will be exercised by the owner trustee on behalf of the note trust and at the direction of the certificate seller (or any successor owner of the owner trust certificates). The exercise of this right will that the same effect as a prepayment on the notes.

Reports to Securityholders

The indenture trustee will, based on the information provided to it by the servicer pursuant to the pooling and servicing agreement and by the certificate seller pursuant to the administration agreement, prepare and make available on its website to each noteholder on each payment date, a statement setting forth for the notes, among other things:
(i) The outstanding principal balance of the notes at the beginning of the related Due Period and after all distributions on the related payment date, the Pool Balance at the beginning and end of the related Due Period, the original principal balance of the notes and the Pool Balance of the HELOCs on the Cut-Off Date;
(ii) The aggregate amount of Interest Collections and Principal Collections;
(iii) The amount of Investor Interest Collections and the Investor Principal Distribution Amount;
(iv) The note rate on the notes for such payment date;
(v) The number of days in the related Interest Period;
(vi) The aggregate amount of additional balances and additional HELOCs that were conveyed to the underlying trust during the related Due Period;
(vii) The aggregate Principal Balance and aggregate credit limit of HELOCs modified pursuant to the pooling and servicing agreement, and the weighted average of the loan rates and the weighted average of the margins of such modified HELOCs, in each case after giving effect to the modifications;
(viii) The aggregate amount required to be paid by the seller in respect of repurchases and substitutions of HELOCs;
(ix) The amount to be paid on the notes as interest for the related payment date and the amount to be paid on the notes as principal for the related payment date;
(x) The amount, if any, of the outstanding accrued overdue interest after giving effect to the payments on the related payment date;
(xi) The amount of the draws under each Policy, if any, to be made on the related payment date, separately stating the amounts to be paid in respect of the related Guaranteed Principal Payment Amount and the amount of interest due on the notes for such payment date;
(xii) The amount of any LIBOR Interest Carryover Shortfall paid on such payment date and remaining LIBOR Interest Carryover Shortfalls;
(xiii) The amount to be paid to the owner of the owner trust certificates in respect of the related payment date;
(xiv) The outstanding principal balance of the notes after giving effect to the payments to be made on the related payment date;
(xv) The weighted average of the loan rates and the weighted average of the maximum loan rates for all of the HELOCs, weighted on the basis of the Principal Balances of all of the HELOCs at the end of the related Due Period;
(xvi) The weighted average of the margins for each HELOC weighted on the basis of the Principal Balance of the HELOC at the end of the related Due Period;
(xvii) The amounts to be paid to the Surety Provider pursuant to the Policies;
(xviii) The Invested Amount (after all distributions on the related distribution date), the amount of overcollateralization (after all distributions on the related distribution date), the O/C Reduction Amount, the Excess O/C Amount and the Specified O/C Amount for the related distribution date;
(xix) The amount of Interest Collections to be paid as principal to the class A underlying certificates on the related distribution date;
(xx) The number of HELOCs outstanding at the beginning and at the end of the related Due Period;
(xxi) The number and aggregate Principal Balances of the HELOCs: (A) that are 31-60 days, 61-90 days and more than 90 days delinquent, (B) secured by mortgaged properties that have been the subject of foreclosure but have not yet been liquidated as of the end of the preceding Due Period, (C) that are in foreclosure and (D) with related borrowers that are the subject of any bankruptcy or insolvency proceeding;
(xxii) The Net Recoveries received during the related Due Period;
(xxiii) The cumulative Charge-Off Amount and the Charge-Off Amount incurred during the related Due Period; and
(xxiv) Whether a Rapid Amortization Event has occurred and is continuing during the related Due Period and, if so, specifying the Rapid Amortization Events.

In the case of the aggregate amount of Principal Collections and Interest Collections received during the related Due Period, the amount paid on the notes as interest for the related payment date, the amount paid on the notes as principal for the related payment date and the outstanding principal balance of the notes after all distributions on the payment date, such amounts shall also be expressed as a dollar amount per security with a $1,000 denomination.

The indenture trustee will be entitled to rely on but shall not be responsible for the content or accuracy of any information provided by the servicer or any third parties for purposes of preparing the monthly statement and may affix thereto any disclaimer regarding third party information it deems appropriate in its reasonable discretion.

Maturity and Prepayment Considerations

The indenture, except as otherwise described in this prospectus supplement, provides that the noteholders will be entitled to receive on each payment date, payments allocable to principal of the notes, in the amounts described in this prospectus supplement, until the related principal balance is reduced to zero.

As described in this prospectus supplement, the actual maturity of the notes will depend in part on the receipt of principal on the HELOCs following the Amortization Date and the amount and timing of charge-off amounts of the HELOCs, which may result in principal payments on the class A underlying certificates. All of the HELOCs may be prepaid in full or in part at any time.

There can be no assurance as to the rate of losses or delinquencies on any of the HELOCs; however, the rate of such losses and delinquencies are likely to be higher than those of traditional first lien mortgage loans, particularly in the case of HELOCs with high combined loan-to-value ratios. To the extent that any losses are incurred on any of the HELOCs that are not covered by excess interest allocable to noteholders, overcollateralization or the Policies, noteholders will bear all risk of such losses resulting from defaults by the related borrowers. Even where a Policy covers losses incurred on the related securities, the effect of losses may be to increase prepayment rates on the HELOCs, thus reducing the weighted average life and affecting the yield to maturity.

Although the loan rates on the HELOCs are subject to adjustment, the loan rates adjust based on the Index, while the class A underlying certificates and the notes adjust based on LIBOR. Changes in LIBOR may not correlate with changes in the Index and neither may correlate with prevailing interest rates. It is possible that an increased level of the Index could occur simultaneously with a lower level of prevailing interest rates, which would be expected to result in faster prepayments, thereby reducing the weighted average life of the class A underlying certificates and the notes. Conversely, if LIBOR were to increase above the Index, the note rate would be limited to the Maximum Rate, which would also adversely affect the yield. The “Index” for any date on which the loan rate for a HELOC subject to adjustment is the highest “prime rate” published in the Wall Street Journal on the business day immediately preceding the borrower's cycle date of each month.

Neither the seller nor the servicer is aware of any publicly generated studies or statistics available on the rate of prepayment of home equity loans such as the HELOCs. Generally, home equity lines of credit are not viewed by borrowers as permanent financing. Accordingly, HELOCs may experience a higher rate of prepayment than traditional mortgage loans. The underlying trust's prepayment experience may be affected by a wide variety of factors, including general economic conditions, changes in the deductibility of interest payments on HELOCs for federal income tax purposes, prevailing interest rates, the availability of alternative financing and homeowner mobility.

In the event that on the Mandatory Auction Payment Date there are funds remaining in the Reserve Fund, the holders of the notes will receive an additional distribution allocable to principal in an amount equal to the amount of such funds. Although there can be no assurance, the seller anticipates that there should be no material principal prepayment to the noteholders due to a lack of additional HELOCs transferred to the underlying trust.

In addition, the underlying trust's prepayment experience and the rate at which the class A underlying certificates amortize following the Amortization Date will be affected by any repurchases of HELOCs by the seller as a result of a breach of a representation and warranty or defective documentation.

Substantially all of the HELOCs contain due-on-sale provisions, and the servicer intends to enforce such provisions unless (i) such enforcement is not permitted by applicable law or (ii) the servicer, in a manner consistent with reasonable commercial practice, permits the purchaser of the mortgaged property to assume the HELOC. The enforcement of the due-on-sale provision will have the same effect as a prepayment of the related HELOC.

Collections on the HELOCs may vary because, among other things, borrowers may make payments during any month as low as the minimum monthly payment for such month or as high as the entire outstanding principal balance plus accrued interest and fees. In addition, borrowers may fail to make scheduled payments. Collections on the HELOCs may also vary due to seasonal purchasing and payment habits of borrowers. Accordingly, because little, if any, principal is due on any HELOC during the ten year draw period, there may be periods following the Amortization Date during which very little is distributed on the class A underlying certificates in respect of principal.

No assurance can be given as to the level of prepayments that will be experienced by the underlying trust and it can be expected that a portion of borrowers will not prepay their HELOCs to any significant degree.

The Pooling and Servicing Agreement

The servicer acting directly or through subservicers engaged by it as permitted by the pooling and servicing agreement is responsible for servicing of the HELOCs in accordance with the pooling and servicing agreement.

The servicer shall establish and maintain on behalf of the trust a collection account for the benefit of the class A underlying certificateholders. The collection account will be an Eligible Account (as defined below). Subject to the investment provision described in the following paragraphs, within two business days of receipt by the servicer or any subservicer of amounts in respect of the HELOCs, excluding amounts representing annual fees, assessments, credit insurance charges, insurance proceeds to be applied to the restoration or repair of a mortgaged property or similar items, the servicer or subservicer will deposit the amounts in the collection account. Amounts so deposited may be invested in Eligible Investments, as described in the pooling and servicing agreement, maturing no later than two business days prior to the date on which the amount on deposit in the collection account is required to be deposited in the distribution account or on the distribution date if approved by the rating agencies.

The certificate trustee will establish one or more distribution accounts into which amounts will be deposited from amounts withdrawn from the collection account for distribution to the class A underlying certificates on a distribution date. The distribution account will be an Eligible Account. Amounts on deposit in the distribution account will be invested in Eligible Investments maturing on or before the related distribution date at the direction of the servicer.

An “Eligible Account” is an account that is maintained at an institution that is:

(1) a depository institution (which may be the certificate trustee) organized under the laws of the United States or any one of the states thereof, including the District of Columbia (or any domestic branch of a foreign bank) which at all times (a) has a short-term unsecured debt rating of “P-1” by Moody's, (b) has a short-term unsecured debt rating of “A-1” by Standard & Poor's and (c) has its accounts fully insured by the FDIC or maintains trust accounts in a fiduciary capacity, or (2) any other institution that is acceptable to each rating agency and the Surety Provider. If so qualified, the certificate trustee or the servicer may be considered such an institution for the purpose of this definition.

“Eligible Investments” are specified in the pooling and servicing agreement and are limited to investments which meet the criteria of the rating agencies from time to time as being consistent with their then current ratings of the securities.

The pooling and servicing agreement prohibits the resignation of the servicer except upon (a) appointment of a successor servicer that is reasonably acceptable to the certificate trustee and the Surety Provider and receipt by the certificate trustee of a letter from each rating agency that the resignation and appointment will not result in a downgrading of the rating of any of the class A underlying certificates without regard to the Certificate Policy or (b) a determination that the servicer's respective duties thereunder are no longer permitted under applicable law. No resignation of the servicer will be effective until a successor servicer has assumed such servicing obligations in the manner provided in the pooling and servicing agreement. In connection with the appointment of a successor servicer, the servicing provisions of the pooling and servicing agreement may be amended without the consent of the class A underlying certificateholders, provided the rating agencies confirm the rating of the class A underlying certificates giving effect to the amendment and the Surety Provider consents.

Servicing Advances

The servicer will advance any amounts related to the foreclosure of a defaulted HELOC, including advances for the protection of the mortgaged property, provided that the servicer is obligated to make such advances only to the extent that the servicer determines, in its reasonable discretion, that such advances are recoverable out of liquidation proceeds. Neither the servicer nor any subservicer or any other party will advance principal or interest on a delinquent HELOC.

Modifications to HELOCs

Subject to applicable law, and subject to satisfaction of the conditions in the pooling and servicing agreement, the servicer may change the terms of a HELOC at any time, including, among other things, increasing the credit limit of a HELOC or reducing the margin of a HELOC. Any modification will be consistent with the seller's then-current underwriting guidelines, or, in the case of a modification to a defaulted HELOC, to the servicer's servicing guidelines.

Consent to Senior Liens

The servicer, acting as agent for the underlying trust, may permit the placement of a subsequent senior mortgage on any mortgaged property; provided, however, that, either (i) the resulting combined loan-to-value ratio is not greater than the combined loan-to-value ratio at the time the HELOC was originated, or (ii) certain other limitations relating to the aggregate number and aggregate principal balance of affected HELOCs, and combined loan-to-value ratios are complied with.

The pooling and servicing agreement limits the aggregate Principal Balance of HELOCs with respect to which the servicer is permitted to consent to the placing of a senior lien.

Hazard Insurance

The pooling and servicing agreement requires the servicer to maintain for any mortgaged property relating to a HELOC acquired upon foreclosure of a HELOC, or by deed in lieu of foreclosure, hazard insurance with extended coverage in an amount equal to the lesser of (1) the maximum insurable value of the mortgaged property and (2) the outstanding balance of the HELOC plus the outstanding balance on any mortgage loan senior to the HELOC at the time of foreclosure or deed in lieu of foreclosure, plus accrued interest and the servicer's good faith estimate of the related liquidation expenses to be incurred in connection therewith. The pooling and servicing agreement provides that the servicer may satisfy its obligation to cause hazard policies to be maintained by maintaining a blanket policy insuring against losses on the mortgaged properties. As set forth above, all amounts collected by the servicer, net of any reimbursements to the servicer, under any hazard policy, except for amounts to be applied to the restoration or repair of the mortgaged property, will ultimately be deposited in the collection account. While the terms of the related Credit Line Agreements typically require borrowers to maintain hazard insurance, the servicer will not monitor the maintenance of hazard insurance.

The standard form of fire and extended coverage policy typically covers physical damage to or destruction of the improvements on the property by fire, lightning, explosion, smoke, windstorm and hail, and the like, strike and civil commotion, subject to the conditions and exclusions specified in each policy. Although the policies relating to the HELOCs will be underwritten by different insurers and therefore will not contain identical terms and conditions, the basic terms of the policies are dictated by state laws and most of the policies typically do not cover any physical damage resulting from the following: war, revolution, governmental actions, floods and other water-related causes, earth movement, including earthquakes, landslides and mudflows, nuclear reactions, wet or dry rot, vermin, rodents, insects or domestic animals, theft and, in some cases vandalism. The foregoing list is merely indicative of kinds of uninsured risks and is not intended to be all-inclusive or an exact description of the insurance policies relating to the mortgaged properties.

Realization Upon Defaulted HELOCs

The servicer will foreclose upon or otherwise comparably convert to ownership mortgaged properties securing the HELOCs that come into default when in accordance with applicable servicing procedures under the pooling and servicing agreement, no satisfactory arrangements can be made for the collection of delinquent payments. In connection with foreclosure or other conversion, the servicer will follow practices as it deems necessary or advisable and as are in keeping with its general servicing activities, provided the servicer will not be required to expend its own funds in connection with foreclosure or other conversion, correction of default on a related senior mortgage loan or restoration of any property unless, in its sole judgment, foreclosure, correction or restoration will increase net liquidation proceeds. The servicer will be reimbursed out of liquidation proceeds for advances of its own funds as liquidation expenses before any net liquidation proceeds are distributed to the securityholders.

Evidence as to Compliance

The pooling and servicing agreement provides for delivery on or before Mar. 1 st of each year, beginning on Mar. 1, 2005, to the certificate trustee and the Surety Provider of an annual statement signed by an officer of the servicer to the effect that the servicer has fulfilled its material obligations under the pooling and servicing agreement throughout the preceding fiscal year, except as specified in such statement.

On or before Mar. 1 st of each year, beginning Mar. 1, 2005, the servicer will furnish a report prepared by a firm of nationally recognized independent public accountants (who may also render other services to the servicer) to the certificate trustee pursuant to the pooling and servicing agreement.

Events of Servicing Termination

“Events of Servicing Termination” will consist of, among other events, the following:
(i) any failure by the servicer to deposit in the collection account, or distribution account any deposit required to be made under the pooling and servicing agreement, which failure continues unremedied for two Business Days after the giving of written notice of such failure to the servicer by the certificate trustee, or to the servicer, and the certificate trustee by the Surety Provider or the holders of at least 25% in principal amount of the class A underlying certificates then outstanding;
(ii) the failure by the servicer to make any required expenditures under the terms of the pooling and servicing agreement, or any failure by the servicer duly to observe or perform in any material respect any other of its covenants or agreements in the pooling and servicing agreement, in each case which materially and adversely affects the interest of the holders of the class A underlying certificates or the Surety Provider and continues unremedied for 30 days after the giving of written notice of such failure to the servicer by the certificate trustee, or to the servicer and the certificate trustee by the Surety Provider or the holders of at least 25% in principal amount of the class A underlying certificates then outstanding; and
(iii) certain events of insolvency, readjustment of debt, marshalling of assets and liabilities or similar proceedings relating to the servicer and certain actions by the servicer indicating insolvency, reorganization or inability to pay its obligations.

Under the above circumstances, the certificate trustee with the consent of the Surety Provider may, and shall at the direction of the Surety Provider or the holders of at least 51% in principal amount of the class A underlying certificates then outstanding, deliver written notice to the servicer terminating all the rights and obligations of the servicer under the pooling and servicing agreement.

Rights Upon an Event of Servicing Termination

Upon the termination of the servicer all of the rights and obligations of the servicer under the pooling and servicing agreement and in and to the HELOCs will be terminated and the certificate trustee will succeed to all the responsibilities, duties and liabilities of the servicer under the pooling and servicing agreement and will be entitled to the compensation arrangements and reimbursements provided in the pooling and servicing agreement. In the event that the certificate trustee is unwilling or unable to act as servicer, it may appoint, or petition a court of competent jurisdiction for the appointment of, an established housing and home finance institution, bank or other mortgage loan or home equity loan servicer having a net worth of at least $50,000,000 and acceptable to the Surety Provider to act as successor to the servicer under the pooling and servicing agreement; provided such appointment does not result in the qualification, reduction or withdrawal of the rating on the class A underlying certificates without regard to the Certificate Policy. Pending such appointment the certificate trustee will be obligated to act in such capacity and to appoint a successor servicer unless prohibited by law. Such successor will be entitled to receive the compensation and reimbursements provided in the pooling and servicing agreement. A receiver or conservator for the servicer may be empowered to prevent the termination and replacement of the servicer where the only Event of Servicing Termination that has occurred is described in clause (iii) under “Events of Servicing Termination.” See “Certain Regulatory Matters Related to Banks” in this prospectus supplement.

Amendment

The pooling and servicing agreement may be amended from time to time by the seller, the Surety Provider, the mortgage loan transferor, the servicer and the certificate trustee, with the consent of the Surety Provider (if no Surety Provider default exists), provided that the rating agencies confirm in writing that such amendment will not result in a downgrading or a withdrawal of the rating then assigned to the class A underlying certificates (without regard to the Certificate Policy).

Matters Regarding the Servicer

Neither the servicer nor any director, officer or employee of the servicer will be under any liability to the underlying trust or the related holders of class A underlying certificates for any action taken or for refraining from the taking of any action in good faith under the pooling and servicing agreement or for errors in judgment; provided, however, that neither the servicer nor any director, officer or employee of the seller, will be protected against any liability which would otherwise be imposed by reason of willful malfeasance, bad faith or gross negligence in the performance of duties or by reason of reckless disregard of its obligations and duties under the pooling and servicing agreement.

The Indenture

The following summary describes all of the material terms of the indenture.

Events of Default; Rights Upon Event of Default

With respect to the notes, events of default under the indenture will include (each, an “event of default”):
a default for five days or more in the payment of any interest on any note;
a default in the payment of the unpaid principal balance of the notes on the maturity date for the notes;
a default in the observance or performance of any other covenant or agreement of the note trust made in the indenture and the continuation of the default for a period of 30 days after notice of the default is given to the note trust by the indenture trustee, or to the note trust and the indenture trustee by the holders of at least 51% in principal amount of the notes then outstanding;
any representation or warranty made by the note trust in the indenture or in any certificate delivered under the indenture having been incorrect in a material respect as of the time made, and the breach not having been cured within 30 days after notice of the breach is given to the note trust by the indenture trustee, or to the note trust and the indenture trustee by the holders of at least 51% in principal amount of notes then outstanding; or
certain events of bankruptcy, insolvency, receivership or liquidation of the trust.

The amount of principal required to be paid to noteholders under the indenture will usually be limited to amounts on deposit in the distribution account that are available to be paid as principal in accordance with the provisions of the Indenture described above under “Description of the Notes—Payments.” Therefore, the failure to pay principal on the notes typically will not result in the occurrence of an event of default until the maturity date for the notes. If there is an event of default with respect to a note due to late payment or nonpayment of interest due on a note, additional interest will accrue on the unpaid interest at the interest rate on the note, to the extent lawful until the interest is paid. The additional interest on unpaid interest shall be due at the time the interest is paid. If there is an event of default due to late payment or nonpayment of principal on a note, interest will continue to accrue on the principal at the interest rate on the note until the principal is paid. If an event of default should occur and be continuing with respect to the notes, the Surety Provider, or the indenture trustee may, with the consent of the Surety Provider or the indenture trustee acting at the direction of the Surety Provider, or if a Surety Provider default exists, the holders of at least 51% in principal amount of notes then outstanding shall, declare the principal of the notes to be immediately due and payable. The declaration may, under some circumstances, be rescinded by the Surety Provider or by the holders of at least 51% in principal amount of the notes then outstanding with the consent of the Surety Provider. If the notes are due and payable following an event of default, the indenture trustee may, and shall, at the direction of the Surety Provider or the holders of at least 51% in principal amount of the notes then outstanding with the consent of the Surety Provider, institute proceedings to collect amounts due or foreclose on trust property or exercise remedies as a secured party. If an event of default occurs and is continuing with respect to the notes, the indenture trustee will be under no obligation to exercise any of the rights or powers under the indenture at the request or direction of any of the holders of the notes, if the indenture trustee reasonably believes it will not be indemnified to its satisfaction against the costs, expenses and liabilities which might be incurred by it in complying with the request. Subject to the provisions for indemnification and limitations contained in the indenture, the Surety Provider (or if a Surety Provider default exists, the holders of at least 51% in principal amount of the outstanding notes) will have the right to direct the time, method and place of conducting any proceeding or any remedy available to the indenture trustee and the Surety Provider (if no Surety Provider default exists) or the holders of at least 51% in principal amount of the notes then outstanding may, with the consent of the Surety Provider (if no Surety Provider default exists) in some cases, waive any default with respect to the default, except a default in the payment of principal or interest or a default in respect of a covenant or provision of the indenture that cannot be modified without the waiver or consent of all the holders of the outstanding notes.

No holder of a note will have the right to institute any proceeding with respect to the indenture, unless:
the holder previously has given the indenture trustee written notice of a continuing event of default;
the holders of not less than 25% in principal amount of the notes then outstanding have made written request to the indenture trustee to institute the proceeding in its own name as indenture trustee;
the holder or holders have offered the indenture trustee indemnity satisfactory to it;
the indenture trustee has for 60 days failed to institute the proceeding; and
no direction inconsistent with the written request has been given to the indenture trustee during the 60-day period by the holders of a majority in principal amount of the notes then outstanding.

In addition, the indenture trustee and the noteholders, by accepting the notes, will covenant that they will not at any time institute against the trust any bankruptcy, reorganization or other proceeding under any federal or state bankruptcy or similar law; provided, however that the indenture trustee will not be prohibited from filing proofs of claim.

With respect to the note trust, neither the indenture trustee nor the owner trustee in its individual capacity, nor any owner of the owner trust certificates nor any of their respective owners, beneficiaries, agents, officers, directors, employees, affiliates, successors or assigns will be personally liable for the payment of the principal of or interest on the notes or for the agreements of the trust contained in the indenture.

Covenants

The indenture will provide that the note trust may not consolidate with or merge into any other entity, unless:
the entity formed by or surviving the consolidation or merger is organized under the laws of the United States, any state or the District of Columbia;
the entity expressly assumes the note trust's obligation to make due and punctual payments upon the notes and the performance or observance of any agreement and covenant of the note trust under the indenture; • no event of default shall have occurred and be continuing immediately after the merger or consolidation;
the note trust has been advised that the ratings of the securities then in effect would not be reduced or withdrawn by any rating agency as a result of the merger or consolidation; and
the Surety Provider shall have consented to such action and the note trust has received an opinion of counsel to the effect that the consolidation or merger would have no material adverse tax consequence to the note trust or to any noteholder.

The note trust will not, among other things:
except as expressly permitted by the indenture or the trust agreement, sell, transfer, exchange or otherwise dispose of any of the assets of the note trust;
claim any credit on or make any deduction from the principal and interest payable in respect of the notes, other than amounts withheld under the Code or applicable state law, or assert any claim
against any present or former holder of notes because of the payment of taxes levied or assessed upon the note trust;
dissolve or liquidate in whole or in part;
permit the validity or effectiveness of the indenture to be impaired or permit any person to be released from any covenants or obligations with respect to the notes under the indenture except as may be expressly permitted by the indenture;
permit any lien, charge excise, claim, security interest, mortgage or other encumbrance to be created on or extended to or otherwise arise upon or burden the assets of the note trust or any part of the assets of the note trust, or any interest in the assets of the note trust or the proceeds of the assets of the note trust;
engage in any activity other than as specified under the trust agreement; or
not incur, assume or guarantee any indebtedness other than indebtedness incurred under the notes and the indenture.
   Annual Compliance Statement

The note trust will be required to file annually with the indenture trustee a written statement as to the fulfillment of the note trust's obligations under the indenture.

Indenture Trustee's Annual Report

The indenture trustee will be required to mail each year to all noteholders a report relating to any change in its eligibility and qualification to continue as indenture trustee under the indenture, any amounts advanced by it under the indenture, the amount, interest rate and maturity date of any indebtedness owing by the trust to the indenture trustee in its individual capacity, any change in the property and funds physically held by the indenture trustee in its capacity as indenture trustee and any action taken by it that materially affects the notes and that has not been previously reported, but if none of those changes have occurred, then no report shall be required.

Satisfaction and Discharge of Indenture

The indenture will be discharged with respect to the collateral securing the notes upon the delivery to the indenture trustee for cancellation of all the notes or, with limitations, upon deposit with the indenture trustee of funds sufficient for the payment in full of all the notes.

Modification of Indenture

With the consent of the Surety Provider, the rating agencies and the holders of a majority of the outstanding notes, the note trust and the indenture trustee may execute a supplemental indenture to add provisions to, change in any manner or eliminate any provisions of, the indenture, or modify, except as provided below, in any manner the rights of the noteholders. Without the consent of the holder of each outstanding note affected, however, no supplemental indenture will, among other things:
change the due date of any installment of principal of or interest on any note or reduce the principal amount of any note, the interest rate specified on any note or the redemption price with respect to any note or change any place of payment where or the coin or currency in which any note or any interest on any note is payable;
impair the right to institute suit for the enforcement of provisions of the indenture regarding payment;
reduce the percentage of the aggregate amount of the outstanding notes, the consent of the holders of which is required for any supplemental indenture or the consent of the holders of which is required for any waiver of compliance with provisions of the indenture or of defaults under the indenture and their consequences as provided for in the indenture;
modify or alter the provisions of the indenture regarding the voting of notes held by the note trust, the seller, the mortgage loan transferor or an affiliate of any of them;
decrease the percentage of the aggregate principal amount of notes required to amend the sections of the indenture which specify the applicable percentage of aggregate principal amount of the notes necessary to amend the indenture or other related agreements; or
permit the creation of any lien ranking prior to or on a parity with the lien of the indenture with respect to any of the collateral for the notes or, except as otherwise permitted or contemplated in the indenture, terminate the lien of the indenture on any collateral for the notes or deprive the holder of any note of the security afforded by the lien of the indenture.

The note trust and the indenture trustee may also enter into supplemental indentures, with the consent of the Surety Provider, but without obtaining the consent of the noteholders, for the purpose of, among other things, adding any provisions to or changing in any manner or eliminating any of the provisions of the indenture or of modifying in any manner the rights of the noteholders; provided that the action will not materially and adversely affect the interest of any noteholder. Any such proposed amendment will be deemed to not adversely affect in any material respect the interests of the noteholders if an opinion of counsel is received to that effect and if the rating agencies confirm in writing that such amendment would not result in a reduction of the ratings then assigned to the notes. In addition, no such supplemental indenture will conflict with the provisions listed above requiring the consent of each noteholder or, without the consent of a majority of noteholders, permit the note trust to:
modify the definition of “Eligible Investments” (except as provided in the indenture) to expand the types of Eligible Investments specified in that definition; or
except as provided for in the sale agreement, enter into a derivative contract for the benefit of the noteholders;

However, the preceding sentence will not prevent the adoption without noteholder consent of any supplemental indenture requiring the above-referenced opinion of counsel, rating agency confirmation and the consent of a majority of noteholders if such supplemental indenture does not materially and adversely affect the interest of any noteholder and the adoption of that supplemental indenture is necessary to correct manifest errors in the transaction documents, conform the transaction documents to any inconsistencies with this prospectus supplement, comply with rating agency requirements or conform to then-current financial accounting standards, as described in the indenture.

Voting Rights

At all times, the voting rights of noteholders under the indenture will be allocated among the notes pro rata in accordance with their outstanding principal balances.

Voting of Class A Underlying Certificates

In the event that matters arise under the pooling and servicing agreement that require the vote or consent of class A underlying certificateholders the indenture trustee will provide notice of the requirement of such vote or consent, requesting voting directions, to the noteholders. The Indenture Trustee will vote the percentage interests of the class A underlying certificates in accordance with the directions of noteholders representing corresponding percentage interests.

So long as there is no Surety Provider default under the Policies, the Surety Provider will exercise all voting and consent rights of the class A underlying certificateholders and the noteholders.

Matters Regarding the Indenture Trustee

Subject to limitations set forth in the indenture, the indenture trustee and any director, officer, employee or agent of the indenture trustee shall be indemnified by the note trust and held harmless against any loss, liability or expense incurred in connection with investigating, preparing to defend or defending any legal action, commenced or threatened, relating to the indenture other than any loss, liability or expense incurred by reason of willful malfeasance, bad faith or negligence in the performance of its duties under the indenture or by reason of reckless disregard of its obligations and duties under the indenture. All persons into which the indenture trustee may be merged or with which it may be consolidated or any person resulting from the merger or consolidation shall be the successor of the indenture trustee under the indenture.

The Trust Agreement

The following summary describes all of the material terms of the trust agreement.

Amendment

The trust agreement may be amended by the certificate seller, the depositor, the registrar, the payment agent and the owner trustee, without consent of the noteholders, to cure any ambiguity, to correct or supplement any provision or for the purpose of adding any provisions to or changing in any manner or eliminating any of the provisions of the trust agreement or of modifying in any manner the rights of the noteholders; provided, however, that the action will not, as evidenced by an opinion of counsel, adversely affect in any material respect the interests of any noteholders, the owner of the owner trust certificates or the Surety Provider. Any such proposed amendment will be deemed to not adversely affect in any material respect the interests of the noteholders, the owner of the owner trust certificates or the Surety Provider if the rating agencies confirm in writing that such amendments will not result in a reduction of the ratings then assigned to the notes or the underlying class A certificates, without giving effect to either Policy. The trust agreement may also be amended by the certificate seller, the depositor, the registrar, the paying agent and the owner trustee with the consent of the holders of notes evidencing at least a majority in principal amount of then outstanding notes and the owner of owner trust certificates for the purpose of adding any provisions to or changing in any manner or eliminating any of the provisions of the trust agreement or modifying in any manner the rights of the holders; provided, however, that no such amendment will be effective unless the Surety Provider consents to such action or such action will not, as evidenced by an opinion of counsel, adversely affect in any material respect the interests of any noteholders or the Surety Provider.

Matters Regarding the Owner Trustee, the Depositor and the Certificate Seller

Neither the owner trustee, the depositor or the certificate seller nor any of their respective directors, officers or employees will be under any liability to the trust or the related securityholders for any action taken or for refraining from the taking of any action in good faith under the trust agreement or for errors in judgment; provided, however, that the owner trustee, the depositor and the certificate seller and any of their respective directors, officers or employees will not be protected against any liability which would otherwise be imposed by reason of willful malfeasance, bad faith or gross negligence in the performance of duties or by reason of reckless disregard of obligations and duties under the trust agreement. Subject to limitations set forth in the trust agreement, the owner trustee and any director, officer, employee or agent of the owner trustee shall be indemnified the certificate seller and held harmless against any loss, liability or expense incurred in connection with the trust agreement other than any loss, liability or expense incurred by reason of willful malfeasance, bad faith or gross negligence in the performance of its duties under the trust agreement. All persons into which the owner trustee may be merged or with which it may be consolidated or any person resulting from the merger or consolidation shall be the successor of the owner trustee under each trust agreement.

Administration Agreement

Administrators or co-administrators will enter into the administration agreement with the trust and the indenture trustee in which the (co)administrators will agree, to the extent provided in the administration agreement, to provide notices and perform other administrative obligations required under the indenture and the trust agreement.

The Indenture Trustee

A trust company is preferably the indenture trustee under the indenture.

The Owner Trustee

A trust company is preferably the owner trustee under the trust agreement.

Use of Proceeds

The net proceeds from the sale of the notes will be applied by the depositor on the closing date towards the purchase price of the underlying class A certificates and the payment of expenses related to the sale of the notes.

Federal Income Tax Considerations

In the opinion of McKee Nelson LLP, special tax counsel to the trust, for federal income tax purposes, the notes will be characterized as indebtedness and the neither the underlying trust nor the note trust will be characterized as an association, a publicly traded partnership taxable as a corporation, or a taxable mortgage pool. Each noteholder will agree to treat the notes as indebtedness. Alternative characterizations of the trust and the notes are possible, and prospective investors should consult their tax advisors regarding the federal income tax consequences of any possible alternative characterization. Because a portion of the interest payable on the notes may be deferred, it is possible that some or all of such interest may not be treated as unconditionally payable. Nevertheless, for tax information reporting purposes, the indenture trustee will treat all stated interest on the notes as qualified stated interest. Accordingly, it is expected that based on their anticipated offering prices, the notes will not be issued with original issue discount. For additional information regarding federal income tax consequences, see “Federal Income Tax Considerations” in the prospectus.

State Tax Considerations

In addition to the federal income tax consequences described above in “Federal Income Tax Considerations,” potential investors should consider the state income tax consequences of the acquisition, ownership, and disposition of the notes. State income tax law may differ substantially from the corresponding federal tax law, and this discussion does not purport to describe any aspect of the income tax laws of any state. Therefore, potential investors should consult their own tax advisors with respect to the various tax consequences of investments in the securities.

ERISA Considerations

Section 406 of the Employee Retirement Income Security Act of 1974, as amended (“ERISA”) and Section 4975 of the Internal Revenue Code of 1986, as amended (the “Code”) prohibit a pension, profit sharing or other employee benefit plan or other retirement arrangement, including an individual retirement account or a Keogh plan, that is subject to Title I of ERISA or to Section 4975 of the Code or entities deemed to hold the plan assets of the foregoing (“Plans”) from engaging in transactions involving “plan assets” with persons that are “parties in interest” under ERISA or “disqualified persons” under the Code with respect to the Plan. Some governmental, church or foreign plans or other retirement arrangements, although not subject to ERISA or the Code, are subject to federal, state, local or foreign laws (“Similar Law”) that impose similar requirements (those plans or arrangements, as well as Plans, herein referred to as “Benefit Plans”). A violation of these “prohibited transaction” rules may generate excise tax and other liabilities under ERISA and the Code or under Similar Law for those persons.

ERISA also imposes duties on persons who are fiduciaries of Plans, including the requirements of investment prudence and diversification, and the requirement that the Plan's investments be made in accordance with the documents governing the Plan. Under ERISA, any person who exercises any authority or control with respect to the management or disposition of the assets of a Plan is considered to be a fiduciary of the Plan.

Certain transactions involving the assets of a trust might be deemed to constitute prohibited transactions under ERISA and the Code with respect to a Plan that purchases securities issued by the trust if assets of the trust were deemed to be assets of the Plan. Under a regulation issued by the United States Department of Labor (the “DOL Regulations”), the assets of a trust would be treated as plan assets of the Plan for the purposes of ERISA and the Code only if the Plan acquires an “equity interest” in the trust and none of the exceptions contained in the DOL Regulations was applicable. An equity interest is defined under the DOL Regulations as an interest other than an instrument which is treated as indebtedness under applicable local law and which has no substantial equity features. Although there is little guidance on how this definition applies, the notes should be treated as indebtedness without substantial equity features for purposes of the DOL Regulations. This determination is based in part upon the traditional debt features of the notes, including the reasonable expectation of purchasers of the notes that they will be repaid when due, as well as the absence of conversion rights, warrants and other typical equity features.

Subject to the considerations discussed in “ERISA Considerations” in the Prospectus, the notes may be purchased by a Benefit Plan. A fiduciary of a Benefit Plan must determine that the purchase of a note is consistent with its fiduciary duties under ERISA and does not result in a non-exempt prohibited transaction as defined in Section 406 of ERISA or Section 4975 of the Code or cause a non-exempt violation of any Similar Law. Each purchaser of a note will be deemed to represent that either (i) it is not acquiring the notes with the assets of a Benefit Plan or (ii) its purchase and holding of the note are eligible for the exemption provided under Prohibited Transaction Class Exemption (“PTCE”) 84-14, PTCE 90-1, PTCE 91-38, PTCE 95-60, PTCE 96-23 or a similar prohibited transaction exemption, or in the case of a Benefit Plan subject to Similar Law, do not result in a non-exempt violation of such Similar Law. A PTCE may not apply to all prohibited transactions that could arise in connection with a Benefit Plan's investment in the notes and Benefit Plans should be aware that ownership of the trust may change as a result of a transfer of the owner trust certificates.

In addition, the fiduciary of any Plan for which the underwriter, the seller, the mortgage loan transferor, the surety provider, any provider of services to the trust or any of their affiliates (a) has investment or administrative discretion with respect to Plan assets; (b) has authority or responsibility to give, or regularly gives, investment advice with respect to Plan assets for a fee and under an agreement or understanding that the advice (i) will serve as a primary basis for investment decisions with respect to the Plan assets and (ii) will be based on the particular investment needs for the Plan; or (c) is an employer maintaining or contributing to the Plan should consult with its counsel concerning whether an investment in the notes may constitute or give rise to a prohibited transaction before investing in a note.

Any person that proposes to acquire a note on behalf of or with plan assets of any Benefit Plan should consult with counsel concerning the application of the fiduciary responsibility provisions of ERISA and the prohibited transaction provisions of ERISA and Section 4975 of the Code or the proposed investment.

Legal Investment Considerations

The notes will not constitute “mortgage related securities” for purposes of SMMEA. Accordingly, many institutions with legal authority to invest in mortgage related securities may not be legally authorized to invest in the notes. No representation is made herein as to whether the notes constitute legal investments for any entity under any applicable statute, law, rule, regulation or order. Prospective purchasers are urged to consult with their counsel concerning the status of the notes as legal investments for such purchasers prior to investing in notes.

Underwriting

Subject to the terms and conditions set forth in the underwriting agreement, the depositor has agreed to sell the notes to Lehman Brothers Inc. (the “underwriter”), and the underwriter has agreed to purchase the notes from the depositor.

It is expected that delivery of the notes will be made only in book-entry form through the Same Day Funds Settlement System of DTC, Clearstream and Euroclear on or about Feb. 27, 2004, against payment therefor in immediately available funds.

The underwriter is obligated to purchase all the notes if any are purchased. The depositor has been advised by the underwriter that it presently intends to make a market in the notes; however, it is not obligated to do so, any market-making may be discontinued at any time, and there can be no assurance that an active public market for the notes will develop.

The depositor has been advised by the underwriter that it proposes initially to offer the notes to the public at the respective offering prices set forth on the cover page of this prospectus supplement and to certain dealers at such price less a discount not in excess of 0.18% of the related denominations. The underwriter may allow and such dealers may reallow a discount not in excess of 0.09% of the related denomination to certain other dealers. After the initial public offering, such public offering price may change.

Proceeds to the depositor are expected to be $498,511,964 from the sale of the notes, before deducting expenses payable by the depositor estimated to be $1,300,000.

Until the distribution of the notes is completed, the rules of the Commission may limit the ability of the underwriter and certain selling group members to bid for and purchase the notes. As an exception to these rules, the underwriter is permitted to engage in certain transactions that stabilize the prices of the notes. Such transactions consist of bids or purchase for the purpose of pegging, fixing or maintaining the price of such notes.

In general, purchases of a security for the purpose of stabilization or to reduce a short position could cause the price of the security to be higher than it might be in the absence of such purchases.

Neither the depositor nor the underwriter make any representation or prediction as to the direction or magnitude of any effect that the transactions described above may have on the prices of the notes.

In addition, neither the depositor nor the underwriter make any representation that the underwriter will engage in such transactions or that such transactions, once commenced, will not be discontinued without notice.

The underwriting agreement provides that the depositor will indemnify the underwriter against liabilities, including liabilities under the Securities Act of 1933, or contribute payments the underwriter may be required to make in respect of liabilities, including liabilities under the Securities Act of 1933.

Lehman Brothers Inc., the underwriter, is an affiliate of Lehman ABS Corporation, the depositor.

Experts

The financial statements of the Surety Provider as of Dec. 31, 2002 and 2001, and for each of the years in the three-year period ended Dec. 31, 2002, have been included in the Form 8-K of the depositor, which is incorporated by reference in the registration statement in reliance upon the report of KPMG LLP, independent certified public accountants, which is also incorporated by reference therein, and upon the authority of said firm as experts in accounting and auditing.

Legal Matters

Certain legal matters with respect to the securities will be passed upon for the depositor and the underwriter by McKee Nelson LLP, New York, N.Y. Certain legal matters will be passed upon for the seller, the mortgage loan transferor, the servicer and the certificate seller by in-house counsel for such parties and by Mayer, Brown, Rowe & Maw LLP, Los Angeles, Calif. Certain legal matters will be passed upon for the note trust by Richards, Layton & Finger, P.A., Wilmington, Del.

Rating

It is a condition to issuance that each class of the notes be rated not lower than “AAA” by S&P and “Aaa” by Moody's. A securities rating addresses the likelihood of the receipt by noteholders of payments required under the indenture. The rating takes into consideration the structural, legal and tax aspects associated with the notes. The ratings on the securities do not, however, constitute statements regarding the possibility that noteholders might realize a lower than anticipated yield. The ratings assigned to the notes do not address the likelihood of the receipt by noteholders of any payment in respect of LIBOR Interest Carryover Shortfalls. The ratings assigned to the notes will depend primarily upon the creditworthiness of the Surety Provider. Any reduction in a rating assigned to the financial strength of the Surety Provider below the ratings initially assigned to the notes may result in a reduction of one or more of the ratings assigned to the notes. A securities rating is not a recommendation to buy, sell or hold securities and may be subject to revision or withdrawal at any time by the assigning rating organization. Each securities rating should be evaluated independently of similar ratings on different securities.

Annex I

Global Clearance, Settlement and Tax Documentation Procedures

Except in certain limited circumstances, the globally offered loan asset-backed notes will be available only in book-entry form. Investors in the Global Securities may hold these Global Securities through any of DTC, Clearstream or Euroclear. The Global Securities will be tradeable as home market instruments in both the European and U.S. domestic markets. Initial settlement and all secondary trades will settle in same-day funds. Secondary market trading between investors holding Global Securities through Clearstream and Euroclear will be conducted in the ordinary way in accordance with their normal rules and operating procedures and in accordance with conventional eurobond practice.

Secondary market trading between investors holding Global Securities through DTC will be conducted according to the rules and procedures applicable to U.S. corporate debt obligations.

Secondary cross-market trading between investors holding Global Securities through Clearstream or Euroclear and investors holding Global Securities through DTC participants will be effected on a delivery-against-payment basis through the respective depositaries of Clearstream and Euroclear, in those capacities, and other DTC participants.

Although DTC, Clearstream and Euroclear are expected to follow the procedures described below to facilitate transfers of interests in the Global Securities among participants of DTC, Clearstream and Euroclear, they are under no obligation to perform or continue to perform those procedures, and those procedures may be discontinued at any time. None of the issuer, the indenture trustee, the depositor or the servicer will have any responsibility for the performance by DTC, Clearstream and Euroclear or their respective participants or indirect participants of their respective obligations under the rules and procedures governing their obligations.

Non-U.S. holders, as described below, of Global Securities will be subject to U.S. withholding taxes unless the holders meet certain requirements and deliver appropriate U.S. tax documents to the securities clearing organizations or their participants.

Initial Settlement

All Global Securities will be held in book-entry form by DTC in the name of Cede & Co. (“Cede”) as nominee of DTC. Investors' interests in the Global Securities will be represented through financial institutions acting on their behalf as direct and indirect participants in DTC. As a result, Clearstream and Euroclear will hold positions on behalf of their participants through their respective depositaries, which in turn will hold the positions in accounts as DTC participants.

Investors electing to hold their Global Securities through DTC participants, rather than through Clearstream or Euroclear accounts, will be subject to the settlement practices applicable to prior similar issues. Investors' securities custody accounts will be credited with their holdings against payment in same-day funds on the settlement date.

Investors electing to hold their Global Securities through Clearstream or Euroclear accounts will follow the settlement procedures applicable to conventional eurobonds, except that there will be no temporary global security and no “lock-up” or restricted period. Global Securities will be credited to the securities custody accounts on the settlement date against payment in same-day funds.

Secondary Market Trading

Since the purchaser determines the place of delivery, it is important to establish at the time of the trade where both the purchaser's and seller's accounts are located to ensure that settlement can be made on the desired value date.

Transfers between DTC Participants.

Secondary market trading between DTC participants will be settled using the DTC procedures applicable to similar pass-through note issues in same-day finds.

Transfers between Clearstream and/or Euroclear Participants.

Secondary market trading between Clearstream participants or Euroclear participants and/or investors holding Global Securities through them will be settled using the procedures applicable to conventional eurobonds in same-day funds.

Transfers between DTC seller and Clearstream or Euroclear purchaser.

When Global Securities are to be transferred on behalf of a seller from the account of a DTC participant to the account of a Clearstream participant or a Euroclear participant for a purchaser, the purchaser will send instructions to Clearstream or Euroclear through a Clearstream participant or Euroclear participant at least one business day prior to settlement. Clearstream or Euroclear operator will instruct its respective depositary to receive the Global Securities against payment. Payment will include interest accrued on the Global Securities from and including the last payment date to and excluding the settlement date. Payment will then be made by the respective depositary of the DTC participant's account against delivery of the Global Securities. After settlement has been completed, the Global Securities will be credited to the respective clearing system, and by the clearing system, in accordance with its usual procedures, to the Clearstream participant's or Euroclear participant's account. The securities credit will appear the next business day, European time, and the cash debt will be back-valued to, and the interest on the Global Securities will accrue from, the value date, which would be the preceding day when settlement occurred in New York. If settlement is not completed on the intended value date (i.e., the trade fails) the Clearstream or Euroclear cash debt will be valued instead as of the actual settlement date.

Clearstream participants and Euroclear participants will need to make available to the respective clearing systems the funds necessary to process same-day funds settlement. The most direct means of doing so is to preposition funds for settlement from cash on hand. Under this approach, they may take on credit exposure to Clearstream or Euroclear operator until the Global Securities are credited to their accounts one day later.

As an alternative, if Clearstream or Euroclear has extended a line of credit to them, Clearstream participants or Euroclear participants can elect not to preposition funds and allow that credit line to be drawn upon. Under this procedure, Clearstream participants or Euroclear participants receiving Global Securities for purchasers would incur overdraft charges for one day, to the extent they cleared the overdraft when the Global Securities were credited to their accounts. However, interest on the Global Securities would accrue from the value date. Therefore, in many cases the investment income on the Global Securities earned during that one-day period would tend to offset the amount of these overdraft charges, although this result will depend on each Clearstream participant's or Euroclear participant's particular cost of funds.

Since the settlement through DTC will take place during New York business hours, DTC participants are subject to DTC procedures for transferring Global Securities to the respective depositary of Clearstream or Euroclear for the benefit of Clearstream participants or Euroclear participants. The sale proceeds will be available to the DTC seller on the settlement date. Thus, to the seller settling the sale through a DTC participant, a cross-market transaction will settle no differently than a sale to a purchaser settling through a DTC participant.

Finally, intra-day traders that use Clearstream participants or Euroclear participants to purchase Global Securities from DTC participants or sellers settling through them for delivery to Clearstream participants or Euroclear participants should note that these trades will automatically fail on the sale side unless affirmative action is taken. At least three techniques should be readily available to eliminate this potential condition:

borrowing Global Securities through Clearstream or Euroclear for one day, until the purchase side of the intra-day trade is reflected in their Clearstream or Euroclear accounts, in accordance with the clearing system's customary procedures;

borrowing the Global Securities in the U.S. from a DTC participant no later than one day prior to settlement, which would give sufficient time for such Global Securities to be reflected in the relevant Clearstream or Euroclear accounts in order to settle the sale side of the trade; or staggering the value dates for the buy and sell sides of the trade so that the value date for the purchase from the DTC participant is at least one day prior to the value date for the sale to the Clearstream participant or Euroclear participant.

Transfer between Clearstream or Euroclear Seller and DTC Purchaser.

Due to time zone differences in their favor, Clearstream participants and Euroclear participants may employ their customary procedures for transactions in which Global Securities are to be transferred by the respective clearing system, through the respective Depositary, to a DTC participant. The seller will send instructions to Clearstream or the Euroclear operator through a Clearstream participant or Euroclear participant at least one business day prior to settlement. In these cases Clearstream or Euroclear will instruct the respective depositary, as appropriate, to deliver the Global Securities to the DTC participant's account against payment. Payment will include interest accrued on the Global Securities from and including the last payment date to but excluding the settlement date. The payment will then be reflected in the account of the Clearstream participant or Euroclear participant the following business day, and receipt of the cash proceeds in the Clearstream participant's or Euroclear participant's account would be back-valued to the value date, which would be the preceding day, when settlement occurred through DTC in New York. If settlement is not completed on the intended value date (i.e., the trade fails), receipt of the cash proceeds in the Clearstream participant's or Euroclear participant's account would instead be valued as of the actual settlement date.

U.S. Federal Income Tax Documentation Requirements

A beneficial owner of Global Securities holding securities through Clearstream or Euroclear, or through DTC if the holder has an address outside the U.S., will be subject to the 30% U.S. withholding tax that applies to payments of interest, including original issue discount, on registered debt issued by U.S. Persons, unless (i) each clearing system, bank or other financial institution that holds customers' securities in the ordinary course of its trade or business in the chain of intermediaries between the beneficial owner and the U.S. entity required to withhold tax complies with applicable certification requirements and (ii) the beneficial owner takes one of the following steps to obtain an exemption or reduced tax rate:

Exemption for non-U.S. Persons (Form W-8BEN).

Beneficial Noteholders of Global Securities that are non-U.S. Persons and are individuals or entities treated as corporations for U.S. federal tax purposes can obtain a complete exemption from the withholding tax by filing a signed Form W-8BEN (Certificate of Foreign Status of Beneficial Owner for United States Tax Withholding). More complex rules may apply to other entities. If the information shown on Form W-8BEN changes, a new W-8BEN must be filed within 30 days of the change. Exemption for non-U.S. Persons with effectively connected income (Form W-8ECI). A non-U.S. Person, including a non-U.S. corporation or bank with a U.S. branch, for which the interest income is effectively connected with its conduct of a trade or business in the United States, can obtain an exemption from the withholding tax by filing Form W-8ECI (Certificate of Foreign Person's Claim for Exemption from Withholding on Income Effectively Connected with the Conduct of a Trade or Business in the United States).

Exemption or reduced rate for non-US. Persons resident in treaty countries (Form W-8BEN).

Non-U.S. Persons that are Noteholders residing in a country that has a tax treaty with the United States and are individuals or entities treated as corporations for U.S. federal tax purposes can obtain an exemption or reduced tax rate (depending on the treaty terms) by filing Form W-8BEN (Certificate of Foreign Status of Beneficial Owner for United States Tax Withholding). More complex rules may apply to other entities.

Exemption for U.S. Persons (Form W-9).

U.S. Persons can obtain a complete exemption from the withholding tax by filing Form W-9 (Payer's Request for Taxpayer Identification Number and Certification).

U.S. Federal Income Tax Reporting Procedure.

The Noteholder of a Global Security or, in the case of a Form W-8ECI filer, his agent, files by submitting the appropriate form to the person through whom it holds, the clearing agency, in the case of persons holding directly on the books of the clearing agency. Except for a more favorable rule applicable to a Form W-8BEN that retains the U.S. taxpayer identification number of the Beneficial Owner, Form W-8BEN and Form W-8ECI are effective until the end of the third succeeding calendar year from the date the form is signed. However, if information shown on the form changes, a new Form W-8BEN must be filed within 30 days of the change.

The term “U.S. Person” means
a citizen or resident of the United States,
an entity treated as a corporation or partnership organized in or under the laws of the United States, any state of the United States or the District of Columbia, other than an entity treated as a partnership that is not treated as a United States person under any applicable Treasury Department regulations,
an estate the income of which is includable in gross income for United States tax purposes, regardless of its source,
a trust if a court within the United States is able to exercise primary supervision over the administration of the trust and one or more United States persons have authority to control all substantial decisions of the trust, and
some trusts treated as United States persons before Aug. 20, 1996 that elect to continue to be so treated to the extent provided in regulations.

This summary does not deal with all aspects of U.S. Federal income tax withholding that may be relevant to foreign holders of the Global Securities. Investors should consult their own tax advisors for specific tax advice concerning their holding and disposing of the Global Securities.

Risk Factors

Limited Liquidity May Result In Delays In Ability To Sell Securities Or Lower Returns

There will be no market for the securities of any series prior to their issuance, and there can be no assurance that a secondary market will develop. If a secondary market does develop, there can be no assurance that it will provide holders with liquidity of investment or that the market will continue for the life of the securities of such series. Lehman Brothers, through one or more of its affiliates, and any other underwriters presently expect to make a secondary market in the securities, but have no obligation to do so. Absent a secondary market for the securities, a delay or reduced price may be experienced as compared to a liquid security. Limited Assets For Payments—No Recourse To Depositor, Seller Or Servicer

The depositor does not have, nor is it expected to have, any significant assets. The securities of a series will be payable solely from the assets of the trust fund for that series. There will be no recourse to the depositor or any other person for any default on the notes or any failure to receive distributions on the certificates or custody receipt. Further, as described in the related prospectus supplement, at the times set forth in the related prospectus supplement, some primary assets and/or any amount remaining in the collection account or distribution account for a series and other amounts described specified in the related prospectus supplement, may be promptly released or remitted to the depositor, the servicer, the provider of any enhancement or any other person entitled thereto and will no longer be available for making payments to the holders of the securities. Consequently, holders of securities of each series must rely solely upon payments with respect to the primary assets and the other assets constituting the trust fund for a series of securities, including, if applicable, any amounts available pursuant to any enhancement for that series, for the payment of principal of and interest on the securities of that series.

If there is a default with respect to payments on a series of notes, holders of those notes will be required under the indenture to proceed only against the primary assets and other assets constituting the related trust fund and may not proceed against any assets of the depositor. If payments with respect to the assets securing a series of notes, including any enhancement, were to become insufficient to make payments on those notes, no other assets would be available for payment of the deficiency and holders of those notes may experience a loss. The only obligations, if any, of the depositor with respect to the securities of any series will be pursuant to representations and warranties. The depositor does not have, and is not expected in the future to have, any significant assets with which to meet any obligation to repurchase primary assets with respect to which there has been a breach of any representation or warranty. If, for example, the depositor were required to repurchase a primary asset, its only sources of funds to make such repurchase would be from funds obtained from the enforcement of a corresponding obligation, if any, on the part of the originator of the primary assets, the servicer or the seller, as the case may be, or from a reserve fund established to provide funds for such repurchases. If the depositor does not have sufficient assets and no other party is obligated to repurchase defective primary assets, a loss may occur.

Refer to the section “The Agreements—Assignment of Primary Assets” For more detail.

Limits On Enhancement May Result In Losses To Holders

Although enhancement for the securities is intended to reduce the risk of delinquent payments or losses to holders of a series of securities entitled to the benefit thereof, the amount of the enhancement will be limited, as set forth in the related prospectus supplement. In addition the amount available will decline and could be depleted prior to the payment in full of the related series of securities, and losses on the primary assets could result in losses to holders of those securities. Refer to the section “Enhancement.” Timing And Rate Of Prepayments May Result In Lower Yield The yield to maturity experienced by a holder of securities may be affected by the rate and timing of payment of principal of the loans or of the underlying loans relating to the private securities. The rate and timing of principal payments of the securities of a series will be affected by a number of factors, including the following:
the extent of prepayments, which may be influenced by a variety of factors,
the manner of allocating principal payments among the classes of securities of a series as specified in the related prospectus supplement, and
the exercise of any right of optional termination.

Prepayments may also result from repurchases of loans or underlying loans, as applicable, due to material breaches of the seller's or the depositor's representations or warranties.

Refer to the section “Description of the Securities—Weighted Average Life of Securities” for more detail

Interest payable on the securities of a series on a distribution date will include all interest accrued during the period specified in the related prospectus supplement. In the event interest accrues during the calendar month prior to a distribution date, the effective yield to holders will be reduced from the yield that would otherwise be obtainable if interest payable on the security were to accrue through the day immediately preceding each distribution date, and the effective yield at par to holders will be less than the indicated coupon rate.

Refer to the section “Description of the Securities—Payments of Interest” for more detail.

Status Of Loans As Junior Liens May Result In Losses In Foreclosure Proceedings

The mortgages may be junior liens subordinate to the rights of the mortgagee under the senior mortgage or mortgages on the same mortgaged property. The proceeds from any liquidation, insurance or condemnation proceedings in connection with a junior mortgage will be available to satisfy the outstanding balance of that mortgage only to the extent that the claims of the senior mortgagees have been satisfied in full, including any related foreclosure costs. In addition, a junior mortgagee may not foreclose on the property securing a junior mortgage unless it forecloses subject to the senior mortgages. If a junior mortgagee forecloses on the mortgaged property, it must either pay the entire amount due on the senior mortgages to the senior mortgagees at or prior to the foreclosure sale or undertake the obligation to make payments on the senior mortgages in the event the mortgagor is in default. The trust fund will not have any source of funds to satisfy the senior mortgages or make payments due to the senior mortgagees. As a result, the servicer may not be able to foreclose on a mortgaged property or may realize lower proceeds in a foreclosure relating to a defaulted loan and a corresponding loss may occur.

Decrease In Value Of Mortgaged Property Would Disproportionately Affect Junior Lienholders

There are several factors that could adversely affect the value of properties and the outstanding balance of the related loan, together with any senior financing, would equal or exceed the value of the properties. Among the factors that could adversely affect the value of the properties are an overall decline in the residential real estate market in the areas in which the properties are located or a decline in the general condition of the properties as a result of failure of borrowers to maintain adequately the properties or of natural disasters that are not necessarily covered by insurance, such as earthquakes and floods. Any decline in the value of a property could extinguish the value of a junior interest in that property before having any effect on the related senior interest therein. If a decline in the value of the properties occurs, the actual rates of delinquencies, foreclosure and losses on the junior loans could be higher than those currently experienced in the mortgage lending industry in general.

Adversely Affects Of Violations Of Environmental Laws

Real property pledged as security to a lender may be subject to environmental risks. Under the laws of some states, contamination of a property may give rise to a lien on the property to assure the costs of clean-up. In several states, such a lien has priority over the lien of an existing mortgage or other lien against the related property. In addition, under the laws of some states and under CERCLA, a lender may be liable, as an “owner” or “operator,” for costs of addressing releases or threatened releases of hazardous substances that require remedy at a property, if agents or employees of the lender have become sufficiently involved in the operations of the borrower, regardless of whether or not the environmental damage or threat was caused by a prior owner. A lender also risks liability under CERCLA on foreclosure of the mortgaged property securing a mortgage. Failure to comply with environmental laws may result in fines and penalties that could be assessed against the trust fund as owner of the related property. If a trust fund is considered an owner or an operator of a contaminated property, the trust fund will suffer losses for any liability imposed for environmental hazards on the property. These losses may result in reductions in the amounts distributed to the holders of the related securities.

Violations Of Lending Laws Could Result In Losses On Primary Assets

Applicable state laws generally regulate interest rates and other charges and require particular disclosures. In addition, other state laws, public policy and general principles of equity relating to the protection of consumers, unfair and deceptive practices and debt collection practices may apply to the origination, servicing and collection of the loans. Depending on the provisions of the applicable law and the specific facts and circumstances involved, violations of these laws, policies and principles may limit the ability of the servicer to collect all or part of the principal of or interest on the loans, may entitle the borrower to a refund of amounts previously paid and, in addition, could subject the related trust fund as the owner of the loan, to damages and administrative enforcement.

The loans are also subject to federal laws, including laws that require particular disclosures to borrowers, that prohibit discrimination and that regulate the use and reporting of information relating to the borrower's credit experience. Violations of provisions of these federal laws may limit the ability of the servicer to collect all or part of the principal of or interest on the loans and in addition could subject the related trust fund as the owner of the loan to damages and administrative enforcement.

Refer to the section “Legal Aspects of Loans” for more detail.

The home improvement contracts are also subject to the regulations of the Federal Trade Commission and other similar federal and state statutes and Holder in Due Course Rules, which protect the homeowner from defective craftsmanship or incomplete work by a contractor. These laws permit the obligor to withhold payment if the work does not meet the quality and durability standards agreed to by the homeowner and the contractor. The Holder in Due Course Rules have the effect of subjecting any assignee of the seller in a consumer credit transaction, such as the related trust fund with respect to the loans, to all claims and defenses which the obligor in the credit sale transaction could assert against the seller of the goods. Losses on loans from violation of these lending laws that are not otherwise covered by the enhancement for a series will be borne by the holders of one or more classes of securities for the related series.

Rating Of The Securities Relates To Credit Risk Only And Does Not Assure Payment On The Securities

The ratings of the securities would be based on, among other things, the adequacy of the value of the primary assets and any enhancement with respect to those securities. A rating should not be deemed a recommendation to purchase, hold or sell securities, since it does not address market price or suitability for a particular investor. There is also no assurance that any rating will remain in effect for any given period of time or that the rating will not be lowered or withdrawn entirely by the rating agency if in its judgment circumstances in the future so warrant. In addition to being lowered or withdrawn due to any erosion in the adequacy of the value of the primary assets, such rating might also be lowered or withdrawn, among other reasons, because of an adverse change in the financial or other condition of an enhancer or a change in the rating of the related enhancer's financial strength. Any reduction or withdrawal of a rating will have an adverse effect on the value of the related securities.

Liquidation Value Of Trust Fund Assets May Be Insufficient To Satisfy All Claims Against Trust Fund

There is no assurance that the market value of the primary assets or any other assets for a series will at any time be equal to or greater than the aggregate principal amount of the securities then outstanding, plus accrued interest thereon. In addition, upon an event of default under the indenture for a series of notes and a sale of the assets in the trust fund or upon a sale of the assets of a trust fund for a series of certificates, the trustee, the servicer, if any, the enhancer and any other service provider generally will be entitled to receive the proceeds of any such sale to the extent of their unpaid fees and other amounts prior to distributions to holders of securities. Upon a sale, the proceeds may be insufficient to pay in full the principal of and interest on the securities of a series.

The amount of liquidation expenses incurred with respect to defaulted loans do not vary directly with the outstanding principal balance of the loan at the time of default. Therefore, assuming that a servicer took the same steps in realizing upon a defaulted loan having a small remaining principal balance as it would in the case of a defaulted loan having a larger principal balance, the amount realized after expenses of liquidation would be smaller as a percentage of the outstanding principal balance of the smaller loan than would be the case with a larger loan. Because the average outstanding principal balances of the loans are small relative to the size of the loans in a typical pool of first mortgages, realizations net of liquidation expenses on defaulted loans may also be smaller as a percentage of the principal amount of the loans than would net realizations in the case of a typical pool of first mortgage loans. The payment of liquidation expenses will reduce the portion of the amount realized that will be available to make payments on the securities and may result in the related securityholders suffering a loss.

Description of the Securities

General

A series of securities issued under this registration statement may consist of any combination of notes, certificates or custody receipts. If notes are issued, they will be issued in series pursuant to an indenture between the related trust fund and the entity named in the related prospectus supplement as trustee with respect to that series. A form of indenture has been filed as an exhibit to the registration statement of which this prospectus forms a part. If certificates are issued, they will also be issued in series pursuant to separate agreements—either a pooling and servicing agreement or a trust agreement among the depositor, the servicer, if the series relates to loans, and the trustee. A form of pooling and servicing agreement and trust agreement have been filed as exhibits to the registration statement of which this prospectus forms a part. If custody receipts are issued, they will be issued in series pursuant to a custody agreement among the depositor and the entity named in the related prospectus supplement as custodian. A form of custody agreement has been filed as an exhibit to the registration statement of which this prospectus forms a part.

The depositor will acquire the primary assets for any series of securities from one or more sellers. The seller will agree to reimburse the depositor for fees and expenses of the depositor incurred in connection with the issuance and offering of the securities.

The following summaries describe provisions in the agreements common to each series of securities. The summaries do not purport to be complete and are subject to, and are qualified in their entirety by reference to, the provisions of the agreements and the prospectus supplement relating to each series of securities. Where particular provisions or terms used in the agreements are referred to, the actual provisions (including definitions of terms) are incorporated herein by reference as part of such summaries. As described herein under “Custody Receipts; Custody Agreements”, custody receipts entitle the related holder of securities to payments that are made on classes of notes held by the custodian. Accordingly, to the extent the following descriptions apply to notes, including the effect that payments on the loans may have on notes that are secured by those loans, those descriptions also apply to custody receipts.

Each series of securities will consist of one or more classes of securities, one or more of which may be Compound Interest Securities, Fixed Interest Securities, Variable Interest Securities, Planned Amortization Class Securities, Zero Coupon Securities, Principal Only Securities, Interest Only Securities, Participating Securities and custody receipts. A series may also include one or more classes of subordinate securities. The securities of each series will be issued only in fully registered form, without coupons, in the authorized denominations for each class specified in the related prospectus supplement. Upon satisfaction of the conditions, if any, applicable to a class of a series, as described in the related prospectus supplement, the transfer of the securities may be registered and the securities may be exchanged at the office of the trustee specified in the prospectus supplement without the payment of any service charge other than any tax or governmental charge payable in connection with the registration of transfer or exchange. One or more classes of a series may be available in book-entry form only.

Payments of principal of and interest on a series of securities will be made on the distribution date to the extent and in the manner specified in the prospectus supplement relating to that series. Payment to holders of securities may be made by check mailed to those holders, registered at the close of business on the related record date specified in the related prospectus supplement at their addresses appearing on the security register, or by wire transfer which may be at the expense of the holder requesting payment by wire transfer. Final payments of principal in retirement of each security will be made only upon presentation and surrender of that security at the office of the trustee specified in the prospectus supplement. Notice of the final payment on a security will be mailed to the holder of that security before the distribution date on which the final principal payment on any security is expected to be made to the holder of that security.

Payments of principal of and interest on the securities will be made by the trustee, by a paying agent on behalf of the trustee or by a custodian, as specified in the related prospectus supplement. As described in the related prospectus supplement, payments with respect to the primary assets for a series, together with reinvestment income thereon, amounts withdrawn from any reserve fund, and amounts available pursuant to any other credit enhancement specified in the prospectus supplement (the “Enhancement”) will be deposited directly into a separate collection account established by the trustee or the servicer. If and as provided in the related prospectus supplement, the deposit to the collection account may be net of amounts payable to the related servicer and any other person specified in the prospectus supplement. Amounts deposited in the collection account will thereafter be deposited into the distribution account so that they are available to make payments on securities of that series on the next distribution date, as the case may be. See “The Trust Funds—Collection and Distribution Accounts.”

Valuation of the Primary Assets

If specified in the related prospectus supplement for a series of notes, each primary asset included in the related trust find for a series will be assigned an initial asset value. As described in the related prospectus supplement, the asset value of the primary assets will be equal to the product of the asset value percentage as set forth in the indenture and the lesser of (a) the stream of remaining regularly scheduled payments on the primary assets, net of amounts payable as expenses described in the prospectus supplement, together with income earned on each scheduled payment received through the day preceding the next distribution date at the Assumed Reinvestment Rate, if any, discounted to present value at the highest interest rate on the notes of that series over periods equal to the interval between payments on the notes, and (b) the then principal balance of the primary assets. The initial asset value of the primary assets will be at least equal to the principal amount of the notes of the related series at the date of issuance thereof or another amount described in the related prospectus supplement.

The “Assumed Reinvestment Rate”, if any, for a series will be the highest rate permitted by the rating agency or a rate insured by means of a surety bond, guaranteed investment contract, deposit agreement or other arrangement satisfactory to the rating agency. If the Assumed Reinvestment Rate is insured, the related prospectus supplement will set forth the terms of that arrangement. Payments of Interest Those securities entitled by their terms to receive interest will bear interest from the date and at the rate per annum specified, or calculated in the method described, in the related prospectus supplement. Interest on interest bearing securities of a series will be payable on the distribution date and in the priority specified in the related prospectus supplement. The rate of interest on securities of a series may be fixed or variable or may change with changes in the annual percentage rates of the loans or underlying loans relating to the private securities, as applicable, included in the related trust fund and/or as prepayments occur with respect to the related loans or underlying loans, as applicable. Principal only securities may not be entitled to receive any interest distributions or may be entitled to receive only nominal interest distributions. Any interest on Zero Coupon Securities that is not paid on the related distribution date will accrue and be added to the principal thereof on that distribution date.

Payments of Principal

On each distribution date for a series, principal payments will be made to the related holders to which principal is then payable, to the extent set forth in the related prospectus supplement. Principal payments will be made in an aggregate amount determined as specified in the related prospectus supplement and will be allocated among the respective classes of a series in the manner, at the times and in the priority, which may, in some specified cases, include allocation by random lot, set forth in the related prospectus supplement. Interest only securities may be assigned a notional amount set forth in the related prospectus supplement which is used solely for convenience for the calculation of interest and for other purposes and does not represent the right to receive any distributions allocable to principal.

Final Scheduled Distribution Date

The final scheduled distribution date with respect to each class of notes and custody receipts is the date no later than the date on which its principal will be fully paid. The final scheduled distribution date with respect to each class of certificates will be the date on which the entire aggregate principal balance of that class is expected to be reduced to zero. The final scheduled distribution date for each class of securities will be calculated on the basis of the assumptions applicable to the related series described in the related prospectus supplement. The final scheduled distribution date for each class of a series will be specified in the related prospectus supplement. The final scheduled distribution date of a class may be the maturity date of the primary asset in the related trust fund which has the latest stated maturity or will be determined as described in the related prospectus supplement.

The actual final distribution date of the securities of a series will depend primarily upon the rate of payment, including prepayments, liquidations due to default, the receipt of proceeds from casualty insurance policies and repurchases, of loans or underlying loans, as applicable, in the related trust fund. Since payments on the primary assets, including prepayments, will be used to make distributions in reduction of the outstanding principal amount of the securities, it is likely that the actual final distribution date of any class will occur earlier, and may occur substantially earlier, than its final scheduled distribution date. Furthermore, with respect to a series of certificates as a result of delinquencies, defaults and liquidations of the primary assets in the trust fund, the actual final distribution date of any certificate may occur later than its final scheduled distribution date. No assurance can be given as to the actual prepayment experience with respect to the primary assets related to a series. See “Weighted Average Life of the Securities” below.

Special Redemption

If so specified in the prospectus supplement relating to a series of securities having distribution dates less frequently than monthly, one or more classes of securities of that series may be subject to special redemption, in whole or in part, on the day specified in the related prospectus supplement. A special redemption may occur if, as a consequence of prepayments on the loans or underlying loans, as applicable, relating to a series of securities or low yields then available for reinvestment, the entity specified in the related prospectus supplement determines, based on assumptions specified in the applicable agreement, that the amount available for the payment of interest is less than the amount of interest that will have accrued on those securities through the designated interest accrual date specified in the related prospectus supplement. In that event and as further described in the related prospectus supplement, the trustee will redeem, prior to the designated interest accrual date, a sufficient principal amount of outstanding securities of that series to cause the available to pay interest to equal the amount of interest that will have accrued on the principal amount that remains outstanding through the designated interest accrual date for the series of securities outstanding immediately after that redemption.

Optional Redemption, Purchase or Termination

The depositor or the servicer may, at its option, redeem, in whole or in part, one or more classes of notes or purchase one or more classes of certificates of any series, on any distribution date under the circumstances, if any, specified in the prospectus supplement relating to that series. Alternatively, if so specified in the related prospectus supplement for a series of certificates, the depositor, the servicer, or another entity designated in the related prospectus supplement may, at its option, cause an early termination of a trust fund by repurchasing all of the primary assets from that trust fund on or after a date specified in the related prospectus supplement, or on or after such time as the aggregate outstanding principal amount of the securities or primary assets, as specified in the related prospectus supplement, is less than the amount or percentage specified in the related prospectus supplement. Notice of a redemption, purchase or termination must be given by the depositor or the trustee prior to the related date.

The redemption, purchase or repurchase price will be set forth in the related prospectus supplement. If specified in the related prospectus supplement, in the event that a REMIC election has been made, the trustee must receive a satisfactory opinion of counsel that the optional redemption, purchase or termination will be conducted so as to constitute a “qualified liquidation” under Section 860F of the Code. In addition, the prospectus supplement may provide other circumstances under which holders of securities of a series could be fully paid significantly earlier than would otherwise be the case if payments or distributions were solely based on the activity of the related primary assets.

Weighted Average Life of the Securities

Weighted average life refers to the average amount of time that will elapse from the date of issue of a security until each dollar of principal of such security will be repaid to the investor. Generally, the weighted average life of the securities of a class will be influenced by the rate at which the amount financed under the loans or underlying loans, as applicable, included in the trust fund for a series is paid, which may be in the form of scheduled amortization or prepayments.

Prepayments on loans and other receivables can be measured relative to a prepayment standard or model. The prospectus supplement for a series of securities will describe the prepayment standard or model, if any, used and may contain tables setting forth the projected weighted average life of each class of securities of that series and the percentage of the original principal amount of each class of securities of that series that would be outstanding on specified distribution dates for that series based on the assumptions stated in such prospectus supplement, including assumptions that prepayments on the loans or underlying loans, as applicable, included in the related trust fund are made at rates corresponding to various percentages of the prepayment standard or model specified in such prospectus supplement.

There is, however, no assurance that prepayment of the loans or underlying loans, as applicable, included in the related trust find will conform to any level of any prepayment standard or model specified in the related prospectus supplement. The rate of principal prepayments on pools of loans is influenced by a variety of economic, demographic, geographic, legal, tax, social and other factors.

The rate of prepayments of conventional housing loans and other receivables has fluctuated significantly in recent years. In general, however, if prevailing interest rates fall significantly below the interest rates on the loans or underlying loans, as applicable, for a series, such loans are likely to prepay at rates higher than if prevailing interest rates remain at or above the interest rates borne by such loans. In this regard, it should be noted that the loans or underlying loans, as applicable, for a series may have different interest rates. In addition, the weighted average life of the securities may be affected by the varying maturities of the loans or underlying loans, as applicable. If any loans or underlying loans, as applicable, for a series have actual terms-to-stated maturity of less than those assumed in calculating the final scheduled distribution date of the related securities, one or more classes of the series may be fully paid prior to their respective final scheduled distribution dates, even in the absence of prepayments and a reinvestment return higher than the Assumed Reinvestment Rate.

The Trust Funds

General

The notes of each series will be secured by the pledge of the assets of the related trust fund, and the certificates of each series will represent interests in the assets of the related trust fund, or in a group of assets specified in the related prospectus supplement. As described under “Custody Receipts; Custody Agreements”, custody receipts entitle the related holders of securities to payments that are made on classes of notes held by the custodian. Accordingly, to the extent the following descriptions apply to notes, including the descriptions of loans that may be primary assets that secure notes, those descriptions also apply to custody receipts. The trust fund of each series will include assets purchased from the seller composed of:
(1) the Primary Assets;
(2) amounts available from the reinvestment of payments on such primary assets at the assumed reinvestment rate, if any, specified in the related prospectus supplement;
(3) any Enhancement for that series;
(4) any property that secured a loan but which is acquired by foreclosure or deed in lieu of foreclosure or repossession; and
(5) the amount, if any, initially deposited in the collection account or distribution account for a series as specified in the related prospectus supplement.

The securities will be non-recourse obligations of the related trust fund. The assets of the trust fund specified in the related prospectus supplement for a series of securities, will serve as collateral only for that series of securities, unless the related prospectus supplement sets forth the other series of securities for which those assets serve as collateral. Holders of a series of notes may only proceed against the collateral securing that series of notes in the case of a default with respect to that series of notes and may not proceed against any assets of the depositor, any of its affiliates or assets of the related trust fund not pledged to secure those notes. The primary assets for a series will be sold by the seller to the depositor or purchased by the depositor in secondary market transactions, in the case of private securities, not from the issuer of such private securities or an affiliate of the issuer, or, in the case of the loans, in privately negotiated transactions, which may include transactions with affiliates of the depositor. The primary assets will be transferred by the depositor to the trust fund. Loans relating to a series will be serviced by the servicer, which may be the seller, specified in the related prospectus supplement, pursuant to a pooling and servicing agreement, with respect to a series of certificates or a servicing agreement between the trust fund and servicer, with respect to a series of notes.

If so specified in the related prospectus supplement, a trust fund relating to a series of securities may be a statutory trust formed under the laws of the state specified in the related prospectus supplement pursuant to a trust agreement between the depositor and the trustee of that trust fund specified in the related prospectus supplement. As used herein, “agreement” means, with respect to a series of certificates, the pooling and servicing agreement or trust agreement, and with respect to a series of notes, the indenture and the servicing agreement, as the context requires. With respect to each trust fund, prior to the initial offering of the related series of securities, the trust fund will have no assets or liabilities. No trust fund is expected to engage in any activities other than acquiring, managing and holding the related primary assets and other assets contemplated herein and in the related prospectus supplement and the proceeds thereof, issuing securities and making payments and distributions to the securities and related activities. No trust fund is expected to have any source of capital other than its assets and any related Enhancement.

Primary assets included in the trust fund for a series may consist of any combination of loans and private securities, to the extent and as specified in the related prospectus supplement. On the closing date, no more than 5% of the primary assets (by aggregate principal balance as of the cut-off date) will have characteristics that deviate from the description of those primary assets in the related prospectus supplement.

The Loans

Mortgage Loans. The property which secures repayment of the loans is referred to as the mortgaged property. The primary assets for a series may consist, in whole or in part, of closed-end and/or revolving home equity loans or balances thereof and/or loans the proceeds of which have been applied to the purchase of the related mortgaged property secured by mortgages primarily on single family properties which may be subordinated to other mortgages on the same mortgaged property. The mortgage loans may have fixed interest rates or variable interest rates and may provide for other payment characteristics as described below and in the related prospectus supplement.

As more fully described in the related prospectus supplement, interest on each revolving credit line loan, may be computed and payable monthly on the average daily outstanding principal balance of the loan. Principal amounts on the revolving credit line loans may be drawn down (up to a maximum amount as set forth in the related prospectus supplement) or repaid under each revolving credit line loan from time to time. If specified in the related prospectus supplement, new draws by borrowers under the revolving credit line loans will automatically become part of the trust fund for a series. As a result, the aggregate balance of the revolving credit line loans will fluctuate from day to day as new draws by borrowers are added to the trust fund and principal payments are applied to the balances on the revolving credit line loans. The amounts of draws and payments on the revolving credit line loans will usually differ each day. The full principal amount of a closed-end loan is advanced at origination of the loan and generally is repayable in equal, or substantially equal, installments of an amount sufficient to fully amortize the loan at its stated maturity. As more fully described in the related prospectus supplement, interest on each loan is calculated on the basis of the outstanding principal balance of the loan multiplied by its loan rate and further multiplied by a fraction described in the related prospectus supplement. The original terms to stated maturity of the loans generally will not exceed 360 months, but may be greater than 360 months if so specified in the related prospectus supplement. If described in the related prospectus supplement, under either a revolving credit line loan or a closed-end loan, a borrower may choose an interest only payment option and is obligated to pay only the amount of interest which accrues on the loan during the billing cycle. An interest only payment option may be available for a specified period before the borrower must begin paying at least the minimum monthly payment of a specified percentage of the average outstanding balance of the loan.

The mortgaged properties will include primarily single family properties, one- to four-family residential housing, including condominium units and cooperative dwellings. The mortgaged properties may consist of detached individual dwellings, individual condominiums, townhouses, duplexes, row houses, individual units in planned unit developments and other attached dwelling units. Each single family property will be located on land owned in fee simple by the borrower or on land leased by the borrower. Attached dwellings may include owner-occupied structures where each borrower owns the land upon which the unit is built, with the remaining adjacent land owned in common or dwelling units subject to a proprietary lease or occupancy agreement in a cooperatively owned apartment building.

The mortgaged properties may include properties containing one to four residential units and no more than three income producing non-residential units. Small Mixed-Use Properties may be owneroccupied or investor properties and the loan purpose may be a refinancing or a purchase.

Mortgages on cooperative dwellings generally consist of a lien on the shares issued by the cooperative dwelling and the proprietary lease or occupancy agreement relating to that cooperative dwelling.

The aggregate principal balance of loans secured by mortgaged properties that are owneroccupied will be disclosed in the related prospectus supplement. The sole basis for a representation that a given percentage of the loans are secured by single family property that is owner-occupied will be either:
(28) the making of a representation by the borrower at origination of the loan either that the underlying mortgaged property will be used by the borrower for a period of at least six months every year or that the mortgagor intends to use the mortgaged property as a primary residence, or
(29) (2) a finding that the address of the underlying mortgaged property is the borrower's mailing address as reflected in the servicer's records.

To the extent specified in the related prospectus supplement, the mortgaged properties may include non-owner-occupied investment properties and vacation and second homes.

The initial combined loan-to-value ratio of a loan is computed in the manner described in the related prospectus supplement and may take into account the amounts of any related senior mortgage loans.

Home Improvement Contracts. The primary assets for a series also may consist, in whole or part, of home improvement installment sales contracts and installment loan agreements originated by a home improvement contractor in the ordinary course of business. As specified in the related prospectus supplement, the home improvement contracts will either be unsecured or secured by the mortgages which are generally subordinate to other mortgages on the same mortgaged property or by purchase money security interest in the home improvements financed thereby. The home improvement contracts may be fully amortizing or provide for a balloon payment, may have fixed interest rates or adjustable interest rates and may provide for other payment characteristics as described below and in the related prospectus supplement.

The home improvements securing the home improvement contracts may include among other things, but are not limited to, replacement windows, house siding, new roofs, swimming pools, satellite dishes, kitchen and bathroom remodeling goods and solar heating panels.

If applicable, the initial loan-to-value ratio of a home improvement contract is computed in the manner described in the related prospectus supplement.

Additional Information. The selection criteria which shall apply with respect to the loans, including, but not limited to, the combined loan-to-value ratios or loan-to-value ratios, as applicable, original terms to maturity and delinquency information, will be specified in the related prospectus supplement.

Some loans may be delinquent as specified in the related prospectus supplement. Loans may be originated by or acquired from an affiliate of the depositor. To the extent provided in the related prospectus supplement, additional loans may be periodically added to the trust fund, or may be removed from time to time if specified asset value tests are met, as described in the related prospectus supplement.

A trust fund may include loans that do not amortize their entire principal balance by their stated maturity in accordance with their terms and require a balloon payment of the remaining principal balance at maturity, as specified in the related prospectus supplement. As further described in the related prospectus supplement, the loans for a series may include loans that do not have a specified stated maturity.

The related prospectus supplement for each series may provide information with respect to the Loans that are primary assets as of the cut-off date specified in such prospectus supplement including, among other things, and to the extent relevant:

(a) the aggregate unpaid principal balance of the loans or the aggregate unpaid principal balance included in the trust fund for the related series;

(b) the range and weighted average loan rate on the loans, and, in the case of adjustable rate loans, the range and weighted average of the current loan rates and the lifetime rate caps, if any;

(c) the range and average outstanding principal balance of the loans;

(d) the weighted average original and remaining term-to-stated maturity of the loans and the range of original and remaining terms-to-stated maturity, if applicable;

(e) the range and weighted average of combined loan-to-value ratios or loan-to-value ratios for the loans, as applicable;

(f) the percentage by outstanding principal balance as of the cut-off date of loans that accrue interest at adjustable or fixed interest rates;

(g) any special hazard insurance policy or bankruptcy bond or other enhancement relating to the loans;

(h) the percentage by outstanding principal balance as of the cut-off date of loans that are secured by mortgaged properties, home improvements or are unsecured;

(i) the geographic distribution of any mortgaged properties securing the loans;

(j) the percentage of loans by outstanding principal balance as of the cut-off date that are secured by single family properties, shares relating to cooperative dwellings, condominium units, investment property and vacation or second homes;

(k) the lien priority of the loans;

(l) the credit limit utilization rate of any revolving credit line loans; and

(m) the delinquency status and year of origination of the loans.

The related prospectus supplement will also specify any other limitations on the types or characteristics of loans for a series.

If information of the nature described above respecting the loans is not known to the depositor at the time the securities are initially offered, approximate or more general information of the nature described above will be provided in the prospectus supplement and additional information will be set forth in a Current Report on Form 8-K to be available to investors on the date of issuance of the related series and will be filed with the SEC within 15 days after the initial issuance of the securities.

Private Securities

General. Primary assets for a series may consist, in whole or in part, of private securities which include:

(n) pass-through certificates representing beneficial interests in underlying loans that are of the type that would otherwise be eligible to be loans; or

(o) collateralized obligations secured by underlying loans.

While the underlying loans will be of a type that would otherwise be eligible to be loans since they will have been part of a prior unrelated securitization they may include underlying loans that are more delinquent or that have been foreclosed.

The pass-through certificates or collateralized obligations will have previously been (1) offered and distributed to the public pursuant to an effective registration statement or (2) purchased in a transaction not involving any public offering from a person who is not an affiliate of the issuer of the private securities at the time of sale nor an affiliate thereof at any time during the three preceding months; provided a period of three years has elapsed since the later of the date the securities were acquired from the issuer or an affiliate thereof. Although individual underlying loans may be insured or guaranteed by the United States or an agency or instrumentality of the United States, they need not be. Private securities will not be insured or guaranteed by the United States or any agency or instrumentality of the United States.

All purchases of private securities for a series by the seller or the depositor will be made in secondary market transactions, not from the issuer of the private securities or any affiliate thereof. As a result, no purchases of private securities offered and distributed to the public pursuant to an effective registration statement will be made by the seller or depositor for at least ninety days after the initial issuance of such private securities. Private securities will have been issued pursuant to a pooling and servicing agreement, a trust agreement or similar agreement (a “PS Agreement”). The seller/servicer of the underlying loans will have entered into the PS Agreement with the trustee under that Agreement (the “PS Trustee”). The PS Trustee, its agent, or a custodian, will possess the underlying loans. The underlying loans will be serviced by a servicer (the “PS Servicer”) directly or by one or more sub-servicers who may be subject to the supervision of the PS Servicer.

The depositor of the private securities (the “PS Depositor”) will be a financial institution or other entity engaged generally in the business of lending; a public agency or instrumentality of a state, local or federal government; or a limited purpose corporation organized for the purpose of, among other things, establishing trusts and acquiring and selling loans to those trusts, and selling beneficial interests in those trusts. If so specified in the prospectus supplement, the PS Depositor may be an affiliate of the depositor. The obligations of the PS Depositor will generally be limited to representations and warranties with respect to the assets conveyed by it to the related trust. The PS Depositor generally will not have guaranteed any of the assets conveyed to the related trust or any of the private securities issued under the PS Agreement but may guarantee those assets if specified in the prospectus supplement.

Distributions of principal and interest will be made on the private securities on the dates specified in the related prospectus supplement. The private securities may be entitled to receive nominal or no principal distributions or nominal or no interest distributions. Principal and interest distributions will be made on the private securities by the PS Trustee or the PS Servicer. Payments on the private securities generally will be distributed directly to the trustee as the registered owner of such private securities. The PS Depositor or the PS Servicer may have the right to repurchase the underlying loans after a specified date or under other circumstances specified in the related prospectus supplement.

The underlying loans may be fixed rate, level payment, filly amortizing loans or adjustable rate loans or loans having balloon or other irregular payment features.

Enhancement Relating To Private Securities. Enhancement in the form of reserve finds, subordination of other private securities issued under the PS Agreement, guarantees, letters of credit, cash collateral accounts, insurance policies or other types of enhancement may be provided with respect to the underlying loans or with respect to the private securities themselves. The type, characteristics and amount of enhancement will be a function of the characteristics of the underlying loans and other factors and will have been established for the private securities on the basis of requirements of the nationally recognized statistical rating organization that rated the private securities. Additional Information. The prospectus supplement for a series for which the primary assets includes private securities will specify on an approximate basis, to the extent relevant and to the extent the information is reasonably available to the depositor and the depositor reasonably believes the information to be reliable:
(30) the aggregate approximate principal amount and type of the private securities to be included in the trust fund for such series;
(31) characteristics of the underlying loans including:
   (A) the payment features of the underlying loans—i.e., whether they are fixed rate or adjustable rate and whether they provide for fixed level payments or other payment features,
   (B) the approximate aggregate principal balance, if known, of the underlying loans insured or guaranteed by a governmental entity,
   (C) the servicing fee or range of servicing fees with respect to the underlying loans,
   (D) the minimum and maximum stated maturities of the underlying loans at origination,
   (E) the lien priority and credit utilization rates, if any, of the underlying loans, and
   (F) the delinquency status and year of origination of the underlying loans;
(32) the maximum original term-to-stated maturity of the private securities;
(33) the weighted average term-to-stated maturity of the private securities;
(34) the pass-through or certificate rate or ranges thereof for the private securities;
(35) the PS Sponsor, the PS Servicer and the PS Trustee for the private securities;
(36) the characteristics of enhancement, if any, including reserve finds, insurance policies, letters of credit or guarantees relating to the underlying loans or to the private securities themselves;
(37) the terms on which underlying loans may, or are required to, be purchased prior to their stated maturity or the stated maturity of the private securities; and
(38) the terms on which additional loans may be substituted for those underlying loans originally underlying the private securities.

If information of the nature described above representing the private securities is not known to the depositor at the time the securities are initially offered, approximate or more general information of the nature described above will be provided in the prospectus supplement and the additional information, if available, will be set forth in a Current Report on Form 8-K to be available to investors on the date of issuance of the related series and to be filed with the SEC within 15 days the initial issuance of the securities. Collection and Distribution Accounts A separate collection account will be established by the trustee or the servicer, in the name of the trustee, for each series of securities for receipt of the amount of cash, if any, specified in the related prospectus supplement. The trustee may be required to apply a portion of the amount in the collection account, together with reinvestment earnings from eligible investments to the extent they are not to be included in payments to the holders to the payment of amounts payable to the servicer under the related agreement and any other person specified in the prospectus supplement, and to deposit a portion of the amount in the collection account into a separate account, the distribution account, to be established by the trustee for that series, each in the manner and at the times established in the related prospectus supplement. Amounts available pursuant to any Enhancement, as provided in the related prospectus supplement, will also be deposited in the related distribution account.

Amounts deposited in the distribution account may be available for the following purposes:
(1) application to the payment of principal of and interest on the series of securities on the next distribution date,
(2) the making of adequate provision for future payments on specified classes of securities and
(3) any other purpose specified in the related prospectus supplement.

After applying the funds in the collection account as described above, any funds remaining in the collection account may be paid over to the servicer, the depositor, any provider of Enhancement with respect to the Series or any other person entitled to those amounts in the manner and at the times described in the related prospectus supplement. As described in the related prospectus supplement, the trustee may invest the funds in the collection and distribution accounts in eligible investments maturing, with permissible exceptions, not later, in the case of funds in the collection account, than the day preceding the date such funds are due to be deposited in the distribution account or otherwise distributed and, in the case of funds in the distribution account, not later than the day preceding the next distribution date for the related series of securities. Eligible investments may include, among other investments, obligations of the United States and agencies thereof, federal funds, certificates of deposit, commercial paper, demand and time deposits and banker's acceptances, repurchase agreements of United States government securities and guaranteed investment contracts, in each case, acceptable to the rating agency.

Notwithstanding any of the foregoing, amounts may be deposited and withdrawn pursuant to any deposit agreement or minimum principal payment agreement as specified in the related prospectus supplement.

Enhancement

If stated in the prospectus supplement relating to a series of securities, simultaneously with the depositor's assignment of the primary assets to the trustee, the depositor or the seller will obtain Enhancement in favor of the trustee on behalf of holders of the related series or designated classes of the series. Enhancement may take the form of an irrevocable letter of credit, surety bond or insurance policy, reserve funds, subordinate securities, overcollateralization or any other form of enhancement or combination thereof. The Enhancement will support the payment of principal and interest on the securities, and may be applied for other purposes to the extent and under the conditions set forth in such prospectus supplement. If so specified in the related prospectus supplement, any Enhancement may be structured so as to protect against losses relating to more than one trust fund, in the manner described therein. As described under “Custody Receipts; Custody Agreements”, custody receipts entitle the related holders to payments that are made on classes of notes held by the related custodian. Accordingly, to the extent the following descriptions apply to notes such descriptions apply to custody receipts.

Subordinate Securities

If specified in the related prospectus supplement, Enhancement for a series may consist of one or more classes of subordinate securities. The rights of holders of subordinate securities to receive distributions on any distribution date will be subordinate in right and priority to the rights of holders of senior securities of the series, but only to the extent described in the related prospectus supplement.

Insurance

If stated in the related prospectus supplement, Enhancement for a series may consist of pool insurance policies, special hazard insurance policies, bankruptcy bonds and other types of insurance relating to the primary assets, as described below and in the related prospectus supplement.

Pool Insurance Policy. If so specified in the prospectus supplement relating to a series of securities, the depositor or the seller may obtain a pool insurance policy for the loans in the related trust fund. A pool insurance policy would cover, subject to the limitations described in a related prospectus supplement, any loss sustained by reason of default, but would not cover the portion of the principal balance of any loan that is required to be covered by any primary mortgage insurance policy. The amount and terms of any such coverage will be set forth in the related prospectus supplement.

Special Hazard Insurance Policy. Although the terms of the policies vary to some degree, a special hazard insurance policy typically provides coverage, where there has been damage to property securing a defaulted or foreclosed loan to which title has been acquired by the insured and to the extent the damage is not covered by the standard hazard insurance policy or any flood insurance policy, if applicable, required to be maintained with respect to the property, or in connection with partial loss resulting from the application of the coinsurance clause in a standard hazard insurance policy. Typically, the special hazard insurer will pay the lesser of (1) the cost of repair or replacement of such property or (2) upon transfer of the property to the special hazard insurer, the unpaid principal balance of the loan at the time of acquisition of the property by foreclosure or deed in lieu of foreclosure, plus accrued interest to the date of claim settlement and expenses incurred by the servicer with respect to the property. If the unpaid principal balance plus accrued interest and expenses is paid by the special hazard insurer, the amount of further coverage under the special hazard insurance policy will be reduced by that amount less any net proceeds from the sale of the property. Any amount paid as the cost of repair of the property will reduce coverage by that amount. Special hazard insurance policies typically do not cover losses occasioned by, among other risks, war, civil insurrection, governmental actions, errors in design, faulty workmanship or materials, nuclear reaction, flood, if the mortgaged property is in a federally designated flood area and chemical contamination.

Restoration of the property with the proceeds described under (1) above is expected to satisfy the condition under any pool insurance policy that the property be restored before a claim under the pool insurance policy may be validly presented with respect to the defaulted loan secured by the property. The payment described under (2) above will render unnecessary presentation of a claim in respect of the loan under any pool insurance policy. Therefore, so long as the pool insurance policy remains in effect, the payment by the special hazard insurer of the cost of repair or of the unpaid principal balance of the related loan plus accrued interest and expenses will not affect the total insurance proceeds paid to holders of the securities, but will affect the relative amounts of coverage remaining under the special hazard insurance policy and pool insurance policy.

Bankruptcy Bond. In the event of a bankruptcy of a borrower, the bankruptcy court may establish the value of the property securing the related loan at an amount less than the then outstanding principal balance of the loan. The amount of the secured debt could be reduced to the value established by the bankruptcy court, and the holder of the loan thus would become an unsecured creditor to the extent the outstanding principal balance of the loan exceeds that value. In addition, other modifications of the terms of a loan can result from a bankruptcy proceeding. See “Legal Aspects of Loans.” If so provided in the related prospectus supplement, the depositor, the seller or other entity specified in the related prospectus supplement will obtain a bankruptcy bond or similar insurance contract covering losses resulting from proceedings with respect to borrowers under the Bankruptcy Code. The bankruptcy bond will cover a portion of losses resulting from a reduction by a bankruptcy court of scheduled payments of principal of and interest on a loan or a reduction by that court of the principal amount of a loan and will cover a portion of unpaid interest on the amount of that principal reduction from the date of the filing of a bankruptcy petition.

The bankruptcy bond will provide coverage in the aggregate amount specified in the related prospectus supplement for all loans in the trust fund for that series. The amount of coverage will be 18 reduced by payments made under the bankruptcy bond in respect of the loans, and may or may not be restored, as described in the related prospectus supplement.

Reserve Funds

If so specified in the related prospectus supplement, the depositor or the seller will deposit into one or more funds to be established with the trustee as part of the trust fund for the series or for the benefit of any enhancer with respect to that series cash, a letter or letters of credit, cash collateral accounts, eligible investments, or other instruments meeting the criteria of the rating agency rating any series of the securities in the amount specified in the related prospectus supplement. In the alternative or in addition to that deposit, a reserve fund for a series may be funded over time through the application of all or a portion of the excess cash flow from the primary assets for the series, to the extent described in the related prospectus supplement. If applicable, the initial amount of the reserve fund and the reserve fund maintenance requirements for a series of securities will be described in the related prospectus supplement.

Amounts withdrawn from any reserve fund will be applied by the trustee to make payments on the securities of a series, to pay expenses, to reimburse any enhancer or for any other purpose, in the manner and to the extent specified in the related prospectus supplement.

Amounts deposited in a reserve fund will be invested by the trustee, in eligible investments maturing no later than the day specified in the related prospectus supplement.

Minimum Principal Payment Agreement

If stated in the prospectus supplement relating to a series of securities, the depositor or the seller will enter into a minimum principal payment agreement with an entity meeting the criteria of the rating agency pursuant to which that entity will provide payments on the securities of the series in the event that aggregate scheduled principal payments and/or prepayments on the primary assets for that series are not sufficient to make payments on the securities of that series, all as provided in the prospectus supplement.

Deposit Agreement

If specified in a prospectus supplement, the depositor or the seller and the trustee for a series of securities will enter into a guaranteed investment contract or an investment agreement with the entity specified in such prospectus supplement on or before the sale of that series of securities. Pursuant to the deposit agreement, all or a portion of the amounts held in the collection account, the distribution account or in any reserve fund would be invested with the entity specified in the prospectus supplement. The purpose of a deposit agreement would be to accumulate available cash for investment so that the cash, together with income thereon, can be applied to future distributions on one or more classes of securities. The trustee would be entitled to withdraw amounts invested pursuant to a deposit agreement, plus interest at a rate equal to the assumed reinvestment rate, in the manner specified in the prospectus supplement. The prospectus supplement for a series of securities pursuant to which a deposit agreement is used will contain a description of the terms of such deposit agreement.

Derivative Products

If specified in the related prospectus supplement, the depositor or the seller may establish one or more derivative products to provide enhancement for the related series of securities. Derivative products may consist of a swap to convert floating or fixed rate payments, as applicable on the loans or private securities into fixed or floating rate payments, as applicable, on the securities or in a cap or floor agreement intended to provide protection against changes in floating rates of interest payable on the loans, private securities or the securities.

Other Insurance, Surety Bonds, Guaranties, Letters of Credit and Similar Instruments or Agreements

A trust fund may also include insurance, guaranties, surety bonds, letters of credit or similar arrangements for the purpose of:
(4) maintaining timely payments to holders of securities or providing additional protection against losses on the assets included in such trust fund,
(5) paying administrative expenses or
(6) establishing a minimum reinvestment rate on the payments made in respect of the assets or principal payment rate on the assets.

These arrangements may include agreements under which holders of securities are entitled to receive amounts deposited in various accounts held by the trustee upon the terms specified in the related prospectus supplement.

Servicing of Loans

General

Customary servicing functions with respect to loans comprising the primary assets in a trust fund will be provided by the servicer directly pursuant to the related servicing agreement or pooling and servicing agreement, as the case may be. As described herein under “Custody Receipts; Custody Agreements”, custody receipts entitle the related holders of securities to payments that are made on classes of notes held by the related custodian. Those classes of notes may be secured by loans. Accordingly, the following descriptions of servicing are relevant to holders of securities which are custody receipts.

In performing its functions, the servicer will exercise the same degree of skill and care that it customarily exercises with respect to similar receivables or loans owned or serviced by it. In addition, the servicer, if so specified in the related prospectus supplement, will act as custodian and will be responsible for maintaining custody of the loans and related documentation on behalf of the trustee.

Collection Procedures; Escrow Accounts

The servicer will make reasonable efforts to collect all payments required to be made under the Loans and will, consistent with the terms of the related agreement for a series and any applicable Enhancement, follow those collection procedures as it follows with respect to comparable loans held in its own portfolio. Consistent with the above, the servicer may, in its discretion, (1) waive any assumption fee, late payment charge, or other charge in connection with a loan or (2) to the extent provided in the related agreement, arrange with an obligor a schedule for curing delinquencies by modifying the due dates of scheduled payments on that loan.

If specified in the related prospectus supplement, the servicer, to the extent permitted by law, will establish and maintain escrow or impound accounts with respect to loans in which payments by obligors to pay taxes, assessments, mortgage and hazard insurance premiums, and other comparable items will be deposited. Loans may not require escrow payments under the related loan documents, in which case the servicer would not be required to establish any escrow account with respect to those loans. Withdrawals from the escrow accounts are to be made to effect timely payment of taxes, assessments and mortgage and hazard insurance, to refund to obligors amounts determined to be overages, to pay interest to obligors on balances in the escrow account to the extent required by law, to repair or otherwise protect the property securing the related loan and to clear and terminate the escrow account. The servicer will be responsible for the administration of the escrow accounts and generally will make advances to that account when a deficiency exists therein.

Deposits to and Withdrawals from the Collection Account

The trustee or the servicer will establish a collection account in the name of the trustee. Typically, the collection account will be an account maintained (1) at a depository institution, the long-term unsecured debt obligations of which at the time of any deposit therein are rated by each rating agency rating the securities of that series at levels satisfactory to each rating agency or (2) in an account or accounts the deposits in which are insured to the maximum extent available by the FDIC or which are secured in a manner meeting requirements established by each rating agency.

The funds held in the collection account may be invested, pending remittance to the trustee, in eligible investments. If so specified in the related prospectus supplement, the servicer will be entitled to receive as additional compensation any interest or other income earned on funds in the collection account.

The servicer, the depositor, the trustee or the seller, as appropriate, will deposit into the collection account for each series on the business day following the closing date any amounts representing scheduled payments due after the related cut-off date but received by the servicer on or before the closing date, and thereafter, within the time-period specified in the related prospectus supplement after the date of receipt thereof, the following payments and collections received or made by it to the extent required to be deposited in to the Collection Account:
(1) All payments on account of principal, including prepayments, on the primary assets;
(2) All payments on account of interest on the primary assets after deducting therefrom, at the discretion of the servicer but only to the extent of the amount permitted to be withdrawn or withheld from the collection account in accordance with the related agreement, the servicing fee in respect of those primary assets;
(3) All amounts received by the servicer in connection with the liquidation of primary assets or property acquired in respect thereof, whether through foreclosure sale, repossession or otherwise, including payments in connection with the primary assets received from the obligor, other than amounts required to be paid or refunded to the obligor pursuant to the terms of the applicable loan documents or otherwise pursuant to law, exclusive of, in the discretion of the servicer, but only to the extent of the amount permitted to be withdrawn from the collection account in accordance with the related agreement, the servicing fee, if any, in respect of the related primary asset;
(4) All proceeds under any title insurance, hazard insurance or other insurance policy covering any primary asset, other than proceeds to be applied to the restoration or repair of the related property or released to the obligor in accordance with the related agreement;
(5) All amounts required to be deposited therein from any applicable reserve fund for that series pursuant to the related agreement;
(6) All advances of delinquent payments of principal of and interest on a loan or other payments specified in the agreement made by the servicer as required pursuant to the related agreement; and
(7) All repurchase prices of any such primary assets repurchased by the depositor, the servicer or the seller, as appropriate, pursuant to the related agreement.

The servicer generally is permitted, from time to time, to make withdrawals from the collection account for each series for the following purposes:
(1) to reimburse itself for advances for that series made by it pursuant to the related agreement to the extent of amounts received on or in respect of particular loans, including, for this purpose, liquidation proceeds and amounts representing proceeds of insurance policies covering the related property, late recoveries of scheduled payments with respect to which any Advance was made;
(2) to the extent provided in the related agreement, to reimburse itself for any advances for that series that the servicer determines in good faith it will be unable to recover from the related primary asset;
(3) to reimburse itself from liquidation proceeds for liquidation expenses and for amounts expended by it in good faith in connection with the restoration of damaged property and, in the event deposited in the collection account and not previously withheld, and to the extent that liquidation proceeds after that reimbursement exceed the outstanding principal balance of the related loan, together with accrued and unpaid interest thereon to the due date for that loan next succeeding the date of its receipt of the liquidation proceeds, to pay to itself out of the excess the amount of any unpaid servicing fee and any assumption fees, late payment charges, or other charges on the related loan;
(4) in the event it has elected not to pay itself the servicing fee out of the interest component of any scheduled payment, late payment or other recovery with respect to a particular loan prior to the deposit of the scheduled payment, late payment or recovery into the collection account, to pay to itself the servicing fee, as adjusted pursuant to the related agreement, from any scheduled payment, late payment or other recovery, to the extent permitted by the related agreement;
(5) to reimburse itself for expenses incurred by and recoverable by or reimbursable to it pursuant to the related agreement;
(6) to pay to the applicable person with respect to each primary asset or REO property acquired in respect thereof that has been repurchased or removed from the trust fund by the depositor, the servicer or the seller pursuant to the related agreement, all amounts received thereon and not distributed as of the date on which the related repurchase price was determined;
(7) to make payments to the trustee of the series for deposit into the distribution account, if any, or for remittance to the holders of the series in the amounts and in the manner provided for in the related agreement; and
(8) to clear and terminate the collection account pursuant to the related agreement.

In addition, if the servicer deposits in the collection account for a series any amount not required to be deposited therein, it may, at any time, withdraw that amount from the collection account.

Advances and Limitations Thereon

The related prospectus supplement will describe the circumstances, if any, under which the servicer will make advances with respect to delinquent payments on loans. If specified in the related prospectus supplement, the servicer will be obligated to make advances, and such obligations may be limited in amount, or may not be activated until a portion of a specified reserve fund is depleted. Advances are intended to provide liquidity and, except to the extent specified in the related prospectus supplement, not to guarantee or insure against losses. Accordingly, any funds advanced are recoverable by the servicer out of amounts received on particular loans which represent late recoveries of principal or interest, proceeds of insurance policies or liquidation proceeds respecting which any advance was made. If an advance is made and subsequently determined to be nonrecoverable from late collections, proceeds of insurance policies, or liquidation proceeds from the related loan, the servicer may be entitled to reimbursement from other funds in the collection account or distribution account, as the case may be, or from a specified reserve fund as applicable, to the extent specified in the related prospectus supplement.

Maintenance of Insurance Policies and Other Servicing Procedures

Standard Hazard Insurance; Flood Insurance. The related prospectus supplement will state whether or not the servicer will be required to maintain or to cause the obligor on each loan to maintain a standard hazard insurance policy providing coverage of the standard form of fire insurance with extended coverage for other hazards as is customary in the state in which the related property is located. If such insurance is required, generally it would provide for coverage at least equal to the applicable state standard form of fire insurance policy with extended coverage for property of the type securing the related loans. In general, the standard form of fire and extended coverage policy will cover physical damage to or destruction of, the related property caused by fire, lightning, explosion, smoke, windstorm, hail, riot, strike and civil commotion, subject to the conditions and exclusions particularized in each policy. Because the standard hazard insurance policies relating to the loans will be underwritten by different hazard insurers and will cover properties located in various states, these policies will not contain identical terms and conditions. The basic terms, however, generally will be determined by state law and generally will be similar. Most standard hazard insurance policies typically will not cover any physical damage resulting from war, revolution, governmental actions, floods and other water-related causes, earth movement, including earthquakes, landslides, and mudflows, nuclear reaction, wet or dry rot, vermin, rodents, insects or domestic animals, theft and, in some cases, vandalism. The foregoing list is merely indicative of uninsured risks and is not intended to be all inclusive. Uninsured risks not covered by a special hazard insurance policy or other form of Enhancement will adversely affect distributions to holders. When a property securing a loan is located in a flood area identified by HUD pursuant to the Flood Disaster Protection Act of 1973, as amended, the servicer will be required to cause flood insurance to be maintained with respect to that property, to the extent available.

The standard hazard insurance policies covering properties securing loans typically will contain a “coinsurance” clause which, in effect, will require the insured at all times to carry hazard insurance of a specified percentage (generally 80% to 90%) of the full replacement value of the property, including the improvements on any property, in order to recover the full amount of any partial loss. If the insured's coverage falls below this specified percentage, the coinsurance clause will provide that the hazard insurer's liability in the event of partial loss will not exceed the greater of (1) the actual cash value (the replacement cost less physical depreciation) of the Property, including the improvements, if any, damaged or destroyed or (2) such proportion of the loss, without deduction for depreciation, as the amount of insurance carried bears to the specified percentage of the full replacement cost of the property and improvements. Since the amount of hazard insurance to be maintained on the improvements securing the loans declines as the principal balances owing thereon decrease, and since the value of the properties will fluctuate in value over time, the effect of this requirement in the event of partial loss may be that hazard insurance proceeds will be insufficient to restore fully the damage to the affected property.

Coverage typically will be in an amount at least equal to the greater of (1) the amount necessary to avoid the enforcement of any co-insurance clause contained in the policy or (2) the outstanding principal balance of the related loan. Coverage may also be in a lesser amount if so described in the related prospectus supplement. The servicer typically will also maintain on REO Property that secured a defaulted loan and that has been acquired upon foreclosure, deed in lieu of foreclosure, or repossession, a standard hazard insurance policy in an amount that is at least equal to the maximum insurable value of the REO Property. However, if so specified in the related prospectus supplement, the servicer may not maintain insurance policies for acquired REO Property. No earthquake or other additional insurance will be required of any obligor or will be maintained on REO Property acquired in respect of a defaulted loan, other than pursuant to such applicable laws and regulations as shall at any time be in force and shall require such additional insurance.

Any amounts collected by the servicer under any policies of insurance, other than amounts to be applied to the restoration or repair of the property, released to the obligor in accordance with normal servicing procedures or used to reimburse the servicer for amounts to which it is entitled to reimbursement, will be deposited in the collection account. In the event that the servicer obtains and maintains a blanket policy insuring against hazard losses on all of the loans, written by an insurer then acceptable to each rating agency which assigns a rating to that series, it will conclusively be deemed to have satisfied its obligations to cause to be maintained a standard hazard insurance policy for each loan or related REO Property. This blanket policy may contain a deductible clause, in which case the servicer will, in the event that there has been a loss that would have been covered by the policy absent the deductible clause, deposit in the collection account the amount of the deductible.

Realization upon Defaulted Loans

The servicer will use its reasonable best efforts to foreclose upon, repossess or otherwise comparably convert the ownership of the properties securing the related loans as come into and continue in default and as to which no satisfactory arrangements can be made for collection of delinquent payments.

In connection with such foreclosure or other conversion, the servicer will follow the practices and procedures it deems necessary or advisable and normal and usual in its servicing activities with respect to comparable loans serviced by it. However, the servicer will not be required to expend its own funds in connection with any foreclosure or towards the restoration of the property unless it determines that:
(1) such restoration or foreclosure will increase the Liquidation Proceeds in respect of the related Loan available to the holders after reimbursement to itself for such expenses and
(2) such expenses will be recoverable by it either through liquidation proceeds or the proceeds of insurance.

Notwithstanding anything to the contrary herein, in the case of a trust fund for which a REMIC election has been made, the servicer shall liquidate any property acquired through foreclosure within three years after the acquisition of the beneficial ownership of that property. While the holder of a property acquired through foreclosure can often maximize its recovery by providing financing to a new purchaser, the trust fund, if applicable, will have no ability to do so and neither the servicer nor the Depositor will be required to do so.

The servicer may arrange with the obligor on a defaulted loan, a modification of that loan to the extent provided in the related prospectus supplement. Modifications may only be entered into if they meet the underwriting policies and procedures employed by the servicer in servicing receivables for its own account.

Enforcement of Due-On-Sale Clauses

Unless otherwise specified in the related prospectus supplement for a series, when any property is about to be conveyed by the obligor, the servicer will, to the extent it has knowledge of the prospective conveyance and prior to the time of the consummation of that conveyance, exercise its rights to accelerate the maturity of the related loan under the applicable “due-on-sale” clause, if any, unless it reasonably believes that the “due-on-sale” clause is not enforceable under applicable law or if the enforcement of that clause would result in loss of coverage under any primary mortgage insurance policy. In that event, the servicer is authorized to accept from or enter into an assumption agreement with the person to whom the property has been or is about to be conveyed, pursuant to which that person becomes liable under the loan and pursuant to which the original obligor is released from liability and that person is substituted as the obligor under the loan. Any fee collected in connection with an assumption will be retained by the servicer as additional servicing compensation. The terms of a loan may not be changed in connection with an assumption.

Servicing Compensation and Payment of Expenses

The servicer will be entitled to a periodic fee as servicing compensation in an amount to be determined as specified in the related prospectus supplement. The servicing fee may be fixed or variable, as specified in the related prospectus supplement. In addition, unless otherwise specified in the related prospectus supplement, the servicer will be entitled to servicing compensation in the form of assumption fees, late payment charges and similar items, or excess proceeds following disposition of property in connection with defaulted loans.

When an obligor makes a principal prepayment in full between due dates on the related loan, the obligor will generally be required to pay interest on the amount prepaid only to the date of prepayment. To the extent provided in the related prospectus supplement, the amount of the servicing fee may be reduced to the extent necessary to include in the servicer's remittance to the trustee for deposit into the distribution account an amount equal to one month's interest on the related loan (less the servicing fee). If the aggregate amount of prepayment interest shortfalls in a month exceeds the servicing fee for that month, a shortfall to holders may occur.

To the extent permitted by the related agreement, the servicer will be entitled to reimbursement for expenses incurred by it in connection with the liquidation of defaulted loans. The related holders will suffer no loss by reason of liquidation expenses to the extent expenses are covered under related insurance policies or from excess liquidation proceeds. If claims are either not made or not paid under the applicable insurance policies or if coverage thereunder has been exhausted, the related holders will suffer a loss to the extent that liquidation proceeds, after reimbursement of the servicer's expenses, are less than the outstanding principal balance of and unpaid interest on the related loan which would be distributable to holders. In addition, the servicer will be entitled to reimbursement of expenditures incurred by it in connection with the restoration of property securing a defaulted loan, prior to the rights of the holders to receive any related proceeds of insurance policies, liquidation proceeds or amounts derived from other Enhancement. The servicer generally is also entitled to reimbursement from the collection account for advances in respect of loans.

The rights of the servicer to receive funds from the collection account for a series, whether as the servicing fee or other compensation, or for the reimbursement of advances, expenses or otherwise, are not subordinate to the rights of holders of the series.

Evidence as to Compliance

The applicable agreement for each series will provide that each year, a firm of independent public accountants will furnish a statement to the trustee to the effect that such firm has examined documents and records relating to the servicing of the loans by the servicer and that, on the basis of such examination, that firm is of the opinion that the servicing has been conducted in compliance with the agreement, except for (1) those exceptions as such firm believes to be immaterial and (2) such other exceptions as are set forth in the statement.

If so specified in the related prospectus supplement, the applicable agreement for each series will also provide for delivery to the trustee for such series of an annual statement signed by an officer of the servicer to the effect that the servicer has fulfilled its obligations under the agreement, throughout the preceding calendar year.

Certain Matters Regarding the Servicer

The servicer for each series will be identified in the related prospectus supplement. The servicer may be an affiliate of the depositor and may have other business relationships with the depositor and its affiliates.

In the event of an Event of Default under either a servicing agreement or a pooling and servicing agreement, the servicer may be replaced by the trustee or a successor servicer. Events of Default and the rights of the trustee upon a default under the agreement for the related series will be described in the related prospectus supplement substantially similar to those described under “The Agreements—Events of Default; Rights Upon Events of Default—Pooling and Servicing Agreement; Servicing Agreement.” The servicer does not have the right to assign its rights and delegate its duties and obligations under the related agreement for each series unless the successor servicer accepting such assignment or delegation:
(1) services similar loans in the ordinary course of its business,
(2) is reasonably satisfactory to the trustee for the related series,
(3) has a net worth of not less than the amount specified in the related prospectus supplement,
(4) would not cause any Rating Agency's rating of the securities for that series in effect immediately prior to the assignment, sale or transfer to be qualified, downgraded or withdrawn as a result of the assignment, sale or transfer and
(5) executes and delivers to the trustee an agreement, in form and substance reasonably satisfactory to the trustee, which contains an assumption by the servicer of the due and punctual performance and observance of each covenant and condition to be performed or observed by the servicer under the related agreement from and after the date of such agreement.
   No assignment will become effective until the trustee or a successor servicer has assumed the servicer's obligations and duties under the related agreement. To the extent that the servicer transfers its obligations to a wholly-owned subsidiary or affiliate, such subsidiary or affiliate need not satisfy the criteria set forth above; however, in that instance, the assigning servicer will remain liable for the servicing obligations under the related agreement. Any entity into which the servicer is merged or consolidated or any successor corporation resulting from any merger, conversion or consolidation will succeed to the servicer's obligations under the related agreement, provided that the successor or surviving entity meets the requirements for a successor servicer set forth above.

Except to the extent otherwise provided therein, each agreement will provide that neither the servicer, nor any director, officer, employee or agent of the servicer, will be under any liability to the related trust fund, the depositor or the holders for any action taken or for failing to take any action in good faith pursuant to the related agreement, or for errors in judgment; provided, however, that neither the servicer nor any person will be protected against any breach of warranty or representations made under the agreement, or the failure to perform its obligations in compliance with any standard of care set forth in such agreement, or liability which would otherwise be imposed by reason of willful misfeasance, bad faith or negligence in the performance of their duties or by reason of reckless disregard of their obligations and duties thereunder. Each agreement will further provide that the servicer and any director, officer, employee or agent of the servicer is entitled to indemnification from the related trust fund and will be held harmless against any loss, liability or expense incurred in connection with any legal action relating to the agreement or the securities, other than any loss, liability or expense incurred by reason of willful misfeasance, bad faith or negligence in the performance of duties thereunder or by reason of reckless disregard of obligations and duties thereunder. In addition, the related agreement will provide that the servicer is not under any obligation to appear in, prosecute or defend any legal action which is not incidental to its servicing responsibilities under the agreement which, in its opinion, may involve it in any expense or liability. The servicer may, in its discretion, undertake any such action which it may deem necessary or desirable with respect to the related agreement and the rights and duties of the parties thereto and the interests of the holders thereunder. In that event, the legal expenses and costs of the action and any liability resulting therefrom may be expenses, costs, and liabilities of the trust fund and the servicer may be entitled to be reimbursed therefor out of the collection account.

The Agreements

The following summaries describe provisions of the agreements. The summaries do not purport to be complete and are subject to, and qualified in their entirety by reference to, the provisions of the agreements. Where particular provisions or terms used in the agreements are referred to, such provisions or terms are as specified in the related agreements. As described herein under “Custody Receipts; Custody Agreements”, custody receipts entitle the related holders of securities to payments that are made on classes of notes held by the related custodian. Accordingly, the following descriptions of agreements, insofar as they relate to notes, are relevant to holders of custody receipts.

Assignment of Primary Assets

General. At the time of issuance of the securities of a series, the depositor will transfer, convey and assign to the trust fund all right, title and interest of the depositor in the primary assets and other property to be transferred to the trust fund for a series. The assignment will include all principal and interest due on or with respect to the primary assets after the cut-off date specified in the related prospectus supplement, (except for the amount or percentage thereof which is not included in the trust 27 fund for the related series). The trustee will, concurrently with the assignment, execute and deliver the securities.

Assignment of Loans. If required by the related prospectus supplement, the depositor will, as to each loan secured by a mortgage, deliver or cause to be delivered to the trustee, or an asset custodian on behalf of the trustee,
the mortgage note endorsed without recourse to the order of the trustee or in blank,
the original mortgage with evidence of recording indicated thereon, (except for any mortgage not returned from the public recording office, in which case a copy of that mortgage will be delivered, together with a certificate that the original of that mortgage was delivered to the recording office) and
an assignment of the mortgage in recordable form.

The trustee, or the asset custodian, will hold the documents in trust for the benefit of the holders of securities.

If required by the related prospectus supplement, the depositor will as to each home improvement contract, deliver or cause to be delivered to the trustee or the asset custodian the original home improvement contract and copies of documents and instruments related to each home improvement contract and, other than in the case of unsecured home improvement contracts, the security interest in the property securing the home improvement contract. In order to give notice of the right, title and interest of holders of securities to the home improvement contracts, the depositor or the seller will cause a UCC-1 financing statement to be executed by the depositor or the seller identifying the trustee as the secured party and identifying all home improvement contracts as collateral. Typically, the home improvement contracts will not be stamped or otherwise marked to reflect their assignment to the trust. Therefore, if, through negligence, fraud or otherwise, a subsequent purchaser were able to take physical possession of the home improvement contracts without notice of the assignment, the interest of holders of securities in the home improvement contracts could be defeated. If specified by the related prospectus supplement, however, the home improvement contracts may be stamped or otherwise marked to reflect their assignment to the trust. See “Legal Aspects of Loans—The Home Improvement Contracts.”

With respect to loans secured by mortgages, if so specified in the related prospectus supplement, the depositor or the seller will, at the time of issuance of the securities, cause assignments to the trustee of the mortgages relating to the loans for a series to be recorded in the appropriate public office for real property records, except in states where, in the opinion of counsel acceptable to the trustee, such recording is not required to protect the trustee's interest in the related loans. If specified in the related prospectus supplement, the depositor will cause assignments of mortgage to be recorded within the time after issuance of the securities as is specified in the related prospectus supplement. If the assignments of mortgage are not so recorded as required, the agreement may, as specified in the related prospectus supplement, require the depositor or the seller to repurchase from the trustee any loan the related mortgage of which is not recorded within the required time, at the price described below with respect to repurchases by reason of defective documentation. The enforcement of the repurchase obligation typically will constitute the sole remedy available to the holders or the trustee for the failure of a mortgage to be recorded. If the agreement for a series does not require that assignments be recorded at closing, the related prospectus supplement will describe the circumstances, if any, under which recordation would be required in the future.

Each loan will be identified in a loan schedule appearing as an exhibit to the related agreement. The loan schedule will specify with respect to each loan: the original principal amount and unpaid principal balance as of the cut-off date; the current interest rate; the current scheduled payment of principal and interest; the maturity date, if any, of the related mortgage note; if the loan is an adjustable rate loan; the lifetime rate cap, if any, and the current index, if applicable.

Assignment of Private Securities. The depositor will cause private securities to be registered in the name of the trustee or its nominee or correspondent. The trustee or its nominee or correspondent will have possession of any certificated private securities. Generally, the trustee will not be in possession of or be assignee of record of any underlying assets for a private security. See “The Trust Funds—Private Securities.” Each private security will be identified in a schedule appearing as an exhibit to the related agreement, which will specify the original principal amount, outstanding principal balance as of the cutoff date, annual pass-through rate or interest rate and maturity date for each private security conveyed to the trust fund. In the agreement, the depositor will represent and warrant to the trustee regarding the private securities:
(1) that the information contained in the private security schedule is true and correct in all material respects;
   that, immediately prior to the conveyance of the private securities, the depositor had good title thereto to the extent good title was conveyed to it, and was the sole owner thereof subject to any retained interest of the depositor or the seller;
   that there has been no other sale by it of the private securities; and
   that there is no existing lien, charge, security interest or other encumbrance other than any retained interest of the depositor or the seller on the private securities.

Repurchase and Substitution of Non-Conforming Primary Assets. Unless otherwise provided in the related prospectus supplement, if any document in the file relating to the primary assets delivered by the depositor to the trustee or asset custodian is found by the trustee during its examination to be defective in any material respect for which the depositor or seller does not cure the defect within the required time period, the depositor or seller will within the required period, after the trustee's notice to the depositor or the seller, as the case may be, of the defect, repurchase the related primary asset or any property acquired in respect thereof from the trustee. The repurchase shall be at a price equal to, unless otherwise specified in the related prospectus supplement, (a) the lesser of (1) the outstanding principal balance of such primary asset and (2) the trust fund's federal income tax basis in the primary asset and (b) accrued and unpaid interest to the date of the next scheduled payment on the primary asset at the rate set forth in the related agreement, (less any unreimbursed advances respecting the primary asset,) provided, however, the purchase price shall not be limited in (1) above to the trust fund's federal income tax basis if the repurchase at a price equal to the outstanding principal balance of the primary asset will not result in any prohibited transaction tax under Section 860F(a) of the Code.

If provided in the related prospectus supplement, the depositor or seller, as the case may be, may, rather than repurchase the primary asset as described above, remove the primary asset from the trust fund and substitute in its place one or more other primary assets provided, however, that (1) with respect to a trust fund for which no REMIC election is made, the substitution must be effected within 120 days of the date of initial issuance of the securities and (2) with respect to a trust fund for which a REMIC election is made, after a specified time period, the trustee must have received a satisfactory opinion of counsel that the substitution will not cause the trust fund to lose its status as a REMIC or otherwise subject the trust fund to a prohibited transaction tax.

Generally, any qualifying substitute primary asset will have, on the date of substitution, the following characteristics:
(1) an outstanding principal balance, after deduction of all scheduled payments due in the month of substitution, not in excess of the outstanding principal balance of the deleted primary asset with the amount of any shortfall to be deposited to the collection account or distribution account in the month of substitution for distribution to holders,
   an interest rate not less than (and not more than 2% greater than) the interest rate of the deleted primary asset,
   a remaining term-to-stated maturity not greater than (and not more than two years less than) that of the deleted primary asset, and
   will comply with all of the representations and warranties set forth in the applicable agreement as of the date of substitution.

The depositor, the seller or another entity will make representations and warranties with respect to primary assets for a series. If the depositor, the seller or the other entity cannot cure a breach of its representations and warranties in all material respects within the time period specified in the related prospectus supplement after notification by the trustee of the breach, and if the breach is of a nature that materially and adversely affects the value of the primary asset, the depositor, the seller or the other entity is obligated to repurchase the affected primary asset or, if provided in the related prospectus supplement, provide a qualifying substitute primary asset therefor, subject to the same conditions and limitations on purchases and substitutions as described above.

The depositor's only source of funds to effect any cure, repurchase or substitution will be through the enforcement of the corresponding obligations of the responsible originator or seller of the primary assets. See “Risk Factors—Limited Assets For Payments—No Recourse To Depositor, Seller Or Servicer.”

The above-described cure, repurchase or substitution obligations generally constitute the sole remedies available to the holders or the trustee for a material defect in a document for a primary asset.

No holder of securities of a series, solely by virtue of that holder's status as a holder, will have any right under the applicable agreement for a series to institute any proceeding with respect to the agreement, unless the holder previously has given to the trustee for that series written notice of default and unless the holders of securities evidencing not less than 51% of the aggregate voting rights of the securities for that series have made written request upon the trustee to institute a proceeding in its own name as trustee thereunder and have offered to the trustee reasonable indemnity, and the trustee for 60 days has neglected or refused to institute any that proceeding.

Pre-Funding Account

If so provided in the related prospectus supplement, on the related closing date the depositor will deposit cash in an amount specified in the related prospectus supplement into a pre-funding account. In no event shall the pre-funded amount exceed 50% of the initial aggregate principal amount of the securities of the related series. The pre-funded amount will be used to purchase subsequent loans during the finding period which is the period from the related closing date to a date not more than one year after the closing date. The pre-funding account will be maintained with the trustee for the related series of securities and will be designed solely to hold funds to be applied by the trustee during the funding period to pay to the seller the purchase price for subsequent loans. Monies on deposit in the pre-funding account will not be available to cover losses on or in respect of the related loans. To the extent that the entire pre-funded amount has not been applied to the purchase of subsequent loans by the end of the related funding period, any amounts remaining in the pre-funding account will be distributed as a prepayment of principal to the holders of the related securities on the distribution date immediately following the end of the funding period, in the amounts and pursuant to the priorities set forth in the related prospectus supplement. Any reinvestment risk resulting from a prepayment will be borne entirely by the classes of the related series of securities entitled to receive the corresponding principal payment. Monies on deposit in the pre-funding account may be invested in eligible investments under the circumstances and in the manner described in the related agreement. Earnings on investment of funds in the pre-funding account will be deposited into the account specified in the related prospectus supplement and losses will be charged against the funds on deposit in the pre-funding account.

In addition, if so provided in the related prospectus supplement, on the related closing date the depositor will deposit in a capitalized interest account cash in an amount sufficient to cover shortfalls in interest on the related series of securities that may arise as a result of the use of funds in the pre-funding account to purchase subsequent loans. The capitalized interest account shall be maintained with the trustee for the related series of securities and is designed solely to cover the above-mentioned interest shortfalls. If monies on deposit in the capitalized interest account have not been applied to cover shortfalls in interest on the related series of securities by the end of the funding period, any amounts remaining in the capitalized interest account will be paid to the depositor or the seller.

Reports to Holders

The trustee or other entity specified in the related prospectus supplement will prepare and forward to each holder on each distribution date, or as soon thereafter as is practicable, a statement setting forth, to the extent applicable to any series, among other things:
(1) the amount of principal distributed to holders of the related securities and the outstanding principal balance of the securities following the distribution;
(2) the amount of interest distributed to holders of the related securities and the current interest on the securities;
(3) the amounts of (a) any overdue accrued interest included in the distribution, (b) any remaining overdue accrued interest with respect to the securities or (c) any current shortfall in amounts to be distributed as accrued interest to holders of the securities;
(4) the amounts of (a) any overdue payments of scheduled principal included in the distribution, (b) any remaining overdue principal amounts with respect to the securities, (c) any current shortfall in receipt of scheduled principal payments on the related primary assets or (d) any realized losses or liquidation proceeds to be allocated as reductions in the outstanding principal balances of the securities;
(5) the amount received under any related Enhancement, and the remaining amount available under the Enhancement;
(6) the amount of any delinquencies with respect to payments on the related primary assets;
(7) the book value of any REO Property acquired by the related trust fund; and
(8) any other information specified in the related Agreement.

In addition, within a reasonable period of time after the end of each calendar year the trustee or other entity will furnish to each holder of record at any time during the calendar year: (a) the aggregate of amounts reported pursuant to (1), (2), and (4)(d) above for such calendar year and (b) the information specified in the related agreement to enable holders to prepare their tax returns including, without limitation, the amount of original issue discount accrued on the securities, if applicable. Information in the distribution date and annual statements provided to the holders will not have been examined and reported upon by an independent public accountant. However, the servicer will provide to the trustee a report by independent public accountants with respect to the servicer's servicing of the loans. See “Servicing of Loans-Evidence as to Compliance.”

Events of Default; Rights upon Event of Default

Pooling And Servicing Agreement; Servicing Agreement. Events of Default under a pooling and servicing agreement or a servicing agreement for each series of certificates relating to loans include, among other things:
(1) any failure by the servicer to deposit amounts in the collection account and distribution account to enable the trustee to distribute to holders of that series any required payment, which failure continues unremedied for the number of days specified in the related prospectus supplement after the giving of written notice of the failure to the servicer by the trustee for that series, or to the servicer and the trustee by the holders of the series evidencing not less than 25% of the aggregate voting rights of the holders for that series,
(2) any failure by the servicer duly to observe or perform in any material respect any other of its covenants or agreements in the applicable agreement which continues unremedied for the number of days specified in the related prospectus supplement after the giving of written notice of that failure to the servicer by the trustee, or to the servicer and the trustee by the holders of the series evidencing not less than 25% of the aggregate voting rights of the holders of that series, and
(3) specified events of insolvency, readjustment of debt, marshalling of assets and liabilities or similar proceedings and actions by the servicer indicating its insolvency, reorganization or inability to pay its obligations.

So long as an Event of Default remains unremedied under the applicable agreement for a series of securities relating to the servicing of loans, unless otherwise specified in the related prospectus supplement, the trustee for that series or holders of securities of that series evidencing not less than 51% of the aggregate voting rights of the securities for that series may terminate all of the rights and obligations of the servicer as servicer under the applicable agreement, other than its right to recovery of other expenses and amounts advanced pursuant to the terms of that agreement which rights the servicer will retain under all circumstances. Upon the termination of the servicer, the trustee will succeed to all the responsibilities, duties and liabilities of the servicer under the agreement and will be entitled to reasonable servicing compensation not to exceed the applicable servicing fee, together with other servicing compensation in the form of assumption fees, late payment charges or otherwise as provided in the agreement.

In the event that the trustee is unwilling or unable so to act, it may select, or petition a court of competent jurisdiction to appoint, a finance institution, bank or loan servicing institution with a net worth specified in the related prospectus supplement to act as successor servicer under the provisions of the 32 applicable agreement. The successor servicer would be entitled to reasonable servicing compensation in an amount not to exceed the servicing fee as set forth in the related prospectus supplement, together with the other servicing compensation in the form of assumption fees, late payment charges or otherwise, as provided in the agreement.

During the continuance of any Event of Default of a servicer under an agreement for a series of securities, the trustee for that series will have the right to take action to enforce its rights and remedies and to protect and enforce the rights and remedies of the holders of that series, and holders of securities evidencing not less than 51% of the aggregate voting rights of the securities for that series may, if so specified in the related prospectus supplement, direct the time, method and place of conducting any proceeding for any remedy available to the trustee or exercising any trust or power conferred upon that trustee. However, the trustee will not be under any obligation to pursue any remedy or to exercise any of the trusts or powers unless the holders have offered the trustee reasonable security or indemnity against the cost, expenses and liabilities which may be incurred by the trustee in connection with a servicer termination. Also, the trustee may decline to follow any direction if the trustee determines that the action or proceeding so directed may not lawfully be taken or would involve the trustee in personal liability or be unjustly prejudicial to the nonassenting holders.

Indenture. Events of Default under the indenture for each series of notes may include, among other things:
(1) a default for five (5) days or more in the payment of any interest on any note of such series or the default in the payment of the principal of any note at any note's maturity;
(2) failure to perform any other covenant of the depositor or the trust find in the indenture which continues for a period of sixty (60) days after notice thereof is given in accordance with the procedures described in the related prospectus supplement;
(3) any representation or warranty made by the depositor or the trust fund in the indenture or in any certificate or other writing delivered pursuant thereto or in connection therewith with respect to or affecting such series having been incorrect in a material respect as of the time made, and such breach is not cured within sixty (60) days after notice thereof is given in accordance with the procedures described in the related prospectus supplement;
(4) specified events of bankruptcy, insolvency, receivership or liquidation of the depositor or the trust fund; or
(5) any other Event of Default provided with respect to notes of that series.

If an Event of Default with respect to the notes of any series occurs and is continuing, either the trustee or the holders of a majority of the then aggregate outstanding amount of the notes of that series may declare the principal amount, or, if the notes of that series are Zero Coupon Securities, that portion of the principal amount as may be specified in the terms of that series, as provided in the related prospectus supplement, of all the notes of that series to be due and payable immediately. The declaration described above may, under specified circumstances, be rescinded and annulled by the holders of a majority in aggregate outstanding amount of the notes of the series. If, following an Event of Default with respect to any series of notes, the notes of that series have been declared to be due and payable, the trustee may, in its discretion, notwithstanding any acceleration, elect to maintain possession of the collateral securing the notes of that series and to continue to apply distributions on the collateral as if there had been no declaration of acceleration if the collateral continues to provide sufficient finds for the payment of principal of and interest on the notes of that series as they would have become due if there had not been a declaration of acceleration. In addition, the trustee may not sell or otherwise liquidate the collateral securing the notes of a series following an Event of Default, unless:
(a) the holders of 100% of the then aggregate outstanding amount of the notes of the series consent to the sale,
(b) the proceeds of the sale or liquidation are sufficient to pay in full the principal of and accrued interest, due and unpaid, on the outstanding notes of that series at the date of the sale or
(c) the trustee determines that the collateral would not be sufficient on an ongoing basis to make all payments on the notes as those payments would have become due if the notes had not been declared due and payable, and the trustee obtains the consent of the holders of 66⅔% of the then aggregate outstanding amount of the notes of that series.

In the event that one or more classes of a series have the benefit of a security insurance policy, the issuer of the policy will have the right to consent to any sale described above. In the event that the trustee liquidates the collateral in connection with an Event of Default, the indenture provides that the trustee will have a prior lien on the proceeds of any liquidation for unpaid fees and expenses. As a result, upon the occurrence of an Event of Default, the amount available for distribution to the noteholders would be less than would otherwise be the case. However, the trustee may not institute a proceeding for the enforcement of its lien except in connection with a proceeding for the enforcement of the lien of the indenture for the benefit of the holders of the notes after the occurrence of an Event of Default.

Unless otherwise specified in the related prospectus supplement, in the event the principal of the notes of a series is declared due and payable, as described above, the holders of any notes issued at a discount from par may be entitled to receive no more than an amount equal to the unpaid principal amount thereof less the amount of that discount which is unamortized.

Subject to the provisions of the indenture relating to the duties of the trustee, in case an Event of Default shall occur and be continuing with respect to a series of notes, the trustee shall be under no obligation to exercise any of the rights or powers under the indenture at the request or direction of any of the holders of notes of a series, unless the holders offered to the trustee security or indemnity satisfactory to it against the costs, expenses and liabilities which might be incurred by it in complying with such request or direction. Subject to the provisions for indemnification and limitations contained in the indenture, the holders of a majority of the then aggregate outstanding amount of the notes of a series shall have the right to direct the time, method and place of conducting any proceeding for any remedy available to the trustee or exercising any trust or power conferred on the trustee with respect to the notes of that series, and the holders of a majority of the then aggregate outstanding amount of the notes of that series may waive any default with respect thereto, except a default in the payment of principal or interest or a default in respect of a covenant or provision of the indenture that cannot be modified without the waiver or consent of all the holders of the outstanding notes of that series affected thereby.

The Trustee

The identity of the commercial bank, savings and loan association or trust company named as the trustee for each series of securities will be set forth in the related prospectus supplement. The entity serving as trustee may have normal banking relationships with the depositor or the servicer. In addition, for the purpose of meeting the legal requirements of local jurisdictions, the trustee will have the power to appoint co-trustees or separate trustees of all or any part of the trust fund relating to a series of securities. In the event of an appointment, all rights, powers, duties and obligations conferred or imposed upon the trustee by the agreement relating to the related series will be conferred or imposed upon the trustee and each separate trustee or co-trustee jointly, or, in any jurisdiction in which the trustee shall be incompetent or unqualified to perform acts, singly upon the separate trustee or co-trustee who shall exercise and perform such rights, powers, duties and obligations solely at the direction of the trustee. The trustee may also appoint agents to perform any of the responsibilities of the trustee, which agents shall have any or all of the rights, powers, duties and obligations of the trustee conferred on them by that appointment; provided that the trustee shall continue to be responsible for its duties and obligations under the agreement.

Duties of the Trustee

The trustee makes no representations as to the validity or sufficiency of the agreement, the securities or of any primary asset or related documents. If no Event of Default has occurred, the trustee is required to perform only those duties specifically required of it under the agreement. Upon receipt of the various certificates, statements, reports or other instruments required to be furnished to it, the trustee is required to examine them to determine whether they are in the form required by the related agreement; however, the trustee will not be responsible for the accuracy or content of any of the documents furnished by it or the holders to the servicer under the agreement.

The trustee may be held liable for its own negligent action or failure to act, or for its own misconduct; provided, however, that the trustee will not be personally liable with respect to any action taken, suffered or omitted to be taken by it in good faith in accordance with the direction of the holders in an Event of Default. The trustee is not required to expend or risk its own funds or otherwise incur any financial liability in the performance of any of its duties under the agreement, or in the exercise of any of its rights or powers, if it has reasonable grounds for believing that repayment of the finds or adequate indemnity against that risk or liability is not reasonably assured to it.

Resignation of Trustee

The trustee may, upon written notice to the depositor, resign at any time, in which event the depositor or the seller will be obligated to use its best efforts to appoint a successor trustee. If no successor trustee has been appointed and has accepted the appointment within 30 days after giving such notice of resignation, the resigning trustee may petition any court of competent jurisdiction for appointment of a successor trustee.

The trustee may also be removed at any time:
(1) if the trustee ceases to be eligible to continue as such under the agreement,
(2) if the trustee becomes insolvent, or
(3) by the holders of securities evidencing over 50% of the aggregate voting rights of the securities in the trust fund upon written notice to the trustee and to the depositor.
   Any resignation or removal of the trustee and appointment of a successor trustee will not become effective until acceptance of the appointment by the successor trustee.
   Amendment of Agreement

The agreement for each series of securities may be amended by the depositor, the servicer, if any, the trustee and any other party specified in the agreement, without notice to or consent of the holders:
(1) to cure any ambiguity,
(2) to correct any defective provisions or to correct or supplement any provision in the agreement,
(3) to add to the duties of the depositor, the trust fund or servicer,
(4) to add any other provisions with respect to matters or questions arising under the agreement or related Enhancement,
(5) to add or amend any provisions of the agreement as required by a rating agency in order to maintain or improve the rating of the securities, or
(6) to comply with any requirements imposed by the Code;
   provided that any such amendment except pursuant to clause (6) above will not adversely affect in any material respect the interests of any holders of that series, as evidenced by an opinion of counsel or by written confirmation from each rating agency rating the securities that the amendment will not cause a reduction, qualification or withdrawal of the then current rating of the securities. The agreement for each series may also be amended by the trustee, the servicer, if applicable, the depositor and any other party specified in the agreement with respect to that series with the consent of the holders possessing not less than 66⅔% of the aggregate outstanding principal amount of the securities of that series or, if only some classes of that series are affected by the amendment, 66⅔% of the aggregate outstanding principal amount of the securities of each class of that series affected thereby, for the purpose of adding any provisions to or changing in any manner or eliminating any of the provisions of the agreement or modifying in any manner the rights of holders of the series; provided, however, that no amendment may (a) reduce the amount or delay the timing of payments on any security without the consent of the holder of that security or (b) reduce the aforesaid percentage of the aggregate outstanding principal amount of securities of each class, the holders of which are required to consent to any amendment without the consent of the holders of 100% of the aggregate outstanding principal amount of each class of securities affected by that amendment.
   Voting Rights

The related prospectus supplement will set forth the method of determining allocation of voting rights with respect to a series.

List of Holders

Upon written request of three or more holders of record of a series for purposes of communicating with other holders with respect to their rights under the agreement, which request is accompanied by a copy of the communication which the holders propose to transmit, the trustee will afford the holders access during business hours to the most recent list of holders of that series held by the trustee.

No agreement will provide for the holding of any annual or other meeting of holders.

REMIC Administrator

For any series with respect to which a REMIC election is made, preparation of required reports and other administrative duties with respect to the trust fund may be performed by a REMIC administrator, who may be an affiliate of the depositor, the servicer or the seller.

Termination

Pooling and Servicing Agreement; Trust Agreement. The obligations created by the pooling and servicing agreement or trust agreement for a series will terminate upon payment to the provider of any related Enhancement of any required amount and the distribution to holders of all amounts distributable to them pursuant to that agreement after the earlier of:
(6) the later of (a) the final payment or other liquidation of the last primary asset remaining in the trust fund for that series and (b) the disposition of all property acquired upon foreclosure or deed in lieu of foreclosure or repossession in respect of any primary asset or
(7) the repurchase, as described below, by the servicer or other entity specified in the related prospectus supplement from the trustee for all primary assets and other property at that time subject to the agreement.
   The Agreement for each series permits, but does not require, the servicer or other entity specified in the related prospectus supplement to purchase from the trust fund for that series all remaining primary assets at a price equal to the price specified in the related prospectus supplement. The exercise of the right to purchase the primary assets will effect early retirement of the securities of that series, but the entity's right to so purchase is subject to the aggregate principal balance of the primary assets or the securities at the time of repurchase being less than a fixed percentage, to be set forth in the related prospectus supplement, of the aggregate principal balance of the primary assets as of the cut-off date or the securities on the closing date. In no event, however, will the trust created by the agreement continue beyond the expiration of 21 years from the death of the last survivor of the persons identified therein. For each series, the servicer or the trustee, as applicable, will give written notice of termination of the agreement to each holder, and the final distribution will be made only upon surrender and cancellation of the securities at an office or agency specified in the notice of termination. If so provided in the related prospectus supplement for a series, the depositor, the servicer or another entity may effect an optional termination of the trust fund under the circumstances described in such prospectus supplement. See “Description of the Securities—Optional Redemption, Purchase or Termination.”

Indenture. The indenture will be discharged with respect to a series of notes, except with respect to continuing rights, upon the delivery to the trustee for cancellation of all the notes of that series or, with limitations, upon deposit with the trustee of funds sufficient for the payment in full of all of the notes of that series.

In addition to the discharge with limitations, the indenture will provide that, if so specified with respect to the notes of any series, the related trust fund will be discharged from any and all obligations in respect of the notes of that series, except for obligations relating to temporary notes and exchange of notes, to register the transfer of or exchange notes of that series, to replace stolen, lost or mutilated notes of that series, to maintain paying agencies and to hold monies for payment in trust, upon the deposit with the trustee, in trust, of money and/or direct obligations of or obligations guaranteed by the United States of America which through the payment of interest and principal in respect thereof in accordance with their terms will provide money in an amount sufficient to pay the principal of and each installment of interest on the notes of the series on the last scheduled distribution date for the notes and any installment of interest on the notes in accordance with the terms of the indenture and the notes of the series. In the event of any defeasance and discharge of notes of the series, holders of notes of the series would be able to look only to the money and/or direct obligations for payment of principal and interest, if any, on their notes until maturity.

Custody Receipts; Custody Agreements

A series of securities may include one or more classes of custody receipts. Custody receipts entitle the related holders of securities to payments made on notes that are held by a custodian. Such notes will be issued pursuant to an indenture and if the primary assets securing the notes are loans, the loans will be serviced pursuant to a servicing agreement. The custody receipts will be issued pursuant to a custody agreement between the depositor and the custodian. The identity of the commercial bank, savings and loan association or trust company named as custodian for each series of securities that includes custody receipts will be set forth in the related prospectus supplement. The entity serving as custodian may have normal banking relationships with the depositor or servicer.

Payments on notes held by a custodian will be made by the related indenture trustee to the custodian. The custodian will in turn remit to holders of custody receipts, from payments on the notes, the amounts to which those holders are entitled in accordance with the terms of the custody receipts.

If a series of securities includes custody receipts, the related prospectus supplement will describe:
the primary assets that are security for the related notes
the terms of the related notes, and
the terms of the custody receipts.

At the time of issuance of a series of securities that includes one or more classes of custody receipts the depositor will deposit the related notes with the custodian. Such notes will be registered in the name of and held by the custodian in a custody account. The custody account will be required at all times to be maintained as a custodial account in the corporate trust department of the custodian for the benefit of the holders of the custody receipts, separated and segregated on the books of the custodian from all other accounts, funds and property in the possession of the custodian.

The custodian will not have any equitable or beneficial interest in the related notes. The notes held by the custodian will not be available to the custodian for its own use or profit, nor will any note be deemed to be part of the general assets of the custodian. Neither the notes held by the custodian nor the proceeds of the notes will be subject to any right, charge, security interest, lien or claim of any kind in favor of the custodian.

No holder of a custody receipt will have the right to withdraw the related notes from the custody account and the custodian will not deliver the related notes to that holder.

Neither the depositor nor the custodian shall have any obligation to advance its own funds to make any payment to any holder of a custody receipt.

Notices; Voting

Upon receipt from a trustee or servicer under agreements relating to the notes held by the custodian of any notice with respect to a note, the custodian shall promptly transmit a copy of that notice by mail to the holders of the related custody receipts. For that purpose, the holders shall consider the date of the receipt by the custodian of any notice as the record date for the purpose of determining the holders of record to whom notices shall be transmitted. In the event notice requests or requires any vote, action or consent by the holders of a note, the custodian shall within the time period specified in the related prospectus supplement following receipt of that notice, deliver to the holders of the custody receipts of a letter of direction with respect to the vote, action or consent, returnable to the custodian, and the custodian shall vote the notes in accordance with that letter of direction. Any record date established by the notice for purposes specified in the notice shall be the record date for the purpose of determining the holders of record for those purposes. If no record date is established by the related trustee, the date the notice is received by the custodian shall be the record date.

Notwithstanding the above, without the consent of the holders of all of the custody receipts of a series, neither the custodian shall vote nor shall the holders of custody receipts consent to any amendments to the related indenture or any other actions which would reduce the amount of or change the amount or timing or currency of payment on the custody receipts.

Defaults

The custodian will not be authorized to proceed against the servicer or the trustee under any agreement relating to notes held by the custodian in the event of a default under the related servicing agreement or indenture. The custodian also has no power or obligation to assert any of the rights and privileges of the holders of the custody receipts. In the event of any default in payment on the notes or any Event of Default or similar event with respect to the servicer, each holder of a custody receipt will have the right to proceed directly and individually against the issuer or the servicer in whatever manner is deemed appropriate by the holder by directing the custodian to take specific actions on behalf of the holder. A holder of a custody receipt will not be required to act in concert with any holder. The custodian will not be required to take any actions on behalf of holders except upon receipt of reasonable indemnity from those holders for resulting costs and liabilities.

The Custodian

Under the custody agreement, the note custodian will not be liable other than by reason of bad faith or gross negligence in the performance of its duties as are specifically set forth in the custody agreement except in regard to payments under notes received by it for the benefit of the owners and safekeeping of notes, with respect to which it shall be a fiduciary. The custodian will not be liable for any damages resulting from any distribution from the custody account to a holder at the address of record of that holder on the books of the custodian. The custodian will not be liable for any action or inaction by it done in reasonable reliance upon the written advice of its accountants or legal counsel. The custodian may request and rely and shall be fully protected in acting in reliance upon any written notice, request, direction or other document reasonably believed by it to be genuine and to have been signed or presented by the proper party or parties.

Duties of the Custodian

The custodian makes no representations as to the validity or sufficiency of the custody agreement, the securities or of any primary asset or related documents. The custodian is required to perform only those duties specifically required of it under the custody agreement.

The custodian will not be required to expend or risk its own funds or otherwise incur any financial liability in the performance of any of its duties under the custody agreement, or in the exercise of any of its rights or powers, if it has reasonable grounds for believing that repayment of funds or adequate indemnity against the risk or liability is not reasonably assured to it.

Resignation of Custodian

The custodian may, upon written notice to the depositor, resign at any time, in which event the depositor will appoint a successor custodian. If no successor custodian has been appointed and has accepted the appointment within 90 days after giving notice of resignation, the resigning custodian may petition any court of competent jurisdiction for appointment of a successor custodian.

The custodian may also be removed at any time upon 30 days notice from the depositor or by holders of custody receipts evidencing at least 66⅔% of the aggregate voting rights of all custody receipts of the related series.

Any resignation or removal of the custodian and appointment of a successor custodian will not become effective until acceptance of the appointment by the successor custodian.

Amendment of Custody Agreement

As set forth in the applicable agreement, the custody agreement for each series of custody receipts may be amended by the depositor, the servicer, if any, and the custodian with respect to that series, without notice to or consent of the holders:
1. to cure any ambiguity,
2. to correct any defective provisions or to correct or supplement any provision in the custody agreement,
3. to add to the duties of the depositor or the custodian, or
4. to add any other provisions with respect to matters or questions arising under the custody agreement or provided that any such amendment will not adversely affect in any material respect the interests of any holders of such series, as evidenced by an opinion of counsel or by written confirmation from each rating agency that the amendment will not cause a reduction, qualification or withdrawal of the then current rating thereof.
   In addition, the custody agreement for each series may also be amended by the custodian and the depositor with respect to that series with the consent of the holders possessing not less than 66⅔% of the aggregate outstanding principal amount of the custody receipts of each class of that series affected thereby, for the purpose of adding any provisions to or changing in any manner or eliminating any of the provisions of the custody agreement or modifying in any manner the rights of holders of such series; provided, however, that no amendment may (a) reduce the amount or delay the timing of payments on any custody receipt without the consent of the holder of those custody receipts or (b) reduce the required percentage of the aggregate outstanding principal amount of custody receipts of each class, the holders of which are required to consent to any amendment, without the consent of the holders of 100% of the aggregate outstanding principal amount of each class of custody receipts affected thereby.
   Voting Rights

The related prospectus supplement will set forth the method of determining allocation of voting rights with respect to custody receipts included in a series.

Termination of Custody Agreement

The obligations created by the custody agreement for a series will terminate upon the payment in full of the notes held by the custodian and the receipt by holders of custody receipts of all amounts to which they are entitled.

Legal Aspects of Loans

The following discussion contains summaries of the material legal aspects of mortgage loans, home improvement installment sales contracts and home improvement installment loan agreements which are general in nature. Because some legal aspects are governed by applicable state law, which laws may differ substantially, the summaries do not purport to be complete nor reflect the laws of any particular state, nor encompass the laws of all states in which the properties securing the loans are situated. The summaries are qualified in their entirety by reference to the applicable federal and state laws governing the loans.

Mortgages

The loans for a series will, and home improvement contracts for a series may, be secured by either mortgages or deeds of trust or deeds to secure debt, depending upon the prevailing practice in the state in which the property subject to a mortgage loan is located. The filing of a mortgage, deed of trust or deed to secure debt creates a lien or title interest upon the real property covered by such instrument and represents the security for the repayment of an obligation that is customarily evidenced by a promissory note. It is not prior to the lien for real estate taxes and assessments or other charges imposed under governmental police powers and may also be subject to other liens pursuant to the laws of the jurisdiction in which the mortgaged property is located. Priority with respect to those instruments depends on their terms, the knowledge of the parties to the mortgage and generally on the order of recording with the applicable state, county or municipal office. There are two parties to a mortgage, the mortgagor, who is the borrower/property owner or the land trustee, and the mortgagee, who is the lender. Under the mortgage instrument, the mortgagor delivers to the mortgagee a note or bond and the mortgage. In the case of a land trust, there are three parties because title to the property is held by a land trustee under a land trust agreement of which the borrower/property owner is the beneficiary. At origination of a mortgage loan, the borrower executes a separate undertaking to make payments on the mortgage note. A deed of trust transaction normally has three parties, the trustor, who is the borrower/property owner, the beneficiary, who is the lender, and the trustee, a third-party grantee. Under a deed of trust, the trustor grants the property, irrevocably until the debt is paid, in trust, generally with a power of sale, to the trustee to secure payment of the obligation. The mortgagee's authority under a mortgage and the trustee's authority under a deed of trust are governed by the law of the state in which the real property is located, the express provisions of the mortgage or deed of trust, and, in some cases, in deed of trust transactions, the directions of the beneficiary.

Foreclosure on Mortgages

Foreclosure of a mortgage is generally accomplished by judicial action. Generally, the action is initiated by the service of legal pleadings upon all parties having an interest of record in the real property. Delays in completion of the foreclosure occasionally may result from difficulties in locating necessary parties defendant. When the mortgagee's right to foreclosure is contested, the legal proceedings necessary to resolve the issue can be time-consuming and expensive. After the completion of a judicial foreclosure proceeding, the court may issue a judgment of foreclosure and appoint a receiver or other officer to conduct the sale of the property. In some states, mortgages may also be foreclosed by advertisement, pursuant to a power of sale provided in the mortgage. Foreclosure of a mortgage by advertisement is essentially similar to foreclosure of a deed of trust by non-judicial power of sale.

Foreclosure of a deed of trust is generally accomplished by a non-judicial trustee's sale under a specific provision in the deed of trust which authorizes the trustee to sell the property upon any default by the borrower under the terms of the note or deed of trust. In some states, foreclosure also may be accomplished by judicial action in the manner provided for foreclosure of mortgages. In some states, the trustee must record a notice of default and send a copy to the borrower-trustor and to any person who has recorded a request for a copy of a notice of default and notice of sale. In addition, the trustee in some states must provide notice to any other individual having an interest in the real property, including any junior lienholders. If the deed of trust is not reinstated within the applicable cure period, a notice of sale must be posted in a public place and, in most states, published for a specified period of time in one or more newspapers. In addition, some state laws require that a copy of the notice of sale be posted on the property and sent to all parties having an interest of record in the property. The trustor, borrower, or any person having a junior encumbrance on the real estate, may, during a reinstatement period, cure the default by paying the entire amount in arrears plus the costs and expenses incurred in enforcing the obligation. Generally, state law controls the amount of foreclosure expenses and costs, including attorney's fees, which may be recovered by a lender. If the deed of trust is not reinstated, a notice of sale must be posted in a public place and, in most states, published for a specified period of time in one or more newspapers. In addition, some state laws require that a copy of the notice of sale be posted on the property, recorded and sent to all parties having an interest in the real property.

An action to foreclose a mortgage is an action to recover the mortgage debt by enforcing the mortgagee's rights under the mortgage. It is regulated by statutes and rules and subject throughout to the court's equitable powers. Generally, a mortgagor is bound by the terms of the related mortgage note and the mortgage as made and cannot be relieved from his default if the mortgagee has exercised his rights in a commercially reasonable manner. However, since a foreclosure action historically was equitable in nature, the court may exercise equitable powers to relieve a mortgagor of a default and deny the mortgagee foreclosure on proof that either the mortgagor's default was neither willful nor in bad faith or the mortgagee's action established a waiver, fraud, bad faith, or oppressive or unconscionable conduct that would warrant a court of equity to refuse affirmative relief to the mortgagee. In some circumstances, a court of equity may relieve the mortgagor from an entirely technical default where that default was not willful.

A foreclosure action is subject to most of the delays and expenses of other lawsuits if defenses or counter-claims are interposed, sometimes requiring up to several years to complete. Moreover, a noncollusive, regularly conducted foreclosure sale may be challenged as a fraudulent conveyance, regardless of the parties' intent, if a court determines that the sale was for less than fair consideration and that the sale occurred while the mortgagor was insolvent and within one year, or within the state statute of limitations if the trustee in bankruptcy elects to proceed under state fraudulent conveyance law of the filing of bankruptcy. Similarly, a suit against the debtor on the related mortgage note may take several years and, generally, is a remedy alternative to foreclosure, the mortgagee being precluded from pursuing both at the same time.

In the case of foreclosure under either a mortgage or a deed of trust, the sale by the referee or other designated officer or by the trustee is a public sale. However, because of the difficulty potential third party purchasers at the sale have in determining the exact status of title and because the physical condition of the property may have deteriorated during the foreclosure proceedings, it is uncommon for a third party to purchase the property at a foreclosure sale. Rather, it is common for the lender to purchase the property from the trustee or referee for an amount which may be equal to the unpaid principal amount of the mortgage note secured by the mortgage or deed of trust plus accrued and unpaid interest and the expenses of foreclosure, in which event the mortgagor's debt will be extinguished. Alternatively, the lender may purchase for a lesser amount in order to preserve its right against a borrower to seek a deficiency judgment in states where a deficiency judgment is available. Thereafter, subject to the right of the borrower in some states to remain in possession during the redemption period, the lender will assume the burdens of ownership, including obtaining hazard insurance, paying taxes and making those repairs at its own expense as are necessary to render the property suitable for sale. The lender will commonly obtain the services of a real estate broker and pay the broker's commission in connection with the sale of the property. Depending upon market conditions, the ultimate proceeds of the sale of the property may not equal the lender's investment in the property. Any loss may be reduced by the receipt of any mortgage guaranty insurance proceeds.

Environmental Risks

Real property pledged as security to a lender may be subject to unforeseen environmental risks. Under the laws of some states, contamination of a property may give rise to a lien on the property to assure the payment of the costs of clean-up. In several states a lien for the costs of clean-up has priority over the lien of an existing mortgage against such property. In addition, under CERCLA, the EPA may impose a lien on property where EPA has incurred clean-up costs. However, a CERCLA lien is subordinate to pre-existing, perfected security interests.

Under the laws of some states and under CERCLA, it is conceivable that a secured lender may be held liable as an “owner” or “operator” for the costs of addressing releases or threatened releases of hazardous substances at a property, even though the environmental damage or threat was caused by a prior or current owner or operator. CERCLA imposes liability for those costs on any and all “responsible parties,” including owners or operators. However, CERCLA excludes from the definition of “owner or operator” a secured creditor who holds indicia of ownership primarily to protect its security interest but without “actually participating in the management” of the property. Thus, if a lender's activities begin to encroach on the actual management of a contaminated facility or property, the lender may incur liability as an “owner or operator” under CERCLA. Similarly, if a lender foreclosures and takes title to a contaminated facility or property, the lender may incur CERCLA liability in various circumstances, including, but not limited to, when it holds the facility or property as an investment, including leasing the facility or property to third party, or fails to market the property in a timely fashion.

Whether actions taken by a lender would constitute actual participation in the management of a mortgaged property or the business of a borrower so as to render the secured creditor exemption unavailable to a lender has been a matter of judicial interpretation of the statutory language, and court decisions have been inconsistent. In 1990, the Court of Appeals for the Eleventh Circuit suggested that the mere capacity of the lender to influence a borrower's decisions regarding disposal of hazardous substances was sufficient participation in the management of the borrower's business to deny the protection of the secured creditor exclusion to the lender.

This ambiguity appears to have been resolved by the enactment of the Asset Conservation, Lender Liability and Deposit Insurance Protection Act of 1996, which was signed into law by President Clinton on Sept. 30, 1996. The new legislation provides that, in order to be deemed to have participated in the management of a mortgaged property, a lender must actually participate in the operational affairs of the property or the borrower. The legislation also provides that participation in the management of the property does not include “merely having the capacity to influence, or unexercised right to control” operations. Rather, a lender will lose the protection of the secured creditor exclusion only if it exercises decision-making control over the borrower's environmental compliance and hazardous substance handling and disposal practices, or assumes day-to-day management of all operational functions of the mortgaged property. If a lender is or becomes liable, it can bring an action for contribution against any other “responsible parties,” including a previous owner or operator, who created the environmental hazard, but those persons or entities may be bankrupt or otherwise judgment proof. The costs associated with environmental clean-up may be substantial. It is conceivable that clean-up costs arising from the circumstances set forth above would result in a loss to holders.

CERCLA does not apply to petroleum products, and the secured creditor exclusion does not govern liability for cleanup costs under federal laws other than CERCLA, in particular Subtitle I of the federal Resource Conservation and Recovery Act (“RCRA”), which regulates underground petroleum storage tanks other than heating oil tanks. The EPA has adopted a lender liability rule for underground storage tanks under Subtitle I of RCRA. Under that rule, a holder of a security interest in an underground storage tank or real property containing an underground storage tank is not considered an operator of the underground storage tank as long as petroleum is not added to, stored in or dispensed from the tank. In addition, under the Asset Conservation, Lender Liability and Deposit Insurance Protection Act of 1996, the protections accorded to lenders under CERCLA are also accorded to the holders of security interests in underground storage tanks. Liability for clean-up of petroleum contamination may, however, be governed by state law, which may not provide for any specific protection for secured creditors.

Except as otherwise specified in the related prospectus supplement, at the time the loans were originated, no environmental or a very limited environmental assessments of the properties were conducted.

Rights of Redemption

In some states, after a sale pursuant to a deed of trust or foreclosure of a mortgage, the trustor or mortgagor and foreclosed junior lienors are given a statutory period in which to redeem the property from the foreclosure sale. The right of redemption should be distinguished from the equity of redemption, which is a non-statutory right that must be exercised prior to the foreclosure sale. In some states, redemption may occur only upon payment of the entire principal balance of the loan, accrued interest and expenses of foreclosure. In other states, redemption may be authorized if the former borrower pays only a portion of the sums due. The effect of a statutory right of redemption is to diminish the ability of the lender to sell the foreclosed property. The exercise of a right of redemption would defeat the title of any purchaser at a foreclosure sale, or of any purchaser from the lender subsequent to foreclosure or sale under a deed of trust. Consequently, the practical effect of a right of redemption is to force the lender to retain the property and pay the expenses of ownership until the redemption period has run. In some states, there is no right to redeem property after a trustee's sale under a deed of trust.

Junior Mortgages; Rights of Senior Mortgages

The mortgage loans comprising or underlying the primary assets included in the trust fund for a series will be secured by mortgages or deeds of trust which may be second or more junior mortgages to other mortgages held by other lenders or institutional investors. The rights of the trust fund, and therefore the holders, as mortgagee under a junior mortgage, are subordinate to those of the mortgagee under the senior mortgage, including the prior rights of the senior mortgagee to receive hazard insurance and condemnation proceeds and to cause the property securing the mortgage loan to be sold upon default of the mortgagor, thereby extinguishing the junior mortgagee's lien unless the junior mortgagee asserts its subordinate interest in the property in foreclosure litigation and, possibly, satisfies the defaulted senior mortgage. A junior mortgagee may satisfy a defaulted senior loan in full and, in some states, may cure the default and bring the senior loan current, in either event adding the amounts expended to the balance due on the junior loan. In most states, absent a provision in the mortgage or deed of trust, no notice of default is required to be given to a junior mortgagee.

The standard form of the mortgage used by most institutional lenders confers on the mortgagee the right both to receive all proceeds collected under any hazard insurance policy and all awards made in connection with condemnation proceedings, and to apply those proceeds and awards to any indebtedness secured by the mortgage, in the order the mortgagee may determine. Thus, in the event improvements on the property are damaged or destroyed by fire or other casualty, or in the event the property is taken by condemnation, the mortgagee or beneficiary under underlying senior mortgages will have the prior right to collect any insurance proceeds payable under a hazard insurance policy and any award of damages in connection with the condemnation and to apply those amounts to the indebtedness secured by the senior mortgages. Proceeds in excess of the amount of senior mortgage indebtedness, in most cases, may be applied to the indebtedness of a junior mortgage.

Another provision sometimes found in the form of the mortgage or deed of trust used by institutional lenders obligates the mortgagor to pay all taxes and assessments on the property before delinquency and, when due, all encumbrances, charges and liens on the property which appear prior to the mortgage or deed of trust, to provide and maintain fire insurance on the property, to maintain and repair the property and not to commit or permit any waste thereof, and to appear in and defend any action or proceeding purporting to affect the property or the rights of the mortgagee under the mortgage. Upon a failure of the mortgagor to perform any of these obligations, the mortgagee is given the right under some mortgages to perform the obligation itself, at its election, with the mortgagor agreeing to reimburse the mortgagee for any sums expended by the mortgagee on behalf of the mortgagor. All sums so expended by the mortgagee become part of the indebtedness secured by the mortgage.

The form of credit line trust deed or mortgage used by most institutional lenders which make revolving home equity loans typically contains a “future advance” clause, which provides, in essence, that additional amounts advanced to or on behalf of the borrower by the beneficiary or lender are to be secured by the deed of trust or mortgage. The priority of the lien securing any advance made under the clause may depend in most states on whether the deed of trust or mortgage is called and recorded as a credit line deed of trust or mortgage. If the beneficiary or lender advances additional amounts, the advance is entitled to receive the same priority as amounts initially advanced under the trust deed or mortgage, notwithstanding the fact that there may be junior trust deeds or mortgages and other liens which intervene between the date of recording of the trust deed or mortgage and the date of the future advance, and notwithstanding that the beneficiary or lender had actual knowledge of those intervening junior trust deeds or mortgages and other liens at the time of the advance. In most states, the trust deed or mortgage lien securing mortgage loans of the type which includes revolving home equity credit lines applies retroactively to the date of the original recording of the trust deed or mortgage, provided that the total amount of advances under the home equity credit line does not exceed the maximum specified principal amount of the recorded trust deed or mortgage, except as to advances made after receipt by the lender of a written notice of lien from a judgment lien creditor of the trustor.

Anti-Deficiency Legislation and Other Limitations on Lenders

Some states have imposed statutory prohibitions which limit the remedies of a beneficiary under a deed of trust or a mortgagee under a mortgage. In some states, statutes limit the right of the beneficiary or mortgagee to obtain a deficiency judgment against the borrower following foreclosure or sale under a deed of trust. A deficiency judgment is a personal judgment against the former borrower equal in most cases to the difference between the net amount realized upon the public sale of the real property and the amount due to the lender.

Other statutes require the beneficiary or mortgagee to exhaust the security afforded under a deed of trust or mortgage by foreclosure in an attempt to satisfy the full debt before bringing a personal action against the borrower. In other states, the lender may have the option of bringing a personal action against the borrower on the debt without first exhausting the security; however, in some of these states, the lender, following judgment on the personal action, may be deemed to have elected a remedy and may be precluded from exercising remedies with respect to the security. Consequently, the practical effect of the election requirement, when applicable, is that lenders will usually proceed first against the security rather than bringing a personal action against the borrower. Finally, other statutory provisions limit any deficiency judgment against the former borrower following a foreclosure sale to the excess of the outstanding debt over the fair market value of the property at the time of the public sale. The purpose of these statutes is generally to prevent a beneficiary or a mortgagee from obtaining a large deficiency judgment against the former borrower as a result of low or no bids at the foreclosure sale.

In addition to laws limiting or prohibiting deficiency judgments, numerous other statutory provisions, including the federal bankruptcy laws, the federal Soldiers' and Sailors' Relief Act of 1940, and state laws affording relief to debtors, may interfere with or affect the ability of the secured lender to realize upon collateral and/or enforce a deficiency judgment. For example, with respect to federal bankruptcy law, the filing of a petition acts as a stay against the enforcement of remedies for collection of a debt. Moreover, a court with federal bankruptcy jurisdiction may permit a debtor through a Chapter 13 Bankruptcy Code rehabilitative plan to cure a monetary default with respect to a loan on a debtor's residence by paying arrearages within a reasonable time period and reinstating the original loan payment schedule even though the lender accelerated the loan and the lender has taken all steps to realize upon his security—provided no sale of the property has yet occurred—prior to the filing of the debtor's Chapter 13 petition. Some courts with federal bankruptcy jurisdiction have approved plans, based on the particular facts of the reorganization case, that effected the curing of a loan default by permitting the obligor to pay arrearages over a number of years.

Courts with federal bankruptcy jurisdiction have also indicated that the terms of a mortgage loan may be modified if the borrower has filed a petition under Chapter 13. These courts have suggested that permissible modifications may include reducing the amount of each monthly payment, changing the rate of interest, altering the repayment schedule and reducing the lender's security interest to the value of the residence, thus leaving the lender a general unsecured creditor for the difference between the value of the residence and the outstanding balance of the loan. Federal bankruptcy law and limited case law indicate that the foregoing modifications could not be applied to the terms of a loan secured by property that is the principal residence of the debtor. In all cases, the secured creditor is entitled to the value of its security plus post-petition interest, attorney's fees and costs to the extent the value of the security exceeds the debt.

In a Chapter 11 case under the Bankruptcy Code, the lender is precluded from foreclosing without authorization from the bankruptcy court. The lender's lien may be transferred to other collateral and/or be limited in amount to the value of the lender's interest in the collateral as of the date of the bankruptcy. The loan term may be extended, the interest rate may be adjusted to market rates and the priority of the loan may be subordinated to bankruptcy court-approved financing. The bankruptcy court can, in effect, invalidate due-on-sale clauses through confirmed Chapter 11 plans of reorganization.

The Bankruptcy Code provides priority to particular tax liens over the lender's security. This may delay or interfere with the enforcement of rights in respect of a defaulted loan. In addition, substantive requirements are imposed upon lenders in connection with the organization and the servicing of mortgage loans by numerous federal and some state consumer protection laws. The laws include the federal Truth-in-Lending Act, RESPA, Equal Credit Opportunity Act, Fair Credit Billing Act, Fair Credit Reporting Act and related statutes and regulations. These federal laws impose specific statutory liabilities upon lenders who originate loans and who fail to comply with the provisions of the law. In some cases, this liability may affect assignees of the loans.

Due-On-Sale Clauses in Mortgage Loans

Due-on-sale clauses permit the lender to accelerate the maturity of the loan if the borrower sells or transfers, whether voluntarily or involuntarily, all or part of the real property securing the loan without the lender's prior written consent. The enforceability of these clauses has been the subject of legislation or litigation in many states, and in some cases, typically involving single family residential mortgage transactions, their enforceability has been limited or denied. In any event, the Garn-St. Germain Depository Institutions Act of 1982 preempts state constitutional, statutory and case law that prohibits the enforcement of due-on-sale clauses and permits lenders to enforce these clauses in accordance with their terms, subject to exceptions. As a result, due-on-sale clauses have become generally enforceable except in those states whose legislatures exercised their authority to regulate the enforceability of such clauses with respect to mortgage loans that were (1) originated or assumed during the “window period” under the Gam-St. Germain Act which ended in all cases not later than Oct. 15, 1982, and (2) originated by lenders other than national banks, federal savings institutions and federal credit unions. Freddie Mac has taken the position in its published mortgage servicing standards that, out of a total of eleven “window period states,” five states—Arizona, Michigan, Minnesota, New Mexico and Utah—have enacted statutes extending, on various terms and for varying periods, the prohibition on enforcement of due-on-sale clauses with respect to some categories of window period loans. Also, the Gam-St. Germain Act does “encourage” lenders to permit assumption of loans at the original rate of interest or at some other rate less than the average of the original rate and the market rate.

In addition, under federal bankruptcy law, due-on-sale clauses may not be enforceable in bankruptcy proceedings and may be eliminated in any modified mortgage resulting from a bankruptcy proceeding.

Enforceability of Prepayment and Late Payment Fees

Forms of notes, mortgages and deeds of trust used by lenders may contain provisions obligating the borrower to pay a late charge if payments are not timely made, and in some circumstances may provide for prepayment fees or penalties if the obligation is paid prior to maturity. In some states, there are or may be specific limitations upon the late charges which a lender may collect from a borrower for delinquent payments. Some states also limit the amounts that a lender may collect from a borrower as an additional charge if the loan is prepaid. Late charges and prepayment fees are typically retained by servicers as additional servicing compensation.

Equitable Limitations on Remedies

In connection with lenders' attempts to realize upon their security, courts have invoked general equitable principles. The equitable principles are generally designed to relieve the borrower from the legal effect of his defaults under the loan documents. Examples of judicial remedies that have been fathomed include judicial requirements that the lender undertake affirmative and expensive actions to determine the causes of the borrower's default and the likelihood that the borrower will be able to reinstate the loan. In some cases, courts have substituted their judgment for the lender's judgment and have required that lenders reinstate loans or recast payment schedules in order to accommodate borrowers who are suffering from temporary financial disability. In other cases, courts have limited the right of a lender to realize upon his security if the default under the security agreement is not monetary, such as the borrower's failure to adequately maintain the property or the borrower's execution of secondary financing affecting the property. Finally, some courts have been faced with the issue of whether or not federal or state constitutional provisions reflecting due process concerns for adequate notice require that borrowers under security agreements receive notices in addition to the statutorily-prescribed minimums. For the most part, these cases have upheld the notice provisions as being reasonable or have found that, in cases involving the sale by a trustee under a deed of trust or by a mortgagee under a mortgage having a power of sale, there is insufficient state action to afford constitutional protections to the borrower.

Most conventional single-family mortgage loans may be prepaid in full or in part without penalty. The regulations of the Federal Home Loan Bank Board prohibit the imposition of a prepayment penalty or equivalent fee for or in connection with the acceleration of a loan by exercise of a due-on-sale clause. A mortgagee to whom a prepayment in full has been tendered may be compelled to give either a release of the mortgage or an instrument assigning the existing mortgage. The absence of a restraint on prepayment, particularly with respect to mortgage loans having higher mortgage rates, may increase the likelihood of refinancing or other early retirements of such mortgage loans.

Applicability of Usury Laws

Title V provides that state usury limitations shall not apply to all types of residential first mortgage loans originated by particular lenders after Mar. 31, 1980. Similar federal statutes were in effect with respect to mortgage loans made during the first three months of 1980. The Federal Home Loan Bank Board is authorized to issue rules and regulations and to publish interpretations governing implementation of Title V. Title V authorizes any state to reimpose interest rate limits by adopting, before Apr. 1, 1983, a state law, or by certifying that the voters of such state have voted in favor of any provision, constitutional or otherwise, which expressly rejects an application of the federal law. Fifteen states adopted such a law prior to the Apr. 1, 1983 deadline. In addition, even where Title V is not so rejected, any state is authorized by the law to adopt a provision limiting discount points or other charges on mortgage loans covered by Title V.

The Home Improvement Contracts

General

The home improvement contracts, other than those home improvement contracts that are unsecured or secured by mortgages on real estate generally are “chattel paper” or constitute “purchase money security interests” each as defined in the UCC. Pursuant to the UCC, the sale of chattel paper is treated in a manner similar to perfection of a security interest in chattel paper. Under the related agreement, the depositor will transfer physical possession of the contracts to the trustee or a designated custodian or may retain possession of the contracts as custodian for the trustee. In addition, the depositor will make an appropriate filing of a UCC-1 financing statement in the appropriate states to give notice of the trustee's ownership of the contracts. Generally, the contracts will not be stamped or otherwise marked to reflect their assignment from the depositor to the trustee. Therefore, if through negligence, fraud or otherwise, a subsequent purchaser were able to take physical possession of the contracts without notice of such assignment, the trustee's interest in the contracts could be defeated.

Security Interests in Home Improvements

The contracts that are secured by the home improvements financed thereby grant to the originator of such contracts a purchase money security interest in such home improvements to secure all or part of the purchase price of such home improvements and related services. A financing statement generally is not required to be filed to perfect a purchase money security interest in consumer goods. Such purchase money security interests are assignable. In general, a purchase money security interest grants to the holder a security interest that has priority over a conflicting security interest in the same collateral and the proceeds of such collateral. However, to the extent that the collateral subject to a purchase money security interest becomes a fixture, in order for the related purchase money security interest to take priority over a conflicting interest in the fixture, the holder's interest in such home improvement must generally be perfected by a timely fixture filing. In general, under the UCC, a security interest does not exist under the UCC in ordinary building material incorporated into an improvement on land, home improvement contracts that finance lumber, bricks, other types of ordinary building material or other goods that are deemed to lose such characterization, upon incorporation of such materials into the related property, will not be secured by a purchase money security interest in the home improvement being financed.

Enforcement of Security Interest in Home Improvements

So long as the home improvement has not become subject to the real estate law, a creditor can repossess a home improvement securing a contract by voluntary surrender, by “self-help” repossession that is “peaceful” —i.e., without breach of the peace—or, in the absence of voluntary surrender and the ability to repossess without breach of the peace, by judicial process. The holder of a contract must give the debtor a number of days' notice, which varies from 10 to 30 days depending on the state, prior to commencement of any repossession. The UCC and consumer protection laws in most states place restrictions on repossession sales, including requiring prior notice to the debtor and commercial reasonableness in effecting such a sale. The law in most states also requires that the debtor be given notice of any sale prior to resale of the unit that the debtor may redeem it at or before such resale.

Under the laws applicable in most states, a creditor is entitled to obtain a deficiency judgment from a debtor for any deficiency on repossession and resale of the property securing the debtor's loan. However, some states impose prohibitions or limitations on deficiency judgments, and in many cases the defaulting borrower would have no assets with which to pay a judgment.

Other statutory provisions, including federal and state bankruptcy and insolvency laws and general equitable principles, may limit or delay the ability of a lender to repossess and resell collateral or enforce a deficiency judgment.

Consumer Protection Laws

The Holder-in-Due-Course rule of the FTC is intended to defeat the ability of the transferor of a consumer credit contract which is the seller of the goods that gave rise to the transaction and related lenders and assignees to transfer that contract free of notice of claims by the debtor under that contract. The effect of this rule is to subject the assignee of such a contract to all claims and defenses which the debtor could assert against the seller of goods. Liability under this rule is limited to amounts paid under a contract; however, the obligor also may be able to assert the rule to set off remaining amounts due as a defense against a claim brought by the trustee against such obligor. Numerous other federal and state consumer protection laws impose requirements applicable to the origination and lending pursuant to the contracts, including the Truth in Lending Act, the Federal Trade Commission Act, the Fair Credit Billing Act, the Fair Credit Reporting Act, the Equal Credit Opportunity Act, the Fair Debt Collection Practices Act and the Uniform Consumer Credit Code. In the case of some of these laws, the failure to comply with their provisions may affect the enforceability of the related contract.

Applicability of Usury Laws

Title V provides that, subject to the following conditions, state usury limitations shall not apply to any contract which is secured by a first lien on particular kinds of consumer goods. The contracts would be covered if they satisfy specified conditions, among other things, governing the terms of any prepayments, late charges and deferral fees and requiring a 30-day notice period prior to instituting any action leading to repossession of the related unit.

Title V authorized any state to reimpose limitations on interest rates and finance charges by adopting before April 1, 1983 a law or constitutional provision which expressly rejects application of the federal law. Fifteen states adopted such a law prior to the Apr. 1, 1983 deadline. In addition, even where Title V was not so rejected, any state is authorized by the law to adopt a provision limiting discount points or other charges on loans covered by Title V.

Installment Contracts

The Loans may also consist of installment contracts. Under an installment contract the seller, or lender, retains legal title to the property and enters into an agreement with the purchaser, or borrower, for the payment of the purchase price, plus interest, over the term of the contract. Only after full performance by the borrower of the contract is the lender obligated to convey title to the property to the purchaser. As with mortgage or deed of trust financing, during the effective period of the installment contract, the borrower is generally responsible for maintaining the property in good condition and for paying real estate taxes, assessments and hazard insurance premiums associated with the property.

The method of enforcing the rights of the lender under an installment contract varies on a stateby-state basis depending upon the extent to which state courts are willing, or able pursuant to state statute, to enforce the contract strictly according to the terms. The terms of installment contracts generally provide that upon a default by the borrower, the borrower loses his or her right to occupy the property, the entire indebtedness is accelerated, and the buyer's equitable interest in the property is forfeited. In that situation, the lender does not have to foreclose in order to obtain title to the property, although in some cases a quiet title action is in order if the borrower has filed the installment contract in local land records and an ejectment action may be necessary to recover possession. In a few states, particularly in cases of borrower default during the early years of an installment contract, the courts will permit ejectment of the buyer and a forfeiture of his or her interest in the property. However, most state legislatures have enacted provisions by analogy to mortgage law protecting borrowers under installment contracts from the harsh consequences of forfeiture. Under those statutes, a judicial or nonjudicial foreclosure may be required, the lender may be required to give notice of default and the borrower may be granted some grace period during which the installment contract may be reinstated upon fill payment of the default amount and the borrower may have a post-foreclosure statutory redemption right. In other states, courts in equity may permit a borrower with significant investment in the property under an installment contract for the sale of real estate to share in the proceeds of sale of the property after the indebtedness is repaid or may otherwise refuse to enforce the forfeiture clause.

Nevertheless, generally speaking, the lender's procedures for obtaining possession and clear title under an installment contract in a given state are simpler and less time-consuming and costly than are the procedures for foreclosing and obtaining clear title to a property subject to one or more liens.

Servicemembers' Civil Relief Act

Under the Servicemembers' Civil Relief Act, members of all branches of the military on active duty, including draftees and reservists in military service:

(1) are entitled to have interest rates reduced and capped at 6% per annum, on obligations incurred prior to the commencement of military service for the duration of military service,

(2) may be entitled to a stay of proceedings on any kind of foreclosure or repossession action in the case of defaults on such obligations entered into prior to military service for the duration of military service and

(3) may have the maturity of such obligations incurred prior to military service extended, the payments lowered and the payment schedule readjusted for a period of time after the completion of military service.

However, the benefits of (1), (2), or (3) above are subject to challenge by creditors and if, in the opinion of the court, the ability of a person to comply with such obligations is not materially impaired by military service, the court may apply equitable principles accordingly. If a borrower's obligation to repay amounts otherwise due on a loan included in a trust fund for a series is relieved pursuant to the Servicemembers' Civil Relief Act, none of the trust fund, the servicer, the depositor nor the trustee will be required to advance those amounts, and any loss in respect thereof may reduce the amounts available to be paid to the holders of the securities of that series. Typically, any shortfalls in interest collections on loans or underlying loans, as applicable, included in a trust fund for a series resulting from application of the Servicemembers' Civil Relief Act will be allocated to each class of securities of that series that is entitled to receive interest in respect of those loans or underlying loans in proportion to the interest that each class of securities would have otherwise been entitled to receive in respect of those loans or underlying loans had the interest shortfall not occurred.

Consumer Protection Laws

Numerous federal and state consumer protection laws impose substantive requirements upon mortgage lenders in connection with originating, servicing and enforcing loans secured by certain residential properties. Theses laws include the federal Truth-in-Lending Act and Regulation Z promulgated thereunder, RESPA and Regulation B promulgated thereunder, Equal Credit Opportunity Act, Fair Credit Billing Act, Fair Credit Reporting Act and related statutes and regulations. In particular, Regulation Z requires particular disclosures to borrowers regarding terms of the loans; the Equal Credit Opportunity Act and Regulation B promulgated thereunder prohibit discrimination in the extension of credit on the basis of age, race, color, sex, religion, martial status, national origin, receipt of public assistance or the exercise of any right under the Consumer Credit Protection Act; and the Fair Credit Reporting Act regulates the use and reporting of information related to the borrower's credit experience. Provisions of these laws impose specific statutory liabilities upon lenders who fail to comply with them. In addition, violations of such laws may limit the ability of the servicer to collect all or part of the principal of or interest on the loans and could subject the servicer and in some cases its assignees to damages and administrative enforcement.

The loans may be subject to the Home Ownership and Equity Protection Act of 1994, or HOEPA, which amended the Truth in Lending Act as it applies to mortgages subject to HOEPA. HOEPA requires additional disclosures, specifies the timing of such disclosures and limits or prohibits inclusion of particular provisions in mortgages subject to HOEPA. HOEPA also provides that any purchaser or assignee of a mortgage covered by HOEPA, such as the trust find with respect to the loans, is subject to all of the claims and defenses which the borrower could assert against the original lender. The maximum damages that may be recovered under HOEPA from an assignee is the remaining amount of indebtedness plus the total amount paid by the borrower in connection with the loan. If the trust find includes loans subject to HOEPA, it will be subject to all of the claims and defenses which the borrower could assert against the seller. Any violation of HOEPA which would result in such liability would be a breach of the seller's representations and warranties, and the seller would be obligated to cure, repurchase or, if permitted by the agreement, substitute for the loan in question.

The Depositor

General

The depositor was incorporated in the State of Delaware on Jan. 29, 1988, and is a wholly owned subsidiary of Lehman Commercial Paper Inc., which is a wholly-owned subsidiary of Lehman Brothers Inc., a wholly-owned subsidiary of Lehman Brothers Holdings Inc. The depositor's principal executive offices are located at 745 Seventh Avenue, New York, N.Y. 10019. Its telephone number is (212) 526-7000. None of the depositor, Lehman Brothers Holdings Inc., Lehman Commercial Paper Inc., Lehman Brothers Inc., the servicer, the trustee or the seller has guaranteed or is otherwise obligated with respect to the securities of any series.

The depositor will not engage in any activities other than to authorize, issue, sell, deliver, purchase and invest in (and enter into agreements in connection with), and/or to engage in the establishment of one or more trusts which will issue and sell, bonds, notes, debt or equity securities, obligations and other securities and instruments (“Depositor Securities”) collateralized or otherwise secured or backed by, or otherwise representing an interest in, among other things, receivables or pass through certificates, or participations or certificates of participation or beneficial ownership in one or more pools of receivables, and the proceeds of the foregoing, that arise in connection with the following:
(8) the sale or lease of automobiles, trucks or other motor vehicles, equipment, merchandise and other personal property,
(9) credit card purchases or cash advances,
(10) the sale, licensing or other commercial provision of services, rights, intellectual properties and other intangibles,
(11) trade financings,
(12) loans secured by certain first or junior mortgages on real estate,
(13) loans to employee stock ownership plans and
(14) any and all other commercial transactions and commercial, sovereign, student or consumer loans or indebtedness and, in connection therewith or otherwise, purchasing, acquiring, owning, holding, transferring, conveying, servicing, selling, pledging, assigning, financing and otherwise dealing with those receivables, pass-through certificates, or participations or certificates of participation or beneficial ownership. Article Third of the depositor's Certificate of Incorporation limits the depositor's activities to the above activities and related activities, such as credit enhancement with respect to such Depositor Securities, and to any activities incidental to and necessary or convenient for the accomplishment of such purposes. The Certificate of Incorporation of the depositor provides that any Depositor Securities, except for subordinated Depositor Securities, must be rated in one of the four highest categories by a nationally recognized rating agency.
   Use of Proceeds

The depositor will apply all or substantially all of the net proceeds from the sale of each series of securities for one or more of the following purposes:
(15) to purchase the related primary assets,
(16) to repay indebtedness which has been incurred to obtain funds to acquire the primary assets,
(17) to establish any reserve finds described in the related prospectus supplement and
(18) to pay costs of structuring and issuing the securities, including the costs of obtaining Enhancement, if any.

If so specified in the related prospectus supplement, the purchase of the primary assets for a series may be effected by an exchange of securities with the seller of such primary assets.

Federal Income Tax Considerations

The following is a general discussion of certain anticipated material federal income tax consequences of the purchase, ownership and disposition of the securities. This discussion has been prepared with the advice of McKee Nelson LLP as special counsel to the depositor. This discussion is based on authorities that are subject to change or differing interpretations. Any such change or differing interpretation could be applied retroactively. No rulings have been or will be sought from the IRS with respect to any of the matters discussed below, and no assurance can be given that the views of the IRS with respect to those matters will not differ from that described below.

This discussion is directed solely to Security Owners that purchase securities at issuance and hold them as “capital assets” within the meaning of Section 1221 of the Code. The discussion does not purport to cover all federal income tax consequences applicable to particular investors, some of which may be subject to special rules. Investors subject to such special rules include dealers in securities, certain traders in securities, financial institutions, tax-exempt organizations, insurance companies, persons who hold securities as part of a hedging transaction or as a position in a straddle or conversion transaction, persons whose functional currency is not the U.S. dollar, or persons who elect to treat gain recognized on the disposition of a security as investment income under Section 163(d)(4)(B)(iii) of the Code.

In addition, this discussion does not address the state, local or other tax consequences of the purchase, ownership, and disposition of securities. It is recommended a tax advisor be consulted in determining the state, local and other tax consequences of the purchase, ownership, and disposition of securities. Moreover, this discussion may be supplemented by a discussion in the applicable prospectus supplement.

The following terms are used in the discussion below:
“Security Owner,” means any person holding a beneficial ownership interest in securities;
“Code,” means the Internal Revenue Code of 1986, as amended;
“IRS,” means the Internal Revenue Service;
“AFR,” means the applicable federal rate, which is an average of current yields for U.S. Treasury securities with specified ranges of maturities and which is computed and published monthly by the IRS for use in various tax calculations;
“Foreign Person,” means any person other than a U.S. Person; and
“U.S. Person,” means (i) a citizen or resident of the United States; (ii) a corporation (or entity treated as a corporation for tax purposes) created or organized in the United States or under the laws of the United States or of any state thereof, including, for this purpose, the District of Columbia; (iii) a partnership (or entity treated as a partnership for tax purposes) organized in the United States or under the laws of the United States or of any state thereof, including, for this purpose, the District of Columbia (unless provided otherwise by future Treasury regulations); (iv) an estate whose income is includible in gross income for United States income tax purposes regardless of its source; or (v) a trust, if a court within the United States is able to exercise primary supervision over the administration of the trust and one or more U.S. Persons have authority to control all substantial decisions of the trust. Notwithstanding the preceding clause, to the extent provided in Treasury regulations, certain trusts that were in existence on Aug. 20, 1996, that were treated as U.S. Persons prior to such date, and that elect to continue to be treated as U.S. Persons, also are U.S. Persons.
   Types of Securities

This discussion addresses the following four types of securities:
REMIC certificates,
FASIT certificates,
notes issued by a trust, including a trust for which a REIT election has been made, and
trust certificates issued by trusts for which a REMIC or FASIT election is not made.

The prospectus supplement for each series of securities will indicate the tax characterization of each security issued pursuant to that supplement. Set forth below is a general description of each type of tax characterization, with references to more detailed discussions regarding particular securities. The discussions under “—Special Tax Attributes” and“—Backup Withholding” below address all types of securities.

REMIC Certificates Generally.

With respect to each series of REMIC certificates, McKee Nelson LLP will deliver its opinion that, assuming compliance with all provisions of the related trust agreement, the related trust will comprise one or more “REMICs” within the meaning of Section 860D of the Code and the classes of interests offered will be considered to be “regular interests” or “residual interests” in a REMIC within the meaning set out in Section 860G(a) of the Code. The prospectus supplement for REMIC certificates will identify the regular interests and residual interest in the REMIC.

A REMIC may issue one or more classes of regular interests and must issue one and only one class of residual interest. A REMIC certificate representing a regular interest in a REMIC is referred to herein as a “REMIC regular certificate.” REMIC regular certificates generally will be treated for federal income tax purposes as debt instruments issued by the REMIC. The tax treatment of securities treated as debt instruments, including REMIC regular certificates, is discussed under “—Taxation of Securities Treated as Debt Instruments” below. Be aware, however, that although interest income on a debt instrument is normally taken into account under the regular method of accounting, interest accrued on a REMIC regular certificate must be included in income under the accrual method of accounting regardless of the method of accounting used for tax purposes.

A REMIC certificate representing a residual interest in a REMIC is referred to herein as a “REMIC residual certificate” and the owner of a beneficial interest in a REMIC residual certificate as a “Residual Owner.” The tax treatment of REMIC residual certificates is discussed under “—REMIC Residual Certificates” below.

A REMIC is subject to tax at a rate of 100 percent on the net income the REMIC derives from prohibited transactions. In general, a “prohibited transaction” means the disposition of a qualified mortgage other than pursuant to certain specified exceptions, the receipt of income from a source other than a qualified mortgage or certain other permitted investments, the receipt of compensation for services, or gain from the disposition of an asset purchased with the payments on the qualified mortgages for temporary investment pending distribution on the REMIC certificates. The Code also imposes a 100 percent tax on the value of any contribution of assets to the REMIC after the closing date other than pursuant to specified exceptions, and subjects “net income from foreclosure property” to tax at the highest corporate rate. It is not anticipated that any such REMIC will engage in such transactions or receive any such income.

If an entity elects to be treated as a REMIC but fails to comply with one or more of the ongoing requirements of the Code for REMIC status during any taxable year, the entity will not qualify as a REMIC for such year and thereafter. In this event, the entity may be subject to taxation as a separate corporation, and the certificates issued by the entity may not be accorded the status described under “—Special Tax Attributes” below. In the case of an inadvertent termination of REMIC status, the Treasury Department has authority to issue regulations providing relief, however, sanctions, such as the imposition of a corporate tax on all or a portion of the entity's income for the period during which the requirements for REMIC status are not satisfied, may accompany any such relief.

To the extent provided in the applicable prospectus supplement, a certificate may represent not only the ownership of a REMIC regular interest but also an interest in a notional principal contract. This can occur, for instance, if the applicable trust agreement provides that the rate of interest payable by the REMIC on the regular interest is subject to a cap based on the weighted average of the net interest rates payable on the qualified mortgages held by the REMIC. In these instances, the trust agreement may provide for a reserve fund that will be held as part of the trust fund but not as an asset of any REMIC created pursuant to the trust agreement (an “outside reserve fund”). The outside reserve fund would typically be funded from monthly excess cashflow. If the interest payments on a regular interest were limited due to the above-described cap, payments of any interest shortfall due to application of that cap would be made to the regular interest holder to the extent of funds on deposit in the outside reserve fund. For federal income tax purposes, payments from the outside reserve fund will be treated as payments under a notional principal contract written by the owner of the outside reserve fund in favor of the regular interest holders.

FASIT Certificates Generally.

With respect to each series of FASIT certificates, McKee Nelson LLP will deliver its opinion that, assuming compliance with all provisions of the related trust agreement, the related trust will qualify as a “FASIT” within the meaning of Section 860L of the Code. In such case, the certificates will represent one or more classes of FASIT regular interests, which is referred to herein as “FASIT regular certificates,” and a single ownership interest, which is referred to herein as the “Ownership certificate.” The prospectus supplement for FASIT certificates will identify the regular interests and ownership interest in the FASIT.

FASIT regular certificates generally will be treated as debt instruments for federal income tax purposes, and a Security Owner must report income from such certificates under an accrual method of accounting, even if it otherwise would have used another method. The tax treatment of securities treated as debt instruments, including FASIT regular certificates, is discussed under “—Taxation of Securities Treated as Debt Instruments” below.

Certain FASIT regular interests, referred to as “High-Yield Interests,” are subject to special rules. The applicable prospectus supplement will identify those FASIT regular certificates, if any, that are High-Yield Interests. Generally, High-Yield Interests may be held only by domestic “C” corporations, other FASITs, and dealers in securities who hold such interests in inventory. If a securities dealer (other than a domestic “C” corporation) initially acquires a High-Yield Interest as inventory, but later begins to hold it for investment or ceases to be a dealer, the dealer will become subject to an excise tax equal to the income from the High-Yield Interest multiplied by the highest corporate income tax rate. In addition, the transfer of a High-Yield Interest to a disqualified holder will be disregarded for federal income tax purposes, and the transferor will continue to be taxed as the holder of the High-Yield Interest.

The beneficial owner of a High-Yield Interest may not use non-FASIT current losses or net operating loss carryforwards or carrybacks to offset any income derived from the High-Yield Interest, for either regular income tax purposes or alternative minimum tax purposes. In addition, the FASIT provisions contain an anti-abuse rule under which corporate income tax could be imposed on income derived from a FASIT regular certificate that is held by a pass through entity (other than another FASIT) that issues debt or equity securities backed by the FASIT regular certificate that have the same features as High-Yield Interests.

The Ownership certificate in a FASIT must be held by an “eligible corporation” within the meaning of Section 860L(a)(2) of the Code (generally, a domestic, taxable “C” corporation other than a REIT, regulated investment company or cooperative). The tax treatment of Ownership certificates is discussed under “—FASIT Ownership Certificates” below.

Qualification as a FASIT requires ongoing compliance with certain conditions. If a trust for which a FASIT election has been made fails to comply with one or more of the Code's ongoing requirements for FASIT status during any taxable year, the Code provides that its FASIT status may be lost for that year and thereafter. If FASIT status is lost, the treatment of the former FASIT and the interests therein for federal income tax purposes is uncertain. The former FASIT might be treated as a trust, as a separate association taxable as a corporation, or as a partnership. The FASIT regular certificates could be treated as debt instruments for federal income tax purposes or as equity interests in the former FASIT. Although the Code authorizes the Treasury to issue regulations that address situations where a failure to meet the requirements for FASIT status occurs inadvertently and in good faith, such regulations have not yet been issued. It is possible that disqualification relief might be accompanied by sanctions, such as the imposition of a corporate tax on all or a portion of the FASIT's income for a period of time in which the requirements for FASIT status are not satisfied.

On Feb. 7, 2000, the IRS released proposed regulations interpreting the provisions of the Code applicable to FASITs. Subject to certain exceptions, the proposed regulations would become effective at the time the regulations are issued in final form. Accordingly, definitive guidance addressing the qualification of a trust as a FASIT and the tax consequences to beneficial owners of interests in FASITs does not exist.

Issuance of Notes Generally.

For each issuance of notes by a trust (which does not make a REMIC or FASIT election), McKee Nelson LLP will deliver its opinion that, assuming compliance with the trust agreement and the indenture, the notes will constitute debt instruments for federal income tax purposes. No regulations, published rulings, or judicial decisions may exist that discuss the characterization for federal income tax purposes of securities with terms substantially the same as the notes. The depositor and the trustee will agree, and the beneficial owners of notes will agree by their purchase of the notes, to treat the notes as debt for all tax purposes. The tax treatment of securities treated as debt instruments is discussed under “—Taxation of Securities Treated as Debt Instruments” below. If, contrary to the opinion of McKee Nelson LLP, the IRS successfully asserted that the notes were not debt instruments for federal income tax purposes, the notes might be treated as equity interests in the trust, and the timing and amount of income allocable to beneficial owners of those notes might be different than as described under “—Taxation of Securities Treated as Debt Instruments.”

With respect to certain trusts that issue notes, an election may be made to treat the trust as a “real estate investment trust” within the meaning of Section 856(a) of the Code (a “REIT”). In general, a REIT receives certain tax benefits, provided the REIT complies with requirements relating to its assets, its income and its operations, all as further provided in the Code. The classification of the trust issuing notes as a REIT generally will not have any tax consequences for a beneficial owner of a note.

Classification of Trust Certificates Generally.

With respect to each series of trust certificates for which no REMIC or FASIT election is made, McKee Nelson LLP will deliver its opinion (unless otherwise limited by the related prospectus supplement) that, assuming compliance with the trust agreement: (1) the trust will be classified as a trust under applicable Treasury regulations and will not be taxable as a corporation and that each beneficial owner of a certificate will be an owner of the trust under the provisions of subpart E, part I, subchapter J of Chapter 1 of the Code (such a trust is referred to herein as a “Grantor Trust” and to the certificates issued by the trust as “Grantor Trust Certificates”); (2) the trust will be classified as a partnership for federal income tax purposes that is not taxable as a corporation under the taxable mortgage pool rules of Section 7701(i) of the Code or the publicly traded partnership rules of Section 7704 of the Code and that each beneficial owner of a certificate issued by the trust will be a partner in that partnership (such certificates are referred to herein as “Partner Certificates”); or (3) the trust will be classified as either a Grantor Trust or a partnership and that each beneficial owner of specified certificates will be treated as holding indebtedness of that Grantor Trust or partnership. The depositor and the trustee will agree, and the beneficial owners of trust certificates will agree by their purchase of such securities, to treat the trust and the related securities consistent with the manner provided in the related supplement for all tax purposes. The proper characterization of the arrangement involving trust certificates may not be clear, because there may be no authority on closely comparable transactions. For a discussion of the tax treatment of Grantor Trust Certificates, see “—Grantor Trust Certificates” below, for a discussion of the tax treatment of Partner Certificates, see “Partner Certificates” below, and for a discussion of the tax treatment of trust certificates treated as indebtedness, see “Taxation of Securities Treated as Debt Instruments” below.

Taxation of Securities Treated as Debt Instruments

“Debt Securities” in the discussion that follows, means (i) REMIC regular certificates, (ii) FASIT regular certificates, (iii) notes issued by a trust that does not make a REMIC or FASIT election and (iv) specified trust certificates that will be treated as indebtedness. This discussion is based in part on the regulations applicable to original issue discount (the “OID Regulations”) and in part on the provisions of the Tax Reform Act of 1986 (the “1986 Act”). Prospective investors should be 57 aware, however, that the OID Regulations do not adequately address certain issues relevant to prepayable securities, such as the Debt Securities. To the extent that those issues are not addressed in the OID Regulations, the trustee intends to apply the methodology described in the Conference Committee Report to the 1986 Act. No assurance can be provided that the IRS will not take a different position as to those matters not currently addressed by the OID Regulations. Moreover, the OID Regulations include an antiabuse rule allowing the IRS to apply or depart from the OID Regulations where necessary or appropriate to ensure a reasonable tax result because of the applicable statutory provisions. A tax result will not be considered unreasonable under the anti-abuse rule in the absence of a substantial effect on the present value of a taxpayer's tax liability. Prospective investors are advised to consult their own tax advisors as to the discussion therein and the appropriate method for reporting interest and original issue discount (“OID”) with respect to Debt Securities.

Interest Income and OID.

Debt Securities may be treated as having been issued with OID. A debt instrument is issued with OID to the extent its stated redemption price at maturity exceeds its issue price by more than a de minimis amount. Although not clear, the de minimis amount for a class of Debt Securities would appear to equal the product of (1) 0.25 percent, (2) the stated redemption price at maturity of the class and (3) the weighted average maturity of the class, computed by taking into account the prepayment assumption discussed below. A beneficial owner of a Debt Security generally must report de minimis OID with respect to that Debt Security pro rata as principal payments are received, and that income will be capital gain if the Debt Security is held as a capital asset.

For OID purposes, the issue price of a Debt Security generally is the first price at which a substantial amount of that class is sold to the public (excluding bond houses, brokers and underwriters). Although unclear under the OID Regulations, it is anticipated that the trustee will treat the issue price of a Debt Security as to which there is no substantial sale as of the issue date, or that is retained by the depositor, as the fair market value of the class as of the issue date. The issue price of a Debt Security also includes any amount paid by an beneficial owner of that Debt Security for accrued interest that relates to a period before the issue date of the Debt Security, unless the Security Owner elects on its federal income tax return to exclude that amount from the issue price and to recover it on the first distribution date.

The stated redemption price at maturity of a debt instrument includes all payments, other than interest unconditionally payable at fixed intervals of one year or less at either a fixed rate or a variable rate (“Qualified Stated Interest”). Interest is unconditionally payable only if either (1) reasonable legal remedies exist to compel the timely payment of interest or (2) the terms or conditions under which the debt instrument is issued make the late payment or nonpayment of interest a remote likelihood. Because a portion of the interest payable on the Debt Securities may be deferred, it is possible that some or all of such interest may not be treated as unconditionally payable. Nevertheless, for tax information reporting purposes, unless disclosed otherwise in the applicable prospectus supplement, the trustee or other person responsible for tax information reporting will treat all stated interest on each class of Debt Securities as Qualified Stated Interest, provided that class is not an interest-only class, a class the interest on which is not payable currently in all accrual periods (an “accrual class”), or a class the interest on which is substantially disproportionate to its principal amount (a “super-premium class”).

To the extent stated interest payable on a class of Debt Securities, other than a class of REMIC regular certificates or FASIT regular certificates, is Qualified Stated Interest, such interest will be taxable as ordinary income to a Security Owner in accordance with such Security Owner's method of tax accounting. If, however, all or a portion of the stated interest payable on the class of Debt Securities is not Qualified Stated Interest, then the stated interest, or portion thereof, would be included in the Debt Security's stated redemption price at maturity. Qualified Stated Interest payable on a REMIC regular certificate or FASIT regular certificate must be included in the income of the Security Owner under an accrual method of accounting, regardless of the method otherwise used by the Security Owner.

If a Debt Security is issued with OID, a Security Owner will be required to include in income, as ordinary income, the daily portion of such OID attributable to each day it holds such Debt Security. This requirement generally will result in the accrual of income before the receipt of cash attributable to that income.

The daily portion of such OID will be determined on a constant yield to maturity basis in accordance with Section 1272(a)(6) of the Code (the “PAC Method”). Under the PAC Method, the amount of OID allocable to any accrual period for a class of Debt Securities will equal (1) the sum of (i) the adjusted issue price of that class of Debt Securities at the end of the accrual period and (ii) any payments made on that class of Debt Securities during the accrual period of amounts included in the stated redemption price at maturity of that class of Debt Securities, minus (2) the adjusted issue price of that class of Debt Securities at the beginning of the accrual period. The OID so determined is allocated ratably among the days in the accrual period to determine the daily portion for each such day. The trustee will treat the monthly period (or shorter period from the date of original issue) ending on the day before each Distribution Date as the accrual period.

The adjusted issue price of a class of Debt Securities at the beginning of its first accrual period will be its issue price. The adjusted issue price at the end of any accrual period (and, therefore, at the beginning of the subsequent accrual period) is determined by discounting the remaining payments due on that class of Debt Securities at their yield to maturity. The remaining payments due are determined based on the prepayment assumption made in pricing the Debt Securities, but are adjusted to take into account the effect of payments actually made on the trust's assets.

For this purpose, the yield to maturity of a class of Debt Securities is determined by projecting payments due on that class of Debt Securities based on a prepayment assumption made with respect to the trust's assets. The yield to maturity of a class of Debt Securities is the discount rate that, when applied to the stream of payments projected to be made on that class of Debt Securities as of its issue date, produces a present value equal to the issue price of that class of Debt Securities. The Code requires that the prepayment assumption be determined in the manner prescribed in Treasury Department regulations. To date, no such regulations have been issued. The legislative history of this Code provision indicates that the regulations will provide that the assumed prepayment rate must be the rate used by the parties in pricing the particular transaction. The prospectus supplement related to each series will describe the prepayment assumption to be used for tax reporting purposes. No representation, however, is made as to the rate at which principal payments or recoveries on the trust's assets actually will occur.

Under the PAC Method, accruals of OID will increase or decrease (but never below zero) to reflect the fact that payments on the trust's assets are occurring at a rate that is faster or slower than that assumed under the prepayment assumption. If the OID accruing on a class of Debt Securities is negative for any period, a beneficial owner of a Debt Security of that class will be entitled to offset such negative accruals only against future positive OID accruals on that Debt Security.

Variable Rate Securities.

Debt Securities may provide for interest based on a variable rate. The amount of OID for a Debt Security bearing a variable rate of interest will accrue in the manner described under “—Interest Income and OID” above, with the yield to maturity and future payments on that Debt Security generally to be determined by assuming that interest will be payable for the life of the Debt Security based on the initial rate (or, if different, the value of the applicable variable rate as of the pricing date) for that Debt Security. It is anticipated that the trustee will treat interest payable at a variable rate as Qualified Stated Interest, other than variable interest on an interest-only class, super-premium class or accrual class. OID reportable for any period will be adjusted based on subsequent changes in the applicable interest rate index.

Acquisition Premium.

If a Security Owner purchases a Debt Security for a price that is greater that its adjusted issue price but less than its stated redemption price at maturity, the Security Owner will have acquired the Debt Security at an “acquisition premium” as that term is defined in Section 1272(a)(7) of the Code. The Security Owner must reduce future accruals of OID on the Debt Security by the amount of the acquisition premium. Specifically, a Security Owner must reduce each future accrual of OID on the Debt Security by an amount equal to the product of the OID accrual and a fixed fraction, the numerator of which is the amount of the acquisition premium and the denominator of which is the OID remaining to be accrued on the Debt Security at the time the Security Owner purchased the Debt Security. Security Owners should be aware that this fixed fraction methodology will not always produce the appropriate recovery of acquisition premium in situations where stated interest on a Debt Security is included in the Debt Security's stated redemption price at maturity because the total amount of OID remaining to be accrued on such a Debt Security at the time of purchase is not fixed.

Market Discount.

If a purchaser acquires a Debt Security at a discount from its outstanding principal amount (or, if the Debt Security is issued with OID, its adjusted issue price), the purchaser will acquire the Debt Security with market discount (a “market discount bond”). If the market discount is less than a statutorily defined de minimis amount (presumably equal to the product of (i) 0.25 percent, (ii) the stated redemption price at maturity of the Debt Security and (iii) the remaining weighted average maturity of the Debt Security), the market discount will be considered to be zero. It appears that de minimis market discount would be reported in a manner similar to de minimis OID. See “—Interest Income and OID” above.

Treasury regulations interpreting the market discount rules have not yet been issued; therefore, it is recommend that prospective investors consult their own tax advisors regarding the application of those rules and the advisability of making any of the elections described below.

Unless the beneficial owner of a market discount bond elects under Section 1278(b) of the Code to include market discount in income as it accrues, any principal payment (whether a scheduled payment or a prepayment) or any gain on disposition of the market discount bond will be treated as ordinary income to the extent that it does not exceed the accrued market discount at the time of such payment. If the beneficial owner makes the election under Section 1278(b) of the Code, the election will apply to all market discount bonds acquired by the beneficial owner at the beginning of the first taxable year to which the election applies and all market discount bonds thereafter acquired by it. The election may be revoked only with the consent of the IRS.

The Code grants the Treasury Department authority to issue regulations providing for the computation of accrued market discount on debt instruments, such as the Debt Securities, the principal of which is payable in more than one installment, but no regulations have been issued. The relevant legislative history provides that, until such regulations are issued, the beneficial owner of a market discount bond may elect to accrue market discount either on the basis of a constant interest rate or according to a pro rata method described in the legislative history. Under that method, the amount of market discount that accrues in any accrual period in the case of a Debt Security issued with OID equals the product of (i) the market discount that remains to be accrued as of the beginning of the accrual period 60 and (ii) a fraction, the numerator of which is the OID accrued during the accrual period and the denominator of which is the sum of the OID accrued during the accrual period and the amount of OID remaining to be accrued as of the end of the accrual period. In the case of a Debt Security that was issued without OID, the amount of market discount that accrues in any accrual period will equal the product of (i) the market discount that remains to be accrued as of the beginning of the accrual period and (ii) a fraction, the numerator of which is the amount of stated interest accrued during the accrual period and the denominator of which is the total amount of stated interest remaining to be accrued at the beginning of the accrual period. For purposes of determining the amount of OID or interest remaining to be accrued with respect to a class of Debt Securities, the prepayment assumption applicable to calculating the accrual of OID on such Debt Securities applies.

If a beneficial owner of a Debt Security incurred or continues indebtedness to purchase or hold Debt Securities with market discount, the beneficial owner may be required to defer a portion of its interest deductions for the taxable year attributable to any such indebtedness. Any such deferred interest expense would not exceed the market discount that accrues during such taxable year and is, in general, allowed as a deduction not later than the year in which such market discount is includible in income. If such beneficial owner elects to include market discount in income currently as it accrues under Section 1278(b) of the Code, the interest deferral rule will not apply.

Amortizable Bond Premium.

A purchaser of a Debt Security that purchases the Debt Security for an amount (net of accrued interest) greater than its stated redemption price at maturity will have premium with respect to that Debt Security in the amount of the excess. Such a purchaser need not include in income any remaining OID with respect to that Debt Security and may elect to amortize the premium under Section 171 of the Code. If a Security Owner makes this election, the amount of any interest payment that must be included in the Security Owner's income for each period will be reduced by a portion of the premium allocable to the period based on a constant yield method. In addition, the relevant legislative history states that premium should be amortized in the same manner as market discount. The election under Section 171 of the Code also will apply to all debt instruments (the interest on which is not excludable from gross income) held by the Security Owner at the beginning of the first taxable year to which the election applies and to all such taxable debt instruments thereafter acquired by it. The election may be revoked only with the consent of the IRS.

Non-Pro Rata Securities.

A Debt Security may provide for certain amounts of principal to be distributed upon the request of a Security Owner or by random lot (a “non-pro rata security”). In the case of a non-pro rata security, it is anticipated that the trustee will determine the yield to maturity based upon the anticipated payment characteristics of the class as a whole under the prepayment assumption. In general, the OID accruing on each non-pro rata security in an accrual period would be its allocable share of the OID for the entire class, as determined in accordance with the discussion of OID above. However, in the case of a distribution in retirement of the entire unpaid principal balance of any non-pro rata security (or portion of the unpaid principal balance), (a) the remaining unaccrued OID allocable to the security (or to that portion) will accrue at the time of the distribution, and (b) the accrual of OID allocable to each remaining security of that class will be adjusted by reducing the present value of the remaining payments on that class and the adjusted issue price of that class to the extent attributable to the portion of the unpaid principal balance thereof that was distributed. The depositor believes that the foregoing treatment is consistent with the “pro rata prepayment” rules of the OID Regulations, but with the rate of accrual of OID determined based on the prepayment assumption for the class as a whole. Prospective investors are advised to consult their tax advisors as to this treatment.

Election to Treat All Interest as OID.

The OID Regulations permit a beneficial owner of a Debt Security to elect to accrue all interest, discount (including de minimis OID and de minimis market discount), and premium in income as interest, based on a constant yield method (a “constant yield election”). It is unclear whether, for this purpose, the initial prepayment assumption would continue to apply or if a new prepayment assumption as of the date of the Security Owner's acquisition would apply. If such an election were to be made and the Debt Securities were acquired at a premium, such a Security Owner would be deemed to have made an election to amortize bond premium under Section 171 of the Code, which is described above. Similarly, if the Security Owner had acquired the Debt Securities with market discount, the Security Owner would be considered to have made the election in Section 1278(b) of the Code, which is described above. A constant yield election may be revoked only with the consent of the IRS.

Treatment of Losses.

Security Owners that own REMIC regular certificates or FASIT regular certificates, or in the case of Debt Securities for which a REMIC or FASIT election is not made, Security Owners that use the accrual method of accounting, will be required to report income with respect to such Debt Securities on the accrual method without giving effect to delays and reductions in distributions attributable to defaults or delinquencies on any of the trust's assets, except possibly, in the case of income that constitutes Qualified Stated Interest, to the extent that it can be established that such amounts are uncollectible. In addition, potential investors are cautioned that while they generally may cease to accrue interest income if it reasonably appears that the interest will be uncollectible, the IRS may take the position that OID must continue to be accrued in spite of its uncollectibility until the Debt Security is disposed of in a taxable transaction or becomes worthless in accordance with the rules of Section 166 of the Code. As a result, the amount of income required to be reported by a Security Owner in any period could exceed the amount of cash distributed to such Security Owner in that period.

Although not entirely clear, it appears that: (a) a Security Owner who holds a Debt Security in the course of a trade or business or a Security Owner that is a corporation generally should be allowed to deduct as an ordinary loss any loss sustained on account of the Debt Security's partial or complete worthlessness and (b) a noncorporate Security Owner who does not hold the Debt Security in the course of a trade or business generally should be allowed to deduct as a short-term capital loss any loss sustained on account of the Debt Security's complete worthlessness. Security Owners should consult their own tax advisors regarding the appropriate timing, character and amount of any loss sustained with respect to a Debt Security, particularly subordinated Debt Securities.

Sale or Other Disposition.

If a beneficial owner of a Debt Security sells, exchanges or otherwise disposes of the Debt Security, or the Debt Security is redeemed, the beneficial owner will recognize gain or loss in an amount equal to the difference between the amount realized by the beneficial owner upon the sale, exchange, redemption or other disposition and the beneficial owner's adjusted tax basis in the Debt Security. The adjusted tax basis of a Debt Security to a particular beneficial owner generally will equal the beneficial owner's cost for the Debt Security, increased by any market discount and OID previously included by such beneficial owner in income with respect to the Debt Security and decreased by the amount of bond premium, if any, previously amortized and by the amount of payments that are part of the Debt Security's stated redemption price at maturity previously received by such beneficial owner. Any such gain or loss will be capital gain or loss if the Debt Security was held as a capital asset, except for gain representing accrued interest and accrued market discount not previously included in income. Capital losses generally may be used only to offset capital gains.

Gain from the sale of a REMIC regular certificate that might otherwise be treated as capital gain will be treated as ordinary income to the extent that such gain does not exceed the excess of (1) the amount that would have been includible in the Security Owner's income had the income accrued at a rate equal to 110 percent of the AFR as of the date of purchase, over (2) the amount actually includible in such Security Owner's income.

Foreign Persons.

Interest (including OID) paid to or accrued by a beneficial owner of a Debt Security who is a Foreign Person generally will be considered “portfolio interest” and generally will not be subject to United States federal income tax or withholding tax, provided the interest is not effectively connected with the conduct of a trade or business within the United States by the Foreign Person and the Foreign Person (i) is not actually or constructively a 10 percent shareholder of the issuer of the Debt Securities or a controlled foreign corporation with respect to which the issuer of the Debt Securities is a related person (all within the meaning of the Code) and (ii) provides the trustee or other person who is otherwise required to withhold U.S. tax with respect to the Debt Securities (the “withholding agent”) with an appropriate statement on Form W-8 BEN (Certificate of Foreign Status of Beneficial Owner for United States Tax Withholding). If a Debt Security is held through a securities clearing organization or certain other financial institutions, the organization or institution may provide the relevant signed statement to the withholding agent; in that case, however, the signed statement must be accompanied by a Form W-8BEN provided by the Foreign Person that owns the Debt Security. If the information shown on Form W-8BEN changes, a new Form W-8BEN must be filed. If the foregoing requirements are not met, then interest (including OID) on the Debt Securities will be subject to United States federal income and withholding tax at a rate of 30 percent, unless reduced or eliminated pursuant to an applicable tax treaty.

Under Treasury regulations relating to withholding obligations, a payment to a foreign partnership is treated, with some exceptions, as a payment directly to the partners, so that the partners are required to provide any required certifications. It is recommended that Foreign Persons that intend to hold a Debt Security through a partnership or other pass-through entity consult their own tax advisors regarding the application of those Treasury regulations to an investment in a Debt Security.

Any capital gain realized on the sale, redemption, retirement or other taxable disposition of a Debt Security by a Foreign Person will be exempt from United States federal income and withholding tax, provided that (i) such gain is not effectively connected with the conduct of a trade or business in the United States by the Foreign Person and (ii) in the case of a Foreign Person who is an individual, the Foreign Person is not present in the United States for 183 days or more in the taxable year.

Information Reporting.

Payments of interest (including OID, if any) on a Debt Security held by a U.S. Person other than a corporation or other exempt holder are required to be reported to the IRS. Moreover, each trust is required to make available to Security Owners that hold beneficial interests in Debt Securities issued by that trust information concerning the amount of OID and Qualified Stated Interest accrued for each accrual period for which the Debt Securities are outstanding, the adjusted issue price of the Debt Securities as of the end of each accrual period, and information to enable a Security Owner to compute accruals of market discount or bond premium using the pro rata method described under “—Market Discount” above.

Payments of interest (including OID, if any) on a Debt Security held by a Foreign Person are required to be reported annually on IRS Form 1042-S, which the withholding agent must file with the IRS and furnish to the recipient of the income.

REMIC Residual Certificates

A Residual Owner will be required to report the daily portion of the taxable income or, subject to the limitation described under “—Basis Rules and Distributions” below, the net loss of the REMIC for each day during a calendar quarter. The requirement that Residual Owners report their pro rata share of taxable income or net loss of the REMIC will continue until there are no certificates of any class of the related series outstanding. For this purpose, the daily portion will be determined by allocating to each day in the calendar quarter a ratable portion of the taxable income or net loss of the REMIC for the quarter. The daily portions then will be allocated among the Residual Owners in accordance with their percentage of ownership on each day. Any amount included in the gross income of, or allowed as a loss to, any Residual Owner will be treated as ordinary income or loss.

Taxable Income or Net Loss of the REMIC.

Generally, a REMIC determines its taxable income or net loss for a given calendar quarter in the same manner as would an individual having the calendar year as his taxable year and using the accrual method of accounting. There are, however, certain modifications. First, a deduction is allowed for accruals of interest and OID on the REMIC regular certificates issued by the REMIC. Second, market discount will be included in income as it accrues, based on a constant yield to maturity method. Third, no item of income, gain, loss or deduction allocable to a prohibited transaction is taken into account. Fourth, the REMIC generally may deduct only items that would be allowed in calculating the taxable income of a partnership under Section 703(a) of the Code. Fifth, the limitation on miscellaneous itemized deductions imposed on individuals by Section 67 of the Code does not apply at the REMIC level to investment expenses such as trustee fees or servicing fees. See, however, “—Pass Through of Certain Expenses” below. If the deductions allowed to the REMIC exceed its gross income for a calendar quarter, such excess will be the net loss for the REMIC for that calendar quarter. For purposes of determining the income or loss of a REMIC, the regulations applicable to REMICs provide that a REMIC has a tax basis in its assets equal to the total of the issue prices of all regular and residual interests in the REMIC.

Pass Through of Certain Expenses.

A Residual Owner who is an individual, estate, or trust will be required to include in income a share of the expenses of the related REMIC and may deduct those expenses subject to the limitations of Sections 67 and 68 of the Code. See “—Grantor Trust Certificates—Trust Expenses” below for a discussion of the limitations of Sections 67 and 68 of the Code. Those expenses may include the servicing fees and all administrative and other expenses relating to the REMIC. In addition, those expenses are not deductible for purposes of computing the alternative minimum tax, and may cause those investors to be subject to significant additional tax liability. Similar rules apply to individuals, estates and trusts holding a REMIC residual certificate through certain pass-through entities.

Excess Inclusions.

Excess inclusions with respect to a REMIC residual certificate are subject to special tax rules. For any Residual Owner, the excess inclusion for any calendar quarter will generally equal the excess of the sum of the daily portions of the REMIC's taxable income allocated to the Residual Owner over the amount of income that the Residual Owner would have accrued if the REMIC residual certificate were a debt instrument having a yield to maturity equal to 120 percent of the long-term AFR in effect at the time of issuance of the REMIC residual certificate. If the issue price of a REMIC residual certificate is zero, which would be the case if the REMIC residual certificate had no economic value at issuance, then all of the daily portions of income allocated to the Residual Owner will be excess inclusions. The issue price of a REMIC residual certificate issued for cash generally will equal the price paid by the first buyer, and if the REMIC residual certificate is issued for property, the issue price will be its fair market value at issuance.

For Residual Owners, an excess inclusion may not be offset by deductions, losses, or loss carryovers. Thus, a Residual Owner that has losses in excess of income for a taxable year would, nevertheless, be required to pay tax on excess inclusions. For Residual Owners that are subject to tax on unrelated business taxable income (as defined in Section 511 of the Code), an excess inclusion is treated as unrelated business taxable income. For Residual Owners that are nonresident alien individuals or foreign corporations generally subject to United States withholding tax, even if interest paid to such Residual Owners is generally eligible for exemptions from such tax, an excess inclusion will be subject to such tax and no tax treaty rate reduction or exemption may be claimed with respect thereto.

Alternative minimum taxable income for a Residual Owner is determined without regard to the special rule that taxable income may not be less than the sum of the Residual Owner's excess inclusions for the year. Alternative minimum taxable income cannot, however, be less than the sum of a Residual Owner's excess inclusions for the year. Also, the amount of any alternative minimum tax net operating loss deduction must be computed without regard to any excess inclusions.

Finally, if a REIT or a regulated investment company owns a REMIC residual certificate, a portion (allocated under Treasury regulations yet to be issued) of dividends paid by the REIT or regulated investment company could not be offset by net operating losses of its shareholders, would constitute unrelated business taxable income for tax-exempt shareholders, and would be ineligible for reduction of withholding to certain persons who are not U.S. Persons.

Taxable Income May Exceed Distributions.

In light of the tax consequences to a Residual Owner, the taxable income from a REMIC residual certificate may exceed cash distributions with respect thereto in any taxable year. The taxable income recognized by a Residual Owner in any taxable year will be affected by, among other factors, the relationship between the timing of recognition of interest, OID or market discount income or amortization of premium for the mortgage loans, on the one hand, and the timing of deductions for interest (including OID) or income from amortization of issue premium on the regular interests, on the other hand. If an interest in the mortgage loans is acquired by the REMIC at a discount, and one or more of these mortgage loans is prepaid, the proceeds of the prepayment may be used in whole or in part to make distributions in reduction of principal on the regular interests, and (2) the discount on the mortgage loans that is includible in income may exceed the deduction allowed upon those distributions on those regular interests on account of any unaccrued OID relating to those regular interests. When there is more than one class of regular interests that distribute principal sequentially, this mismatching of income and deductions is particularly likely to occur in the early years following issuance of the regular interests when distributions in reduction of principal are being made in respect of earlier classes of regular interests to the extent that those classes are not issued with substantial discount or are issued at a premium. If taxable income attributable to that mismatching is realized, in general, losses would be allowed in later years as distributions on the later maturing classes of regular interests are made.

Taxable income also may be greater in earlier years that in later years as a result of the fact that interest expense deductions, expressed as a percentage of the outstanding principal amount of that series of regular interests, may increase over time as distributions in reduction of principal are made on the lower yielding classes of regular interests, whereas, to the extent the REMIC consists of fixed rate mortgage loans, interest income for any particular mortgage loan will remain constant over time as a percentage of the outstanding principal amount of that loan. Consequently, Residual Owners must have sufficient other sources of cash to pay any federal, state, or local income taxes due as a result of that mismatching or unrelated deductions against which to offset that income, subject to the discussion of excess inclusions under “—Excess Inclusions” above. The timing of mismatching of income and deductions described in this paragraph, if present for a series of REMIC certificates, may have a significant adverse effect upon a Residual Owner's after-tax rate of return.

Basis Rules and Distributions.

A Residual Owner's adjusted basis in a REMIC residual certificate will equal the amount paid for the REMIC residual certificate, increased by the sum of the daily portions of REMIC income taken into account by the Residual Owner, and decreased by the sum of (i) the daily portions of REMIC net loss taken into account by the Residual Owner and (ii) distributions made by the REMIC to the Residual Owner.

A distribution by a REMIC to a Residual Owner will not be includible in gross income by the Residual Owner if the distribution does not exceed the Residual Owner's adjusted basis in the REMIC residual certificate immediately before the distribution. The distribution will reduce the Residual Owner's adjusted basis of such interest, but not below zero. To the extent a distribution exceeds the Residual Owner's adjusted basis in the REMIC residual certificate, the excess will be treated as gain from the sale of the REMIC residual certificate. See “—Sales of REMIC Residual Certificates” below.

A Residual Owner is not allowed to take into account any net loss for any calendar quarter to the extent such net loss exceeds such Residual Owner's adjusted basis in its REMIC residual certificate as of the close of such calendar quarter, determined without regard to such net loss. Any loss disallowed by reason of this limitation may be carried forward indefinitely to future calendar quarters and, subject to the same limitation, may be used by that Residual Owner to offset income from the REMIC residual certificate.

The effect of these basis and distribution rules is that a Residual Owner may not amortize its basis in a REMIC residual certificate but may only recover its basis through distributions, through the deduction of any net losses of the REMIC, or upon the sale of its REMIC residual certificate. See “—Sales of REMIC Residual Certificates.”

Sales of REMIC Residual Certificates.

If a Residual Owner sells a REMIC residual certificate, the Residual Owner will recognize gain or loss equal to the difference between the amount realized on the sale and its adjusted basis in the REMIC certificate. If a Residual Owner sells a REMIC residual certificate at a loss, the loss will not be recognized if, within six months before or after the sale of the REMIC residual certificate, the Residual Owner purchases another residual interest in any REMIC or any interest in a taxable mortgage pool (as defined in Section 7701(i) of the Code) comparable to a residual interest in a REMIC. Such disallowed loss will be allowed upon the sale of the other residual interest (or comparable interest) if the rule referred to in the preceding sentence does not apply to that sale.

Inducement Fees.

Regulations have been proposed regarding the federal income tax treatment of “inducement fees” received by transferees of non-economic REMIC residual interests. The proposed regulations (i) provide tax accounting rules for the treatment of such fees as income over an appropriate period and (ii) specify that inducement fees constitute income from sources within the United States. The proposed regulations provide that the final regulations will be applicable to taxable years ending on or after the date final 66 regulations are published, and thus yet to be issued final regulations may apply to the treatment of any inducement fee received in connection with the acquisition of a Residual Certificate. Prospective purchasers of the Residual Certificates should consult with their tax advisors regarding the effect of these proposed regulations.

Disqualified Organizations.

If a Residual Owner were to transfer a REMIC residual certificate to a disqualified organization, the Residual Owner would be subject to a tax in an amount equal to the maximum corporate tax rate applied to the present value (using a discount rate equal to the applicable AFR) of the total anticipated excess inclusions with respect to such residual interest for the periods after the transfer. For this purpose, disqualified organizations include the United States, any state or political subdivision of a state, any foreign government or international organization or any agency or instrumentality of any of the foregoing; any tax-exempt entity (other than a Section 521 cooperative) which is not subject to the tax on unrelated business income; and any rural electrical or telephone cooperative. However, a transferor of a REMIC residual certificate would in no event be liable for the tax for a transfer if the transferee furnished to the transferor an affidavit stating that the transferee is not a disqualified organization and, as of the time of the transfer, the transferor does not have actual knowledge that the affidavit is false.

The anticipated excess inclusions must be determined as of the date that the REMIC residual certificate is transferred and must be based on events that have occurred up to the time of such transfer, the prepayment assumption (see “—Taxation of Securities Treated as Debt Instruments—Interest Income and OID,” for a discussion of the prepayment assumption), and any required or permitted clean up calls or required liquidation provided for in the trust agreement. The tax generally is imposed on the transferor of the REMIC residual certificate, except that it is imposed on an agent for a disqualified organization if the transfer occurs through such agent. The trust agreement for each series of REMIC certificates will require, as a prerequisite to any transfer of a REMIC residual certificate, the delivery to the trustee of an affidavit of the transferee to the effect that it is not a disqualified organization and will contain other provisions designed to render any attempted transfer of a REMIC residual certificate to a disqualified organization void.

In addition, if a pass through entity includes in income excess inclusions with respect to a REMIC residual certificate, and a disqualified organization is the record holder of an interest in such entity at any time during any taxable year of such entity, then a tax will be imposed on the entity equal to the product of (1) the amount of excess inclusions on the REMIC residual certificate for such taxable year that are allocable to the interest in the pass through entity held by such disqualified organization and (2) the highest marginal federal income tax rate imposed on corporations. A pass through entity will not be subject to this tax for any period with respect to an interest in such entity, however, if the record holder of such interest furnishes to such entity (1) such holder's social security number and a statement under penalties of perjury that such social security number is that of the record holder or (2) a statement under penalties of perjury that such record holder is not a disqualified organization. For these purposes, a “pass through entity” means any regulated investment company, REIT, trust, partnership or certain other entities described in Section 860E(e)(6) of the Code. In addition, a person holding an interest in a pass through entity as a nominee for another person shall, with respect to such interest, be treated as a pass through entity. Moreover, in the case of any “electing large partnership,” within the meaning of Section 775 of the Code, all record holders are considered to be disqualified organizations so that the partnership itself will be subject to tax on the excess inclusions and such excess inclusions will be excluded in determining partnership income. The exception to this tax, otherwise available to a pass through entity that is furnished certain affidavits by record holders of interests in the entity and that does not know those affidavits are false, is not available to an electing large partnership.

Noneconomic REMIC Residual Certificates.

A transfer of a “noneconomic” REMIC residual certificate will be disregarded for all federal income tax purposes if a significant purpose of the transfer was to enable the transferor to impede the assessment or collection of tax. If such transfer is disregarded, the purported transferor will continue to be treated as the Residual Owner and will, therefore, be liable for any taxes due with respect to the daily portions of income allocable to such noneconomic REMIC residual certificate.

A REMIC residual certificate is noneconomic for this purpose unless, at the time of its transfer, (1) the present value of the expected future distributions on the REMIC residual certificate at least equals the product of the present value of the anticipated excess inclusions and the highest tax rate applicable to corporations for the year of the transfer and (2) the transferor reasonably expects that the transferee will receive distributions with respect to the REMIC residual certificate at or after the time the taxes accrue on the anticipated excess inclusions in an amount sufficient to satisfy the accrued taxes. The present value computations are based on a discount rate equal to the applicable AFR and a prepayment assumption used in computing income on the mortgage loans held by the trust. See “—Taxation of Securities Treated as Debt Instruments—Interest Income and OID,” for a discussion concerning prepayment assumptions.

All transfers of REMIC residual certificates will be subject to certain restrictions under the terms of the related trust agreement that are intended to reduce the possibility of any such transfer being disregarded. Such restrictions will require each party to a transfer to provide an affidavit that no purpose of such transfer is to impede the assessment or collection of tax, including certain representations as to the financial condition of the prospective transferee.

Prior to purchasing a REMIC residual certificate, prospective purchasers should consider the possibility that a purported transfer of such REMIC residual certificate by such a purchaser to another purchaser at some future date may be disregarded in accordance with the above-described rules, which would result in the retention of tax liability by such purchaser. The applicable prospectus supplement will disclose whether offered REMIC residual certificates may be considered noneconomic residual interests; provided, however, that any disclosure that a REMIC residual certificate will or will not be considered noneconomic will be based upon certain assumptions, and the depositor will make no representation that a REMIC residual certificate will not be considered noneconomic for purposes of the above-described rules or that a Residual Owner will receive distributions calculated pursuant to such assumptions.

The Treasury Department recently adopted final regulations setting forth the requirements of a safe harbor under which a transfer of a noneconomic residual is presumed to be a valid transfer that will be respected for federal income tax purposes. To qualify under the safe harbor:
the transferor must perform a reasonable investigation of the financial status of the transferee and determine that the transferee has historically paid its debts as they come due and find no significant evidence to indicate that the transferee will not continue to pay its debts as they come due,
the transferor must obtain a representation from the transferee to the effect that the transferee understands that as the holder of the residual interest the transferee will recognize taxable income in excess of cash flow and that the transferee intends to pay taxes on the income as those taxes become due,
the transferee must represent that it will not cause income from the residual interest to be attributable to a foreign permanent establishment or fixed base (within the meaning of an applicable income tax treaty) of the transferee or another U.S. taxpayer and
either (i) the present value (computed based upon a statutory discount rate) of the anticipated tax liabilities associated with holding the residual interest must be no greater than the present value of the sum of any consideration given to the transferee to acquire the interest, the anticipated distributions on the interest and the anticipated tax savings associated with holding the interest, or (ii) the transferee must be a domestic taxable C corporation that meets certain asset tests and that agrees that any subsequent transfer of the interest will satisfy the same safe harbor provision and be to a domestic taxable C corporation.
   Eligibility for the safe harbor requires, among other things, that the facts and circumstances known to the transferor at the time of transfer not indicate to a reasonable person that the taxes with respect to the interest will not be paid, with an unreasonably low cost for the transfer specifically mentioned as negating eligibility. The final regulations contain additional detail regarding their application. Further a tax advisor should be consulted regarding the application of the safe harbor to a transfer of a REMIC residual certificate before acquiring one.

Restrictions on Transfers of Residual Certificates to Foreign Persons.

Transfers to a Foreign Person of REMIC residual certificates that have tax avoidance potential are disregarded for all federal income tax purposes. If such a transfer is disregarded, the purported transferor of the REMIC residual certificate to the Foreign Person continues to remain liable for any taxes due with respect to the income on such REMIC residual certificate. A transfer of a REMIC residual certificate has tax avoidance potential unless, at the time of the transfer, the transferor reasonably expects (1) that the REMIC will distribute to the transferee of the REMIC residual certificate amounts that will equal at least 30 percent of each excess inclusion and (2) that such amounts will be distributed at or after the time at which the excess inclusion accrues and not later than the close of the calendar year following the calendar year of accrual. This rule does not apply to transfers if the income from the REMIC residual certificate is taxed in the hands of the transferee as income effectively connected with the conduct of a U.S. trade or business. Moreover, if a Foreign Person transfers a REMIC residual certificate to a U.S. Person (or to a Foreign Person in whose hands income from the REMIC residual certificate would be effectively connected income) and the transfer has the effect of allowing the transferor to avoid tax on accrued excess inclusions, that transfer is disregarded for all federal income tax purposes and the purported Foreign Person transferor continues to be treated as the owner of the REMIC residual certificate. The trust agreement for each series will preclude the transfer of a REMIC residual certificate to a Foreign Person, other than a Foreign Person in whose hands the income from the REMIC residual certificate would be effectively connected with a U.S. trade or business.

Foreign Persons.

The Conference Committee Report to the 1986 Act indicates that amounts paid to Residual Owners who are Foreign Persons generally should be treated as interest for purposes of the 30 percent (or lower treaty rate) United States withholding tax. Treasury regulations provide that amounts distributed to Residual Owners may qualify as “portfolio interest,” subject to the conditions described in “—Taxation of Securities Treated as Debt Instruments—Foreign Persons” above, but only to the extent that (i) the mortgage loans were issued after Jul. 18, 1984, and (ii) the trust fund to which the REMIC residual certificate relates consists of obligations issued in “registered form” within the meaning of Section 163 (f)(1) of the Code. Generally, mortgage loans will not be, but regular interests in another REMIC will be, considered obligations issued in registered form. Furthermore, Residual Owners will not be entitled to any exemption from the 30 percent withholding tax (or lower treaty rate) to the extent of that portion of REMIC taxable income that constitutes an “excess inclusion.” See “—Excess Inclusions” above. If the amounts paid to Residual Owners who are Foreign Persons are effectively connected with the conduct of a trade or business within the United States by those Foreign Persons, the 30 percent (or lower treaty rate) withholding will not apply. Instead, the amounts paid to those Foreign Persons will be subject to United States federal income tax at regular rates. If the 30 percent (or lower treaty rate) withholding is applicable, those amounts generally will be taken into account for purposes of withholding only when paid or otherwise distributed (or when the REMIC residual certificate is disposed of) under rules similar to withholding upon disposition of Debt Securities that have OID. See “—Restrictions on Transfers of Residual Certificates to Foreign Persons” above concerning the disregard of certain transfers having “tax avoidance potential.” Potential investors who are Foreign Persons should consult their own tax advisors regarding the specific tax consequences to them of owning REMIC residual certificates.

Administrative Provisions.

The REMIC will be required to maintain its books on a calendar year basis and to file federal income tax returns for federal income tax purposes in a manner similar to a partnership. The form for the income tax return is Form 1066, U.S. Real Estate Mortgage Investment Conduit Income Tax Return. The trustee will be required to sign the REMIC's returns. Treasury regulations provide that, except where there is a single Residual Owner for an entire taxable year, the REMIC will be subject to the procedural and administrative rules of the Code applicable to partnerships, including the determination by the IRS of any adjustments to, among other things, items of REMIC income, gain, loss deduction, or credit in a unified administrative proceeding. The master servicer will be obligated to act as “tax matters person,” as defined in applicable Treasury regulations, for the REMIC as agent of the Residual Owners holding the largest percentage interest in the REMIC's residual interest. If the Code or applicable Treasury regulations do not permit the master servicer to act as tax matters person in its capacity as agent of the Residual Owner, the Residual Owner or any other person specified pursuant to Treasury regulations will be required to act as tax matters person. The tax matters person generally has responsibility for overseeing and providing notice to the other Residual Owner of certain administrative and judicial proceedings regarding the REMIC's tax affairs, although other holders of the REMIC residual certificates of the same series would be able to participate in those proceedings in appropriate circumstances.

Treasury regulations provide that a Residual Owner is not required to treat items on its return consistently with their treatment on the REMIC's return if the holder owns 100 percent of the REMIC residual certificates for the entire calendar year. Otherwise, each Residual Owner is required to treat items on its returns consistently with their treatment on the REMIC's return, unless the holder either files a statement identifying the inconsistency or establishes that the inconsistency resulted from incorrect information received from the REMIC. The IRS may access a deficiency resulting from a failure to comply with the consistency requirement without instituting an administrative proceeding at the REMIC level. A REMIC typically will not register as a tax shelter pursuant to Code Section 6111 because it generally will not have a net loss for any of the first five taxable years of its existence. Any person that holds a REMIC residual certificate as a nominee for another person may be required to furnish the related REMIC, in a manner to be provided in Treasury regulations, with the name and address of that person and other specified information.

The IRS Form 1066 has an accompanying Schedule Q, Quarterly Notice to Residual Interest Holders of REMIC taxable Income or Net Loss Allocation. Treasury regulations require that a Schedule Q be furnished by the REMIC Pool to each Residual Owner by the end of the month following the close of each calendar quarter (41 days after the end of a quarter under proposed Treasury regulations) in which the REMIC is in existence. Treasury regulations require that, in addition to the foregoing requirements, information must be furnished quarterly to Residual Owners and filed annually with the IRS concerning Section 67 of the Code expenses (see “—Pass Through of Certain Expenses” above) allocable to those holders. Furthermore, under those regulations, information must be furnished quarterly to Residual Owners and filed annually with the IRS concerning the percentage of the REMIC's assets meeting the qualified asset tests described under “—Special Tax Attributes—REMIC Certificates” below.

Mark-To-Market Rules.

Section 475 of the Code generally requires that securities dealers include securities in inventory at their fair market value, recognizing gain or loss as if the securities were sold at the end of each tax year. The Treasury regulations provide that a REMIC residual certificate is not treated as a security for purposes of the mark-to-market rules and thus may not be marked to market.

FASIT Ownership Certificates

An Ownership certificate represents the residual equity interest in a FASIT. The beneficial owner of an Ownership certificate determines its taxable income by taking into account all assets, liabilities and items of income, gain, deduction, loss and credit of the FASIT (other than those allocable to prohibited transactions as described below). In general, the character of the income to the beneficial owner of an Ownership certificate will be the same as the character of such income of the FASIT, except that any taxexempt interest income taken into account by the beneficial owner of an Ownership certificate is treated as ordinary income. In determining that taxable income, the beneficial owner of an Ownership certificate must determine the amount of interest, OID, market discount and premium recognized with respect to the FASIT's assets and the FASIT regular certificates issued by the FASIT according to a constant yield methodology and under an accrual method of accounting. In addition, the beneficial owner of the Ownership certificate is subject to the same limitations on its ability to use losses to offset income from the FASIT as are the beneficial owners of High-Yield Interests. See “—Types of Securities—FASIT Certificates Generally” above.

A Security Owner that holds an Ownership certificate will recognize gain, but not loss, upon the contribution of assets to a FASIT to support one or more FASIT regular certificates to the extent the value of the assets exceeds the Security Owner's basis in those assets. In the case of debt instruments that are not publicly traded, the value for purposes of the gain computation will be determined by reference to a formula set out in Section 860I(d) of the Code that will likely overstate the market value of those debt instruments. Any gain recognized will increase the Security Owner's basis in the assets held in the FASIT. Proposed Treasury regulations would, if issued in final form, provide that the Security Owner holding the Ownership certificate would not be allowed to use non-FASIT losses to offset the gain recognized.

Rules similar to the wash sale rules applicable to REMIC residual certificates also will apply to the Ownership certificate. Accordingly, losses on dispositions of an Ownership certificate generally will be disallowed where, within six months before or after the disposition, the seller of such security acquires any other Ownership certificate or, in the case of a FASIT holding mortgage assets, any REMIC residual interest or interest in a taxable mortgage pool that is economically comparable to an Ownership certificate.

The beneficial owner of an Ownership certificate will be subject to a tax equal to 100 percent of the net income derived by the FASIT from any “prohibited transactions.” Prohibited transactions include:
the receipt of income derived from assets that are not permitted assets,
certain dispositions of permitted assets,
the receipt of any income derived from any loan originated by a FASIT, and
in certain cases, the receipt of income representing a servicing fee or other compensation.
   Any trust for which a FASIT election will be made will be structured in order to avoid application of the prohibited transaction tax.
   Grantor Trust Certificates

For purposes of this discussion, two types of certificates are typically issued by a Grantor Trust: “Standard Certificates” and “Stripped Certificates.” Each certificate issued by a Grantor Trust that is not a Stripped Certificate is a Standard Certificate.

Classification of Stripped Certificates.

There generally are three situations in which a Grantor Trust Certificate will be classified as a Stripped Certificate. First, if the trust holds assets that pay principal and interest but issues interest-only or principal-only certificates, all the certificates of that trust likely will be Stripped Certificates. Second, if the seller, depositor, or some other person retains the right to receive a portion of the interest payments on assets held in the trust, all the certificates issued by the trust could be Stripped Certificates. Finally, if a portion of a servicing or guarantee fee were recharacterized under rules established by the IRS as ownership interests in stripped coupons, all the certificates of the trust could be Stripped Certificates.

Taxation of Stripped Certificates.

Stripped Certificates will be treated under rules contained in Section 1286 of the Code (the “Stripped Bond Rules”). Pursuant to the Stripped Bond Rules, the separation of ownership of some or all of the interest payments on a debt instrument from ownership of some or all of the principal payments results in the creation of “stripped bonds” with respect to principal payments and “stripped coupons” with respect to interest payments. A beneficial owner of a Stripped Certificate will be treated as owning “stripped bonds” to the extent of its share of principal payments and “stripped coupons” to the extent of its share of interest payments.

Generally, if a taxpayer acquires an interest in “stripped coupons” or “stripped bonds,” the taxpayer will be treated as having purchased a newly issued debt instrument on the date of purchase for an issue price equal to the purchase price paid. As a result, a beneficial owner of a Stripped Certificate would be taxed as holding a newly issued debt instrument. The tax consequences of holding a debt instrument are discussed generally under “—Taxation of Securities Treated as Debt Instruments” above.

Although a Stripped Certificate may represent a beneficial ownership interest in stripped coupons from all or several of the assets held in the trust, for information reporting purposes, the trustee will aggregate all such interests and treat each class of Stripped Certificates as a single issue of debt instruments. Moreover, the trustee will apply the PAC Method to compute accruals of any OID on the Stripped Certificates, as described herein under “—Taxation of Securities Treated as Debt Instruments—Interest Income and OID,” and will comply with any tax information reporting obligations with respect to Stripped Certificates in the manner described under “—Taxation of Securities Treated as Debt Instruments—Information Reporting.” Whether aggregation of stripped coupons from several assets acquired in a single purchase is appropriate, and whether the PAC Method should apply to compute OID accruals on Stripped Certificates are not free from doubt. It is recommended, therefore, that a prospective investor in Stripped Certificates consult their tax advisor concerning the application of these rules to Stripped Certificates.

For this purpose, the tax information will include the amount of OID accrued on Stripped Certificates. However, the amount required to be reported by the trustee may not be equal to the proper amount of OID required to be reported as taxable income by a Security Owner, other than an original Security Owner who purchased at the issue price. In particular, in the case of Stripped Securities, the reporting will be based upon a representative initial offering price of each class of Stripped Securities, except as set forth in the prospectus supplement. It is not clear for this purpose whether the assumed prepayment rate that is to be used in the case of an owner other than a Security Owner that acquires its Stripped Certificate at original issue should be the prepayment assumption or a new rate based on the circumstances at the date of subsequent purchase.

A beneficial owner of a Stripped Certificate, particularly any Stripped Certificate that is subordinate to another class, may deduct losses incurred for the Stripped Certificate as described under “—Taxation of Standard Certificates” below. In addition, if the mortgage loans prepay at a rate either faster or slower than that under the prepayment assumption, a Security Owner's recognition of OID either will be accelerated or decelerated and the amount of that OID either will be increased or decreased depending on the relative interests in principal and interest on each mortgage loan represented by that Security Owner's Stripped Certificate. While the matter is not free from doubt, the beneficial owner of a Stripped Certificate should be entitled to recognize a loss (which may be a capital loss) in the year that it becomes certain (assuming no further prepayments) that the Security Owner will not recover a portion of its adjusted basis in the Stripped Certificate, such loss being equal to that portion of unrecoverable basis.

In addition, each beneficial owner of a Stripped Certificate will be required to include in income its share of the expenses of the trust, including the servicing fees with respect to any assets held by the trust. Although not free from doubt, for purposes of reporting to Security Owners of Stripped Certificates, the trust expenses will be allocated to the classes of Stripped Certificates in proportion to the distributions to those classes for the related period. The beneficial owner of a Stripped Certificate generally will be entitled to a deduction in respect of the trust expenses, as described under “—Trust Expenses” below, subject to the limitation described therein.

Purchase of More Than One Class of Stripped Certificates.

When an investor purchases more than one class of Stripped Certificates, it is currently unclear whether for federal income tax purposes those classes of Stripped Certificates should be treated separately or aggregated for purposes of the rules described above.

Taxation of Standard Certificates.

For federal income tax purposes, a Standard Certificate will represent an undivided beneficial ownership interest in the assets of the Grantor Trust. As a result, each Security Owner holding an interest in a Standard Certificate must include in income its proportionate share of the entire income from the assets represented by its Standard Certificate. Thus, for example, in the case of a Standard Certificate representing ownership of mortgage loans, a beneficial owner of the certificate would be required to include in income interest at the coupon rate on the mortgage loans, OID (if any), and market discount (if any), and any prepayment fees, assumption fees, and late payment charges received by the servicer, in accordance with the beneficial owner's method of accounting. In addition, beneficial owners of Standard Certificates, particularly any class of a series that is subordinate to other classes, may incur losses of interest or principal with respect to the trust's assets. Those losses would be deductible generally only as described under “—Taxation of Securities Treated as Debt Instruments—Treatment of Losses” above.

For information reporting purposes, although not free from doubt, the trustee will report information concerning income accruals and principal payments on the assets of the trust in the aggregate.

Trust Expenses.

Each Security Owner that holds an interest in a Grantor Trust Certificate must include in income its share of the trust's expenses, as described above. Each Security Owner may deduct its share of those expenses at the same time, to the same extent, and in the same manner as such items would have been reported and deducted had it held directly interests in the trust's assets and paid directly its share of the servicing and related fees and expenses. Investors who are individuals, estates or trusts who own Grantor Trust Certificates, either directly or indirectly through certain pass-through entities, will be subject to limitations for certain itemized deductions described in Section 67 of the Code, including deductions for the servicing fees and all administrative and other expenses of the trust. In general, such an investor can deduct those expenses only to the extent that those expenses, in total, exceed 2 percent of the investor's adjusted gross income. In addition, Section 68 of the Code provides that itemized deductions otherwise allowable for a taxable year will be reduced by the lesser of (i) 3 percent of the excess, if any, of adjusted gross income over $100,000 ($50,000 in the case of a married individual filing a separate return) (in each case, as adjusted for post-1991 inflation), and (ii) 80 percent of the amount of itemized deductions otherwise allowable for that year. This reduction is currently scheduled to be phased-out over a five year period beginning 2006. As a result of the limitations set forth in Sections 67 and 68 of the Code, those investors holding Grantor Trust Certificates, directly or indirectly through a pass-through entity, may have total taxable income in excess of the total amount of cash received on the Grantor Trust Certificates. In addition, those investors cannot deduct the expenses of the trust for purposes of computing the alternative minimum tax, and thus those investors may be subject to significant additional tax liability.

Sales of Grantor Trust Certificates.

If a Grantor Trust Certificate is sold, gain or loss will be recognized by the Security Owner in an amount equal to the difference between the amount realized on the sale and the Security Owner's adjusted tax basis in the Grantor Trust Certificate. Such tax basis will equal the Security Owner's cost for the Grantor Trust Certificate, increased by any OID or market discount previously included in income and decreased by any premium previously taken into account and by the amount of payments, other than payments of Qualified Stated Interest, previously received with respect to such Grantor Trust Certificate. The portion of any such gain attributable to accrued market discount not previously included in income will be ordinary income. See “—Taxation of Securities Treated as Debt Instruments—Sale or Other Disposition.” Any remaining gain or any loss will be capital gain or loss. Capital losses generally may be used only to offset capital gains.

Trust Reporting.

Each registered holder of a Grantor Trust Certificate will be furnished with each distribution a statement setting forth the allocation of such distribution to principal and interest. In addition, within a reasonable time after the end of each calendar year each registered holder of a Grantor Trust Certificate at any time during such year will be furnished with information regarding the amount of servicing compensation and other trust expenses to enable beneficial owners of Grantor Trust Certificates to prepare their tax returns. The trustee also will file any required tax information with the IRS, to the extent and in the manner required by the Code.

Foreign Persons.

The tax and withholding rules that apply to Foreign Persons who acquire an interest in Grantor Trust Certificates generally are the same as those that apply to a Foreign Person who acquires an interest in Debt Securities. See the discussion of the tax and withholding rules under “—Taxation of Securities Treated as Debt Instruments—Foreign Persons.”

Partner Certificates

If a trust is classified as a partnership for federal income tax purposes, the trust will not be subject to an entity level federal income tax. Instead, pursuant to the terms of the trust agreement, the trustee will compute taxable income for each taxable year for the trust and will allocate the income so computed among the Security Owners owning Partner Certificates. Each such Security Owner must take into account in computing its taxable income for federal income tax purposes its allocable share of the trust's income for the taxable year of the trust that ends with or within the Security Owner's taxable year. The trust will adopt the calendar year as its taxable year unless otherwise specified in the applicable prospectus supplement.

Security Owner's Distributive Share.

The trust will compute taxable income for each taxable year in the same manner as would an individual, except that certain deductions specified in Section 703(a)(2) of the Code are not allowed. The trustee will allocate that taxable income among the Partner Certificates. The method of allocation will be described in the applicable prospectus supplement.

A share of expenses of the partnership (including fees of the master servicer but not interest expense) allocable to a beneficial owner who is an individual, estate or trust would constitute miscellaneous itemized deductions subject to the limitations described under “—Grantor Trust Certificates—Trust Expenses” above. Accordingly, those deductions might be disallowed to the individual in whole or in part and might result in that holder being taxed on an amount of income that exceeds the amount of cash actually distributed to that holder over the life of the partnership.

Distributions.

A distribution of cash to a Security Owner owning a Partner Certificate will not be taxable to the Security Owner to the extent that the amount distributed does not exceed the Security Owner's adjusted basis in the Partner Certificate. If the amount of cash distributed exceeds a Security Owner's basis in a Partner Certificate, the excess will be treated as though it were gain from the sale of the Partner Certificate. If, upon receipt of a cash distribution in liquidation of a Security Owner's interest in the trust, the Security Owner's adjusted basis exceeds the amount distributed, the excess will be treated as though it were a loss from the sale of the Partner Certificate.

A Security Owner's adjusted basis in a Partner Certificate at any time will equal the purchase price paid by the Security Owner for the Partner Certificate, increased by allocations of income made to the Security Owner by the trust, and decreased by distributions previously made by the trust on the Partner Certificate and any losses allocated by the trust to the Security Owner with respect to the Partner Certificate.

If a trust distributes its assets in-kind to a Security Owner in liquidation of the trust, neither the trust nor the Security Owner will recognize gain or loss on the distribution. The Security Owner would be required to allocate its adjusted basis in its Partner Certificate among the assets it received in the liquidating distribution.

Sale or Exchange of a Partner Certificate.

If a Security Owner sells a Partner Certificate, the Security Owner will recognize gain or loss equal to the difference between the amount realized on the sale and the Security Owner's adjusted basis in the Partner Certificate at the time of sale. Generally, except to the extent provided otherwise in the applicable prospectus supplement, any gain or loss will be capital gain or loss.

Section 708 Terminations.

Under Section 708 of the Code, the trust will be deemed to have terminated for federal income tax purpose if 50 percent of the capital and profits interests in the trust are sold or exchanged within a 12-month period. If a termination were to occur, it would result in the deemed contribution by the trust of its assets to a newly formed trust in exchange for interests in such newly formed trust, which the terminated trust would be deemed to distribute to the Security Owners. The series of deemed transactions would not result in recognition of gain or loss to the trust or to the Security Owners. If the Partner Certificates are Book Entry Certificates, the trust most likely will not be able to comply with the termination provisions of Section 708 of the Code due to lack of information concerning the transfer of interests in the trust.

Section 754 Election.

If a Security Owner were to sell its Partner Certificate at a profit (loss), the purchaser would have a higher (lower) adjusted basis in the Certificate than did the seller. The trust's adjusted basis in its assets would not be adjusted to reflect this difference unless the trust made an election under Section 754 of the Code. To avoid the administrative complexities that would be involved if such an election were to be made, a trust that is classified as a partnership will not make an election under Section 754 of the Code unless otherwise provided in the applicable prospectus supplement. As a result, a beneficial owner of a Partner Certificate might be allocated a greater or lesser amount of partnership income than would be appropriate based on its own purchase price for its Partner Certificate.

Foreign Persons.

Unless otherwise provided in the applicable prospectus supplement, income allocated and distributions made by the trust to a Security Owner who is a Foreign Person will be subject to United States federal income tax and withholding tax, if the income attributable to a security is not effectively connected with the conduct of a trade or business within the United States by the Foreign Person.

Any capital gain realized on the sale, redemption, retirement or other taxable disposition of a beneficial interest in a Partner Certificate by a Foreign Person will be exempt from United States federal income and withholding tax, provided that (i) such gain is not effectively connected with the conduct of a trade or business in the United States by the Foreign Person and (ii) in the case of an individual, the individual is not present in the United States for 183 days or more in the taxable year.

Information Reporting.

Each trust classified as a partnership will file a partnership tax return on IRS Form 1065 with the IRS for each taxable year of the trust. The trust will report each Security Owner's allocable share of the trust's items of income and expense to the Security Owner and to the IRS on Schedules K-1. The trust will provide the Schedules K-1 to nominees that fail to provide the trust with the information statement described below and the nominees then will be required to forward that information to the beneficial owners of the Partner Certificates. Generally, a Security Owner must file tax returns that are consistent with the information reported on the Schedule K-1 or be subject to penalties, unless the Security Owner notifies the IRS of the inconsistencies.

Under Section 6031 of the Code, any person that holds a Partner Certificate as a nominee at any time during a calendar year is required to furnish to the trust a statement containing certain information concerning the nominee and the beneficial owner of the Partner Certificates. In addition, brokers and financial institutions that hold Partner Certificates through a nominee are required to furnish directly to the trust information as to the beneficial ownership of the Partner Certificates. The information referred to above for any calendar year is to be provided to the trust by Jan. 31 of the following year. Brokers and nominees who fail to provide the information may be subject to penalties. However, a clearing agency registered under Section 17A of the Securities Exchange Act of 1934 is not required to furnish that information statement to the trust.

Administrative Matters.

Unless another designation is made, the depositor will be designated as the tax matters partner in the trust agreement and, as the tax matters partner, will be responsible for representing the beneficial owners of Partner Certificates in any dispute with the IRS. The Code provides for administrative examination of a partnership as if the partnership were a separate and distinct taxpayer. Generally, the statute of limitations for partnership items does not expire until three years after the date on which the partnership information return is filed. Any adverse determination following an audit of the return of the partnership by the appropriate taxing authorities could result in an adjustment of the returns of the beneficial owners of Partner Certificates, and, under certain circumstances, a beneficial owner may be precluded from separately litigating a proposed adjustment to the items of the partnership. An adjustment also could result in an audit of a beneficial owner's returns and adjustments of items not related to the income and losses of the partnership.

Special Tax Attributes

In certain cases, securities are afforded special tax attributes under particular sections of the Code, as discussed below.

REMIC Certificates.

REMIC certificates held by a domestic building and loan association will constitute “regular or residual interests in a REMIC” within the meaning of Section 7701(a)(19)(C)(xi) of the Code in proportion to the assets of the REMIC that are described in Section 7701(a)(19)(C)(i) through (x). If, however, at least 95 percent of the assets of the REMIC are described in Section 7701(a)(19)(C)(i) through (x), the entire REMIC certificates in that REMIC will so qualify.

In addition, REMIC certificates held by a REIT will constitute “real estate assets” within the meaning of Section 856(c)(5)(B) of the Code. If at any time during a calendar year less than 95 percent of the assets of a REMIC consist of “real estate assets,” then the portion of the REMIC certificates that are real estate assets under Section 856(c)(5)(B) during the calendar year will be limited to the portion of the assets of the REMIC that are real estate assets. Similarly, income on the REMIC certificates will be treated as “interest on obligations secured by mortgages on real property” within the meaning of Section 856(c)(3)(B) of the Code, subject to the same limitation as set forth in the preceding sentence.

REMIC regular certificates also will be “qualified mortgages” within the meaning of Section 860G(a)(3) of the Code with respect to other REMICs, provided they are transferred to the other REMICs within the periods required by the Code, and will be “permitted assets” within the meaning of Section 860L(c)(1) of the Code with respect to FASITs.

The determination as to the percentage of the REMIC's assets that constitute assets described in the foregoing sections of the Code will be made for each calendar quarter based on the average adjusted basis of each category of the assets held by the REMIC during that calendar quarter. The REMIC will report those determinations in the manner and at the times required by applicable Treasury regulations. The Small Business Job Protection Act of 1996 (the “SBJPA of 1996”) repealed the reserve method for bad debts of domestic building and loan associations and mutual savings banks, and thus has eliminated the asset category of “qualifying real property loans” in former Section 593(d) of the Code for taxable years beginning after Dec. 31, 1995. The requirements in the SBJPA of 1996 that these institutions must “recapture” a portion of their existing bad debt reserves is suspended if a certain portion of their assets are maintained in “residential loans” under Section 7701(a)(19)(C)(v) of the Code, but only if those loans were made to acquire, construct or improve the related real property and not for the purpose of refinancing. However, no effort will be made to identify the portion of the mortgage loans of any series meeting this requirement, and no representation is made in this regard.

The assets of the REMIC will include, in addition to mortgage loans, payments on mortgage loans held pending distribution on the REMIC certificates and property acquired by foreclosure held pending sale, and may include amounts in reserve accounts. It is unclear whether property acquired by foreclosure held pending sale and amounts in reserve accounts would be considered to be part of the mortgage loans, or whether those assets (to the extent not invested in assets described in the foregoing sections) otherwise would receive the same treatment as the mortgage loans for purposes of all of the foregoing sections. Under the regulations applicable to REITs, however, mortgage loan payments held by a REMIC pending distribution are real estate assets for purposes of Section 856(c)(5)(B) of the Code. Furthermore, foreclosure property generally will qualify as real estate assets under Section 856(c)(5)(B) of the Code.

For some series of REMIC certificates, two or more separate elections may be made to treat designated portions of the related trust fund as REMICs (“Tiered REMICs”) for federal income tax purposes. Solely for purposes of determining whether the REMIC certificates will be “real estate assets” within the meaning of Section 856(c)(5)(B) of the Code and “loans secured by an interest in real property” under Section 7701(a)(19)(C) of the Code, and whether the income on those Certificates is interest described in Section 856(c)(3)(B) of the Code, the Tiered REMICs will be treated as one REMIC.

As described above, certain REMIC regular certificates will evidence ownership of a REMIC regular interest and a notional principal contract, as further described in the accompanying supplement. See “Types of Securities—REMIC Certificates Generally” above. Any such notional principal contract (and any income therefrom) will not be afforded any of the special tax attributes described in this section.

FASIT Regular Certificates.

FASIT regular certificates held by a REIT will qualify as “real estate assets” within the meaning of Section 856(c)(5)(B) of the Code, and interest on such certificates will be considered “interest on obligations secured by mortgages on real property” within the meaning of Section 856(c)(3)(B) of the Code to the same extent that REMIC certificates would be so considered. Likewise, FASIT regular certificates held by a domestic building and loan association will represent qualifying assets for purposes of the qualification requirements set forth in Section 7701(a)(19)(C) of the Code to the same extent that REMIC certificates would be so considered. See “—REMIC Certificates” above.

Non-REMIC and Non-FASIT Debt Securities. Debt Securities that are not REMIC regular certificates or FASIT regular certificates and that are owned by domestic building and loan associations and other thrift institutions will not be considered “loans secured by an interest in real property” or “qualifying real property loans.” Moreover, such Debt Securities owned by a REIT will not be treated as “real estate assets” nor will interest on the Debt Securities be considered “interest on obligations secured by mortgages on real property.” In addition, such Debt Securities will not be “qualified mortgages” for REMICs.

Grantor Trust Certificates.

Standard Certificates held by a domestic building and loan association will constitute “loans secured by interests in real property” within the meaning of Section 7701(a)(19)(C)(v) of the Code; Standard Certificates held by a REIT will constitute “real estate assets” within the meaning of Section 856(c)(5)(B) of the Code; amounts includible in gross income with respect to Standard Certificates held by a REIT will be considered “interest on obligations secured by mortgages on real property” within the meaning of Section 856(c)(3)(B) of the Code; and Standard Certificates transferred to a REMIC within the prescribed time periods will qualify as “qualified mortgages” within the meaning of Section 860G(a)(3) of the Code; provided in each case that the related assets of the trust (or income therefrom, as applicable) would so qualify.

Although there appears to be no policy reason not to accord to Stripped Certificates the treatment described above for Standard Certificates, there is no authority addressing such characterization for instruments similar to Stripped Certificates. It is recommended that prospective investors in Stripped Certificates consult their own tax advisers regarding the characterization of Stripped Certificates, and the income therefrom, if the characterization of the Stripped Certificates under the above-referenced rules is relevant.

Partner Certificates.

For federal income tax purposes, Partner Certificates held by a domestic building and loan association will not constitute “loans secured by an interest in real property” within the meaning of Code Section 7701(a)(19)(C)(v), but, for purposes of the provisions applicable to REITs, a REIT holding a Partnership Certificate will be deemed to hold its proportionate share of each of the assets of the partnership and will be deemed to be entitled to the income of the partnership attributable to such share, based in each case on the REIT's capital interest in the issuer.

Backup Withholding

Distributions on securities, as well as payment of proceeds from the sale of securities, may be subject to the backup withholding tax under Section 3406 of the Code if recipients fail to furnish certain information, including their taxpayer identification numbers, or otherwise fail to establish an exemption from such tax. Any amounts deducted and withheld from a recipient would be allowed as a credit against such recipient's federal income tax. Furthermore, certain penalties may be imposed by the IRS on a recipient that is required to supply information but that does not do so in the manner required.

State Tax Considerations

In addition to the federal income tax consequences described above, potential investors should consider the state and local income tax consequences of the acquisition, ownership and disposition of securities. State and local income tax law may differ substantially from the corresponding federal law, and this discussion does not purport to describe any aspect of the income tax laws of any state or locality.

For example, a REMIC or FASIT or non-REMIC or non-FASIT trust may be characterized as a corporation, a partnership, or some other entity for purposes of state income tax law. Such characterization could result in entity level income or franchise taxation of the trust. It is recommended that potential investors consult their own tax advisors with respect to the various state and local tax consequences of an investment in securities.

ERISA Considerations

General

The Employee Retirement Income Security Act of 1974, as amended (“ERISA”), and the Code impose certain requirements in connection with the investment of plan assets on employee benefit plans and on certain other retirement plans and arrangements, including individual retirement accounts and annuities, Keogh plans and collective investment funds and separate accounts in which these plans, accounts or arrangements are invested, that are subject to Title I of ERISA or to Section 4975 of the Code (“Plans”) and on persons who are fiduciaries for those Plans. Some employee benefit plans, such as governmental plans (as defined in ERISA Section 3(32)) and, if no election has been made under Section 410(d) of the Code, church plans (as defined in Section 3(33) of ERISA), are not subject to ERISA requirements. Therefore, assets of these plans may be invested in securities without regard to the ERISA considerations described below, subject to the provisions of other applicable federal, state and local law. Any of these plans that are qualified and exempt from taxation under Sections 401(a) and 501(a) of the Code, however, are subject to the prohibited transaction rules set forth in Section 503 of the Code.

ERISA generally imposes on Plan fiduciaries certain general fiduciary requirements, including those of investment prudence and diversification and the requirement that a Plan's investments be made in accordance with the documents governing the Plan. In addition, ERISA and the Code prohibit a broad range of transactions involving assets of a Plan and persons (“Parties in Interest”) who have certain specified relationships to the Plan unless a statutory, regulatory or administrative exemption is available. Certain Parties in Interest that participate in a prohibited transaction may be subject to excise taxes imposed pursuant to Section 4975 of the Code, unless a statutory, regulatory or administrative exemption is available. These prohibited transactions generally are set forth in Sections 406 and 407 of ERISA and Section 4975 of the Code.

A Plan's investment in securities may cause the primary assets and other assets included in a related trust find to be deemed Plan assets. The United States Department of Labor (“DOL”) has issued regulations set forth at 29 C.F.R. Section 2510.3-101 (the “DOL Regulations”) which provide that when a Plan acquires an equity interest in an entity, the Plan's assets include both the equity interest and an undivided interest in each of the underlying assets of the entity, unless certain exceptions not applicable here apply, or unless the equity participation in the entity by “benefit plan investors” (i.e., Plans, employee benefit plans not subject to ERISA, and entities whose underlying assets include plan assets by reason of a Plan's investment in the entity) is not “significant,” both as defined therein. For this purpose, in general, equity participation by benefit plan investors will be “significant” on any date if 25% or more of the value of any class of equity interests in the entity is held by benefit plan investors. To the extent the securities are treated as equity interests for purposes of the DOL Regulations, equity participation in a trust fund will be significant on any date if immediately after the most recent acquisition of any security, 25% or more of any class of securities is held by benefit plan investors.

Any person who has discretionary authority or control respecting the management or disposition of assets of a Plan, and any person who provides investment advice for those assets for a fee, is a fiduciary of the Plan. If the primary assets and other assets included in a trust fund constitute plan assets of an investing Plan, then any party exercising management or discretionary control regarding those assets, such as any servicer, may be deemed to be a “fiduciary” of the Plan and thus subject to the fiduciary responsibility provisions and prohibited transaction provisions of ERISA and the Code with respect to the investing Plan. In addition, if the primary assets and other assets included in a trust fund constitute plan assets, certain activities involved in the operation of the trust fund may constitute or involve prohibited servicing, sales or exchanges of property or extensions of credit transactions under ERISA and the Code.

The Underwriter Exemption

The DOL issued an individual exemption to Lehman Brothers Inc.'s predecessor in interest, Shearson Lehman Hutton Inc. (Prohibited Transaction Exemption (“PTE”) 91-14 et al.; 56 Fed. Reg. 7413 (1991) as most recently amended and restated by PTE 2002-41, 67 Fed. Reg. 54487 (2002)) (the “Exemption”) that generally exempts from the application of the prohibited transaction provisions of Sections 406(a) and 407(a) of ERISA, and the excise taxes imposed on those prohibited transactions pursuant to Sections 4975(a) and (b) of the Code, certain transactions relating to the servicing and operation of mortgage pools and the purchase (in both the initial offering and secondary market), sale and holding of securities underwritten by an underwriter, as defined below, that (1) represent a beneficial ownership interest in the assets of an issuer which is a trust and entitle the holder to pass-through payments of principal, interest and/or other payments made with respect to the assets of the trust fund or (2) are denominated as a debt instrument and represent an interest in or issued by the issuer, provided that certain conditions set forth in the Exemption are satisfied.

For purposes of this Section “ERISA Considerations,” the term “underwriter” will include (a) Lehman Brothers Inc., (b) any person directly or indirectly, through one or more intermediaries, controlling, controlled by or under common control with Lehman Brothers Inc., and (c) any member of the underwriting syndicate or selling group of which a person described in (a) or (b) is a manager or co-manager for a class of securities.

Among the general conditions that must be satisfied for exemptive relief under the Exemption are:
1. The acquisition of securities by a Plan must be on terms (including the price for the securities) that are at least as favorable to the Plan as they would be in an arm's-length transaction with an unrelated party;
2. The securities at the time of acquisition by the Plan must be rated in one of the three highest generic rating categories (four, in a Designated Transaction) by Standard & Poor's Ratings Services, a division of The McGraw-Hill Companies, Inc. (“S&P”), Moody's Investors Service, Inc. (“Moody's”) or Fitch Ratings (“Fitch”) (each, a “Rating Agency”);
3. In the case of a transaction described in the Exemption as a designated transaction (a “Designated Transaction”), in which the investment pool contains only certain types of assets such as the primary assets which are fully secured, the Exemption covers subordinated securities issued by the trust fund in such transaction which are rated in one of the four highest generic rating categories by a Rating Agency. The Exemption also applies to securities backed by residential and home equity loans that are less than fully secured, provided that (1) the rights and interests evidenced by the securities are not subordinated to the rights and interests evidenced by the other securities of the trust fund, (2) the securities are rated in either of the two highest generic rating categories by a Rating Agency and (3) any loan included in the investment pool is secured by collateral whose fair market value on the closing date of the transaction is at least equal to 80% of the sum of (a) the outstanding principal balance due under the loan which is held by the trust fund and (b) the outstanding principal balance(s) of any other loan(s) of higher priority (whether or not held by the trust fund) which are secured by the same collateral;
4. Assets of the type included in a particular trust find have been included in other investment pools and securities evidencing interests in such other pools have been both (i) rated in one of the three (or in the case of a Designated Transaction, four) highest generic rating categories by a Rating Agency and (ii) been purchased by investors other than Plans for at least one year prior to a Plan's acquisition of securities in reliance on the Exemption;
5. The trustee may not be an affiliate of any other member of the Restricted Group, as defined below, other than any underwriter;
6. The sum of all payments made to and retained by the underwriter(s) must represent not more than reasonable compensation for underwriting the securities; the sum of all payments made to and retained by the depositor pursuant to the assignment of the assets to the issuer must represent not more than the fair market value of those obligations; and the sum of all payments made to and retained by the master servicer and any other servicer must represent not more than reasonable compensation for that person's services under the related Agreement and reimbursement of that person's reasonable expenses in connection therewith;
7. The Plan investing in the securities must be an accredited investor as defined in Rule 501(a)(1) of Regulation D of the Commission under the securities Act of 1933, as amended; and
8. For certain types of issuers, the documents establishing the issuer and governing the transaction must contain provisions intended to protect the assets of the issuer from creditors of the depositor.

The rating of a security may change. If the rating of a security declines below the lowest permitted rating, the security will no longer be eligible for relief under the Exemption (although a Plan that had purchased the security when the security had a permitted rating would not be required by the Exemption to dispose of it). Consequently, only Plan investors that are insurance company general accounts would be permitted to purchase the securities in such circumstances pursuant to Section I and III of Prohibited Transaction Class Exemption (“PTCE”) 95-60.

The Exemption permits interest-rate swaps and yield supplement agreements to be assets of the trust fund subject to certain conditions. An interest-rate swap (or if purchased by or on behalf of the trust fund) an interest-rate cap contract (collectively, a “Swap” or “Swap Agreement”) is a permitted trust fund asset if it:
1. is an “eligible Swap;”
2. is with an “eligible counterparty;”
3. is purchased by a “qualified plan investor;”
4. meets certain additional specific conditions which depend on whether the Swap is a “ratings dependent Swap” or a “non-ratings dependent Swap;” and
5. permits the trust fund to make termination payments to the Swap (other than currently scheduled payments) solely from excess spread or amounts otherwise payable to the servicer or depositor.

An “eligible Swap” is one which:
a. is denominated in U.S. dollars;
b. pursuant to which the trust fund pays or receives, on or immediately prior to the respective payment or distribution date for the class of securities to which the Swap relates, a fixed rate of interest or a floating rate of interest based on a publicly available index (e.g., LIBOR or the U.S. Federal Reserve's Cost of Funds Index (COFI)), with the trust fund receiving such payments on at least a quarterly basis and obligated to make separate payments no more frequently than the counterparty, with all simultaneous payments being netted (“Allowable Interest Rate”);
c. has a notional amount that does not exceed either: (i) the principal balance of the class of securities to which the Swap relates, or (ii) the portion of the principal balance of such class represented by primary assets (“Allowable Notional Amount”);
d. is not leveraged (i.e., payments are based on the applicable notional amount, the day count fractions, the fixed or floating rates permitted above, and the difference between the products thereof, calculated on a one-to-one ratio and not on a multiplier of such difference) (“Leveraged”);
e. has a final termination date that is either the earlier of the date on which the issuer terminates or the related class of securities are fully repaid; and
f. does not incorporate any provision that could cause a unilateral alteration in the interest rate requirements described above or the prohibition against leveraging.

An “eligible counterparty” means a bank or other financial institution which has a rating at the date of issuance of the securities, which is in one of the three highest long term credit rating categories or one of the two highest short term credit rating categories, utilized by at least one of the Rating Agencies rating the securities; provided that, if a counterparty is relying on its short term rating to establish eligibility hereunder, such counterparty must either have a long term rating in one of the three highest long term rating categories or not have a long term rating from the applicable Rating Agency.

A “qualified plan investor” is a Plan or Plans where the decision to buy such class of securities is made on behalf of the Plan by an independent fiduciary qualified to understand the Swap transaction and the effect the Swap would have on the rating of the securities and such fiduciary is either:
a. a “qualified professional asset manager” (“QPAM”) under PTCE 84-14,
b. an “in-house asset manager” under PTCE 96-23 or
c. has total assets (both Plan and non-Plan) under management of at least $100 million at the time the securities are acquired by the Plan.

In “ratings dependent Swaps” (where the rating of a class of securities is dependent on the terms and conditions of the Swap), the Swap Agreement must provide that if the credit rating of the counterparty is withdrawn or reduced by any Rating Agency below a level specified by the Rating Agency, the servicer must, within the period specified under the pooling and servicing agreement:
a. obtain a replacement Swap Agreement with an eligible counterparty which is acceptable to the Rating Agency and the terms of which are substantially the same as the current Swap Agreement (at which time the earlier Swap Agreement must terminate); or
b. cause the Swap counterparty to establish any collateralization or other arrangement satisfactory to the Rating Agency such that the then current rating by the Rating Agency of the particular class of securities will not be withdrawn or reduced (and the terms of the Swap Agreement must specifically obligate the counterparty to perform these duties for any class of securities with a term of more than one year).

In the event that the servicer fails to meet these obligations, Plan securityholders must be notified in the immediately following periodic report, which is provided to securityholders, but in no event later than the end of the second month beginning after the date of such failure. Sixty days after the receipt of such report, the exemptive relief provided under the Exemption will prospectively cease to be applicable to any class of securities held by a Plan which involves such ratings dependent Swap.

“Non-ratings dependent Swaps” (those where the rating of the securities does not depend on the terms and conditions of the Swap) are subject to the following conditions. If the credit rating of the counterparty is withdrawn or reduced below the lowest level permitted above, the servicer will, within a specified period after such rating withdrawal or reduction:
a. obtain a replacement Swap Agreement with an eligible counterparty, the terms of which are substantially the same as the current Swap Agreement (at which time the earlier Swap Agreement must terminate);
b. cause the counterparty to post collateral with the trust in an amount equal to all payments owed by the counterparty if the Swap transaction were terminated; or
c. terminate the Swap Agreement in accordance with its terms.

An “eligible yield supplement agreement” is any yield supplement agreement or similar arrangement (or if purchased by or on behalf of the trust find) an interest rate cap contract to supplement the interest rates otherwise payable on obligations held by the trust fund (“EYS Agreement”). If the EYS Agreement has a notional principal amount and/or is written on an International Swaps and Derivatives Association, Inc. (ISDA) form, the EYS Agreement may only be held as an asset of the trust find with respect to securities purchased by Plans if it meets the following conditions:
a. it is denominated in U.S. dollars;
b. it pays an Allowable Interest Rate;
c. it is not Leveraged;
d. it does not allow any of these three preceding requirements to be unilaterally altered without the consent of the trustee;
e. it is entered into between the trust fund and an eligible counterparty; and
f. it has an Allowable Notional Amount.

The Exemption permits transactions using a Pre-Funding Account whereby a portion of the primary assets are transferred to the trust fund within a specified period following the closing date (“DOL Pre-Funding Period”) instead of requiring that all such primary assets be either identified or transferred on or before the closing date, provided that the DOL Pre-Funding Period generally ends no later than three months or 90 days after the closing date, the ratio of the amount allocated to the Pre-Funding Account to the total principal amount of the securities being offered generally does not exceed twenty-five percent (25%) and certain other conditions set forth in the Exemption are satisfied.

If the general conditions of the Exemption are satisfied, the Exemption may provide an exemption from the restrictions imposed by Sections 406(a) and 407(a) of ERISA (as well as the related excise taxes imposed by Section 4975 of the Code) in connection with the direct or indirect sale, exchange, transfer, holding or the direct or indirect acquisition or disposition in the secondary market of securities by Plans and the servicing, management and operation of the trust fund. A fiduciary of a Plan contemplating purchasing a security should make its own determination that the general conditions set forth above will be satisfied for that security.

The Exemption also may provide an exemption from the restrictions imposed by Sections 406(a) and 407 of ERISA, and the excise taxes imposed by Section 4975 of the Code, if those restrictions are deemed to otherwise apply merely because a person is deemed to be a “party in interest” with respect to an investing Plan by virtue of providing services to the Plan (or by virtue of having certain specified relationships to that person) solely as a result of the Plan's ownership of securities.

The Exemption also provides relief from certain self-dealing/conflict of interest prohibited transactions that may arise under Sections 406(b)(1) and 406(b)(2) of ERISA (as well as from the excise taxes imposed by Section 4975 of the Code) when a fiduciary causes a Plan to invest in an issuer that holds obligations on which the fiduciary (or its affiliate) is an obligor only if, among other requirements: (1) the fiduciary (or its affiliate) is an obligor with respect to no more than 5% of the fair market value of the obligations contained in the trust fund; (2) the Plan's investment in each class of securities does not exceed 25% of all of the securities of that class outstanding at the time of the acquisition; (3) immediately after the acquisition, no more than 25% of the assets of any Plan for which the fiduciary serves as a fiduciary are invested in securities representing an interest in one or more trusts containing assets sold or serviced by the same entity; (4) in the case of an acquisition of securities in connection with their initial issuance, at least 50% of each class of securities in which Plans have invested and at least 50% of the aggregate interest in the issuer is acquired by persons independent of the Restricted Group; and (5) the Plan is not an Excluded Plan. An “Excluded Plan” is one that is sponsored by a member of the Restricted Group, which consists of the trustee, each underwriter, any insurer of the securities, the depositor, any servicer, any obligor with respect to obligations included in the issuer constituting more than 5% of the aggregate unamortized principal balance of the assets of the issuer on the date of the initial issuance of securities, each counterparty in any eligible swap transactions and any affiliate of any such persons.

However, no exemption is provided from the restrictions of Sections 406(a)(1)(E), 406(a)(2) and 407 of ERISA for the acquisition or holding of a security on behalf of an Excluded Plan by any person who has discretionary authority or renders investment advice with respect to the assets of that Excluded Plan.

Additional Considerations For Securities Which Are Notes

Without regard to whether securities are treated as equity interests for purposes of the DOL Regulations, because any of the depositor, the trustee, any underwriter, the issuer or any of their affiliates might be considered or might become Parties in Interest with respect to a Plan, the acquisition or holding of securities which are considered debt without substantial equity features by or on behalf of that Plan could be considered to give rise to both direct and indirect prohibited transactions within the meaning of ERISA and the Code, unless one or more statutory, regulatory or administrative exemptions are applicable. Included among such exemptions are: the Exemption, PTCE 84-14, which exempts certain transactions effected on behalf of a Plan by a “qualified professional asset manager,” PTCE 90-1, which exempts certain transactions involving insurance company pooled separate accounts, PTCE 91-38, which exempts certain transactions involving bank collective investment funds, PTCE 95-60, which exempts certain transactions involving insurance company general accounts, or PTCE 96-23, which exempts certain transactions effected on behalf of a Plan by certain “in-house” asset managers. It should be noted, however, that even if the conditions specified in one or more of these exemptions are met, the scope of relief provided may not necessarily cover all acts that might be construed as prohibited transactions.

Additional Fiduciary Considerations

The depositor, any servicer, the servicer, the trustee or any underwriter may be the sponsor of, or investment advisor with respect to, one or more Plans. Because these parties may receive certain benefits in connection with the sale of securities, the purchase of securities using Plan assets over which any of these parties has investment discretion or management authority might be deemed to be a violation of the prohibited transaction rules of ERISA and the Code for which no exemption may be available. Accordingly, securities should not be purchased using the assets of any Plan if any of the depositor, any servicer, the trustee or any underwriter or any of their affiliates has investment discretion or management authority for those assets, or is an employer maintaining or contributing to the Plan, if such acquisition would constitute a non-exempt prohibited transaction.

Any Plan fiduciary that proposes to cause a Plan to purchase securities should consult with its counsel with respect to the potential applicability of ERISA and the Code to that investment, the availability of the exemptive relief provided in the Exemption and the potential applicability of any other prohibited transaction exemption in connection therewith. In particular, a Plan fiduciary that proposes to cause a Plan to purchase securities representing a beneficial ownership interest in a pool of single-family residential first mortgage loans should consider the applicability of PTCE 83-1, which provides exemptive relief for certain transactions involving mortgage pool investment trusts. The prospectus supplement for a series of securities may contain additional information regarding the application of the Exemption, PTCE 83-1 or any other exemption, with respect to the securities offered thereby.

Any Plan fiduciary considering whether to purchase a security on behalf of a Plan should consult with its counsel regarding the application of the DOL Regulations and the fiduciary responsibility and prohibited transaction provisions of ERISA and the Code to that investment.

The sale of securities to a Plan is in no respect a representation by the depositor or the underwriter that the investment meets all relevant legal requirements for investments by Plans generally or any particular Plan, or that the investment is appropriate for Plans generally or any particular Plan.

Legal Investment

Unless otherwise specified in the related prospectus supplement, the securities will not constitute “mortgage related securities” under SMMEA. Accordingly, investors whose investment authority is subject to legal restrictions should consult their own legal advisors to determine whether and to what extent the securities constitute legal investments for them.

Ratings

It will be a requirement for issuance of any series that the securities offered by this prospectus and the related prospectus supplement be rated by at least one Rating Agency in one of its four highest applicable rating categories. The rating or ratings applicable to securities of each series offered hereby and by the related prospectus supplement will be as set forth in the related prospectus supplement. A securities rating should be evaluated independently of similar ratings on different types of securities. A securities rating does not address the effect that the rate of prepayments on loans or underlying loans, as applicable, for a series may have on the yield to investors in the securities of the series.

Plan of Distribution

The depositor may offer each series of securities through Lehman Brothers Inc. or one or more other firms that may be designated at the time of each offering of the securities. The participation of Lehman Brothers in any offering will comply with Schedule E to the By-Laws of the National Association of Securities Dealers, Inc. The prospectus supplement relating to each series of securities will set forth the specific terms of the offering of the series of securities and of each class within the series, the names of the underwriters, the purchase price of the securities, the proceeds to the depositor from such sale, any securities exchange on which the securities may be listed, and, if applicable, the initial public offering prices, the discounts and commissions to the underwriters and any discounts and concessions allowed or reallowed to dealers. The place and time of delivery of each series of securities will also be set forth in the prospectus supplement relating to that series. Lehman Brothers is an affiliate of the depositor.

Trust Example

$500,012,000
A Home Equity Loan Trust, as Issuer
Home Equity Loan Asset-Backed Notes

| | BANK | | | | |
|---|---|---|---|---|---|
| | a federal savings bank, | | Lehman ABS Corporation, | | |
| | as seller and servicer | | as depositor | | |
| | Principal | Note | Price to | Underwriting | Proceeds to the |
| | Balance | Rate (1) | Public | Discount | Depositor (2) |
| Per Note | | LIBOR + 0.12% | 100.00% | 0.30% | 99.70% |
| Total | $500,012,000 | | $500,012,000 | $1,500,036 | $498,511,964 |

(1) Variable, as described in this prospectus supplement.
(2) Before deducting expenses, payable by the depositor, estimated to be $1,300,000.

Incorporation of Certain Documents by Reference

All documents subsequently filed by or on behalf of the trust fund referred to in the accompanying prospectus supplement with the Commission pursuant to Section 13(a), 13(c), 14 or 15(d) of the Securities Exchange Act of 1934, as amended, after the date of this prospectus and prior to the termination of any offering of the securities issued by the trust fund will be deemed to be incorporated by reference in this prospectus and to be a part of this prospectus from the date of the filing of the documents. Any statement contained in a document incorporated or deemed to be incorporated by reference herein will be deemed to be modified or superseded for all purposes of this prospectus to the extent that a statement contained herein (or in the accompanying prospectus supplement) or in any other subsequently filed document that also is or is deemed to be incorporated by reference modifies or replaces the statement. Any statement so modified or superseded will not be deemed, except as so modified or superseded, to constitute a part of this prospectus.

The trustee on behalf of any trust fund will provide without charge to each person to whom this prospectus is delivered, on the written or oral request of that person, a copy of any or all of the documents referred to above that have been or may be incorporated by reference in this prospectus (not including exhibits to the information that is incorporated by reference unless the exhibits are specifically incorporated by reference into the information that this prospectus incorporates). Requests should be directed to the corporate trust office of the trustee specified in the accompanying prospectus supplement.

What is claimed is:

1. A method for determining a coupon margin comprising:
establishing one or more collateralized notes each having a first coupon margin, said first coupon margin comprising one or more periodic distributions and one or more periodic payments for a predetermined time;
at the expiration of the predetermined time, holding an auction for the one or more collateralized notes, said auction comprising one or more auction bids from each of one or more parties;
calculating a second coupon margin based on at least one of the one or more auction bids;
transferring the one or more collateralized notes to at least one of the one or more parties; and making a par payment.

2. The method of claim 1, wherein a portion of the par payment comprises an amount provided by a guarantor.

3. The method of claim 1, wherein the one or more collateralized notes are secured by a lot loan pool certificate.

4. The method of claim 1, wherein the one or more collateralized notes are secured by a lot loan pool.

5. The method of claim 1, wherein a portion of the par payment is calculated using a backstop amount.

6. The method of claim 1, wherein said one or more collateralized notes are secured by a HELOC loan pool certificate.

7. The method of claim 1, wherein said one or more collateralized notes are secured by a HELOC loan pool.

8. A method for determining a coupon margin comprising:
establishing one or more collateralized notes each having a first coupon margin, said first coupon margin comprising one or more periodic distributions and one or more periodic payments for a predetermined time;
at the expiration of the predetermined time, holding an auction for the one or more collateralized notes, said auction comprising one or more bids from each of one or more parties;
if no bid is within one or more parameters, setting a second coupon margin based on at least one of said one or more parameters; and
making a backstop payment.

9. A method for limiting guarantor exposure in a note auction comprising:
setting a preferred coupon margin, an acceptable coupon margin, and a maximum coupon margin in a note auction;
holding said note auction;
where the note auction results in the preferred coupon margin, paying a par value comprising proceeds from the note auction;
where the note auction results in the acceptable coupon margin, paying the par value comprising proceeds from the note auction and a backstop payment; and
where the note auction exceeds the maximum coupon margin, paying only a backstop payment.

10. A method for ensuring par payments to one or more note owners comprising:
setting a preferred coupon margin and an acceptable coupon margin in a note auction;
holding said note auction;
where the note auction results in the preferred coupon margin, paying a par value comprising proceeds from the note auction; and
where the note auction results in the acceptable coupon margin, paying the par value comprising proceeds from the note auction and a backstop payment.
